(19) United States
(12) Patent Application Publication
(10) Pub. No.: US 2026/0289280 A1
(43) Pub. Date: Sep. 24, 2026

(54) ADAPTIVE MULTI-MODAL SIGNAL MONITORING PLATFORM

(71) Applicants: Tueng T. Shen, Woodinville, WA (US); Nathan White, Woodinville, WA (US); RuiKang Wang, Bellevue, WA (US); Xu Chen, Seattle, WA (US); Jihui Yang, Bellevue, WA (US); Jenq-Neng Hwang, Lake Forest Park, WA (US)

(72) Inventors: Tueng T. Shen, Woodinville, WA (US); Nathan White, Woodinville, WA (US); RuiKang Wang, Bellevue, WA (US); Xu Chen, Seattle, WA (US); Jihui Yang, Bellevue, WA (US); Jenq-Neng Hwang, Lake Forest Park, WA (US)

(21) Appl. No.: 19/572,718

(22) Filed: Mar. 19, 2026

Related U.S. Application Data
(60) Provisional application No. 63/774,488, filed on Mar. 19, 2025.

(51) Int. Cl. G06N 3/0475; G06N 3/08

(52) U.S. Cl. CPC G06N 3/0475; G06N 3/08

(57) ABSTRACT

Disclosed are techniques for multi-modal signal monitoring and processing, such as obtaining a first environment signal set indicating a physical environment around the edge computing apparatus that comprises the target signal source, calculating a spatial position of the target signal source within the physical environment, adjusting spatial positioning of the one or more sensors relative to the spatial position of the target signal source to uncover a region of interest, obtaining a second environment signal set of a uniform data modality indicating physical features of the region of interest, use an artificial intelligence (AI) model to generate output metrics of data modalities different from the uniform data modality, using a generative AI model to generate metric deviation scores for the output metrics, and automatically transmitting a notification indicating required maintenance of the target signal source when the metric deviation scores fail a tolerance threshold value.

### CROSS-REFERENCE TO RELATED APPLICATIONS

This application claims priority to U.S. Provisional Patent Application No. 63/774,488, filed on Mar. 19, 2025, entitled DYNAMIC ROBOTICS SYSTEMS AND METHODS FOR OPERATING THE SAME, which is hereby incorporated by reference in its entirety.

### BACKGROUND

In clinical and biomedical computing environments, monitoring can refer to the systematic observation and computational assessment of physiological conditions, disease states, or medical parameters over defined temporal intervals utilizing one or more hardware processors and associated sensor arrays. Such monitoring can be performed through continuous acquisition of physiological measurement information utilizing medical monitoring apparatus (e.g., continuous vital sign measurement acquisition via bedside monitoring systems comprising one or more data processors), and/or through periodic execution of diagnostic processing operations (e.g., glycemic measurement monitoring utilizing glucose measurement devices for patients presenting with metabolic disorders).

The advancement of monitoring methodologies can represent an evolving domain within intelligent healthcare computing systems, biomedical-integrated diagnostic platforms, personalized preventive care systems, and predictive medical analytics engines. These computational approaches can emphasize comprehensive acquisition and algorithmic analysis of medical measurement information from patients, at-risk populations, and healthy individuals through utilization of sophisticated minimally invasive biomedical instrumentation, biosensor arrays, microfluidic diagnostic platforms, and computationally-enhanced diagnostic and early warning systems that can extend beyond conventional clinical assessment and therapeutic intervention protocols.

### BRIEF DESCRIPTION OF THE DRAWINGS

Detailed descriptions of implementations of the present invention will be described and explained through the use of the accompanying drawings.

FIG. 1 is a system diagram that illustrates an example environment in which a signal monitoring apparatus operates in accordance with some implementations of the present technology.

FIG. 2A is a block diagram that illustrates a signal monitoring apparatus that can implement aspects of the present technology.

FIG. 2B is a block diagram that illustrates a signal monitoring platform that can implement aspects of the present technology.

FIG. 3 is a block diagram that illustrates a signal monitoring lifecycle in accordance with some implementations of the present technology.

FIG. 4A is a diagram that illustrates an example spatial mapping of a physical environment in accordance with some implementations of the present technology.

FIG. 4B is a block diagram that illustrates a navigation framework in accordance with some implementations of the present technology.

FIG. 4C is a block diagram that illustrates a prioritization process for spatial navigation in accordance with some implementations of the present technology.

FIG. 4D is a flowchart that illustrates a navigation process for spatial navigation in accordance with some implementations of the present technology.

FIGS. 5A-5B are block diagrams that illustrate example user interfaces in accordance with some implementations of the present technology.

FIG. 6 is a flowchart that illustrates a process for adaptive multi-modal signal monitoring in accordance with some implementations of the present technology.

FIG. 7 is a system diagram illustrating an example of a computing environment in which the disclosed system operates in some implementations.

FIG. 8 illustrates a layered architecture of an artificial intelligence (AI) system that can implement the ML models of the signal monitoring platform in accordance with some implementations of the present technology.

FIG. 9 is a block diagram of an example transformer that can implement aspects of the present technology.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Conventional healthcare monitoring systems face substantial limitations in their ability to provide continuous, comprehensive physiological assessment of individuals within residential or assisted living environments. Traditional monitoring approaches typically require patients to visit clinical facilities for periodic assessments (e.g., scheduled doctor appointments, hospital visits, outpatient diagnostic sessions, and/or the like), creating temporal gaps during which significant changes in health status may go undetected. These episodic monitoring paradigms fail to capture the dynamic nature of physiological conditions that can fluctuate throughout daily activities (e.g., variations in heart rate during different postures, temperature changes across circadian cycles, gait pattern alterations during fatigue, and/or the like). Furthermore, conventional platforms often rely on contact-based measurement devices (e.g., wearable sensors, finger-clip pulse oximeters, adhesive electrode patches, and/or the like) that impose compliance burdens on patients, particularly elderly individuals or those with cognitive impairments who may forget to wear devices or find them uncomfortable. The fragmented nature of data collection across multiple standalone devices (e.g., separate blood pressure monitors, glucose meters, thermometers, and/or the like) creates challenges in synthesizing a holistic view of patient health, as each device typically operates in isolation without integration into a unified monitoring platform. Additionally, the static placement of monitoring equipment (e.g., bedside monitors, wall-mounted cameras, fixed sensor arrays, and/or the like) constrains observation to limited spatial regions, failing to track patients as they move throughout their living environments and potentially missing physiological events that occur outside the monitored zones.

Contemporary healthcare monitoring technologies exhibit further deficiencies in their capacity to adapt to changing patient positions, integrate diverse data modalities, and provide intelligent interpretation of captured physiological signals. Existing stationary monitoring platforms (e.g., surveillance camera networks, room-based sensor installations, fixed vital sign monitors, and/or the like) cannot autonomously reposition themselves to maintain optimal observation angles when patients move between rooms or change postures (e.g., transitioning from standing to sitting, moving from bedroom to kitchen, lying down on a couch, and/or the like). The inability to dynamically adjust sensor positioning results in degraded signal quality (e.g., suboptimal viewing angles for camera-based measurements, increased distance from thermal sensors, obstructed line-of-sight conditions, and/or the like) that compromises the accuracy of physiological measurements. Moreover, conventional platforms lack the computational intelligence to transform raw sensor data (e.g., video frames, thermal images, audio recordings, and/or the like) into meaningful physiological metrics (e.g., heart rate values, body temperature readings, gait analysis parameters, and/or the like) without specialized medical equipment requiring physical contact with the patient. The absence of integrated artificial intelligence capabilities in existing monitoring platforms prevents automated interpretation of physiological trends (e.g., detecting gradual changes indicative of disease progression, identifying anomalous patterns requiring clinical attention, correlating multiple vital signs for comprehensive health assessment, and/or the like). Furthermore, contemporary platforms typically transmit sensitive health data to cloud servers for processing (e.g., remote artificial intelligence inference, centralized data storage, third-party analytics services, and/or the like), raising privacy concerns and creating dependencies on network connectivity that may be unreliable in residential settings. The lack of interoperability between disparate medical devices (e.g., proprietary data formats, incompatible communication protocols, closed application programming interfaces, and/or the like) prevents unified data aggregation, forcing patients and caregivers to manually consolidate information from multiple sources to obtain a comprehensive health picture.

The disclosed platform (alternatively a “system”) provides an adaptive multi-modal signal monitoring capability that addresses the aforementioned limitations through integration of mobile sensing capabilities, non-contact uniform data-modality based physiological measurement techniques, and edge-based artificial intelligence processing. The platform can comprise an edge computing apparatus equipped with sensors (e.g., RGB and/or RGB-D cameras, thermal imaging sensors, microphone arrays, and/or the like) and actuators (e.g., locomotion assemblies, positioning motors, and/or the like) that enable autonomous navigation within physical environments and dynamic adjustment of sensor positioning and orientation relative to target signal sources. For example, the platform can calculate spatial positions of target signal sources using depth information derived from RGB-D camera configurations and can adjust sensor orientations to uncover regions of interest (e.g., face regions for heart rate estimation, body segments for pose analysis, medical device displays for instrument reading capture, and/or the like) corresponding to physiological measurement objectives. The platform can capture environment signals of a uniform data modality (e.g., digital images, video frames, thermal readings, and/or the like) and input these signals into artificial intelligence models to generate output metrics of different data modalities (e.g., heart rate values, temperature measurements, skeletal pose estimations, instrument readings, and/or the like) indicating physiological measurements associated with the target signal source. Further, the platform can input the output metrics into a generative artificial intelligence model to generate metric deviation scores indicating degrees of deviation between current measurements and physiological baselines, automatically transmitting notifications when deviation scores exceed tolerance thresholds.

The platform can implement a universal visual-based measurement approach for capturing readings from diverse medical instruments (e.g., blood pressure monitors, glucose meters, pulse oximeters, thermometers, and/or the like) by positioning cameras to capture images of device displays and using optical character recognition or visual interpretation techniques to extract numerical readings without requiring digital data interfaces. For example, the platform can navigate to spatial positions associated with candidate signal sources when environment signals from primary target signal sources do not satisfy correspondence threshold values, capturing complementary signals to generate complete output metrics. The platform can execute all artificial intelligence inference operations locally on embedded/edge graphics processing units (e.g., tensor processing units, neural processing units, and/or the like) to maintain privacy of personal health information without transmitting data to external cloud servers. Further, the platform can generate spatial mappings of physical environments using simultaneous localization and mapping techniques based on monocular RGB or RGB-D cameras, enabling autonomous navigation through ordered sequences of key spatial positions to follow patients throughout residential spaces and capture continuous physiological measurements across different rooms and locations.

For illustrative purposes, examples are described herein in the context of computer systems for adaptive multi-modal signal monitoring in residential healthcare environments. However, a person skilled in the art will appreciate that the disclosed system can be applied in other contexts. For example, the disclosed system can be used within an assisted living facility context (e.g., nursing homes, memory care units, rehabilitation centers, and/or the like) to perform continuous monitoring of multiple residents across shared living spaces using non-contact physiological measurement techniques. The disclosed system can be used within a remote patient monitoring context (e.g., post-surgical recovery tracking, chronic disease management, telehealth integration, and/or the like) to provide continuous physiological assessment that supports clinical decision-making without requiring in-person visits. The disclosed system can be used within an occupational health context (e.g., workplace wellness programs, industrial safety monitoring, ergonomic assessment applications, and/or the like) to monitor worker health and detect early signs of fatigue or physical strain. The disclosed system can be used within a sports medicine and athletic training context (e.g., performance monitoring, injury prevention, recovery tracking, and/or the like) to capture gait analysis and physiological metrics during training activities. The disclosed system can be used within a veterinary context (e.g., animal health monitoring, livestock management, companion animal care, and/or the like) to perform non-contact physiological assessment without physical restraint of animal subjects.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Signal Monitoring Platform

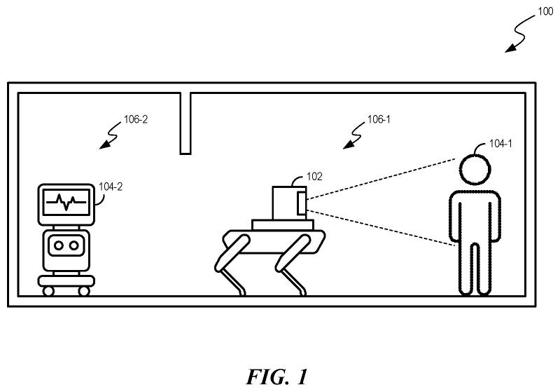

FIG. 1 is a system diagram that illustrates an example environment in which a signal monitoring apparatus operates in accordance with some implementations of the present technology. Referring to FIG. 1, an environment 100 represents a physical space (e.g., a residential home, a healthcare facility, an assisted living center, a hospital room, and/or the like) in which an edge computing apparatus 102 operates to perform multi-modal signal monitoring. The environment 100 can include one or more rooms (e.g., a kitchen, a bedroom, a living room, a bathroom, a hallway, and/or the like) that are interconnected through doorways or passages, allowing the apparatus 102 to navigate throughout the physical space. The environment 100 can be bounded by physical structures (e.g., walls, floors, ceilings, doors, windows, and/or the like) that define the extent of the monitored area. The apparatus 102 can generate and store spatial mappings of the environment 100 that represent the layout of the physical space, including locations of fixed objects (e.g., furniture, appliances, medical equipment, and/or the like) and traversable pathways between different regions of the environment 100.

In some implementations, the environment 100 can include multiple distinct zones (e.g., monitoring zones, privacy zones, transition zones, and/or the like) that the apparatus 102 can recognize and respond to differently based on configured monitoring parameters. The environment 100 is illustrated as a residential home for purposes of illustration and simplicity, but the disclosed techniques can be applicable to other physical environments and contexts. The residential home context can be particularly illustrative of the utility of the apparatus 102 because the apparatus 102 can function as a personal medical monitoring system that provides continuous physiological assessment of an individual outside of traditional clinical settings. The apparatus 102 can extend healthcare monitoring capabilities beyond episodic hospital visits or scheduled clinical appointments by maintaining persistent observation of an individual throughout daily activities within the home environment. The apparatus 102 can capture physiological measurements (e.g., heart rate, body temperature, gait patterns, and/or the like) as the individual moves between rooms, engages in routine activities, and transitions through different postures and positions throughout the day. This continuous monitoring capability can enable early detection of physiological changes that might otherwise go unnoticed between periodic clinical assessments, potentially allowing for timely intervention before health conditions deteriorate.

The residential home context can further illustrate the data localization advantages of the apparatus 102. The apparatus 102 can execute artificial intelligence inference operations locally on edge-based embedded processing units (e.g., graphics processing units, tensor processing units, neural processing units, and/or the like) without transmitting sensitive personal health information to external cloud servers or remote computing infrastructure. The localized data processing architecture of the apparatus 102 can maintain privacy of physiological measurements within the physical boundaries of the home environment, reducing exposure of personal health data to network transmission vulnerabilities and third-party data storage systems. The apparatus 102 can store historical signal data, physiological baselines, and output metrics within local cache memory coupled to the hardware processor, enabling the apparatus 102 to perform trend analysis and deviation detection without reliance on external data repositories. This localized approach can be particularly valuable in residential settings where network connectivity may be intermittent or where individuals may have heightened privacy concerns regarding transmission of personal health information beyond the home environment.

While the residential home context provides an illustrative example, the environment 100 can represent other physical spaces where the apparatus 102 provides monitoring capabilities. For example, the environment 100 can represent a hospital ward where the apparatus 102 monitors multiple patient beds across a shared clinical space, navigating between bed locations to capture physiological measurements from different patients according to scheduled monitoring routines or in response to detected events. The environment 100 can represent an industrial facility where the apparatus 102 monitors worker health and safety across manufacturing floors, assembly areas, and break rooms. The environment 100 can represent a sports training facility where the apparatus 102 follows athletes through different training stations to capture gait analysis, heart rate measurements, and pose estimations during exercise activities. The environment 100 can represent a veterinary clinic or animal shelter where the apparatus 102 monitors the health status of animals in different enclosures or examination areas without requiring physical restraint. The environment 100 can represent a school or childcare facility where the apparatus 102 monitors the well-being of children across classrooms, play areas, and rest spaces. The principles described herein with respect to the residential environment 100 can be adapted to these and other physical spaces where continuous, non-contact physiological monitoring provides value.

With continued reference to FIG. 1, the apparatus 102 includes computing logic (e.g., one or more hardware processors, memory devices, and/or the like) that executes instructions to perform signal monitoring operations within the environment 100. The apparatus 102 can include one or more sensors (e.g., cameras, microphones, thermal sensors, depth sensors, and/or the like) that capture data signals associated with signal sources and 3D physical space within the environment 100. The apparatus 102 can include one or more actuators (e.g., motors, servos, linear actuators, and/or the like) that enable displacement of the apparatus 102 within the physical environment and adjustment of sensor positioning and orientation relative to signal sources. The apparatus 102 can be mounted on a mobile robot platform (e.g., a quadruped robot dog, a wheeled robot base, a tracked robot chassis, a humanoid robot, and/or the like) to follow patients throughout the home environment, enabling continuous monitoring as the patient moves between different rooms and locations within the environment 100. The mobile robot platform can include locomotion mechanisms (e.g., legs, wheels, tracks, and/or the like) that allow the apparatus 102 to traverse various floor surfaces (e.g., carpet, hardwood, tile, and/or the like) and navigate around obstacles within the environment 100.

In some implementations, the apparatus 102 can operate as a standalone stationary device (e.g., a tabletop unit, a desk-mounted device, a wall-mounted unit, and/or the like) that can be placed on a desk or table for monitoring without mobility features. The stationary configuration of the apparatus 102 can include an actuated sensor assembly (e.g., a tilt mechanism, a rotating camera mount, a gimbal system, and/or the like) that adjusts the orientation and position of sensors to track signal sources within the field of view of the apparatus 102. The stationary apparatus 102 can be positioned at a fixed location within the environment 100 where the apparatus 102 can observe regions of interest (e.g., a bed, a chair, a couch, a dining area, and/or the like) where a patient spends time. The stationary configuration can be suitable for applications where the signal source remains within a limited area of the environment 100 or where mobility of the apparatus 102 is not required for the monitoring objectives.

As shown in FIG. 1, a target signal source 104-1 represents a primary subject for monitoring by the apparatus 102 within the environment 100. The target signal source 104-1 can correspond to a user (e.g., a patient, an elderly individual, a person with a medical condition, a caregiver, and/or the like), a physical object (e.g., a medical instrument, a health monitoring device, a medication dispenser, and/or the like), or a combination thereof. The apparatus 102 can capture environment signals (e.g., visual images, audio recordings, thermal readings, depth measurements, and/or the like) associated with the target signal source 104-1 to generate output metrics (e.g., heart rate measurements, body temperature readings, skeletal pose estimations, instrument readings, and/or the like) indicating physiological measurements. The target signal source 104-1 can be identified by the apparatus 102 using recognition techniques (e.g., facial recognition, object detection, pattern matching, feature extraction, and/or the like) that distinguish the target signal source 104-1 from other objects and individuals within the environment 100. The apparatus 102 can maintain tracking of the target signal source 104-1 as the target signal source 104-1 moves throughout the environment 100, adjusting sensor positioning and apparatus displacement to maintain observation of the target signal source 104-1.

With continued reference to FIG. 1, a candidate signal source 104-2 represents a secondary signal source within the environment 100 that can provide complementary environment signals for monitoring operations. The candidate signal source 104-2 can serve as an alternative or supplementary source for capturing environment signals when signals from the target signal source 104-1 do not satisfy correspondence threshold values (e.g., minimum signal quality scores, minimum confidence levels, minimum data completeness metrics, and/or the like). The candidate signal source 104-2 can include medical instruments (e.g., blood pressure monitors, glucose meters, pulse oximeters, thermometers, and/or the like) that display measurement readings that the apparatus 102 can capture using visual sensors. The candidate signal source 104-2 can include environmental sensors (e.g., room temperature sensors, humidity sensors, air quality monitors, and/or the like) that provide contextual information relevant to the health status of the target signal source 104-1. The apparatus 102 can maintain a stored mapping of available signal sources within the environment 100 that associates the candidate signal source 104-2 with the target signal source 104-1, enabling the apparatus 102 to selectively determine which candidate signal sources to capture based on monitoring objectives and signal quality requirements.

As further shown in FIG. 1, the environment 100 can include one or more spatial locations 106 that represent distinct positions within the physical space associated with corresponding signal sources 104. Each spatial location 106 can correspond to a region (e.g., a room, a corner, an area near furniture, a position along a pathway, and/or the like) where a respective signal source 104 is located or frequently occupies. The apparatus 102 can store spatial position data that maps each signal source 104 to a corresponding spatial location 106 within the environment 100. For example, the spatial location 106-1 represents a first distinct position within the environment 100 that is associated with the target signal source 104-1. The apparatus 102 can calculate the spatial location 106-1 using environment signals captured by sensors (e.g., an RGB camera, an RGB-D camera, time-of-flight sensors, and/or the like) that provide depth information enabling triangulation of the position of the target signal source 104-1 within the environment 100. The spatial location 106-1 can be represented as coordinates (e.g., Cartesian coordinates, polar coordinates, grid cell indices, voxel indices, and/or the like) within a 2D or 3D spatial mapping of the environment 100 that the apparatus 102 uses for navigation and positioning operations.

In a further example, a spatial location 106-2 represents a second distinct position within the environment 100 that is associated with the candidate signal source 104-2. The spatial location 106-2 can correspond to a fixed position (e.g., a location of a medical device, a position of a display screen, a mounting location of a sensor, and/or the like) where the candidate signal source 104-2 is installed or placed within the environment 100. The apparatus 102 can store the spatial location 106-2 in a cache memory as part of spatial position data that maps available signal sources to corresponding spatial positions within the environment 100. The apparatus 102 can navigate between the spatial location 106-1 and the spatial location 106-2 using spatial mappings that define traversable pathways and key spatial positions within the environment 100. The apparatus 102 can generate ordered sequences of key spatial positions (e.g., waypoints, intermediate positions, navigation checkpoints, and/or the like) from an initial spatial position to a final spatial position to facilitate displacement between the spatial location 106-1 and the spatial location 106-2 when monitoring operations require signals from both the target signal source 104-1 and the candidate signal source 104-2.

In some implementations, the apparatus 102 can utilize a generative artificial intelligence model (e.g., a large language model, a transformer-based model, a neural network model, and/or the like) to generate navigation instructions based on the spatial mapping of the environment 100 and an input query requesting information associated with the target signal source 104-1. The generative artificial intelligence model can be configured to process multiple data modalities as input, enabling the apparatus 102 to provide diverse types of information for navigation and query resolution operations. For example, the generative artificial intelligence model can comprise a visual language model (e.g., a multimodal transformer, a vision-language encoder-decoder architecture, a cross-modal attention network, and/or the like) that can process both image data (e.g., captured environment signals, spatial mapping visualizations, thermal images, depth maps, and/or the like) and textual data (e.g., natural language queries, alphanumeric descriptions, structured metadata, and/or the like) as combined inputs. The visual language model can analyze visual features extracted from environment signals in conjunction with semantic representations of textual queries to generate contextually relevant navigation instructions and query responses. In some implementations, the generative artificial intelligence model can additionally process audio data (e.g., voice commands, ambient sound recordings, speech transcriptions, and/or the like), sensor telemetry data (e.g., temperature readings, motion sensor outputs, proximity measurements, and/or the like), and structured data representations (e.g., spatial graphs, coordinate sequences, object relationship mappings, and/or the like) to inform navigation decisions and output generation.

The generative artificial intelligence model can rank spatial positions within the environment 100 according to confidence scores (e.g., likelihood scores, probability values, relevance metrics, and/or the like) indicating the likelihood that a queried object or signal source exists near each spatial position. The apparatus 102 can navigate through the ranked spatial positions in order of confidence, capturing environment signals at each location until the apparatus 102 obtains sufficient information to respond to the input query. The navigation between the spatial location 106-1 and the spatial location 106-2 can be performed autonomously by the apparatus 102 based on the generated navigation instructions, enabling the apparatus 102 to collect comprehensive environment signal sets from multiple signal sources within the environment 100 without manual intervention.

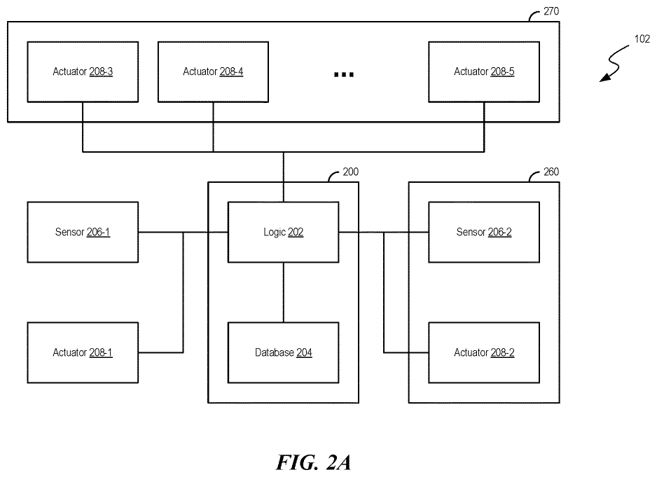

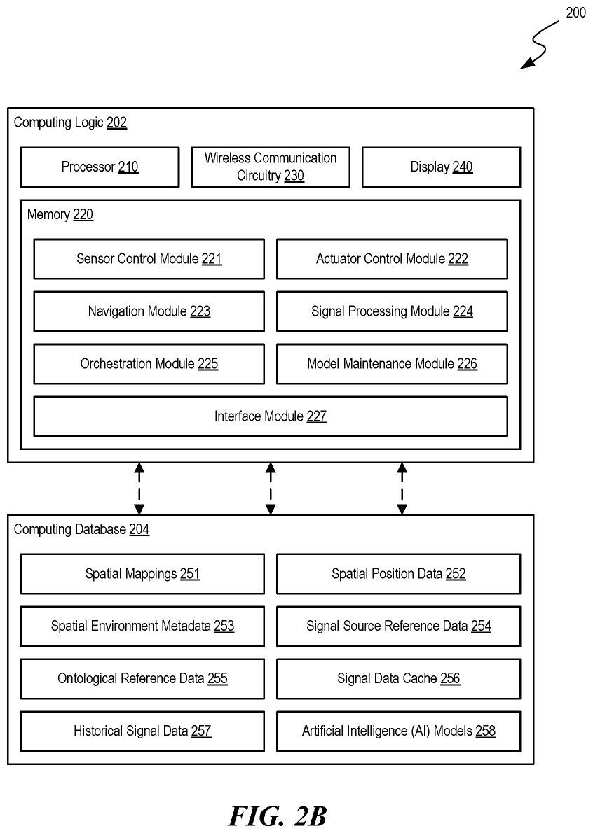

FIG. 2A is a block diagram that illustrates a signal monitoring apparatus that can implement aspects of the present technology. Referring to FIG. 2A, the apparatus 102 incorporates a signal monitoring platform 200 that provides the computational infrastructure and hardware components for performing multi-modal signal monitoring operations within the environment 100. The signal monitoring platform 200 can include integrated circuits (e.g., application-specific integrated circuits, field-programmable gate arrays, system-on-chip devices, and/or the like), processing units (e.g., central processing units, graphics processing units, neural processing units, and/or the like), and memory devices (e.g., random access memory, flash memory, solid-state storage, and/or the like) that execute instructions for capturing environment signals, processing captured data through artificial intelligence models, and generating output metrics indicating physiological measurements associated with the target signal source 104-1. The signal monitoring platform 200 can be implemented as a modular architecture that allows different sensor configurations, actuator arrangements, and processing capabilities to be combined based on the monitoring requirements of a particular deployment within the environment 100. The signal monitoring platform 200 can operate using embedded software (e.g., firmware, real-time operating systems, device drivers, and/or the like) that coordinates the operation of hardware components to perform signal capture, data processing, and actuation control functions in a synchronized manner.

With continued reference to FIG. 2A, a computing logic 202 of the signal monitoring platform 200 provides the computational capabilities for executing signal monitoring operations within the apparatus 102. The computing logic 202 can include one or more hardware processors (e.g., microprocessors, microcontrollers, digital signal processors, tensor processing units, and/or the like) that execute machine-readable instructions stored in memory to perform data processing, artificial intelligence inference, navigation planning, and control operations. The computing logic 202 can be implemented using a graphics processing unit (e.g., an NVIDIA Jetson Thor GPU, an NVIDIA Jetson Orin module, an embedded GPU accelerator, and/or the like) that provides parallel processing capabilities for executing artificial intelligence models, including large language models and computer vision models, directly on the apparatus 102 without requiring cloud-based processing. The computing logic 202 can execute sensor control operations that activate sensors to capture environment signals, actuator control operations that adjust sensor positioning and apparatus displacement, signal processing operations that transform captured environment signals into output metrics, and orchestration operations that coordinate the timing and sequencing of monitoring activities. The computing logic 202 can implement privacy-preserving processing by performing all data analysis locally on the apparatus 102, ensuring that personal health information associated with the target signal source 104-1 remains on the device and is not transmitted to external servers or cloud services.

As shown in FIG. 2A, a computing database 204 of the signal monitoring platform 200 is communicatively coupled to the computing logic 202 and provides persistent storage for data structures, configuration parameters, and artificial intelligence models used by the apparatus 102 during signal monitoring operations. The computing database 204 can include non-volatile storage media (e.g., solid-state drives, embedded flash memory, secure digital cards, and/or the like) that retain stored data when the apparatus 102 is powered off, enabling the apparatus 102 to maintain spatial mappings, historical signal data, and trained model parameters across power cycles. The computing database 204 can store spatial mappings of the environment 100 that represent the layout of the physical space, including locations of walls, doorways, furniture, and other fixed objects that define traversable pathways for navigation. The computing database 204 can store spatial position data that maps available signal sources (e.g., the target signal source 104-1, the candidate signal source 104-2, and/or the like) to corresponding spatial positions (e.g., the spatial location 106-1, the spatial location 106-2, and/or the like) within the environment 100. The computing database 204 can store signal source reference data that associates signal sources with metadata describing the type of signals each source provides, the data formats of captured signals, and the artificial intelligence models appropriate for processing signals from each source. The computing database 204 can store artificial intelligence models (e.g., convolutional neural networks, transformer models, diffusion models, large language models, and/or the like) that the computing logic 202 loads into memory and executes to transform environment signals into output metrics and generate responses to input queries.

With continued reference to FIG. 2A, the signal monitoring platform 200 can include one or more sensors that are coupled to the computing logic 202 and configured to capture data signals associated with signal sources within the environment 100. The sensors of the signal monitoring platform 200 can include various types of data capture devices (e.g., image capture devices, audio capture devices, thermal sensing devices, depth sensing devices, and/or the like) that obtain environment signals representing physical features of target signal sources and surrounding regions of interest. The sensors can be configured to capture environment signals of uniform data modalities (e.g., visual images, thermal images, audio recordings, depth measurements, and/or the like) that are subsequently processed by the computing logic 202 to generate output metrics of different data modalities. The sensors can be arranged in configurations (e.g., stereo configurations, array configurations, distributed configurations, and/or the like) that enable the computing logic 202 to derive spatial information, depth measurements, and multi-perspective observations of the target signal source 104-1. The sensors can be mounted on actuated assemblies that enable adjustment of sensor positioning relative to target signal sources, allowing the apparatus 102 to uncover regions of interest for capturing environment signals.

As shown in FIG. 2A, a sensor 206-1 and a sensor 206-2 of the signal monitoring platform 200 are coupled to the computing logic 202 and are configured to capture data signals associated with the target signal source 104-1 within the environment 100. The sensor 206-1 can include an image capture device (e.g., a complementary metal-oxide-semiconductor camera, a charge-coupled device camera, a stereo vision camera, and/or the like) that captures visual environment signals representing physical features of the target signal source 104-1 and surrounding regions of interest. The sensor 206-2 can include a second image capture device (e.g., a thermal imaging camera, an infrared camera, a depth-sensing camera, and/or the like) that captures environment signals of a different modality or from a different spatial perspective than the sensor 206-1. The sensor 206-1 and the sensor 206-2 can be arranged in a stereo configuration (e.g., positioned at a fixed baseline distance apart, oriented to have overlapping fields of view, calibrated for triangulation calculations, and/or the like) that enables the computing logic 202 to calculate depth information by comparing environment signals captured simultaneously by both sensors. The depth information derived from the stereo configuration of the sensor 206-1 and the sensor 206-2 can be used by the computing logic 202 to determine the spatial position of the target signal source 104-1 within the environment 100, enabling the apparatus 102 to adjust sensor positioning and navigate to appropriate locations for capturing environment signals.

The signal monitoring platform 200 can include one or more actuators that enable physical movement and positioning adjustments of components within the apparatus 102. An actuator can comprise an electromechanical device (e.g., a motor, a servo, a linear actuator, a solenoid, and/or the like) that converts electrical signals from the computing logic 202 into mechanical motion. The actuators can be configured to provide rotational motion (e.g., rotation about an axis, angular displacement, pivoting movement, and/or the like), linear motion (e.g., translation along an axis, extension and retraction, sliding movement, and/or the like), or combinations thereof to achieve desired positioning of sensors and other components. The actuators can receive control signals from the computing logic 202 that specify target positions, velocities, accelerations, and/or torque values for executing positioning operations. The actuators can include feedback mechanisms (e.g., encoders, potentiometers, hall effect sensors, and/or the like) that provide position and velocity information to the computing logic 202 for closed-loop control of actuator movements.

As further shown in FIG. 2A, the sensor 206-1 and the sensor 206-2 together form part of an actuated sensor assembly 260 of the signal monitoring platform 200 that enables coordinated data capture operations with adjustable sensor positioning. The actuated sensor assembly 260 can include a mechanical mounting structure (e.g., a pan-tilt head, a gimbal mechanism, a multi-axis positioning stage, and/or the like) that supports the sensor 206-1 and the sensor 206-2 and allows the sensors to be rotated, tilted, and repositioned relative to the target signal source 104-1. The actuated sensor assembly 260 can include a thermal sensor (e.g., a thermopile sensor, a microbolometer array, a pyrometer, and/or the like) positioned between or adjacent to the sensor 206-1 and the sensor 206-2 to capture temperature measurements of the target signal source 104-1 without physical contact. The actuated sensor assembly 260 can include microphones (e.g., microelectromechanical system microphones, condenser microphones, directional microphone arrays, and/or the like) arranged in a spatial configuration that enables sound source localization through triangulation, allowing the computing logic 202 to determine the direction and distance of audio signals originating from the target signal source 104-1. The actuated sensor assembly 260 can capture environment signals of a uniform data modality (e.g., digital images, audio waveforms, thermal readings, and/or the like) that the computing logic 202 inputs into artificial intelligence models to generate output metrics of data modalities different from the uniform data modality.

Referring again to FIG. 2A, an actuator 208-1 and an actuator 208-2 of the signal monitoring platform 200 are coupled to the computing logic 202 and are associated with the actuated sensor assembly 260 for adjusting the spatial positioning of the sensor 206-1 and the sensor 206-2 relative to the target signal source 104-1. The actuator 208-1 can include a rotational drive mechanism (e.g., a servo motor, a stepper motor, a brushless direct current motor, and/or the like) that rotates the actuated sensor assembly 260 about a vertical axis (e.g., a yaw axis, a pan axis, an azimuth axis, and/or the like) to orient the sensor 206-1 and the sensor 206-2 toward the target signal source 104-1 as the target signal source 104-1 moves within the environment 100. The actuator 208-2 can include a tilting drive mechanism (e.g., a servo motor, a linear actuator, a lead screw mechanism, and/or the like) that rotates the actuated sensor assembly 260 about a horizontal axis (e.g., a pitch axis, a tilt axis, an elevation axis, and/or the like) to adjust the vertical angle of the sensor 206-1 and the sensor 206-2 based on whether the target signal source 104-1 is standing, sitting, or lying down. The actuator 208-1 and the actuator 208-2 can operate in coordination under control of the computing logic 202 to track the target signal source 104-1 as the target signal source 104-1 moves throughout the environment 100, maintaining the target signal source 104-1 within the field of view of the sensor 206-1 and the sensor 206-2. The actuator 208-1 and the actuator 208-2 can adjust the spatial positioning of the sensor 206-1 and the sensor 206-2 to uncover regions of interest (e.g., a face region for heart rate estimation, a torso region for respiratory monitoring, a limb region for gait analysis, and/or the like) corresponding to the target signal source 104-1 based on the physiological measurements being captured.

As shown in FIG. 2A, the apparatus 102 can include a displacement assembly 270 that enables physical movement of the apparatus 102 within the physical environment 100. The displacement assembly 270 can provide locomotion capabilities that allow the apparatus 102 to traverse floor surfaces, navigate around obstacles, and reposition itself relative to target signal sources (e.g., the target signal source 104-1, the candidate signal source 104-2, and/or the like) within the environment 100. The displacement assembly 270 can include one or more actuators (e.g., the actuator 208-3, the actuator 208-4, the actuator 208-5, and/or the like) that convert electrical control signals from the computing logic 202 into mechanical motion. The displacement assembly 270 can further include locomotion elements (e.g., wheels, legs, tracks, and/or the like) that interface with floor surfaces to propel the apparatus 102 in desired directions. The displacement assembly 270 can operate under control of the computing logic 202, which can generate navigation instructions based on spatial mappings 251 of the physical environment stored in the computing database 204, enabling autonomous movement between spatial positions (e.g., the spatial location 106-1, the spatial location 106-2, and/or the like) associated with signal sources.

With continued reference to FIG. 2A, the actuator 208-3 of the displacement assembly 270 can include a first drive motor (e.g., a brushless direct current motor, a geared motor, a hub motor, and/or the like) that provides rotational power to a first locomotion element (e.g., a wheel, a leg joint, a track sprocket, and/or the like). The actuator 208-4 can include a second drive motor that provides rotational power to a second locomotion element, enabling differential steering or coordinated movement of the apparatus 102. The actuator 208-5 can include a third drive motor or auxiliary actuator (e.g., a steering motor, a leg actuator, a stabilization mechanism, and/or the like) that provides additional degrees of freedom for maneuvering the apparatus 102 within the environment 100. The coordinated operation of the actuator 208-3, the actuator 208-4, and the actuator 208-5 can enable the apparatus 102 to navigate from a current spatial position to a target spatial position following an ordered sequence of key spatial positions generated based on the spatial mappings 251.

As shown in FIG. 2A, the displacement assembly 270 enables the apparatus 102 to follow the target signal source 104-1 throughout the environment 100, maintaining proximity to the target signal source 104-1 for continuous monitoring as the target signal source 104-1 moves between different rooms and locations. The displacement assembly 270 can navigate the apparatus 102 to positions that provide optimal viewing angles for the sensor 206-1 and the sensor 206-2 to capture environment signals from the target signal source 104-1, adjusting the position of the apparatus 102 based on the orientation and posture of the target signal source 104-1. The displacement assembly 270 can navigate the apparatus 102 to the spatial location 106-2 associated with the candidate signal source 104-2 when the computing logic 202 determines that environment signals from the candidate signal source 104-2 are needed to complement signals captured from the target signal source 104-1. The displacement assembly 270 can include obstacle avoidance capabilities (e.g., proximity sensors, collision detection systems, path planning algorithms, and/or the like) that enable the apparatus 102 to navigate around furniture, walls, and other obstacles within the environment 100 while moving between spatial positions. The displacement assembly 270 can operate in coordination with the actuated sensor assembly 260, with the actuator 208-3, the actuator 208-4, and the actuator 208-5 positioning the apparatus 102 at a suitable location while the actuator 208-1 and the actuator 208-2 orient the sensor 206-1 and the sensor 206-2 toward the target signal source 104-1 for capturing environment signals.

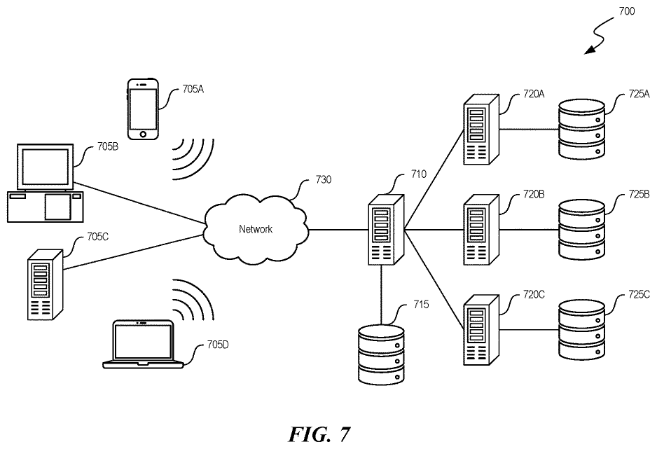

FIG. 2B is a block diagram that illustrates a signal monitoring platform 200 (alternatively “platform 200” or “system 200”) that can implement aspects of the present technology. The components shown in FIG. 2B are merely illustrative, and well-known components are omitted for brevity. As shown, the computing logic 202 (alternatively “computing server 202” or “server 202”) includes a processor 210, a memory 220, a wireless communication circuitry 230 to establish wireless communication and/or information channels (e.g., Wi-Fi, internet, APIs, communication standards) with other computing devices and/or services (e.g., servers, databases, cloud infrastructure), and a display 240 (e.g., user interface). The processor 210 can have generic characteristics similar to general-purpose processors, or the processor 210 can be an application-specific integrated circuit (ASIC) that provides arithmetic and control functions to the computing logic 202. While not shown, the processor 210 can include a dedicated cache memory. The processor 210 can be coupled to all components of the computing logic 202, either directly or indirectly, for data communication. Further, the processor 210 of the computing logic 202 can be communicatively coupled to a computing database 204 that is hosted alongside the computing logic 202 on the core network 706 described in reference to FIG. 7. As shown, the computing database 204 can include and/or store spatial mappings 251, spatial position data 252, spatial environment metadata 253, signal source reference data 254, ontological reference data 255, signal data cache 256, historical signal data 257, and/or artificial intelligence (AI) models 258.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional, or alternative, embodiments, the processor 210 can store temporary information onto the memory 220 and store long-term data onto the computing database 204. The memory 220 is merely an abstract representation of a storage environment. Hence, in some embodiments, the memory 220 comprises one or more actual memory chips or modules.

As shown in FIG. 2B, modules of the memory 220 can include a sensor control module 221, an actuator control module 222, a navigation module 223, a signal processing module 224, an orchestration module 225, a model maintenance module 226, and/or an interface module 227. Other implementations of the computing logic 202 include additional, fewer, or different modules, or distribute functionality differently between the modules. As used herein, the term “module” and/or “engine” refers broadly to software components, firmware components, and/or hardware components. Accordingly, the modules 221-227 could each comprise software, firmware, and/or hardware components implemented in, or accessible to, the computing logic 202.

Referring to FIG. 2B, the sensor control module 221 of the memory 220 provides executable instructions that the processor 210 executes to manage the operation of sensors (e.g., the sensor 206-1, the sensor 206-2, and/or the like) coupled to the computing logic 202 for capturing environment signals within the environment 100. The sensor control module 221 can include sensor initialization routines (e.g., power-on sequences, calibration procedures, configuration loading operations, and/or the like) that prepare sensors for data capture operations by establishing communication interfaces, setting capture parameters, and verifying sensor functionality.

The sensor control module 221 can establish communication interfaces by instantiating driver objects corresponding to each sensor type and configuring communication bus parameters (e.g., Inter-Integrated Circuit (I2C) bus addresses, Serial Peripheral Interface (SPI) clock frequencies, Universal Serial Bus (USB) endpoint configurations, and/or the like) that enable data transfer between the processor 210 and the sensors. The sensor control module 221 can enumerate connected sensors by transmitting device identification requests over the communication bus and parsing response packets to determine sensor model identifiers, firmware versions, and supported feature sets. The sensor control module 221 can allocate memory buffers within the memory 220 for storing incoming sensor data streams and can configure direct memory access (DMA) channels to enable efficient data transfer from sensor hardware registers to the allocated memory buffers without requiring continuous processor intervention.

The sensor control module 221 can set capture parameters by writing configuration values to sensor control registers that define operational characteristics of the data capture process. For camera sensors (e.g., the sensor 206-1, the sensor 206-2, and/or the like), the sensor control module 221 can configure image resolution parameters (e.g., frame width in pixels, frame height in pixels, pixel format specifications, and/or the like), exposure settings (e.g., shutter speed values, gain levels, auto-exposure mode flags, and/or the like), and frame rate parameters (e.g., frames per second, inter-frame timing intervals, and/or the like). For thermal sensors, the sensor control module 221 can configure temperature range boundaries (e.g., minimum detectable temperature, maximum detectable temperature, temperature resolution granularity, and/or the like) and emissivity correction factors. For audio sensors, the sensor control module 221 can configure sampling rate parameters (e.g., samples per second, bit depth per sample, channel count, and/or the like) and filter coefficients for noise reduction processing. The sensor control module 221 can retrieve default configuration values from the signal source reference data 254 stored in the computing database 204 and can apply sensor-specific calibration offsets stored in the spatial environment metadata 253 to compensate for environmental factors affecting sensor accuracy.

The sensor control module 221 can verify sensor functionality by executing diagnostic test sequences that validate sensor operation prior to initiating data capture workflows. The sensor control module 221 can transmit test commands to sensors and compare response values against expected reference values stored in the ontological reference data 255 to detect communication errors, hardware malfunctions, or calibration drift. For camera sensors, the sensor control module 221 can capture test frames and analyze pixel value distributions to verify that image data falls within expected intensity ranges and does not exhibit artifacts indicative of sensor damage (e.g., dead pixels, hot pixels, line defects, and/or the like). For thermal sensors, the sensor control module 221 can compare measured ambient temperature readings against reference temperature values obtained from auxiliary temperature sensors to verify measurement accuracy within specified tolerance bounds. The sensor control module 221 can generate sensor status records indicating pass or fail results for each diagnostic test and can store these records in the signal data cache 256 for subsequent retrieval by the orchestration module 225. The sensor control module 221 can transmit error notifications to the interface module 227 when sensor verification fails, enabling the apparatus 102 to alert users or caregivers of sensor malfunctions requiring maintenance attention.

The sensor control module 221 can include capture timing logic (e.g., frame rate controllers, sampling schedulers, synchronization mechanisms, and/or the like) that coordinates the timing of environment signal capture across multiple sensors to ensure that environment signals from the sensor 206-1 and the sensor 206-2 are captured simultaneously for stereo vision processing and depth calculation. For example, the capture timing logic can implement hardware-level synchronization through trigger signals (e.g., pulse signals, clock signals, interrupt signals, and/or the like) that are transmitted to the sensor 206-1 and the sensor 206-2 at precisely the same time instant, causing both sensors to initiate exposure and capture operations within a defined temporal tolerance (e.g., less than one millisecond, less than one hundred microseconds, and/or the like). The frame rate controllers can maintain configurable capture frequencies (e.g., 15 frames per second, 30 frames per second, 60 frames per second, and/or the like) by generating periodic trigger events at intervals corresponding to the desired frame rate, where each trigger event initiates a synchronized capture cycle across all active sensors. The sampling schedulers can implement priority queues that manage capture requests from different modules of the signal monitoring platform 200, ensuring that high-priority capture operations (e.g., real-time physiological monitoring, motion tracking, emergency detection, and/or the like) are serviced before lower-priority operations (e.g., background mapping updates, calibration routines, diagnostic captures, and/or the like). The synchronization mechanisms can utilize timestamp injection techniques where a common clock reference (e.g., a system clock, a GPS-synchronized clock, a network time protocol clock, and/or the like) is used to tag each captured environment signal with a precise timestamp, enabling the signal processing module 224 to correlate environment signals captured from different sensors based on temporal proximity. The capture timing logic can further implement adaptive frame rate adjustment that dynamically modifies capture frequencies based on detected motion levels within the environment, increasing frame rates when rapid motion is detected (e.g., a target signal source walking, changing posture, gesturing, and/or the like) and decreasing frame rates during periods of minimal activity to conserve computational resources and storage capacity.

The sensor control module 221 can include sensor mode selection logic (e.g., resolution selectors, exposure controllers, gain adjusters, and/or the like) that configures sensor operating parameters based on environmental conditions (e.g., lighting levels, distance to target signal source, motion characteristics, and/or the like) and the type of physiological measurements being captured. The sensor mode selection logic can implement a parameter configuration pipeline that receives environmental condition data as input and generates optimized sensor settings as output. For example, the resolution selectors can comprise software routines that evaluate the distance between the sensors 206 and the target signal source 104-1 to determine an appropriate capture resolution, where greater distances can trigger selection of higher resolution modes to maintain sufficient pixel density for accurate physiological measurement extraction. The exposure controllers can implement automatic exposure algorithms that sample ambient light levels from preliminary sensor readings and calculate exposure duration values that prevent image saturation in bright conditions while maintaining adequate signal-to-noise ratios in low-light environments. The gain adjusters can comprise amplification control circuits that modulate analog signal amplification prior to digital conversion, where the sensor control module 221 can increase gain values when capturing signals from distant target signal sources or decrease gain values to reduce noise artifacts when signal strength is sufficient. The sensor control module 221 can maintain a lookup table data structure that maps combinations of environmental conditions and measurement types to corresponding sensor parameter configurations, enabling rapid parameter selection without requiring real-time computation of optimal values. For physiological measurements requiring temporal analysis (e.g., heart rate estimation from subtle color variations, respiratory rate detection from motion patterns, and/or the like), the sensor control module 221 can configure frame rate parameters to ensure sufficient temporal resolution for capturing periodic physiological signals while balancing data throughput constraints of the processor 210.

The sensor control module 221 can include data acquisition routines (e.g., frame grabbers, buffer managers, data packetizers, and/or the like) that retrieve captured environment signals from sensor hardware and store the environment signals in the signal data cache 256 of the computing database 204 for subsequent processing by the signal processing module 224. The frame grabbers can be implemented as hardware abstraction layer components that interface with sensor driver APIs (e.g., Video4Linux interfaces, DirectShow capture filters, AVFoundation capture sessions, and/or the like) to retrieve raw data frames from sensor hardware at configurable sampling rates. The frame grabbers can execute interrupt-driven or polling-based acquisition loops that read pixel data, thermal readings, or audio samples from sensor memory buffers into application-accessible memory regions. The buffer managers can implement circular buffer data structures (e.g., ring buffers, double-buffering schemes, triple-buffering configurations, and/or the like) that maintain temporal sequences of captured frames while preventing memory overflow conditions during continuous acquisition operations. The buffer managers can allocate contiguous memory blocks sized according to frame dimensions and bit depths, and can maintain read and write pointers that track current acquisition positions and processing positions within the circular buffer. The data packetizers can segment captured environment signals into discrete data packets that include metadata headers (e.g., timestamps, sequence numbers, sensor identifiers, frame dimensions, color space encodings, and/or the like) appended to payload data containing the raw sensor readings. The data packetizers can serialize the environment signals into standardized data formats (e.g., Protocol Buffers, MessagePack, CBOR, and/or the like) that facilitate efficient storage in the signal data cache 256 and subsequent deserialization by the signal processing module 224. The sensor control module 221 can implement thread-safe queue mechanisms (e.g., producer-consumer queues, lock-free ring buffers, condition variable synchronization, and/or the like) that enable concurrent data acquisition from multiple sensors while maintaining temporal alignment between environment signals captured by different sensor modalities.

The sensor control module 221 can implement non-contact sensing techniques that enable the apparatus 102 to capture environment signals (e.g., visual images, thermal readings, audio waveforms, and/or the like) from the target signal source 104-1 without physical contact. For remote photoplethysmography (rPPG) heart rate estimation, the sensor control module 221 can configure one or more cameras (e.g., RGB cameras, near-infrared cameras, and/or the like) to capture video frames of exposed skin regions (e.g., facial regions, forehead areas, cheek surfaces, and/or the like) at a frame rate sufficient to detect subtle color variations caused by blood volume changes during cardiac cycles (e.g., 30 frames per second, 60 frames per second, and/or the like). The sensor control module 221 can extract pixel intensity values from the captured frames across color channels (e.g., red, green, blue channels, and/or the like) and can apply signal processing techniques (e.g., bandpass filtering, independent component analysis, blind source separation, and/or the like) to isolate the pulsatile component of the signal from noise sources (e.g., ambient lighting variations, subject motion artifacts, camera sensor noise, and/or the like). The sensor control module 221 can then perform frequency domain analysis (e.g., fast Fourier transform, power spectral density estimation, and/or the like) on the extracted signal to identify the dominant frequency corresponding to the heart rate of the target signal source 104-1.

For thermal imaging body temperature measurement, the sensor control module 221 can configure a thermal sensor (e.g., a long-wave infrared camera, a microbolometer array, a thermopile sensor, and/or the like) to capture infrared radiation emitted by the target signal source 104-1. The sensor control module 221 can identify anatomical regions of interest (e.g., inner canthus of the eye, forehead surface, temporal artery region, and/or the like) that correlate with core body temperature and can extract temperature values from corresponding pixel regions in the thermal image. The sensor control module 221 can apply calibration parameters (e.g., emissivity coefficients, ambient temperature compensation factors, distance correction values, and/or the like) to convert raw sensor readings into accurate temperature measurements. The sensor control module 221 can further implement face detection algorithms to automatically locate and track the appropriate measurement regions as the target signal source 104-1 moves within the field of view of the thermal sensor.

With continued reference to FIG. 2B, the actuator control module 222 of the memory 220 provides executable instructions that the processor 210 executes to manage the operation of actuators (e.g., the actuator 208-1, the actuator 208-2, the actuator 208-3, the actuator 208-4, the actuator 208-5, and/or the like) coupled to the computing logic 202 for adjusting sensor positioning and enabling displacement of the apparatus 102 within the environment 100. The actuator control module 222 can include motor control routines (e.g., pulse-width modulation controllers, servo position controllers, stepper motor drivers, and/or the like) that generate control signals to drive actuator motors to specified positions or velocities based on commands from the navigation module 223 and the orchestration module 225.

The actuator control module 222 can implement a hierarchical control architecture comprising a high-level motion planner and a low-level motor controller. The high-level motion planner can receive target position coordinates (e.g., Cartesian coordinates, joint angles, end-effector poses, and/or the like) from the navigation module 223 and can decompose these target positions into trajectory segments that define intermediate waypoints along a motion path. The trajectory segments can be computed using interpolation techniques (e.g., linear interpolation, cubic spline interpolation, polynomial trajectory generation, and/or the like) that produce smooth motion profiles satisfying velocity and acceleration constraints of the actuator hardware. The actuator control module 222 can store actuator configuration parameters (e.g., maximum velocity limits, acceleration limits, torque limits, gear ratios, encoder resolution values, and/or the like) in data structures within the memory 220 that the motion planner accesses when computing feasible trajectories.

The low-level motor controller of the actuator control module 222 can implement closed-loop feedback control algorithms (e.g., proportional-integral-derivative controllers, model predictive controllers, feedforward controllers, and/or the like) that regulate actuator motor positions and velocities to track the commanded trajectory segments. The closed-loop feedback control can utilize encoder signals (e.g., incremental encoder pulses, absolute encoder readings, hall effect sensor outputs, and/or the like) received from position sensors coupled to the actuator motors to compute error values representing deviations between commanded positions and actual positions. The actuator control module 222 can apply proportional gain coefficients to position errors, integral gain coefficients to accumulated position errors over time, and derivative gain coefficients to rates of change of position errors to compute motor drive signals. The computed motor drive signals can be converted to pulse-width modulation duty cycles that the processor 210 outputs through general-purpose input/output pins or dedicated motor driver interfaces to H-bridge circuits or motor driver integrated circuits that supply current to the actuator motors.

The actuator control module 222 can implement safety monitoring routines that continuously evaluate actuator states against predefined safety thresholds. The safety monitoring routines can detect fault conditions (e.g., motor stall conditions indicated by high current draw without corresponding position change, over-temperature conditions indicated by thermal sensor readings exceeding limits, mechanical obstruction conditions indicated by unexpected resistance during motion, and/or the like) and can execute protective actions such as reducing motor power, reversing motor direction, or disabling motor drive signals. The actuator control module 222 can maintain state machine logic that tracks the operational mode of each actuator (e.g., idle mode, positioning mode, velocity mode, fault mode, and/or the like) and can enforce valid state transitions based on received commands and detected conditions. The actuator control module 222 can expose application programming interfaces that the orchestration module 225 invokes to command actuator movements, query actuator positions, and receive status notifications regarding actuator operation completion or fault detection.

The actuator control module 222 can include position feedback processing logic (e.g., encoder readers, potentiometer samplers, limit switch monitors, and/or the like) that reads position feedback signals from actuators to determine current actuator positions and verify that commanded movements have been completed. The position feedback processing logic can implement encoder reader functionality by interfacing with rotary or linear encoders coupled to actuator shafts, where the encoder reader can sample quadrature pulse signals (e.g., A and B channel signals with 90-degree phase offset) at a configurable sampling rate (e.g., 1 kHz, 10 KHz, 100 kHz, and/or the like) and can maintain pulse counters that track cumulative encoder counts representing angular or linear displacement from a reference position. The actuator control module 222 can convert raw encoder counts to physical position units (e.g., degrees, radians, millimeters, and/or the like) by applying a counts-per-revolution or counts-per-unit conversion factor stored in configuration memory associated with each actuator. The potentiometer sampler functionality can interface with analog potentiometers coupled to actuator joints by sampling analog voltage signals through analog-to-digital converter channels, where the sampled voltage values can be mapped to angular positions using calibration lookup tables or linear interpolation functions that correlate voltage ranges to corresponding position ranges. The limit switch monitor functionality can poll digital input channels connected to mechanical or optical limit switches positioned at actuator travel boundaries, where detection of a limit switch activation can trigger interrupt service routines that halt actuator motion, reset position counters to known reference values, and generate fault notifications to the orchestration module 225. The actuator control module 222 can implement closed-loop position verification by comparing commanded target positions against measured feedback positions and can calculate position error values representing the difference between commanded and actual positions. The position feedback processing logic can apply configurable tolerance thresholds (e.g., ±0.5 degrees, ±1 millimeter, and/or the like) to determine whether actuator movements have settled within acceptable error bounds, and can generate movement completion signals to calling modules when position errors fall within tolerance thresholds for a configurable settling time duration.

The actuator control module 222 can include trajectory generation routines (e.g., motion profile generators, acceleration limiters, jerk controllers, and/or the like) that compute smooth motion trajectories for actuator movements to minimize vibration and ensure stable sensor positioning during environment signal capture. The trajectory generation routines can implement trapezoidal velocity profiles that define acceleration phases, constant velocity phases, and deceleration phases for each actuator movement command, where the duration and magnitude of each phase can be calculated based on the distance between current and target positions, maximum allowable velocity constraints, and maximum allowable acceleration constraints stored in configuration parameters within the memory 220. The motion profile generators can compute position setpoints at discrete time intervals (e.g., every 1 millisecond, every 5 milliseconds, every 10 milliseconds, and/or the like) that define the desired actuator position at each control cycle, enabling the actuator control module 222 to issue position commands to servo controllers or stepper motor drivers that execute the physical actuator movements. The acceleration limiters can enforce maximum acceleration bounds by comparing commanded acceleration values against predefined thresholds and clamping acceleration commands that exceed the thresholds, preventing sudden movements that could induce mechanical stress or cause oscillations in the sensor positioning system. The jerk controllers can limit the rate of change of acceleration by applying smoothing filters (e.g., moving average filters, low-pass filters, polynomial interpolation functions, and/or the like) to acceleration profiles, producing continuous acceleration curves that reduce mechanical shock and vibration transmitted to the sensors 206-1 and 206-2 during repositioning operations. The trajectory generation routines can implement S-curve motion profiles that provide continuous jerk profiles by defining seven distinct phases including jerk-limited acceleration ramp-up, constant acceleration, jerk-limited velocity, jerk-limited deceleration ramp-up, constant deceleration, and jerk-limited deceleration ramp-down, where the duration of each phase can be computed using kinematic equations that relate position, velocity, acceleration, and jerk constraints. The actuator control module 222 can store motion profile parameters (e.g., maximum velocity values, maximum acceleration values, maximum jerk values, settling time tolerances, and/or the like) in the computing database 204 and can retrieve these parameters when generating trajectories for specific actuator types or movement scenarios.

The actuator control module 222 can include coordinated motion logic (e.g., multi-axis interpolators, synchronized movement controllers, kinematic solvers, and/or the like) that coordinates the movement of multiple actuators (e.g., the actuator 208-1 and the actuator 208-2 of the actuated sensor assembly 260, and/or the like) to achieve compound movements such as tracking the target signal source 104-1 as the target signal source 104-1 moves within the environment 100. The coordinated motion logic can implement inverse kinematics algorithms that calculate joint angles and actuator positions required to position the sensors 206-1 and 206-2 at desired orientations relative to the target signal source 104-1. For example, the actuator control module 222 can receive a target position vector specifying desired sensor coordinates in three-dimensional space and can compute the corresponding actuator displacement values (e.g., motor rotation angles, linear actuator extension distances, servo positions, and/or the like) necessary to achieve the target position. The multi-axis interpolators can generate smooth motion trajectories by calculating intermediate waypoints between a current actuator configuration and a target actuator configuration, applying interpolation functions (e.g., linear interpolation, cubic spline interpolation, trapezoidal velocity profiles, and/or the like) to produce continuous motion paths that minimize mechanical stress and vibration. The synchronized movement controllers can coordinate timing signals across multiple actuators to ensure that compound movements (e.g., simultaneous pan and tilt adjustments, coordinated rotation and translation, and/or the like) execute in a synchronized manner, preventing jerky or uncoordinated motion that could degrade signal capture quality. The kinematic solvers can model the mechanical linkages and constraints of the actuated sensor assembly 260 to determine feasible motion ranges and detect potential collisions or singularities before executing movement commands. The actuator control module 222 can implement feedback control loops that continuously compare actual actuator positions (e.g., obtained from encoder readings, potentiometer values, position sensors, and/or the like) against commanded positions and apply corrective adjustments to maintain tracking accuracy as the target signal source 104-1 moves within the environment 100.

The actuator control module 222 can include safety monitoring routines (e.g., overcurrent detectors, stall monitors, collision avoidance handlers, and/or the like) that monitor actuator operation and halt movement when anomalous conditions are detected to protect the apparatus 102 and objects within the environment 100. The overcurrent detectors can be implemented as software routines that periodically sample current draw values from analog-to-digital converters coupled to current sensing resistors positioned in series with actuator motor windings, comparing the sampled current values against predefined threshold values stored in the memory 220 to detect conditions indicative of mechanical binding, obstruction contact, or motor failure. When the sampled current value exceeds the predefined threshold value for a duration exceeding a configurable time window (e.g., 50 milliseconds, 100 milliseconds, 200 milliseconds, and/or the like), the overcurrent detector can generate an interrupt signal that triggers the actuator control module 222 to immediately cease pulse-width modulation signals to the affected actuator and transition the actuator to a safe state. The stall monitors can be implemented by comparing encoder feedback signals against commanded velocity profiles, where a stall condition can be detected when the encoder indicates zero or near-zero rotational velocity while the actuator control module 222 is commanding non-zero torque output for a duration exceeding a stall detection threshold. The collision avoidance handlers can receive proximity sensor data (e.g., infrared distance measurements, ultrasonic range readings, time-of-flight depth values, and/or the like) from sensors coupled to the apparatus 102 and can execute trajectory modification algorithms that adjust actuator commands in real-time to prevent contact between the apparatus 102 and detected obstacles within the environment 100. The collision avoidance handlers can implement predictive collision detection by projecting the current trajectory of the apparatus 102 forward in time and comparing the projected positions against a spatial occupancy grid derived from the spatial mappings 251, generating preemptive deceleration commands when the projected trajectory intersects with occupied grid cells within a configurable safety margin distance.

As shown in FIG. 2B, the navigation module 223 of the memory 220 provides executable instructions that the processor 210 executes to plan and execute navigation of the apparatus 102 within the environment 100 using the spatial mappings 251 stored in the computing database 204. The navigation module 223 can include path planning algorithms (e.g., A-star pathfinding, rapidly-exploring random trees, potential field methods, and/or the like) that compute traversable routes from a current spatial position of the apparatus 102 to a target spatial position (e.g., the spatial location 106-1, the spatial location 106-2, and/or the like) while avoiding obstacles represented in the spatial mappings 251. For example, the navigation module 223 can implement A-star pathfinding by maintaining a priority queue data structure that stores candidate spatial positions along with associated cost values. The navigation module 223 can calculate a total cost for each candidate spatial position as a sum of a path cost (e.g., the accumulated distance traveled from the current spatial position of the apparatus 102 to the candidate spatial position) and a heuristic cost (e.g., an estimated distance from the candidate spatial position to the target spatial position calculated using Euclidean distance, Manhattan distance, or other distance metrics). The navigation module 223 can iteratively select the candidate spatial position with the lowest total cost from the priority queue, evaluate neighboring spatial positions accessible from the selected candidate spatial position based on the spatial mappings 251, and add newly discovered spatial positions to the priority queue until the target spatial position is reached or the priority queue is exhausted.

The navigation module 223 can also implement rapidly-exploring random trees by iteratively sampling random spatial positions within the environment 100 and extending a tree data structure from the current spatial position of the apparatus 102 toward the sampled positions. For each sampled spatial position, the navigation module 223 can identify a nearest node in the existing tree, compute a new node position by extending from the nearest node toward the sampled position by a predetermined step distance, and verify that the path segment between the nearest node and the new node does not intersect obstacles represented in the spatial mappings 251. The navigation module 223 can add valid new nodes to the tree and continue sampling until a node is generated within a threshold distance of the target spatial position, at which point the navigation module 223 can trace back through parent node references to construct a complete path from the current spatial position to the target spatial position.

The navigation module 223 can also implement potential field methods by computing attractive and repulsive force vectors that guide the apparatus 102 toward the target spatial position while avoiding obstacles. The navigation module 223 can calculate an attractive force vector pointing from the current spatial position of the apparatus 102 toward the target spatial position, with a magnitude proportional to the distance between the two positions. The navigation module 223 can calculate repulsive force vectors pointing away from each obstacle represented in the spatial mappings 251, with magnitudes that increase as the apparatus 102 approaches the obstacles (e.g., using inverse square distance relationships). The navigation module 223 can sum the attractive and repulsive force vectors to produce a resultant force vector that indicates a direction of movement for the apparatus 102, and the navigation module 223 can generate actuation commands for the actuator control module 222 based on the resultant force vector to displace the apparatus 102 along the computed trajectory.

The navigation module 223 can include localization routines (e.g., simultaneous localization and mapping algorithms, visual odometry processors, sensor fusion filters, and/or the like) that determine the current spatial position of the apparatus 102 within the environment 100 by processing environment signals from sensors and comparing observed features to the spatial mappings 251. The simultaneous localization and mapping algorithms of the localization routines can construct and update the spatial mappings 251 while concurrently tracking the position of the apparatus 102 within the environment 100. The simultaneous localization and mapping algorithms can extract visual features (e.g., corner points, edge descriptors, scale-invariant feature transform keypoints, oriented FAST and rotated BRIEF descriptors, and/or the like) from environment signals captured by the sensor 206-1 and the sensor 206-2 and can match the extracted features against a stored feature database maintained within the spatial mappings 251 of the computing database 204. The simultaneous localization and mapping algorithms can maintain a pose graph data structure (e.g., a graph of estimated apparatus positions connected by relative transformation constraints, a factor graph encoding odometry measurements and loop closure detections, and/or the like) that represents the trajectory of the apparatus 102 through the environment 100 over time. The simultaneous localization and mapping algorithms can detect loop closures (e.g., recognizing when the apparatus 102 returns to a previously visited location based on visual feature similarity, identifying revisited spatial regions through place recognition techniques, and/or the like) and can apply graph optimization algorithms (e.g., Levenberg-Marquardt optimization, Gauss-Newton optimization, incremental smoothing and mapping techniques, and/or the like) to correct accumulated drift errors in the estimated position of the apparatus 102 by adjusting the pose graph to satisfy loop closure constraints.

The visual odometry processors of the localization routines can estimate the incremental displacement of the apparatus 102 between successive time steps by analyzing changes in environment signals captured by the sensor 206-1 and the sensor 206-2 across consecutive frames. The visual odometry processors can implement feature-based visual odometry (e.g., detecting and tracking sparse feature points across consecutive frames, computing essential matrices or fundamental matrices from feature correspondences, decomposing the essential matrix into rotation and translation components representing the inter-frame motion, and/or the like) that estimates the relative motion of the apparatus 102 between frames by identifying corresponding visual features in successive images and computing the geometric transformation that relates the two sets of feature positions. The visual odometry processors can alternatively implement direct visual odometry (e.g., minimizing photometric error between consecutive frames by optimizing the rigid body transformation that aligns pixel intensity values, computing dense or semi-dense depth maps from stereo image pairs captured by the sensor 206-1 and the sensor 206-2, and/or the like) that estimates inter-frame motion by directly comparing pixel intensity patterns without requiring explicit feature extraction and matching. The visual odometry processors can accumulate the estimated inter-frame displacements over time to maintain a running estimate of the current spatial position and orientation of the apparatus 102 relative to a reference coordinate frame established during initialization of the localization routines.

The sensor fusion filters of the localization routines can combine position estimates from multiple sensor modalities (e.g., visual odometry estimates from the sensor 206-1 and the sensor 206-2, inertial measurement unit readings from accelerometers and gyroscopes, wheel encoder odometry from the displacement assembly 270, and/or the like) to produce a refined spatial position estimate with improved accuracy and robustness compared to any single sensor modality alone. The sensor fusion filters can implement extended Kalman filter algorithms (e.g., maintaining a state vector comprising the position, orientation, and velocity of the apparatus 102, propagating the state estimate forward in time using a motion model that predicts the next state based on actuator commands, updating the state estimate when new sensor measurements become available by computing Kalman gain matrices that weight the relative reliability of the predicted state and the observed measurement, and/or the like) that recursively estimate the spatial position of the apparatus 102 by combining predictions from a dynamic motion model with corrections from sensor observations. The sensor fusion filters can alternatively implement particle filter algorithms (e.g., maintaining a set of weighted particles where each particle represents a hypothesis for the current spatial position and orientation of the apparatus 102, propagating particles forward using a stochastic motion model, reweighting particles based on the likelihood of observed sensor measurements given each particle's hypothesized position, resampling particles to concentrate computational resources on high-likelihood position hypotheses, and/or the like) that represent the probability distribution of the apparatus 102 position as a set of discrete samples and can handle non-linear motion models and multi-modal position distributions that arise in environments with perceptual ambiguities. The sensor fusion filters can store the fused position estimate in the spatial position data 252 of the computing database 204, enabling the navigation module 223 and the orchestration module 225 to access the current estimated position of the apparatus 102 when planning navigation routes and coordinating monitoring operations.

The navigation module 223 can include sequential position management logic (e.g., position sequencers, checkpoint validators, progress trackers, and/or the like) that manages ordered sequences of key spatial positions (e.g., intermediate navigation positions, position checkpoints, room entry positions, and/or the like) that the apparatus 102 follows when navigating between the spatial location 106-1 and the spatial location 106-2. The sequential position management logic can maintain a position queue data structure (e.g., a doubly-linked list, a priority queue, an indexed array, and/or the like) stored in the memory 220 that holds an ordered collection of key spatial position entries, where each entry can comprise a position coordinate tuple (e.g., x-coordinate, y-coordinate, and optionally z-coordinate values within the coordinate frame of the spatial mappings 251), an associated arrival tolerance radius (e.g., a distance threshold in centimeters or millimeters within which the apparatus 102 is considered to have reached the target spatial position), and a position status flag (e.g., pending, active, reached, skipped, and/or the like) indicating the current processing state of the spatial position within the navigation sequence.

The position sequencer functionality of the sequential position management logic can generate the ordered sequence of key spatial positions by receiving a start position (e.g., the current estimated position of the apparatus 102 obtained from the sensor fusion filters of the localization routines) and a destination position (e.g., the spatial location 106-2 associated with the candidate signal source 104-2) as inputs, and can invoke the path planning algorithms (e.g., A-star pathfinding, rapidly-exploring random trees, potential field methods, and/or the like) of the navigation module 223 to compute a collision-free path between the start and destination positions using the spatial mappings 251. The position sequencer can then sample the computed path at configurable interval distances (e.g., every 0.5 meters, every 1.0 meter, every 2.0 meters, and/or the like) to generate discrete intermediate spatial positions along the path, inserting each sampled position into the position queue in traversal order from the initial spatial position to the final spatial position. The position sequencer can additionally insert mandatory spatial positions at critical navigation points (e.g., doorway thresholds where the apparatus 102 transitions between rooms, corridor intersections where multiple path options exist, narrow passage entry points where precise alignment is required, and/or the like) identified from the spatial mappings 251 to ensure that the apparatus 102 navigates through constrained regions with appropriate positioning and orientation.

The checkpoint validator functionality of the sequential position management logic can verify that the apparatus 102 has successfully reached each key spatial position in the ordered sequence before advancing to the next spatial position. The checkpoint validator can implement a position comparison routine that periodically retrieves the current estimated position of the apparatus 102 from the spatial position data 252 stored in the computing database 204 and computes the Euclidean distance between the current estimated position and the target spatial position. When the computed distance falls within the arrival tolerance radius associated with the current key spatial position for a configurable settling duration (e.g., 500 milliseconds, 1 second, 2 seconds, and/or the like), the checkpoint validator can update the position status flag of the current key spatial position to a reached state, dequeue the current spatial position from the position queue, and signal the position sequencer to advance to the next key spatial position in the ordered sequence. The checkpoint validator can also implement timeout detection logic that monitors the elapsed time since the apparatus 102 began navigating toward the current target spatial position and can trigger position replanning operations (e.g., recomputing the path to the current spatial position, selecting an alternative spatial position, skipping the current spatial position and advancing to the next key spatial position, and/or the like) when the elapsed time exceeds a configurable timeout threshold (e.g., 30 seconds, 60 seconds, 120 seconds, and/or the like) without the apparatus 102 reaching the target spatial position, which can indicate that an obstacle or environmental change has blocked the planned path.

The progress tracker functionality of the sequential position management logic can maintain a navigation progress record (e.g., a data structure stored in the signal data cache 256 of the computing database 204) that tracks the overall progress of the apparatus 102 through the ordered sequence of key spatial positions. The progress tracker can record metrics including the total number of key spatial positions in the sequence, the number of key spatial positions reached, the number of key spatial positions remaining, the cumulative distance traveled, the estimated remaining distance to the final spatial position, and the elapsed navigation time since the sequence was initiated. The progress tracker can expose these metrics to the orchestration module 225 through application programming interfaces, enabling the orchestration module 225 to monitor navigation progress and make scheduling decisions (e.g., determining whether to continue the current navigation sequence, abort navigation to respond to a higher-priority event, or adjust monitoring parameters based on the estimated time to reach the destination, and/or the like) based on the current state of the key spatial position traversal. The progress tracker can also provide navigation progress information to the interface module 227 for display on the display 240, enabling users to observe the current navigation status of the apparatus 102 within the environment 100.

The navigation module 223 can include target tracking routines (e.g., Kalman filter trackers, particle filter estimators, motion predictors, and/or the like) that track the position of the target signal source 104-1 as the target signal source 104-1 moves within the environment 100 and update navigation plans to maintain proximity to the target signal source 104-1 for continuous monitoring. For example, the platform 200 can configure Kalman filter trackers to maintain a state vector comprising the estimated position, velocity, and acceleration of the target signal source 104-1 within the coordinate frame of the spatial mappings 251, where the state vector can be propagated forward in time at each control cycle using a linear or non-linear motion model (e.g., a constant velocity model, a constant acceleration model, a coordinated turn model, and/or the like) that predicts the next state of the target signal source 104-1 based on the current state and elapsed time since the previous update. The Kalman filter trackers can compute a prediction step by multiplying the current state vector by a state transition matrix that encodes the motion model dynamics and adding a process noise covariance matrix that accounts for uncertainty in the motion model, producing a predicted state estimate and a predicted error covariance matrix representing the uncertainty of the prediction. When new position observations of the target signal source 104-1 become available from the signal processing module 224 (e.g., via face detection coordinates, skeletal keypoint centroids, depth-based position estimates, and/or the like), the Kalman filter trackers can compute an update step by calculating a Kalman gain matrix as the product of the predicted error covariance and the observation matrix transposed, divided by the sum of the observation-transformed predicted error covariance and the measurement noise covariance, where the Kalman gain matrix can weight the relative reliability of the predicted state and the observed measurement to produce a corrected state estimate that fuses the prediction with the observation.

The particle filter estimators of the target tracking routines can maintain a set of weighted particles (e.g., 100 particles, 500 particles, 1000 particles, and/or the like) where each particle represents a hypothesis for the current position and velocity of the target signal source 104-1 within the environment 100. The particle filter estimators can propagate each particle forward in time by sampling from a stochastic motion model that adds random perturbations (e.g., Gaussian noise samples scaled by expected motion variance, and/or the like) to the particle state to account for uncertainty in the movement behavior of the target signal source 104-1. The particle filter estimators can reweight each particle based on the likelihood of the observed position measurement given the particle's hypothesized position, where the likelihood can be computed using a Gaussian probability density function centered at the observed position with a variance corresponding to the measurement noise characteristics of the sensors 206-1 and 206-2. The particle filter estimators can perform resampling operations (e.g., systematic resampling, stratified resampling, multinomial resampling, and/or the like) that duplicate high-weight particles and eliminate low-weight particles to concentrate computational resources on high-likelihood position hypotheses, preventing particle degeneracy where a small number of particles accumulate disproportionate weight.

The motion predictors of the target tracking routines can generate predicted future positions of the target signal source 104-1 by extrapolating the estimated velocity and trajectory from the Kalman filter trackers or particle filter estimators over a configurable prediction horizon (e.g., 0.5 seconds, 1.0 second, 2.0 seconds, and/or the like). The motion predictors can enable the navigation module 223 to proactively adjust the navigation plan of the apparatus 102 by anticipating where the target signal source 104-1 will be located at a future time instant rather than reactively following the last observed position, reducing the lag between the movement of the target signal source 104-1 and the repositioning of the apparatus 102. The target tracking routines can store the estimated position and velocity of the target signal source 104-1 in the spatial position data 252 of the computing database 204 at each update cycle, enabling the navigation module 223 to continuously generate updated navigation commands for the actuator control module 222 that direct the displacement assembly 270 to maintain the apparatus 102 within a configurable proximity distance (e.g., 1.0 meter, 2.0 meters, 3.0 meters, and/or the like) of the target signal source 104-1 as the target signal source 104-1 moves between rooms and locations within the environment 100.

The navigation module 223 can interface with the actuator control module 222 to issue movement commands to the displacement assembly 270 (e.g., the actuator 208-3, the actuator 208-4, the actuator 208-5, and/or the like) based on computed navigation plans. The navigation module 223 can translate computed navigation plans into a sequence of discrete movement commands by decomposing a planned path into individual trajectory segments, where each trajectory segment can specify a target displacement vector (e.g., a direction and distance for the next movement increment, a velocity setpoint for a path segment, a turning radius for a curved path portion, and/or the like) that the actuator control module 222 can convert into motor control signals for the actuators of the displacement assembly 270. The navigation module 223 can maintain a command interface (e.g., an application programming interface, a shared memory buffer, a message passing interface, a function call interface, and/or the like) through which the navigation module 223 can transmit movement commands to the actuator control module 222, where each movement command can include a command type identifier (e.g., a linear displacement command, a rotational displacement command, a combined linear and rotational command, a stop command, and/or the like), target position or velocity parameters, and execution timing constraints that specify when the movement should begin and the maximum duration allowed for completion.

The navigation module 223 can implement a command execution pipeline that monitors the progress of issued movement commands by polling the actuator control module 222 for position feedback data (e.g., current encoder readings, estimated displacement values, orientation measurements from inertial measurement units, and/or the like) at configurable intervals (e.g., every 10 milliseconds, every 50 milliseconds, every 100 milliseconds, and/or the like) and comparing the reported position against the expected position along the planned trajectory. The navigation module 223 can compute a position error value representing the deviation between the actual position of the apparatus 102 and the expected position at the current time step, and can issue corrective movement commands to the actuator control module 222 when the position error exceeds a configurable correction threshold (e.g., 5 centimeters, 10 centimeters, 20 centimeters, and/or the like) to maintain the apparatus 102 on the planned path. The navigation module 223 can implement a velocity regulation mechanism that adjusts the speed parameters of movement commands based on proximity to obstacles detected in the spatial mappings 251, where the navigation module 223 can reduce commanded velocities as the apparatus 102 approaches obstacles or narrow passages and can increase commanded velocities in open areas where collision risk is minimal. The navigation module 223 can maintain a command queue data structure (e.g., a first-in-first-out queue, a priority queue, a circular buffer, and/or the like) stored in the memory 220 that holds pending movement commands awaiting execution by the actuator control module 222, enabling the navigation module 223 to pre-compute multiple trajectory segments ahead of the current position of the apparatus 102 and enqueue the corresponding movement commands for sequential execution by the displacement assembly 270.

With continued reference to FIG. 2B, the signal processing module 224 of the memory 220 provides executable instructions that the processor 210 executes to transform environment signals captured by sensors (e.g., the sensor 206-1, the sensor 206-2, and/or the like) into output metrics indicating physiological measurements associated with the target signal source 104-1. The signal processing module 224 can implement a multi-stage processing pipeline architecture where raw environment signals from the signal data cache 256 are sequentially processed through preprocessing stages, feature extraction stages, and inference stages to produce structured output metrics that are stored in the signal data cache 256 and the historical signal data 257 of the computing database 204.

The signal processing module 224 can include image processing routines (e.g., face detection algorithms, skin segmentation processors, region of interest extractors, and/or the like) that analyze visual environment signals to identify and isolate regions of the target signal source 104-1 relevant to physiological measurement extraction. The face detection algorithms can be implemented using convolutional neural network-based detectors (e.g., single shot multibox detectors, you only look once detectors, multi-task cascaded convolutional network detectors, and/or the like) loaded from the artificial intelligence models 258 stored in the computing database 204, where the detector receives an input image frame from the signal data cache 256 and generates bounding box coordinates (e.g., top-left x-coordinate, top-left y-coordinate, width, height, and/or the like) along with confidence scores indicating the likelihood that each detected region contains a face of the target signal source 104-1. The signal processing module 224 can apply non-maximum suppression (e.g., iteratively selecting the bounding box with the highest confidence score and removing overlapping bounding boxes that exceed an intersection-over-union threshold, and/or the like) to eliminate redundant detections and retain the most confident face detection for subsequent processing stages.

The skin segmentation processors of the signal processing module 224 can receive the cropped face region identified by the face detection algorithms and can generate a binary mask (e.g., a pixel-level classification map where each pixel is labeled as skin or non-skin, and/or the like) that isolates skin pixels from non-skin pixels (e.g., hair, eyes, background, clothing, and/or the like) within the detected face region. The skin segmentation can be implemented using semantic segmentation models (e.g., U-Net architectures, DeepLab models, fully convolutional network architectures, and/or the like) that process the cropped face image through encoder-decoder neural network layers to produce a per-pixel probability map indicating the likelihood that each pixel corresponds to exposed skin tissue. The signal processing module 224 can apply a configurable probability threshold (e.g., 0.5, 0.7, 0.9, and/or the like) to the probability map to generate the binary skin mask, where pixels with probability values exceeding the threshold are classified as skin and pixels below the threshold are classified as non-skin. The skin segmentation processors can alternatively implement color space-based segmentation techniques (e.g., converting RGB pixel values to YCbCr color space and applying empirically determined threshold ranges for the Cb and Cr chrominance channels, converting to HSV color space and filtering based on hue and saturation ranges characteristic of human skin tones, and/or the like) that classify pixels as skin based on their color characteristics without requiring neural network inference.

The region of interest extractors of the signal processing module 224 can apply the binary skin mask to the original image frame to extract pixel values exclusively from skin regions, generating a masked image where non-skin pixels are set to zero or excluded from subsequent analysis. The region of interest extractors can compute spatial statistics (e.g., centroid coordinates of the skin region, bounding rectangle dimensions, total skin pixel count, contiguous region area, and/or the like) from the binary skin mask that the signal processing module 224 uses to evaluate the quality and sufficiency of the detected skin region for physiological measurement extraction. The region of interest extractors can implement adaptive region selection logic (e.g., selecting the forehead region for remote photoplethysmography when the full face is visible, selecting cheek regions when the forehead is occluded, selecting exposed neck or hand regions when the face is not detected, and/or the like) that identifies the most suitable skin region for measurement extraction based on the available skin area and the specific physiological measurement being captured. The signal processing module 224 can compute a region quality score (e.g., a weighted combination of skin pixel count, region contiguity, motion stability, and illumination uniformity, and/or the like) that the orchestration module 225 uses to determine whether the captured environment signals provide sufficient signal quality for reliable physiological measurement extraction or whether sensor repositioning is required to improve the captured region of interest.

The signal processing module 224 can include remote photoplethysmography (rPPG) processing logic (e.g., color channel extractors, bandpass filters, peak detectors, frequency domain analyzers, and/or the like) that processes sequences of visual environment signals to extract subtle color variations in skin regions caused by blood volume changes during cardiac cycles, enabling non-contact heart rate estimation from the target signal source 104-1. The rPPG processing logic can implement a multi-stage signal extraction pipeline that receives a temporal sequence of cropped skin region images from the region of interest extractors and produces a heart rate value expressed in beats per minute as output.

The color channel extractors of the rPPG processing logic can compute spatially averaged pixel intensity values across the detected skin region for each color channel (e.g., red channel mean intensity, green channel mean intensity, blue channel mean intensity, and/or the like) at each frame in the temporal sequence, producing three one-dimensional time-series signals corresponding to the red, green, and blue color channels. The color channel extractors can apply the binary skin mask generated by the skin segmentation processors to exclude non-skin pixels from the spatial averaging computation, ensuring that only pixel values from exposed skin tissue contribute to the extracted color channel signals. The green channel signal can exhibit the strongest pulsatile component corresponding to blood volume changes because hemoglobin absorption characteristics cause the green wavelength band (e.g., approximately 500 to 570 nanometers, and/or the like) to be most sensitive to variations in blood volume within dermal tissue layers.

The rPPG processing logic can apply signal decomposition techniques (e.g., independent component analysis, principal component analysis, chrominance-based methods such as CHROM, plane-orthogonal-to-skin methods such as POS, and/or the like) to the extracted color channel time-series signals to isolate the pulsatile blood volume pulse (BVP) component from noise sources (e.g., ambient lighting variations, subject motion artifacts, camera sensor noise, specular reflections, and/or the like). The independent component analysis technique can decompose the three color channel signals into statistically independent source signals by computing an unmixing matrix that maximizes the statistical independence of the output components, where one of the resulting independent components can correspond to the blood volume pulse signal and the remaining components can correspond to noise sources. The chrominance-based method can project the color channel signals onto a chrominance subspace defined by linear combinations of the color channels (e.g., computing X=3R−2G and Y=1.5R+G−1.5B, where R, G, and B represent the normalized red, green, and blue channel signals, and/or the like) that amplify the pulsatile component while attenuating motion-induced intensity variations.

The bandpass filters of the rPPG processing logic can apply frequency-domain filtering to the extracted blood volume pulse signal to retain only frequency components within a physiologically plausible heart rate range (e.g., 0.7 Hz to 3.5 Hz corresponding to approximately 42 to 210 beats per minute, and/or the like) while attenuating frequency components outside this range that correspond to noise, respiratory artifacts, or other non-cardiac physiological signals. The bandpass filters can be implemented using finite impulse response (FIR) filter designs (e.g., windowed sinc filters, Parks-Mcclellan optimal equiripple filters, and/or the like) or infinite impulse response (IIR) filter designs (e.g., Butterworth filters, Chebyshev filters, elliptic filters, and/or the like) with configurable cutoff frequencies and filter orders that determine the sharpness of the frequency transition bands.

The peak detectors and frequency domain analyzers of the rPPG processing logic can determine the heart rate from the filtered blood volume pulse signal using frequency domain analysis techniques (e.g., fast Fourier transform computation, power spectral density estimation via Welch's method, short-time Fourier transform analysis, and/or the like) that transform the time-domain signal into a frequency-domain representation and identify the dominant frequency peak corresponding to the cardiac cycle frequency. The signal processing module 224 can compute the fast Fourier transform of the filtered blood volume pulse signal over a sliding temporal window (e.g., a 10-second window, a 15-second window, a 30-second window, and/or the like) to generate a power spectrum where the frequency axis represents possible heart rate frequencies and the magnitude axis represents the strength of each frequency component. The peak detectors can identify the frequency bin with the maximum power spectral density value within the physiologically plausible heart rate range and can convert the identified peak frequency to a heart rate value in beats per minute by multiplying the frequency value by 60 (e.g., a peak frequency of 1.2 Hz corresponds to 72 beats per minute, and/or the like). The rPPG processing logic can compute a confidence score for the extracted heart rate measurement based on the signal-to-noise ratio of the dominant frequency peak relative to surrounding frequency bins, the temporal stability of the heart rate estimate across successive analysis windows, and the skin pixel count available for spatial averaging, enabling the orchestration module 225 to assess the reliability of the heart rate measurement and determine whether sensor repositioning is required to improve signal quality.

The signal processing module 224 can include pose estimation routines (e.g., skeletal keypoint detectors, joint angle calculators, body segment trackers, and/or the like) that analyze visual environment signals to estimate the three-dimensional pose of the target signal source 104-1 for gait analysis and fall detection applications. The pose estimation routines can implement a multi-stage pipeline architecture where the signal processing module 224 first receives visual environment signals (e.g., RGB image frames, depth images, stereo image pairs, and/or the like) from the signal data cache 256 and processes the visual environment signals through a keypoint detection neural network (e.g., a convolutional neural network trained to regress two-dimensional joint coordinates, a heatmap-based detector that generates per-joint probability maps, a bottom-up detector that identifies all body joints and associates them to individual persons, and/or the like) loaded from the artificial intelligence models 258 stored in the computing database 204. The keypoint detection neural network can receive an input image frame and generate a set of two-dimensional keypoint coordinates (e.g., pixel-space x and y coordinates for each detected joint, and/or the like) along with per-keypoint confidence scores indicating the reliability of each detection, where the keypoint set can comprise a predefined number of anatomical landmarks (e.g., 17 keypoints corresponding to nose, eyes, ears, shoulders, elbows, wrists, hips, knees, and ankles in a COCO-format skeleton, 33 keypoints in a MediaPipe BlazePose format including additional landmarks for hands, feet, and facial reference points, and/or the like) that collectively define the skeletal structure of the target signal source 104-1.

The skeletal keypoint detectors of the pose estimation routines can implement a top-down detection approach (e.g., first detecting the bounding box of the target signal source 104-1 using an object detection model and then running a single-person pose estimation model within the detected bounding box, and/or the like) or a bottom-up detection approach (e.g., detecting all keypoints in the image simultaneously and then grouping keypoints into individual person instances using associative embedding techniques or part affinity fields, and/or the like) depending on the number of persons present in the environment 100 and the computational resources available on the processor 210. The top-down approach can invoke the face detection algorithms described in the signal processing module 224 to generate a bounding box around the target signal source 104-1, crop the image region corresponding to the bounding box, resize the cropped region to a fixed input resolution (e.g., 256 by 192 pixels, 384 by 288 pixels, and/or the like) expected by the pose estimation model, and feed the resized crop through the keypoint detection neural network to produce heatmaps (e.g., two-dimensional Gaussian probability distributions centered at each predicted joint location, and/or the like) from which the signal processing module 224 extracts peak coordinates using argmax operations or sub-pixel refinement techniques (e.g., fitting a quadratic function to the heatmap values surrounding the peak location to achieve sub-pixel localization accuracy, and/or the like).

The joint angle calculators of the pose estimation routines can compute angular measurements between connected body segments by calculating the angle formed at each joint using the two-dimensional or three-dimensional coordinates of adjacent keypoints. For example, the joint angle calculators can compute a knee angle by constructing two vectors originating from the knee keypoint (e.g., a first vector from the knee keypoint to the hip keypoint and a second vector from the knee keypoint to the ankle keypoint, and/or the like) and calculating the angle between the two vectors using the inverse cosine of the dot product of the normalized vectors. The joint angle calculators can similarly compute hip angles, elbow angles, shoulder angles, and ankle angles by selecting the appropriate triplets of keypoints that define each joint and applying the same vector-based angle computation. The computed joint angles can be stored as feature vectors in the signal data cache 256 for use by downstream classification routines that determine the posture state (e.g., standing, sitting, walking, lying down, and/or the like) of the target signal source 104-1 based on the combination of joint angle values across the full body skeleton.

The body segment trackers of the pose estimation routines can maintain temporal associations of detected keypoints across consecutive frames by implementing tracking algorithms (e.g., Hungarian algorithm-based assignment, intersection-over-union based tracking, optical flow-assisted keypoint propagation, and/or the like) that link keypoint detections in a current frame to corresponding detections in previous frames. The body segment trackers can maintain a state representation for each tracked body segment (e.g., a Kalman filter state comprising position, velocity, and acceleration of each keypoint, and/or the like) that enables prediction of keypoint positions in subsequent frames when detections are temporarily lost due to occlusion, motion blur, or other signal degradation conditions. The temporal tracking of keypoints across frames can enable the signal processing module 224 to compute velocity and acceleration profiles for individual body segments (e.g., calculating the displacement of ankle keypoints between successive frames to determine foot velocity during gait cycles, computing the angular velocity of the knee joint during walking to characterize gait dynamics, and/or the like) that are used for gait analysis, fall detection, and activity recognition applications. The body segment trackers can store tracked keypoint trajectories as time-series data in the signal data cache 256, enabling the signal processing module 224 to analyze temporal patterns in body motion over configurable time windows (e.g., 1-second windows for fall detection, 5-second windows for gait cycle analysis, 30-second windows for activity classification, and/or the like) for generating the output metrics 310 associated with the target signal source 104-1.

The signal processing module 224 can include optical character recognition routines (e.g., text region detectors, character classifiers, digit recognizers, and/or the like) that extract numerical readings from displays of medical instruments (e.g., blood pressure monitors, glucose meters, pulse oximeters, thermometers, cholesterol meters, and/or the like) captured in visual environment signals from the candidate signal source 104-2. The optical character recognition routines can implement a multi-stage extraction pipeline that receives cropped display region images from the region of interest extractors and produces structured numerical measurement values as output.

The text region detectors of the optical character recognition routines can locate regions within the captured display images that contain textual or numerical content by applying connected component analysis (e.g., identifying contiguous groups of foreground pixels that form character shapes, filtering connected components based on aspect ratio and area constraints to distinguish character-like regions from noise or background elements, and/or the like) or by executing text detection neural networks (e.g., EAST text detectors, CRAFT character region awareness detectors, differentiable binarization networks, and/or the like) loaded from the artificial intelligence models 258 stored in the computing database 204. The text region detectors can generate bounding box coordinates (e.g., top-left x-coordinate, top-left y-coordinate, width, height, rotation angle, and/or the like) that delineate regions within the display image containing numerical readings, enabling the signal processing module 224 to crop and isolate individual text regions for subsequent character-level recognition. The text region detectors can apply display type classification logic (e.g., seven-segment display pattern matchers, dot-matrix display recognizers, liquid crystal display format detectors, and/or the like) that identifies the type of display technology used by the medical instrument, enabling the signal processing module 224 to select appropriate recognition techniques optimized for the specific display format.

The character classifiers of the optical character recognition routines can process each cropped text region to identify individual characters within the detected text areas. For seven-segment display formats commonly used in medical instruments, the character classifiers can implement segment-based recognition (e.g., detecting the presence or absence of each of the seven segments in a digit display, mapping the detected segment pattern to a corresponding digit value using a lookup table that associates segment activation patterns with digits zero through nine, and/or the like) that exploits the structured layout of seven-segment displays to achieve high recognition accuracy. For other display formats (e.g., dot-matrix displays, proportional font displays, variable-width character displays, and/or the like), the character classifiers can implement convolutional neural network-based classifiers (e.g., LeNet-style digit classifiers, ResNet-based character recognizers, lightweight mobile classification networks, and/or the like) loaded from the artificial intelligence models 258 that receive individual character images as input and generate probability distributions over possible character classes (e.g., digits zero through nine, decimal point, minus sign, unit labels such as mmHg or mg/dL, and/or the like) as output. The character classifiers can apply confidence thresholding (e.g., accepting character classifications with confidence scores exceeding a configurable threshold such as 0.8 or 0.9, flagging low-confidence classifications for verification, and/or the like) to ensure that only reliable character recognitions contribute to the extracted numerical readings.

The digit recognizers of the optical character recognition routines can assemble the individually classified characters into complete numerical readings by applying spatial ordering logic (e.g., sorting detected characters from left to right based on bounding box x-coordinates, grouping characters into reading fields based on spatial proximity and vertical alignment, inserting decimal points based on detected decimal separator positions, and/or the like) that reconstructs the full numerical value displayed on the medical instrument screen. The digit recognizers can apply domain-specific validation rules (e.g., verifying that extracted blood pressure readings fall within physiologically plausible ranges such as 60 to 250 mmHg for systolic and 30 to 150 mmHg for diastolic, confirming that glucose readings fall within expected ranges such as 20 to 600 mg/dL, validating that temperature readings fall within expected ranges such as 90 to 110 degrees Fahrenheit, and/or the like) stored in the ontological reference data 255 of the computing database 204 to detect and reject erroneous readings caused by partial occlusion, glare, or misrecognition of display characters. The digit recognizers can implement temporal consistency checking (e.g., comparing the current extracted reading against readings extracted from previous frames within a configurable time window, computing the median or mode of extracted readings across multiple frames to reduce single-frame recognition errors, and/or the like) that leverages multiple sequential captures of the same display to improve the reliability of the extracted instrument reading 316. The digit recognizers can store the extracted numerical readings along with associated metadata (e.g., instrument type identifiers, measurement unit labels, extraction confidence scores, capture timestamps, and/or the like) in the signal data cache 256 of the computing database 204 for use by the orchestration module 225 in generating the output metrics 310.

The signal processing module 224 can include thermal processing routines (e.g., temperature mappers, hotspot detectors, body region segmenters, emissivity correction algorithms, and/or the like) that analyze thermal environment signals captured by thermal sensors of the actuated sensor assembly 260 to extract body temperature measurements from the target signal source 104-1 without requiring physical contact. The thermal processing routines can implement a multi-stage thermal analysis pipeline that receives raw thermal image data from the signal data cache 256 and produces calibrated temperature measurement values as output.

The temperature mappers of the thermal processing routines can convert raw sensor readings from the thermal sensor (e.g., a microbolometer array, a thermopile sensor, a long-wave infrared camera, and/or the like) into calibrated temperature values for each pixel in the thermal image. The temperature mappers can apply a radiometric calibration function (e.g., a polynomial mapping from raw digital counts to temperature values, a lookup table correlating sensor output levels to known temperature references, a linear gain and offset correction derived from factory calibration data, and/or the like) that transforms the raw infrared intensity values captured by the thermal sensor into absolute temperature values expressed in degrees Celsius or degrees Fahrenheit. The temperature mappers can apply ambient temperature compensation (e.g., subtracting the contribution of reflected ambient radiation from the measured signal, adjusting for the thermal sensor's own internal temperature drift using an onboard reference sensor, correcting for atmospheric attenuation between the sensor and the target signal source 104-1, and/or the like) to improve the accuracy of the temperature mapping under varying environmental conditions within the environment 100.

The hotspot detectors of the thermal processing routines can identify regions within the calibrated thermal image that exhibit elevated temperature values relative to surrounding areas, enabling the signal processing module 224 to locate anatomical regions of the target signal source 104-1 that are most relevant for body temperature estimation. The hotspot detectors can implement threshold-based detection (e.g., identifying contiguous pixel regions where temperature values exceed a configurable minimum threshold such as 30 degrees Celsius, filtering detected regions based on area constraints to exclude small noise artifacts and large background surfaces, ranking detected regions by peak temperature value to identify the most thermally prominent body region, and/or the like) that isolates candidate measurement regions from the thermal image. The hotspot detectors can implement gradient-based detection (e.g., computing spatial temperature gradients across the thermal image using Sobel or Laplacian operators, identifying regions where temperature gradients indicate transitions between body surfaces and background, delineating body region boundaries based on gradient magnitude thresholds, and/or the like) that identifies the edges of thermally distinct body regions for subsequent segmentation processing.

The body region segmenters of the thermal processing routines can isolate specific anatomical regions (e.g., the forehead surface, the inner canthus of the eye, the temporal artery region, exposed skin areas of the face, and/or the like) within the thermal image that correlate with core body temperature and provide the most clinically relevant temperature measurements. The body region segmenters can leverage face detection results from the signal processing module 224 (e.g., bounding box coordinates generated by the face detection algorithms applied to corresponding RGB image frames captured simultaneously by the sensor 206-1, facial landmark positions identifying the locations of eyes, nose, and forehead, and/or the like) to map detected facial regions from the visual image coordinate space to the thermal image coordinate space using a spatial registration transformation (e.g., an affine transformation, a homography matrix, a calibrated extrinsic parameter mapping between the visual camera and the thermal sensor, and/or the like) that accounts for the spatial offset and field-of-view differences between the visual sensor and the thermal sensor of the actuated sensor assembly 260. The body region segmenters can extract temperature values from the registered anatomical regions by computing spatial statistics (e.g., the maximum temperature value within the inner canthus region, the mean temperature across the forehead region, the median temperature of the detected facial skin area, and/or the like) that produce a representative temperature measurement for the target signal source 104-1.

The thermal processing routines can further include emissivity correction algorithms that adjust the extracted temperature values to account for the emissivity characteristics of human skin (e.g., applying an emissivity coefficient of approximately 0.98 for human skin, adjusting for variations in emissivity across different skin regions, compensating for the presence of hair or clothing that partially occludes the measurement region, and/or the like) and for the distance between the thermal sensor and the target signal source 104-1 (e.g., applying distance-dependent attenuation correction factors stored in the spatial environment metadata 253, adjusting for the solid angle subtended by the measurement region at the sensor aperture, compensating for atmospheric absorption of infrared radiation over the measurement path, and/or the like). The emissivity correction algorithms can retrieve calibration parameters from the signal source reference data 254 stored in the computing database 204 that specify the emissivity coefficients, distance correction factors, and ambient temperature compensation values appropriate for the thermal sensor configuration of the actuated sensor assembly 260. The thermal processing routines can implement temporal averaging (e.g., computing a running average of temperature measurements across multiple consecutive thermal frames within a configurable time window such as 5 seconds or 10 seconds, applying exponential moving average filtering to reduce frame-to-frame measurement noise, rejecting outlier temperature readings that deviate from the running average by more than a configurable threshold, and/or the like) that improves the stability and reliability of the extracted temperature 314 output metric stored in the signal data cache 256 of the computing database 204.

The signal processing module 224 can store processed output metrics in the signal data cache 256 and the historical signal data 257 of the computing database 204 for use by the orchestration module 225 and the model maintenance module 226. The signal processing module 224 can implement a dual-path storage architecture where the output metrics are written to both the signal data cache 256 and the historical signal data 257 through separate write operations coordinated by the processor 210. The signal data cache 256 can receive the output metrics as structured data records (e.g., key-value pairs, serialized data objects, timestamped measurement tuples, and/or the like) that the signal processing module 224 writes to designated memory regions within the signal data cache 256 using write pointer management logic that maintains references to the most recently stored output metrics for immediate access by the orchestration module 225 during real-time monitoring operations. The signal processing module 224 can format each output metric record to include a metric type identifier (e.g., an enumerated value distinguishing heart rate metrics from temperature metrics, pose estimation metrics, and instrument reading metrics, and/or the like), a numerical measurement value, a timestamp indicating the capture time of the corresponding environment signal, a confidence score indicating the reliability of the extracted measurement, and a source sensor identifier indicating which sensor of the sensors 206 captured the environment signal from which the metric was derived.

The signal processing module 224 can write the output metrics to the historical signal data 257 using append-mode write operations (e.g., sequential record insertion, time-series data appending, log-structured write operations, and/or the like) that add each new output metric record to a persistent time-series data store without overwriting previously stored records, enabling the historical signal data 257 to accumulate a longitudinal record of physiological measurements associated with the target signal source 104-1 over extended time periods. The signal processing module 224 can implement write batching logic (e.g., accumulating multiple output metric records in a memory buffer before committing the batch to the historical signal data 257 in a single write transaction, and/or the like) that reduces the frequency of write operations to the non-volatile storage media of the computing database 204, thereby minimizing storage latency impact on the real-time signal processing pipeline while ensuring that output metrics are durably persisted for subsequent retrieval.

The orchestration module 225 can access the output metrics stored in the signal data cache 256 through read operations (e.g., cache lookup queries, pointer-based data retrieval, indexed record access, and/or the like) that retrieve the most recent output metrics for use in alert generation routines (e.g., comparing current measurements against physiological baselines to calculate metric deviation scores, and/or the like), query response generation (e.g., assembling output metrics into alphanumeric signals that respond to input queries received through the interface module 227, and/or the like), and closed-loop control operations (e.g., evaluating signal quality scores to determine whether sensor repositioning or navigation to candidate signal sources is required, and/or the like). The model maintenance module 226 can access the output metrics stored in the historical signal data 257 through retrieval operations (e.g., time-range queries, metric-type filtered queries, statistical aggregation queries, and/or the like) that obtain historical measurement records for use in model adaptation routines (e.g., low-rank adaptation of the artificial intelligence models 258 based on accumulated patient-specific measurement data, retrieval-augmented generation context assembly using historical health records, and/or the like) and baseline evolution tracking (e.g., computing updated physiological baseline values from rolling statistical summaries of historical output metrics, and/or the like). The signal processing module 224 can implement thread-safe access mechanisms (e.g., mutex locks, read-write locks, atomic operations, lock-free data structures, and/or the like) that enable concurrent read access by the orchestration module 225 and the model maintenance module 226 while the signal processing module 224 continues to write new output metrics to the signal data cache 256 and the historical signal data 257 without data corruption or race conditions.

As further shown in FIG. 2B, the orchestration module 225 of the memory 220 provides executable instructions that the processor 210 executes to coordinate the operation of other modules (e.g., the sensor control module 221, the actuator control module 222, the navigation module 223, the signal processing module 224, and/or the like) and manage the overall signal monitoring lifecycle of the apparatus 102. The orchestration module 225 can include workflow scheduling logic (e.g., task schedulers, priority queues, event dispatchers, and/or the like) that determines the sequence and timing of monitoring operations based on monitoring objectives, signal quality requirements, and the current state of the apparatus 102 within the environment 100.

The workflow scheduling logic of the orchestration module 225 can implement a task scheduler comprising a priority-based execution queue that maintains a collection of pending monitoring tasks, where each task can be represented as a data structure containing a task type identifier (e.g., an enumerated value distinguishing vital sign capture tasks from navigation tasks, alert evaluation tasks, model update tasks, and query response tasks, and/or the like), a priority level (e.g., an integer value where lower values indicate higher priority, a weighted urgency score computed from task type and elapsed time since last execution, and/or the like), a target module identifier (e.g., a reference to the sensor control module 221 for capture tasks, a reference to the navigation module 223 for displacement tasks, a reference to the signal processing module 224 for inference tasks, and/or the like), and a set of task parameters (e.g., sensor identifiers, capture duration values, target spatial positions, model identifiers, and/or the like) that configure the execution behavior of the task. The task scheduler can evaluate the priority queue at configurable scheduling intervals (e.g., every 50 milliseconds, every 100 milliseconds, every 500 milliseconds, and/or the like) by dequeuing the highest-priority task and dispatching the task to the corresponding module for execution through inter-module communication interfaces (e.g., function call invocations, shared memory message buffers, callback registration mechanisms, and/or the like) exposed by each module of the memory 220.

The orchestration module 225 can implement event-driven coordination logic (e.g., event listener registrations, callback dispatch mechanisms, publish-subscribe messaging patterns, and/or the like) that enables the orchestration module 225 to respond to asynchronous events generated by other modules of the memory 220 during monitoring operations. The event-driven coordination logic can maintain an event dispatcher comprising a registry data structure (e.g., a hash map, a dictionary, an associative array, and/or the like) that maps event type identifiers (e.g., sensor capture completion events, navigation arrival events, signal quality threshold violation events, model inference completion events, user input events, and/or the like) to corresponding handler functions that the orchestration module 225 executes when events of each type are received. For example, when the signal processing module 224 completes generation of the output metrics 310 and writes the output metrics to the signal data cache 256, the signal processing module 224 can emit a metric generation completion event that the event dispatcher routes to a handler function within the orchestration module 225, where the handler function can evaluate the output metrics against physiological baselines stored in the ontological reference data 255 to determine whether alert generation routines should be invoked. Similarly, when the navigation module 223 detects that the target signal source 104-1 has moved beyond a configurable proximity threshold (e.g., 2.0 meters, 3.0 meters, 5.0 meters, and/or the like) from the current position of the apparatus 102, the navigation module 223 can emit a target displacement event that the event dispatcher routes to a handler function that enqueues a high-priority navigation task into the task scheduler to initiate apparatus displacement toward the updated position of the target signal source 104-1.

The orchestration module 225 can implement a monitoring state machine (e.g., a finite state machine, a hierarchical state machine, a statechart, and/or the like) that tracks the current operational mode of the apparatus 102 and enforces valid transitions between operational modes based on detected events and monitoring conditions. The monitoring state machine can define a set of operational states (e.g., an idle state where the apparatus 102 awaits monitoring triggers, an active monitoring state where the apparatus 102 continuously captures environment signals and generates output metrics, a navigation state where the apparatus 102 is displacing to a target spatial position, a query processing state where the apparatus 102 is generating responses to input queries received through the interface module 227, an alert state where the apparatus 102 is executing alert response workflows, and/or the like) and a set of transition conditions (e.g., receipt of a monitoring start command transitioning from idle to active monitoring, detection of target signal source displacement transitioning from active monitoring to navigation, receipt of an input query transitioning from active monitoring to query processing, detection of metric deviation scores exceeding tolerance thresholds transitioning from active monitoring to alert state, and/or the like) that govern how the apparatus 102 transitions between operational modes. The monitoring state machine can maintain a current state variable stored in the memory 220 that the orchestration module 225 updates when transition conditions are satisfied, and can invoke state entry actions (e.g., activating sensors upon entering the active monitoring state, initiating path planning upon entering the navigation state, loading the generative AI model upon entering the query processing state, and/or the like) and state exit actions (e.g., deactivating non-essential sensors upon exiting the active monitoring state, halting actuator motion upon exiting the navigation state, releasing model memory upon exiting the query processing state, and/or the like) that configure the modules of the memory 220 for the requirements of each operational mode.

The orchestration module 225 can implement resource allocation logic (e.g., computational budget managers, sensor scheduling arbitrators, memory allocation coordinators, and/or the like) that manages the distribution of computational resources of the processor 210 across concurrent monitoring operations to prevent resource contention and ensure that high-priority operations receive sufficient processing capacity. The resource allocation logic can maintain a resource budget data structure (e.g., a table of available processor cycles per scheduling interval, a memory allocation ledger tracking allocated and available memory regions, a sensor utilization schedule tracking which sensors are currently active and available, and/or the like) that the orchestration module 225 consults when evaluating whether to dispatch new tasks from the priority queue. The resource allocation logic can implement preemption mechanisms (e.g., suspending lower-priority tasks to free resources for higher-priority tasks, reducing the frame rate of background monitoring to allocate processing capacity for query response generation, temporarily pausing model maintenance operations during active alert processing, and/or the like) that enable the orchestration module 225 to dynamically reallocate resources in response to changing monitoring conditions and priority requirements within the environment 100.

The orchestration module 225 can include query processing routines (e.g., natural language parsers, intent classifiers, parameter extractors, and/or the like) that receive input queries from the interface module 227 and determine the monitoring operations and data retrieval actions needed to generate responses to the input queries. The natural language parsers of the query processing routines can implement tokenization operations (e.g., splitting input query text into word tokens, subword tokens, or character-level tokens using byte-pair encoding, WordPiece tokenization, or whitespace-based segmentation, and/or the like) that decompose the raw text of the input query into a sequence of discrete linguistic units suitable for subsequent semantic analysis. The natural language parsers can further implement syntactic parsing operations (e.g., dependency parsing to identify grammatical relationships between tokens, constituency parsing to determine phrase structure, part-of-speech tagging to classify tokens as nouns, verbs, adjectives, and other grammatical categories, and/or the like) that generate structured representations of the input query enabling the orchestration module 225 to identify the subject, action, and object components of the query for mapping to corresponding monitoring operations.

The intent classifiers of the query processing routines can implement classification models (e.g., multi-class neural network classifiers, support vector machine classifiers, logistic regression classifiers, transformer-based sequence classifiers, and/or the like) loaded from the artificial intelligence models 258 stored in the computing database 204 that receive the tokenized input query as input and generate a probability distribution over a predefined set of intent categories (e.g., vital sign measurement request intents, historical data retrieval intents, navigation command intents, medication management intents, alert configuration intents, general health question intents, and/or the like) as output. The intent classifiers can select the intent category with the highest probability value as the classified intent for the input query, provided the probability value exceeds a configurable confidence threshold (e.g., 0.7, 0.8, 0.9, and/or the like) stored in the ontological reference data 255 of the computing database 204. When the highest probability value falls below the confidence threshold, the intent classifiers can generate a disambiguation request (e.g., a follow-up question presented through the interface module 227, a clarification prompt displayed on the display 240, and/or the like) that asks the user to provide additional context or rephrase the input query to enable more accurate intent classification.

The parameter extractors of the query processing routines can implement named entity recognition models (e.g., conditional random field sequence labelers, bidirectional long short-term memory network taggers, transformer-based token classifiers, and/or the like) that identify and extract structured parameter values from the input query text by classifying each token in the query as belonging to a predefined entity category (e.g., measurement type entities such as “heart rate” or “temperature,” temporal reference entities such as “today” or “last week,” signal source identifiers such as “my glucose meter” or “the blood pressure monitor,” location reference entities such as “kitchen” or “bedroom,” and/or the like) or as a non-entity token. The parameter extractors can map the extracted entity values to corresponding parameter fields in a structured query representation data structure (e.g., a dictionary, a key-value mapping, a typed parameter object, and/or the like) stored in the memory 220 that the orchestration module 225 uses to configure the execution of monitoring operations. For example, when the input query includes the text “What was my heart rate yesterday afternoon?”, the parameter extractors can extract “heart rate” as a measurement type parameter, “yesterday afternoon” as a temporal reference parameter, and the orchestration module 225 can use these extracted parameters to configure a retrieval operation that queries the historical signal data 257 stored in the computing database 204 for heart rate output metrics recorded during the specified time period. The orchestration module 225 can then assemble the retrieved data along with the classified intent and extracted parameters into a structured request that is provided to the generative AI model 320 or to the response generation logic of the orchestration module 225 for generating the appropriate query response.

The orchestration module 225 can include response generation logic (e.g., template fillers, metric aggregators, narrative generators, and/or the like) that assembles output metrics from the signal processing module 224 and historical signal data 257 from the computing database 204 into alphanumeric signals (e.g., text responses, formatted reports, summary statements, and/or the like) that respond to input queries received through the interface module 227. The response generation logic can implement a multi-stage assembly pipeline that receives the classified intent and extracted parameters from the query processing routines along with the output metrics stored in the signal data cache 256 and produces a structured response data object suitable for input to the generative AI model 320 or for direct presentation through the interface module 227.

The template fillers of the response generation logic can implement a template selection mechanism that maintains a library of response template data structures (e.g., stored as parameterized string templates, structured document templates, formatted report layouts, and/or the like) within the ontological reference data 255 of the computing database 204, where each template corresponds to a specific intent category (e.g., vital sign measurement response templates, historical data summary templates, alert notification templates, medication reminder templates, and/or the like) identified by the intent classifiers of the query processing routines. The template fillers can select an appropriate template based on the classified intent and can populate placeholder fields within the selected template with corresponding values extracted from the output metrics 310 stored in the signal data cache 256. For example, when the classified intent corresponds to a vital sign measurement request, the template fillers can select a vital sign response template containing placeholder fields for measurement type, measurement value, measurement unit, confidence score, and capture timestamp, and can populate each placeholder field by retrieving the corresponding values from the most recent output metric records written to the signal data cache 256 by the signal processing module 224. The template fillers can apply formatting rules (e.g., rounding numerical values to specified decimal places, converting units between measurement systems, applying locale-specific number formatting, and/or the like) stored in the ontological reference data 255 to ensure that populated template values are presented in a format appropriate for the target audience (e.g., the target signal source 104-1, a caregiver, a healthcare provider, and/or the like).

The metric aggregators of the response generation logic can implement statistical aggregation routines that compute summary statistics (e.g., mean values, median values, minimum values, maximum values, standard deviation values, percentile values, and/or the like) from collections of output metrics retrieved from the historical signal data 257 of the computing database 204 over configurable time windows (e.g., the past 24 hours, the past 7 days, the past 30 days, and/or the like) specified by the temporal reference parameters extracted from the input query by the parameter extractors. The metric aggregators can execute time-range queries against the historical signal data 257 by specifying a metric type identifier (e.g., heart rate, temperature, blood pressure, glucose level, and/or the like) and a temporal range defined by start and end timestamps derived from the extracted temporal reference parameters, retrieving a result set of output metric records that fall within the specified time range. The metric aggregators can iterate over the retrieved result set to compute the requested summary statistics by maintaining running accumulators (e.g., sum accumulators for mean calculation, sorted value arrays for median and percentile calculation, minimum and maximum trackers for range calculation, and/or the like) that are updated with each output metric value in the result set. The metric aggregators can further compute trend indicators (e.g., increasing trend, decreasing trend, stable trend, fluctuating trend, and/or the like) by applying linear regression analysis or slope calculation to the time-series values within the retrieved result set, enabling the response generation logic to include trend descriptions in the assembled alphanumeric signals.

The narrative generators of the response generation logic can implement natural language construction routines that transform the populated templates and aggregated metric summaries into coherent alphanumeric signals suitable for presentation to users through the interface module 227 or for input to the generative AI model 320 as context for generating more detailed responses. The narrative generators can concatenate template-filled segments with contextual phrases (e.g., comparative statements such as “which is higher than your average of,” temporal references such as “over the past week,” interpretive annotations such as “within the normal range,” and/or the like) retrieved from a phrase library stored in the ontological reference data 255 to produce human-readable response text that contextualizes the output metrics within the health history of the target signal source 104-1. The narrative generators can apply conditional logic (e.g., if-then rules, threshold-based branching, severity-level selection, and/or the like) that selects different narrative structures based on the relationship between current output metrics and physiological baselines stored in the ontological reference data 255, enabling the response generation logic to produce responses that emphasize normal readings when metrics fall within expected ranges or highlight concerning deviations when metrics exceed baseline thresholds. The narrative generators can store the assembled alphanumeric signals as structured response objects in the signal data cache 256, where each response object can include a response text field, a response confidence score, a list of source metric references, and a timestamp, enabling the orchestration module 225 to transmit the response to the interface module 227 for display on the display 240 or to provide the response as supplementary context to the generative AI model 320 for further elaboration.

The orchestration module 225 can include alert generation routines (e.g., threshold comparators, deviation calculators, notification formatters, and/or the like) that compare output metrics against physiological baselines associated with the target signal source 104-1 and generate notification alerts when metric deviation scores exceed tolerance threshold values. The alert generation routines can implement a multi-stage evaluation pipeline that receives the output metrics 310 from the signal data cache 256 and processes the output metrics through successive comparison, scoring, and notification stages to determine whether alert conditions are satisfied.

The threshold comparators of the alert generation routines can implement comparison logic that retrieves physiological baseline values (e.g., resting heart rate ranges, normal body temperature bounds, expected gait symmetry parameters, healthy blood pressure ranges, and/or the like) from the ontological reference data 255 stored in the computing database 204 and compares each output metric value against the corresponding baseline value. The threshold comparators can maintain a baseline data structure (e.g., a dictionary, a lookup table, a key-value mapping, and/or the like) stored in the memory 220 that associates each metric type identifier (e.g., heart rate, temperature, blood pressure, gait variability, and/or the like) with a corresponding baseline range defined by an upper bound value and a lower bound value. The threshold comparators can evaluate each output metric by determining whether the numerical measurement value of the output metric falls within the baseline range associated with the metric type, where values falling outside the baseline range can trigger subsequent deviation scoring operations.

The deviation calculators of the alert generation routines can compute metric deviation scores that quantify the magnitude and direction of deviation between current output metric values and the physiological baseline values. The deviation calculators can implement absolute deviation computation (e.g., calculating the difference between the current measurement value and the nearest baseline boundary value, and/or the like) that produces a raw deviation magnitude indicating how far the current measurement falls outside the expected range. The deviation calculators can implement statistical deviation computation (e.g., calculating z-scores by dividing the difference between the current measurement and the historical mean by the historical standard deviation retrieved from the historical signal data 257, computing percentile rankings relative to the distribution of prior measurements, and/or the like) that normalizes the deviation relative to the historical variability of the measurement for the target signal source 104-1. The deviation calculators can implement percentage deviation computation (e.g., calculating the percentage change between the current measurement and the baseline midpoint value, computing the ratio of the current measurement to the baseline upper or lower bound, and/or the like) that expresses the deviation as a proportion of the expected value. The deviation calculators can store the computed metric deviation scores as numerical values in the signal data cache 256 alongside the corresponding output metric records, enabling the orchestration module 225 to access both the raw measurements and the deviation scores when determining alert generation actions.

The alert generation routines can compare the computed metric deviation scores against configurable tolerance threshold values (e.g., a first threshold for informational alerts, a second higher threshold for warning alerts, a third higher threshold for urgent alerts, a fourth highest threshold for emergency alerts, and/or the like) stored in the ontological reference data 255 of the computing database 204. The tolerance threshold values can be defined as a tiered threshold data structure (e.g., an ordered list of threshold-severity pairs, a multi-level threshold configuration, a hierarchical alert boundary specification, and/or the like) that maps ranges of deviation score magnitudes to corresponding alert severity levels. The alert generation routines can iterate through the tiered threshold data structure from the highest severity level to the lowest severity level, comparing the metric deviation score against each threshold value to determine the appropriate severity level for the detected deviation. When the metric deviation score exceeds a tolerance threshold value, the alert generation routines can classify the deviation according to the corresponding severity level and initiate notification generation for that severity level.

The notification formatters of the alert generation routines can assemble the notification alert 326 by constructing a structured alert data object (e.g., a notification record, an alert message structure, a formatted alert payload, and/or the like) that includes the metric type identifier of the deviating output metric, the current measurement value, the baseline range values, the computed metric deviation score, the assigned severity level, a human-readable description of the detected deviation, and a timestamp indicating when the deviation was detected. The notification formatters can select alert description templates from the ontological reference data 255 based on the metric type and severity level, populating template placeholder fields with the specific measurement values and deviation magnitudes to produce contextually relevant alert descriptions (e.g., “Heart rate of 112 BPM exceeds the upper baseline of 100 BPM by 12 percent,” “Body temperature of 101.2° F. exceeds the normal range of 97.0° F. to 99.5° F.,” and/or the like). The notification formatters can transmit the assembled notification alert 326 to the interface module 227 for immediate display on the display 240 and can additionally transmit the notification alert 326 through the wireless communication circuitry 230 to external devices (e.g., caregiver mobile phones, healthcare provider systems, emergency services, and/or the like) when the assigned severity level exceeds a configurable external notification threshold stored in the ontological reference data 255. The alert generation routines can implement alert suppression logic (e.g., cooldown timers that prevent repeated alerts for the same metric within a configurable time window, deduplication filters that suppress alerts when the deviation score has not changed significantly since the previous alert, and/or the like) that prevents excessive notification generation during sustained periods of metric deviation while ensuring that new or worsening deviations are promptly communicated.

The orchestration module 225 can include closed-loop control logic (e.g., feedback controllers, adaptive schedulers, quality monitors, and/or the like) that adjusts monitoring operations based on the quality of captured environment signals and the correspondence between captured signals and the physiological measurements being monitored. The closed-loop control logic can implement a signal quality evaluation pipeline that receives the output metrics 310 from the signal data cache 256 along with associated confidence scores generated by the signal processing module 224 and compares the confidence scores against configurable correspondence threshold values (e.g., minimum confidence levels such as 0.7 or 0.8, minimum signal-to-noise ratio values, minimum skin pixel count thresholds for remote photoplethysmography, and/or the like) stored in the ontological reference data 255 of the computing database 204 to determine whether the captured environment signals provide sufficient quality for reliable physiological measurement extraction.

The feedback controllers of the closed-loop control logic can implement a proportional response mechanism that maps the magnitude of signal quality deficiency to a corresponding corrective action intensity. For example, when the confidence score for a heart rate measurement falls below the correspondence threshold value by a small margin (e.g., the confidence score is 0.65 against a threshold of 0.7, and/or the like), the feedback controllers can generate a low-intensity corrective action (e.g., commanding the actuator control module 222 to make minor adjustments to the pan and tilt angles of the actuated sensor assembly 260 to improve the viewing angle of the face region, instructing the sensor control module 221 to increase the frame rate or adjust exposure settings, and/or the like) that attempts to improve signal quality without interrupting the current monitoring session. When the confidence score falls below the correspondence threshold value by a larger margin (e.g., the confidence score is 0.3 against a threshold of 0.7, and/or the like), the feedback controllers can generate a high-intensity corrective action (e.g., commanding the navigation module 223 to replan the position of the apparatus 102 relative to the target signal source 104-1, initiating navigation to the candidate signal source 104-2 for complementary signal capture, triggering a full sensor recalibration sequence through the sensor control module 221, and/or the like) that involves more substantial repositioning or reconfiguration of the monitoring system.

The adaptive schedulers of the closed-loop control logic can implement dynamic scheduling routines that modify the frequency and type of monitoring operations based on observed signal quality trends over configurable time windows (e.g., the past 30 seconds, the past 5 minutes, the past hour, and/or the like). The adaptive schedulers can maintain a rolling quality history data structure (e.g., a circular buffer of recent confidence scores, a time-weighted moving average of signal quality metrics, a sliding window of correspondence evaluation results, and/or the like) stored in the signal data cache 256 that the orchestration module 225 accesses to detect patterns in signal quality degradation or improvement. When the rolling quality history indicates a sustained period of high signal quality (e.g., confidence scores consistently above the correspondence threshold for a configurable duration such as 5 minutes, and/or the like), the adaptive schedulers can reduce the frequency of quality evaluation checks and lower the capture frame rate to conserve computational resources on the processor 210. When the rolling quality history indicates a declining trend in signal quality (e.g., a monotonically decreasing sequence of confidence scores over successive evaluation intervals, and/or the like), the adaptive schedulers can proactively increase the frequency of quality evaluation checks, enqueue sensor repositioning tasks into the priority queue of the workflow scheduling logic, and pre-compute alternative sensor configurations that the feedback controllers can apply if the signal quality continues to deteriorate.

The quality monitors of the closed-loop control logic can implement per-metric quality tracking routines that independently evaluate the signal quality for each type of output metric (e.g., the heart rate 312, the temperature 314, the instrument reading 316, pose estimation metrics, and/or the like) generated by the signal processing module 224, enabling the orchestration module 225 to apply targeted corrective actions for specific measurement types that exhibit quality deficiencies without disrupting the capture of other measurement types that maintain acceptable quality levels. The quality monitors can maintain a metric-specific quality state table (e.g., a data structure mapping each metric type identifier to a current quality state such as acceptable, marginal, or insufficient, along with the most recent confidence score and a timestamp of the last quality evaluation, and/or the like) stored in the memory 220 that the orchestration module 225 consults when determining which corrective actions to dispatch through the feedback controllers. The quality monitors can generate quality degradation events (e.g., event notifications emitted through the event-driven coordination logic of the orchestration module 225, and/or the like) when a metric transitions from an acceptable quality state to a marginal or insufficient quality state, triggering the corresponding handler functions within the orchestration module 225 to initiate corrective workflows such as sensor repositioning, navigation to candidate signal sources, or adjustment of sensor operating parameters through the sensor control module 221.

Referring again to FIG. 2B, the model maintenance module 226 of the memory 220 provides executable instructions that the processor 210 executes to manage, update, and optimize artificial intelligence models 258 stored in the computing database 204 that the signal processing module 224 and the orchestration module 225 use for transforming environment signals into output metrics and generating responses to input queries. The model maintenance module 226 can include model loading routines (e.g., weight deserializers, graph loaders, runtime initializers, and/or the like) that load artificial intelligence models 258 from the computing database 204 into the memory 220 for execution by the processor 210 during signal processing and response generation operations.

The model loading routines of the model maintenance module 226 can implement a multi-stage model initialization pipeline that prepares artificial intelligence models 258 for inference execution on the processor 210. The weight deserializers can read serialized model parameter files (e.g., PyTorch checkpoint files with .pt or .pth extensions, TensorFlow SavedModel directories, ONNX model files, and/or the like) from the non-volatile storage media of the computing database 204 and can reconstruct in-memory tensor data structures by parsing the serialized binary representations of model weights, biases, and normalization parameters into floating-point arrays allocated within the memory 220. The weight deserializers can implement format detection logic that examines file headers or metadata fields within the serialized model files to determine the serialization format (e.g., Protocol Buffers, FlatBuffers, pickle-based serialization, safetensors format, and/or the like) and can invoke the corresponding deserialization codec to reconstruct the model parameter tensors with correct data types (e.g., 32-bit floating point, 16-bit floating point, 8-bit integer for quantized models, and/or the like) and dimensional shapes matching the model architecture specifications stored in the signal source reference data 254 of the computing database 204.

The graph loaders of the model loading routines can reconstruct the computational graph data structures (e.g., directed acyclic graphs representing the sequence of mathematical operations that transform input tensors into output tensors, layer connectivity specifications defining how data flows between neural network layers, operator node definitions specifying the computation performed at each graph node, and/or the like) that define the architecture and execution order of each artificial intelligence model 258. The graph loaders can parse model definition files (e.g., model architecture configuration files in JSON or YAML format, graph definition protobuf files, ONNX graph representations, and/or the like) to instantiate operator nodes (e.g., convolution operators, matrix multiplication operators, activation function operators, normalization operators, attention mechanism operators, and/or the like) within the memory 220 and can establish data flow connections between the instantiated operator nodes by linking output tensor references of predecessor nodes to input tensor references of successor nodes according to the graph topology. The graph loaders can perform graph optimization passes (e.g., operator fusion that combines sequential operations into single fused kernels, constant folding that pre-computes operations on static inputs, dead code elimination that removes unused graph branches, memory planning that determines optimal tensor allocation and deallocation schedules, and/or the like) that transform the computational graph into an optimized execution plan suitable for the hardware capabilities of the processor 210.

The runtime initializers of the model loading routines can configure the execution environment for the loaded artificial intelligence models 258 by allocating GPU memory buffers (e.g., reserving contiguous memory regions on the graphics processing unit for storing intermediate activation tensors, pre-allocating workspace memory for convolution algorithms, establishing memory pools for dynamic tensor allocation during inference, and/or the like) on the processor 210, initializing inference engine contexts (e.g., TensorRT execution contexts, CUDA stream objects for asynchronous kernel execution, cuDNN handle objects for neural network primitive operations, and/or the like) that manage the runtime state of model execution, and binding the deserialized model parameters to the corresponding operator nodes in the optimized computational graph. The runtime initializers can perform model warm-up operations (e.g., executing one or more inference passes with dummy input data to trigger just-in-time compilation of GPU kernels, populate instruction caches, and establish optimal memory access patterns, and/or the like) that ensure the artificial intelligence models 258 achieve consistent inference latency from the first production inference call. The runtime initializers can register the loaded models in a model registry data structure (e.g., a hash map keyed by model identifier strings, a lookup table mapping model type enumerations to loaded model objects, and/or the like) stored in the memory 220 that the signal processing module 224 and the orchestration module 225 query to obtain references to loaded models when initiating inference operations.

The model maintenance module 226 can implement model lifecycle management logic (e.g., reference counting mechanisms, memory pressure monitors, model eviction policies, and/or the like) that tracks which artificial intelligence models 258 are currently loaded in the memory 220, monitors the memory utilization of loaded models, and selectively unloads models that are not actively being used by the signal processing module 224 or the orchestration module 225 to free memory resources for higher-priority models or processing operations. The model lifecycle management logic can maintain a model usage tracking data structure (e.g., a least-recently-used cache, a frequency-based priority queue, a time-stamped access log, and/or the like) that records when each loaded model was last invoked for inference, enabling the model maintenance module 226 to identify models that can be safely unloaded from the memory 220 and reloaded from the computing database 204 when needed. The model lifecycle management logic can implement lazy loading strategies (e.g., deferring model loading until the first inference request for a particular model type is received, loading model components incrementally as different processing pipeline stages are activated, pre-loading models based on predicted monitoring schedules stored in the orchestration module 225, and/or the like) that balance memory utilization against inference latency requirements for the monitoring operations of the apparatus 102.

The model maintenance module 226 can include model adaptation routines (e.g., low-rank adaptation processors, retrieval-augmented generation configurators, fine-tuning executors, and/or the like) that update artificial intelligence models 258 based on historical signal data 257 and output metrics specific to the target signal source 104-1, enabling the models to become personalized to the physiological characteristics of the target signal source 104-1 over time.

The low-rank adaptation processors of the model adaptation routines can implement parameter-efficient fine-tuning techniques that modify a subset of the model parameters of the artificial intelligence models 258 without requiring full retraining of the entire model architecture. The low-rank adaptation processors can decompose weight update matrices into products of two lower-rank matrices (e.g., a first matrix of dimensions d-by-r and a second matrix of dimensions r-by-k, where r is a rank value substantially smaller than both d and k, and/or the like) that are injected alongside the frozen pre-trained weight matrices of the artificial intelligence models 258, enabling the model maintenance module 226 to learn patient-specific adaptations while preserving the general knowledge encoded in the original pre-trained parameters. The low-rank adaptation processors can select target layers within the artificial intelligence models 258 for adaptation (e.g., attention projection layers in transformer-based models, convolutional filter layers in vision models, classification head layers in detection models, and/or the like) based on layer sensitivity analysis that identifies which layers contribute most to patient-specific measurement accuracy. The low-rank adaptation processors can accumulate training samples from the output metrics stored in the historical signal data 257 over configurable time windows (e.g., one week of heart rate measurements, two weeks of gait analysis data, one month of temperature readings, and/or the like) and can execute gradient-based optimization (e.g., stochastic gradient descent, Adam optimization, and/or the like) on the low-rank matrices using the accumulated samples as a training dataset, where the optimization objective can minimize the difference between model-predicted output metrics and validated ground truth measurements obtained from the candidate signal source 104-2 (e.g., readings from calibrated medical instruments, clinician-verified measurements, and/or the like). The low-rank adaptation processors can store the learned low-rank matrices as compact adapter weight files (e.g., files occupying a fraction of the storage required by the full model weights, and/or the like) in the computing database 204, enabling the model maintenance module 226 to maintain multiple patient-specific adapter configurations and swap between them when the apparatus 102 monitors different target signal sources.

The retrieval-augmented generation configurators of the model adaptation routines can implement a context augmentation pipeline that supplements the input prompts provided to the generative AI model 320 with relevant medical knowledge, patient-specific measurement history, and contextual information retrieved from the computing database 204 at inference time. The retrieval-augmented generation configurators can maintain a document index data structure (e.g., a vector database, an inverted index, a hierarchical navigable small world graph, and/or the like) stored in the computing database 204 that indexes medical knowledge documents from the ontological reference data 255 and patient measurement records from the historical signal data 257 as embedding vectors generated by an embedding model loaded from the artificial intelligence models 258. When the orchestration module 225 submits an input query or requests health assessment generation from the generative AI model 320, the retrieval-augmented generation configurators can encode the query into an embedding vector using the same embedding model, perform a similarity search (e.g., cosine similarity computation, approximate nearest neighbor search, maximum inner product search, and/or the like) against the document index to identify the top-k most relevant documents (e.g., the five most similar medical knowledge entries, the ten most relevant historical measurement records, and/or the like), and concatenate the retrieved documents into a context window that is prepended to the input prompt provided to the generative AI model 320. The retrieval-augmented generation configurators can apply relevance filtering (e.g., discarding retrieved documents with similarity scores below a configurable threshold, removing duplicate or near-duplicate entries, prioritizing recent measurement records over older records, and/or the like) to ensure that the context window contains high-quality, non-redundant information that improves the accuracy and specificity of the generated output without exceeding the maximum context length supported by the generative AI model 320.

The fine-tuning executors of the model adaptation routines can implement supervised training procedures that update the full parameter set or a designated subset of parameters of the artificial intelligence models 258 using labeled training data derived from the historical signal data 257 and validated output metrics accumulated during monitoring operations. The fine-tuning executors can construct training datasets by pairing environment signal samples stored in the signal data cache 256 with corresponding validated output metric values stored in the historical signal data 257, where the validated output metric values can serve as ground truth labels for supervised training. The fine-tuning executors can implement training loop logic (e.g., iterating over mini-batches of training samples, computing forward pass predictions through the model, calculating loss values using loss functions such as mean squared error for regression tasks or cross-entropy for classification tasks, computing gradients via backpropagation, and updating model parameters using the computed gradients scaled by a learning rate, and/or the like) that executes on the processor 210 during periods of low monitoring activity (e.g., when the target signal source 104-1 is sleeping, when the apparatus 102 is in a standby mode, during scheduled maintenance windows, and/or the like) to avoid consuming computational resources needed for real-time signal processing operations. The fine-tuning executors can implement early stopping logic (e.g., monitoring a validation loss computed on a held-out subset of the training data, terminating training when the validation loss fails to decrease for a configurable number of consecutive epochs, restoring the model parameters from the epoch with the lowest validation loss, and/or the like) that prevents overfitting of the artificial intelligence models 258 to the limited patient-specific training data. The fine-tuning executors can store fine-tuned model checkpoints (e.g., serialized model parameter files, optimizer state snapshots, training progress metadata, and/or the like) in the computing database 204, enabling the model maintenance module 226 to roll back to previous model versions if fine-tuned models exhibit degraded performance on subsequent monitoring operations.

The model maintenance module 226 can include retrieval-augmented generation logic (e.g., document indexers, similarity searchers, context assemblers, and/or the like) that augments generative artificial intelligence models with medical knowledge, patient history, and measurement data retrieved from the computing database 204 when the amount of training data is limited.

The document indexers of the retrieval-augmented generation logic can implement an indexing pipeline that processes medical knowledge documents from the ontological reference data 255 and patient measurement records from the historical signal data 257 into searchable index structures stored in the computing database 204. The document indexers can segment source documents into discrete text chunks (e.g., fixed-length passages of 256 tokens, overlapping windows of 512 tokens with 128-token stride, semantically coherent paragraph-level segments, and/or the like) that represent atomic units of retrievable information. The document indexers can transform each text chunk into a dense vector representation (e.g., a fixed-dimensional embedding vector of 768 dimensions, 1024 dimensions, or 1536 dimensions, and/or the like) by passing the text chunk through an embedding model loaded from the artificial intelligence models 258 stored in the computing database 204. The embedding model can comprise a sentence transformer (e.g., a bi-encoder architecture that maps input text to a fixed-length vector, a contrastive learning-trained encoder that produces semantically meaningful embeddings, and/or the like) that generates embedding vectors such that semantically similar text chunks produce embedding vectors with high cosine similarity values. The document indexers can store the generated embedding vectors alongside their corresponding text chunks in a vector index data structure (e.g., a hierarchical navigable small world graph, a product quantization-based index, an inverted file index with scalar quantization, and/or the like) within the computing database 204 that enables efficient approximate nearest neighbor search over the indexed embedding vectors.

The similarity searchers of the retrieval-augmented generation logic can implement a query-time retrieval pipeline that identifies the most relevant indexed documents for a given input query or health assessment request submitted to the generative AI model 320. The similarity searchers can encode the input query into a query embedding vector using the same embedding model employed by the document indexers, ensuring that the query embedding resides in the same vector space as the indexed document embeddings. The similarity searchers can execute an approximate nearest neighbor search (e.g., traversing the hierarchical navigable small world graph from an entry point node through successively finer graph layers, scanning inverted file clusters nearest to the query vector, performing multi-probe locality-sensitive hashing lookups, and/or the like) against the vector index data structure to identify a candidate set of top-k document embeddings (e.g., the 5 nearest embeddings, the 10 nearest embeddings, the 20 nearest embeddings, and/or the like) with the highest similarity scores relative to the query embedding. The similarity searchers can compute similarity scores using distance metrics (e.g., cosine similarity computed as the dot product of normalized vectors, negative Euclidean distance, maximum inner product, and/or the like) that quantify the semantic relevance of each candidate document to the input query. The similarity searchers can apply a relevance threshold (e.g., discarding candidate documents with cosine similarity scores below a configurable minimum threshold such as 0.6 or 0.7, and/or the like) to filter out low-relevance documents that could introduce noise into the context provided to the generative AI model 320.

The context assemblers of the retrieval-augmented generation logic can implement a prompt construction pipeline that combines the retrieved documents from the similarity searchers with the original input query to form an augmented input prompt for the generative AI model 320. The context assemblers can rank the retrieved documents by their similarity scores in descending order and can select a subset of the highest-ranked documents that fit within the maximum context window length (e.g., 2048 tokens, 4096 tokens, 8192 tokens, and/or the like) supported by the generative AI model 320 after accounting for the token length of the input query and any system-level prompt instructions. The context assemblers can apply deduplication logic (e.g., computing pairwise similarity between retrieved documents and removing documents that exceed a configurable redundancy threshold such as 0.95 cosine similarity with another already-selected document, and/or the like) to ensure that the assembled context contains diverse and non-redundant information. The context assemblers can apply recency weighting (e.g., boosting the ranking of measurement records from the historical signal data 257 that were captured within a recent time window such as the past 24 hours or the past 7 days, attenuating the ranking of older records that may be less relevant to the current health state of the target signal source 104-1, and/or the like) to prioritize temporally relevant patient data when assembling the context. The context assemblers can concatenate the selected documents into a structured context block (e.g., a formatted text string with section delimiters separating individual retrieved passages, a structured prompt template with labeled fields for medical knowledge context and patient history context, and/or the like) that is prepended to the input query within the augmented prompt provided to the generative AI model 320. The context assemblers can store the assembled augmented prompt in the signal data cache 256 of the computing database 204 prior to submission to the generative AI model 320, enabling the orchestration module 225 to log and audit the context provided to the model for each inference request. The retrieval-augmented generation logic can enable the generative AI model 320 to generate more accurate and patient-specific responses by grounding the model's output in relevant medical knowledge and historical measurement data retrieved from the computing database 204, compensating for limitations in the model's parametric knowledge that arise when the amount of patient-specific training data available for fine-tuning is limited.

The model maintenance module 226 can include model versioning routines (e.g., checkpoint managers, rollback handlers, version selectors, and/or the like) that maintain multiple versions of artificial intelligence models 258 and enable selection of appropriate model versions based on monitoring objectives and available computational resources.

The checkpoint managers of the model versioning routines can implement a persistent model snapshot pipeline that serializes the complete state of each artificial intelligence model 258 at configurable intervals (e.g., after each fine-tuning epoch, after each low-rank adaptation update, after a configurable number of inference cycles, and/or the like) to non-volatile storage within the computing database 204. The checkpoint managers can generate checkpoint data structures (e.g., serialized model parameter files, optimizer state snapshots, training progress metadata, epoch counters, loss function values at the time of checkpointing, and/or the like) that encapsulate the full recoverable state of a model version, enabling the model maintenance module 226 to restore any previously saved model version to an operational state within the memory 220 without requiring retraining from initial parameters. The checkpoint managers can maintain a checkpoint registry data structure (e.g., a chronologically ordered list, a hash map keyed by version identifiers, a database table indexed by timestamp and model type, and/or the like) stored in the computing database 204 that catalogs each saved checkpoint with associated metadata including a unique version identifier (e.g., an auto-incrementing integer, a timestamp-based identifier, a hash of the model parameters, and/or the like), the timestamp at which the checkpoint was created, the training dataset characteristics used to produce the checkpoint (e.g., the number of training samples, the time range of historical signal data 257 used for fine-tuning, the target signal source identifier, and/or the like), and performance metrics (e.g., validation loss values, inference accuracy scores, mean per joint position error for pose estimation models, heart rate estimation error margins for remote photoplethysmography models, and/or the like) measured at the time of checkpoint creation. The checkpoint managers can implement storage quota management logic (e.g., maximum checkpoint count limits, total storage size thresholds, retention period policies, and/or the like) that automatically prunes older checkpoints from the computing database 204 when storage utilization exceeds configurable thresholds, retaining a configurable number of most recent checkpoints (e.g., the last 5 checkpoints, the last 10 checkpoints, and/or the like) along with any checkpoints explicitly marked for permanent retention by the orchestration module 225.

The rollback handlers of the model versioning routines can implement a model restoration pipeline that reverts a currently loaded artificial intelligence model 258 to a previously saved checkpoint version when the model maintenance module 226 detects that a recently fine-tuned or adapted model version exhibits degraded performance relative to prior versions. The rollback handlers can monitor inference performance by comparing output metrics generated by the currently active model version against validation benchmarks (e.g., ground truth measurements obtained from the candidate signal source 104-2, clinician-verified reference values, historical accuracy baselines stored in the ontological reference data 255, and/or the like) and can compute a performance degradation score (e.g., the percentage increase in prediction error relative to the previous model version, the absolute difference in validation loss between the current and previous versions, the ratio of current accuracy to baseline accuracy, and/or the like) that quantifies the extent to which the current model version underperforms relative to prior versions. When the performance degradation score exceeds a configurable rollback threshold (e.g., a 10 percent increase in prediction error, a 15 percent decrease in accuracy, a validation loss exceeding the previous version's loss by more than a configurable margin, and/or the like), the rollback handlers can execute a rollback operation by unloading the current model parameters from the memory 220, retrieving the checkpoint data structure corresponding to the target rollback version from the computing database 204, deserializing the stored model parameters using the weight deserializers of the model loading routines, and loading the restored parameters into the memory 220 for execution by the processor 210. The rollback handlers can log each rollback event (e.g., recording the version identifier of the rolled-back model, the version identifier of the restored model, the performance degradation score that triggered the rollback, the timestamp of the rollback operation, and/or the like) in the historical signal data 257 of the computing database 204, enabling the model maintenance module 226 to track rollback frequency and identify patterns in model degradation that may inform future fine-tuning strategies.

The version selectors of the model versioning routines can implement a model selection pipeline that evaluates available model versions stored in the checkpoint registry and selects the most appropriate version for the current monitoring context based on monitoring objectives specified by the orchestration module 225 and computational resource constraints of the processor 210. The version selectors can maintain a version compatibility matrix (e.g., a lookup table, a configuration mapping, a structured data file, and/or the like) stored in the signal source reference data 254 of the computing database 204 that associates each model version with metadata describing the model's computational requirements (e.g., memory footprint in megabytes, inference latency in milliseconds, GPU utilization percentage during inference, and/or the like), the model's accuracy characteristics for different measurement types (e.g., heart rate estimation accuracy, temperature measurement precision, pose estimation error margins, optical character recognition accuracy for instrument readings, and/or the like), and the model's compatibility with different monitoring scenarios (e.g., low-light conditions, high-motion environments, multi-person scenes, distant target signal sources, and/or the like). The version selectors can receive a version selection request from the orchestration module 225 that specifies the current monitoring objective (e.g., the type of physiological measurement being captured, the environmental conditions detected by the sensor control module 221, the available computational budget determined by the resource allocation logic, and/or the like) and can evaluate each available model version against the specified requirements by computing a suitability score (e.g., a weighted combination of accuracy metrics, computational cost factors, and environmental compatibility indicators, and/or the like) for each version. The version selectors can select the model version with the highest suitability score and can invoke the model loading routines to load the selected version into the memory 220 for execution, enabling the model maintenance module 226 to dynamically swap between model versions (e.g., selecting a lightweight quantized model version when computational resources are constrained by concurrent processing tasks, selecting a high-accuracy full-precision model version when computational resources are available and measurement precision is prioritized, selecting a patient-specific fine-tuned version when monitoring a known target signal source 104-1, and/or the like) without requiring manual intervention from users or caregivers.

The model maintenance module 226 can include model performance monitoring logic (e.g., accuracy trackers, latency measurers, resource utilization monitors, and/or the like) that tracks the performance of artificial intelligence models 258 during inference operations and identifies opportunities for model optimization or retraining. The accuracy trackers of the model performance monitoring logic can implement continuous evaluation routines that compare output metrics generated by the currently active artificial intelligence models 258 against validated reference measurements (e.g., ground truth values obtained from the candidate signal source 104-2, clinician-verified readings, calibrated instrument measurements, and/or the like) to compute running accuracy statistics (e.g., mean absolute error values, root mean square error values, percentage of predictions within acceptable tolerance bounds, and/or the like) that quantify the predictive performance of each model over configurable evaluation windows (e.g., past inference cycles, the past 24 hours of monitoring operations, the past 7 days of accumulated measurements, and/or the like). The accuracy trackers can maintain per-model accuracy ledger data structures (e.g., time-stamped accuracy records, rolling statistical accumulators, exponentially weighted moving average trackers, and/or the like) stored in the signal data cache 256 of the computing database 204 that the model maintenance module 226 queries to detect accuracy degradation trends (e.g., monotonically increasing error rates over successive evaluation windows, accuracy values falling below configurable minimum thresholds such as 90 percent or 95 percent, sudden accuracy drops exceeding configurable change detection thresholds, and/or the like) indicative of model drift or environmental changes that warrant retraining or rollback operations.

The latency measurers of the model performance monitoring logic can implement inference timing instrumentation that records the elapsed wall-clock time (e.g., measured in milliseconds or microseconds using high-resolution system timers, hardware performance counters, or monotonic clock sources, and/or the like) consumed by each inference invocation of the artificial intelligence models 258 executed by the processor 210. The latency measurers can capture timing measurements at multiple granularity levels within the signal processing pipeline (e.g., per-model inference latency measuring the time from input tensor submission to output tensor retrieval, per-stage pipeline latency measuring the cumulative time across preprocessing, inference, and postprocessing stages, end-to-end latency measuring the total time from environment signal capture to output metric generation, and/or the like) by inserting timestamp capture operations (e.g., reading system clock values before and after each measured code segment, computing elapsed time as the difference between start and end timestamps, and/or the like) at instrumentation points within the signal processing module 224 and the orchestration module 225. The latency measurers can maintain latency histogram data structures (e.g., binned frequency distributions of observed latency values, percentile trackers computing the 50th, 95th, and 99th percentile latency values, maximum latency trackers recording the worst-case inference time within each evaluation window, and/or the like) stored in the signal data cache 256 that the model maintenance module 226 accesses to detect latency anomalies (e.g., inference times exceeding configurable maximum thresholds such as 100 milliseconds or 500 milliseconds, latency percentile values drifting upward over successive evaluation windows, and/or the like) that can indicate computational resource contention, model complexity issues, or hardware degradation requiring corrective action.

The resource utilization monitors of the model performance monitoring logic can implement hardware telemetry collection routines that periodically sample (e.g., at configurable intervals such as every 100 milliseconds, every 1 second, every 5 seconds, and/or the like) the computational resource consumption of the artificial intelligence models 258 during inference execution on the processor 210. The resource utilization monitors can query hardware monitoring interfaces (e.g., NVIDIA Management Library APIs for GPU utilization percentage and GPU memory occupancy, operating system process accounting interfaces for CPU utilization and system memory consumption, thermal management interfaces for processor temperature readings, power management interfaces for current power draw measurements, and/or the like) to obtain resource utilization metrics that the model maintenance module 226 stores in the signal data cache 256 as time-series telemetry records. The resource utilization monitors can compute derived utilization metrics (e.g., average GPU utilization percentage over a sliding window, peak memory consumption during inference batches, ratio of active inference time to idle time, thermal headroom calculated as the difference between current temperature and maximum rated temperature, and/or the like) that the model maintenance module 226 evaluates against configurable resource budget thresholds (e.g., maximum GPU utilization of 80 percent to reserve capacity for concurrent monitoring tasks, maximum memory occupancy of 90 percent to prevent out-of-memory conditions, maximum thermal threshold of 85 degrees Celsius to prevent thermal throttling, and/or the like) stored in the ontological reference data 255 of the computing database 204. When the resource utilization monitors detect that resource consumption exceeds the configured budget thresholds, the model maintenance module 226 can trigger optimization actions (e.g., invoking the version selectors to swap to a lighter-weight quantized model variant, reducing the inference batch size or frame rate through the sensor control module 221, deferring non-critical model maintenance operations to periods of lower resource utilization, and/or the like) that reduce resource consumption while maintaining acceptable monitoring performance for the target signal source 104-1.

With continued reference to FIG. 2B, the interface module 227 of the memory 220 provides executable instructions that the processor 210 executes to manage user interactions with the apparatus 102 through the display 240 and other input/output interfaces coupled to the computing logic 202. The interface module 227 can include graphical user interface rendering routines (e.g., screen composers, widget renderers, layout managers, and/or the like) that generate visual displays on the display 240 presenting monitoring status, output metrics, historical trends, and interactive controls for the apparatus 102.

The graphical user interface rendering routines of the interface module 227 can implement a screen composition pipeline that constructs visual display frames by assembling individual graphical elements (e.g., text labels, numerical value displays, chart widgets, button controls, icon graphics, and/or the like) into a composite frame buffer that the processor 210 outputs to the display 240 through a display controller interface (e.g., a Display Serial Interface, a Low-Voltage Differential Signaling interface, an HDMI interface, and/or the like). The screen composers can maintain a scene graph data structure (e.g., a hierarchical tree of renderable nodes, a directed acyclic graph of visual elements, a layered composition stack, and/or the like) stored in the memory 220 that defines the spatial arrangement, z-ordering, and visibility state of each graphical element within the display frame. The screen composers can traverse the scene graph at configurable refresh intervals (e.g., every 16 milliseconds for 60 frames per second rendering, every 33 milliseconds for 30 frames per second rendering, and/or the like) to generate updated display frames that reflect changes in monitoring data, user interaction states, and notification conditions received from the orchestration module 225 and the signal processing module 224.

The widget renderers of the interface module 227 can implement a library of reusable graphical components that encapsulate rendering logic, data binding behavior, and user interaction handling for specific types of interface elements. The widget renderers can include vital sign display widgets (e.g., numerical readout components that display the heart rate 312 value with units and confidence indicators, temperature gauge components that render the temperature 314 as a color-coded numerical display, trend chart components that plot time-series output metrics from the signal data cache 256 as scrolling line graphs, and/or the like) that the interface module 227 instantiates and populates with data retrieved from the signal data cache 256 and the historical signal data 257 of the computing database 204. Each widget renderer can implement a data binding mechanism (e.g., an observer pattern subscription, a reactive data stream connection, a polling-based data refresh callback, and/or the like) that registers the widget with a data source in the signal data cache 256, such that when the signal processing module 224 writes new output metric values to the signal data cache 256, the widget renderer receives a notification and re-renders the corresponding graphical element with the updated measurement value. The widget renderers can implement state-dependent visual styling (e.g., rendering heart rate values in green when within the physiological baseline range stored in the ontological reference data 255, rendering values in yellow when approaching baseline boundaries, rendering values in red when exceeding baseline thresholds, and/or the like) that provides immediate visual feedback to users about the health status of the target signal source 104-1 without requiring interpretation of raw numerical values.

The layout managers of the interface module 227 can implement spatial arrangement algorithms (e.g., grid-based layout engines, constraint-based layout solvers, flow-based layout calculators, and/or the like) that compute the position, dimensions, and alignment of graphical elements within the display frame based on configurable layout parameters stored in the memory 220. The layout managers can maintain layout constraint data structures (e.g., minimum and maximum widget dimensions, inter-widget spacing values, margin and padding specifications, alignment anchor references, and/or the like) that define how widgets are arranged relative to each other and relative to the boundaries of the display 240. The layout managers can implement responsive layout adaptation logic that recalculates widget positions and dimensions when the display configuration changes (e.g., when switching between the 7.1 inch touchscreen implementation and the 10.1 inch touchscreen implementation, when transitioning between portrait and landscape orientations, when accommodating accessibility-driven font size increases, and/or the like), ensuring that the interface remains usable and visually coherent across different display form factors supported by the apparatus 102. The layout managers can implement a screen navigation stack (e.g., a last-in-first-out stack of screen state objects, a navigation history buffer, a breadcrumb trail data structure, and/or the like) stored in the memory 220 that tracks the sequence of interface screens visited by the user, enabling the interface module 227 to support back navigation, screen transitions, and state restoration when users navigate between different functional areas (e.g., transitioning from the vitals monitoring screen to the historical data screen and returning to the vitals monitoring screen, and/or the like) of the interface presented on the display 240.

The interface module 227 can include touch input processing logic (e.g., gesture recognizers, tap detectors, swipe handlers, pinch-to-zoom interpreters, long-press detectors, and/or the like) that processes touch input events from the display 240 when the display 240 includes a touchscreen (e.g., a 7.1 inch touchscreen, a 10.1 inch touchscreen, and/or the like) and translates touch inputs into commands for other modules of the computing logic 202. The touch input processing logic can implement a multi-stage event processing pipeline that receives raw touch event data (e.g., touch coordinate pairs indicating x-position and γ-position on the display surface, touch pressure values, touch contact area dimensions, touch event type identifiers such as touch-down, touch-move, and touch-up, and/or the like) from the touchscreen hardware controller of the display 240 through a device driver interface (e.g., a Linux input event subsystem interface, a direct framebuffer touch input interface, a Human Interface Device protocol handler, and/or the like) and transforms the raw touch event data into structured interaction commands that the orchestration module 225, the sensor control module 221, and other modules of the memory 220 can process.

The gesture recognizers of the touch input processing logic can implement finite state machine-based recognition algorithms that track sequences of touch events over time to classify touch interactions into discrete gesture categories. The gesture recognizers can maintain a gesture state machine (e.g., a state machine with states including idle, possible gesture, gesture recognized, gesture failed, and/or the like) for each supported gesture type, where the state machine transitions between states based on the spatial displacement, temporal duration, and velocity characteristics of incoming touch events. For example, a tap gesture recognizer can transition from an idle state to a possible gesture state upon receiving a touch-down event, can monitor the spatial displacement of the touch contact point relative to the initial touch-down position, and can transition to a gesture recognized state when a touch-up event is received within a configurable maximum duration threshold (e.g., 300 milliseconds, 500 milliseconds, and/or the like) and the spatial displacement remains within a configurable maximum distance threshold (e.g., 10 pixels, 20 pixels, and/or the like) from the initial touch-down position. The tap gesture recognizer can transition to a gesture failed state when the duration exceeds the maximum threshold or the spatial displacement exceeds the distance threshold, indicating that the touch interaction does not constitute a tap gesture and may instead correspond to a drag or swipe gesture.

The swipe handlers of the touch input processing logic can implement directional gesture detection by computing velocity vectors (e.g., the rate of change of touch position in pixels per second along horizontal and vertical axes, and/or the like) from sequences of touch-move events received between a touch-down event and a touch-up event. The swipe handlers can classify the computed velocity vector into a directional category (e.g., swipe left, swipe right, swipe up, swipe down, and/or the like) by comparing the horizontal and vertical velocity components against configurable minimum velocity thresholds (e.g., 200 pixels per second, 500 pixels per second, and/or the like) and determining the dominant axis of motion based on which velocity component has the greater absolute magnitude. The swipe handlers can map recognized swipe gestures to navigation commands (e.g., mapping a swipe left gesture to a forward navigation command that transitions the display 240 to the next interface screen in the screen navigation stack, mapping a swipe right gesture to a back navigation command that returns to the previous interface screen, mapping a swipe down gesture to a scroll command that advances the displayed content within a scrollable region, and/or the like) that the interface module 227 processes to update the visual content rendered on the display 240.

The touch input processing logic can implement hit testing routines (e.g., point-in-rectangle collision tests, bounding box intersection checks, widget boundary containment evaluations, and/or the like) that determine which graphical element within the scene graph data structure of the interface module 227 corresponds to the spatial coordinates of a recognized touch gesture. The hit testing routines can traverse the scene graph in reverse z-order (e.g., evaluating the topmost rendered graphical elements first, proceeding to underlying elements only when no match is found at higher z-order levels, and/or the like) to identify the frontmost interactive widget (e.g., a button of the control panel 534, a selectable option of the vitals interface 520, the quick action element 510, and/or the like) whose bounding rectangle contains the touch coordinates. Upon identifying the target widget, the touch input processing logic can invoke the corresponding event handler function (e.g., a button press callback, a toggle state change handler, a navigation action trigger, and/or the like) registered by the widget through the event-driven coordination logic of the interface module 227, causing the associated module of the memory 220 to execute the commanded operation. The touch input processing logic can implement touch event debouncing (e.g., suppressing duplicate touch events received within a configurable minimum inter-event interval such as 50 milliseconds or 100 milliseconds, filtering spurious touch contacts caused by accidental screen brushes, and/or the like) that prevents unintended repeated activation of interactive elements, which can be particularly beneficial for elderly users or users with motor control limitations interacting with the apparatus 102 through the display 240.

The interface module 227 can include voice input processing routines (e.g., speech recognizers, command parsers, wake word detectors, and/or the like) that process audio input from microphones of the actuated sensor assembly 260 to enable voice-based interaction with the apparatus 102 by the target signal source 104-1 or caregivers. The voice input processing routines can implement a multi-stage audio processing pipeline that receives raw audio waveform data captured by the microphones of the actuated sensor assembly 260 and transforms the raw audio data into structured command representations that the orchestration module 225 and other modules of the memory 220 can process to execute corresponding monitoring operations.

The wake word detectors of the voice input processing routines can implement a lightweight keyword spotting model (e.g., a small-footprint convolutional neural network, a recurrent neural network-based keyword detector, a depthwise separable convolution classifier, and/or the like) loaded from the artificial intelligence models 258 stored in the computing database 204 that continuously monitors incoming audio frames from the microphones to detect a predefined activation phrase (e.g., “Hey DocBot,” “Hello DocBot,” a configurable custom wake phrase, and/or the like) that signals the apparatus 102 to begin processing subsequent speech as a voice command or query. The wake word detectors can operate in a low-power listening mode (e.g., processing audio frames at reduced computational cost, executing on a dedicated low-power audio processing core, sampling audio at a reduced duty cycle, and/or the like) that enables the apparatus 102 to remain responsive to voice activation without consuming significant computational resources on the processor 210 during periods when no voice interaction is occurring. The wake word detectors can compute short-time spectral features (e.g., Mel-frequency cepstral coefficients, log-Mel filterbank energies, spectral centroid values, and/or the like) from overlapping audio frames (e.g., 25-millisecond frames with 10-millisecond stride, 30-millisecond frames with 15-millisecond stride, and/or the like) and can feed the computed spectral features into the keyword spotting model, which can generate a detection confidence score indicating the probability that the wake word was spoken within the current audio window. When the detection confidence score exceeds a configurable activation threshold (e.g., 0.85, 0.90, 0.95, and/or the like) stored in the ontological reference data 255 of the computing database 204, the wake word detectors can transition the voice input processing routines from the low-power listening mode to an active speech capture mode that begins buffering subsequent audio frames for speech recognition processing.

The speech recognizers of the voice input processing routines can implement automatic speech recognition models (e.g., connectionist temporal classification-based models, attention-based encoder-decoder models, transformer-based speech recognition models such as Whisper or wav2vec, recurrent neural network transducer models, and/or the like) loaded from the artificial intelligence models 258 stored in the computing database 204 that convert the buffered audio waveform data captured after wake word detection into a textual transcription representing the spoken utterance of the target signal source 104-1 or a caregiver. The speech recognizers can implement an audio preprocessing stage that converts raw pulse-code modulation audio samples into spectral feature representations (e.g., Mel-frequency cepstral coefficients computed by applying a Mel-scale filterbank to short-time Fourier transform magnitudes, log-Mel spectrogram features computed by taking the logarithm of Mel-filtered power spectra, and/or the like) that serve as input to the speech recognition model. The speech recognizers can implement a decoding stage (e.g., beam search decoding with configurable beam width, greedy decoding selecting the highest-probability token at each time step, language model-assisted decoding that incorporates a statistical or neural language model to improve transcription accuracy, and/or the like) that generates the textual transcription from the output probability distributions produced by the speech recognition model at each time step. The speech recognizers can implement endpoint detection logic (e.g., voice activity detection algorithms that identify the onset and offset of speech segments within the audio stream, silence duration thresholds that terminate speech capture after a configurable period of silence such as 1.5 seconds or 2.0 seconds following the last detected speech frame, energy-based endpoint detectors that monitor the root-mean-square energy of audio frames to distinguish speech from background noise, and/or the like) that determines when the target signal source 104-1 has finished speaking and the captured audio should be submitted to the speech recognition model for transcription. The speech recognizers can execute locally on the processor 210 of the computing logic 202 using quantized or distilled model variants stored in the artificial intelligence models 258 that enable on-device speech recognition without transmitting audio data to external cloud servers, thereby maintaining privacy of voice interactions within the physical boundaries of the environment 100.

The command parsers of the voice input processing routines can receive the textual transcription generated by the speech recognizers and can transform the transcription into structured command representations (e.g., intent-parameter pairs, action-object tuples, structured query objects, and/or the like) that the orchestration module 225 can process to execute corresponding monitoring operations. The command parsers can invoke the query processing routines (e.g., natural language parsers, intent classifiers, parameter extractors, and/or the like) of the orchestration module 225 to classify the transcribed text into an intent category (e.g., vital sign measurement request intents, navigation command intents, historical data retrieval intents, medication management intents, emergency assistance intents, and/or the like) and to extract structured parameter values (e.g., measurement type entities, temporal reference entities, location reference entities, signal source identifiers, and/or the like) from the transcribed text. The command parsers can apply noise correction logic (e.g., spelling correction algorithms, phonetic similarity matching, domain-specific vocabulary substitution, and/or the like) that compensates for transcription errors introduced by the speech recognizers due to ambient noise, accented speech, or low signal-to-noise ratio conditions within the environment 100. The command parsers can transmit the structured command representations to the orchestration module 225 through inter-module communication interfaces (e.g., function call invocations, shared memory message buffers, callback registration mechanisms, and/or the like), enabling the orchestration module 225 to dispatch corresponding monitoring tasks (e.g., initiating vital sign capture through the sensor control module 221, generating navigation instructions through the navigation module 223, retrieving historical data from the historical signal data 257, submitting the transcribed query to the generative AI model 320 for response generation, and/or the like) based on the classified intent and extracted parameters.

The voice input processing routines can include audio response generation logic (e.g., text-to-speech synthesizers, pre-recorded audio clip selectors, speech output controllers, and/or the like) that converts the query response 324 or the notification alert 326 generated by the generative AI model 320 into audible speech output delivered through speakers (e.g., built-in speakers of the apparatus 102, external speakers coupled to the computing logic 202 through audio output interfaces, and/or the like) to provide voice-based feedback to the target signal source 104-1. The text-to-speech synthesizers can implement neural speech synthesis models (e.g., WaveNet-based vocoders, Tacotron-style spectrogram generators, FastSpeech-based parallel synthesis models, and/or the like) loaded from the artificial intelligence models 258 that generate natural-sounding speech waveforms from the textual content of the query response 324 or the notification alert 326. The audio response generation logic can apply configurable speech parameters (e.g., speaking rate adjustments for elderly users who may benefit from slower speech, volume level settings appropriate for the ambient noise conditions within the environment 100, pitch adjustments for improved intelligibility, and/or the like) stored in the ontological reference data 255 of the computing database 204 to customize the audible output for the preferences and needs of the target signal source 104-1. The voice input processing routines can implement barge-in detection logic (e.g., monitoring microphone input during speech output to detect when the target signal source 104-1 begins speaking, interrupting the current audio output when new speech is detected, transitioning back to the active speech capture mode to process the new utterance, and/or the like) that enables the target signal source 104-1 to interrupt the apparatus 102 during voice responses to issue follow-up commands or corrections without waiting for the current response to complete.

The interface module 227 can include accessibility compliance logic (e.g., contrast adjusters, font scalers, screen reader interfaces, and/or the like) that configures the display 240 to comply with accessibility standards (e.g., Web Content Accessibility Guidelines 2.2, ISO accessibility standards, and/or the like) for elderly users and users with visual impairments. The interface module 227 can include notification presentation routines (e.g., alert displayers, sound generators, vibration controllers, and/or the like) that present notification alerts generated by the orchestration module 225 to users through visual, auditory, and haptic feedback mechanisms.

As shown in FIG. 2B, the wireless communication circuitry 230 of the computing logic 202 provides hardware and firmware components that enable the apparatus 102 to establish wireless communication channels with other computing devices and services external to the apparatus 102. The wireless communication circuitry 230 can include radio frequency transceivers (e.g., Wi-Fi transceivers, Bluetooth transceivers, cellular modems, and/or the like) that transmit and receive wireless signals to communicate with wireless access points, mobile devices, and network infrastructure within and beyond the environment 100. The wireless communication circuitry 230 can include protocol stack implementations (e.g., TCP/IP stacks, HTTP clients, WebSocket handlers, and/or the like) that enable the apparatus 102 to communicate with remote servers, cloud services, and application programming interfaces over network connections established through the wireless transceivers. The wireless communication circuitry 230 can include secure communication logic (e.g., encryption engines, certificate validators, secure socket layer handlers, and/or the like) that encrypts data transmitted from the apparatus 102 and decrypts data received by the apparatus 102 to protect the confidentiality of health information associated with the target signal source 104-1 during wireless transmission. The wireless communication circuitry 230 can include device pairing routines (e.g., Bluetooth pairing handlers, Wi-Fi Direct connectors, near-field communication initiators, and/or the like) that establish connections with peripheral devices (e.g., wearable health monitors, smart medical instruments, caregiver mobile devices, and/or the like) that provide additional environment signals or receive notifications from the apparatus 102. The wireless communication circuitry 230 can support communication with healthcare provider systems while maintaining local storage of personal health information on the apparatus 102 to align with privacy regulations (e.g., Health Insurance Portability and Accountability Act requirements, and/or the like).

With continued reference to FIG. 2B, the display 240 of the computing logic 202 provides a visual output interface that presents information to users interacting with the apparatus 102 within the environment 100. The display 240 can include a touchscreen panel (e.g., a capacitive touchscreen, a resistive touchscreen, a multi-touch display, and/or the like) that combines visual output capabilities with touch input capabilities, enabling users to view monitoring information and interact with the apparatus 102 through touch gestures. The display 240 can be implemented as a 7.1 inch touchscreen display that provides a compact form factor suitable for portable or space-constrained deployments of the apparatus 102 within the environment 100. The display 240 can alternatively be implemented as a 10.1 inch touchscreen display that provides a larger viewing area suitable for users who benefit from larger text, icons, and interactive elements due to visual impairments or motor control limitations. The display 240 can include high-contrast display modes (e.g., dark mode themes, high-contrast color schemes, adjustable brightness levels, and/or the like) that improve visibility for elderly users and users with visual impairments in various lighting conditions within the environment 100. The display 240 can present user interface screens (e.g., home screens, vitals monitoring screens, medication tracking screens, history viewing screens, and/or the like) generated by the interface module 227 that provide access to monitoring functions, output metrics, and configuration options of the apparatus 102. The display 240 can present live data visualizations (e.g., real-time heart rate displays, temperature readings, pose estimations, and/or the like) that show current physiological measurements being captured from the target signal source 104-1.

As further shown in FIG. 2B, the computing database 204 stores the spatial mappings 251 that represent the layout of the environment 100 and enable the navigation module 223 to plan traversable routes for the apparatus 102. The spatial mappings 251 can include floor plan representations (e.g., occupancy grids, topological maps, metric maps, and/or the like) that encode the positions of walls, doorways, furniture, and other fixed objects within the environment 100. The spatial mappings 251 can include traversability information (e.g., passable regions, obstacle locations, floor surface types, and/or the like) that indicates which regions of the environment 100 the apparatus 102 can navigate through and which regions are blocked by obstacles. The spatial mappings 251 can include room segmentation data (e.g., room boundaries, room labels, room connectivity graphs, and/or the like) that partitions the environment 100 into distinct rooms (e.g., kitchen, bedroom, living room, bathroom, and/or the like) and identifies connections between rooms through doorways and passages. The spatial mappings 251 can be generated by the navigation module 223 using simultaneous localization and mapping techniques that process environment signals from the sensor 206-1 and the sensor 206-2 as the apparatus 102 explores the environment 100. The spatial mappings 251 can be updated by the navigation module 223 when changes to the environment 100 are detected (e.g., furniture moved, new obstacles placed, doorways blocked, and/or the like) to maintain accurate representations of the current layout of the environment 100.

The floor plan representations stored within the spatial mappings 251 can be implemented using occupancy grid data structures that discretize the continuous physical space of the environment 100 into a two-dimensional array of grid cells, where each grid cell can correspond to a fixed-size region of the physical floor area (e.g., a five centimeter by five centimeter region, a ten centimeter by ten centimeter region, a twenty centimeter by twenty centimeter region, and/or the like). Each grid cell within the occupancy grid can store a probability value (e.g., a floating-point value ranging from zero to one, and/or the like) indicating the likelihood that the corresponding physical region is occupied by an obstacle such as a wall, a piece of furniture, or another fixed object. The navigation module 223 can initialize the occupancy grid with uniform prior probability values (e.g., a value of 0.5 indicating unknown occupancy status, and/or the like) for all grid cells and can progressively update the probability values as the apparatus 102 captures environment signals from the sensor 206-1 and the sensor 206-2 during exploration of the environment 100. The navigation module 223 can update the occupancy grid by projecting depth measurements obtained from stereo vision processing of environment signals captured by the sensor 206-1 and the sensor 206-2 into the grid coordinate frame, incrementing the occupancy probability of grid cells that correspond to detected obstacle surfaces and decrementing the occupancy probability of grid cells along the line of sight between the sensors and the detected surfaces to indicate that those intermediate regions are free of obstacles. The navigation module 223 can apply a log-odds representation (e.g., storing the logarithm of the ratio of occupied probability to free probability for each grid cell, and/or the like) that enables efficient incremental updates to the occupancy grid by converting multiplicative probability updates into additive log-odds updates, reducing computational overhead during real-time mapping operations on the processor 210.

The traversability information stored within the spatial mappings 251 can be derived from the occupancy grid by the navigation module 223 through application of occupancy threshold classification logic that categorizes each grid cell into one of a plurality of traversability states (e.g., a free state indicating the region is traversable by the apparatus 102, an occupied state indicating the region is blocked by an obstacle, an unknown state indicating the region has not been sufficiently observed, and/or the like) based on whether the occupancy probability value of the grid cell exceeds or falls below configurable threshold values stored in the spatial environment metadata 253 of the computing database 204. The navigation module 223 can apply an inflation operation (e.g., expanding the boundaries of occupied grid cells outward by a configurable safety margin distance corresponding to the physical dimensions of the apparatus 102, and/or the like) to the traversability classification that marks grid cells within the safety margin distance of occupied cells as non-traversable, preventing the apparatus 102 from planning paths that would bring the physical body of the apparatus 102 into contact with obstacles during navigation. The navigation module 223 can further annotate the traversability information with floor surface type classifications (e.g., carpet regions, hardwood regions, tile regions, transition strip locations, and/or the like) derived from visual texture analysis of environment signals captured by the sensor 206-1, enabling the actuator control module 222 to adjust locomotion parameters (e.g., wheel speed, traction control settings, turning radius constraints, and/or the like) of the displacement assembly 270 based on the floor surface type at the current position of the apparatus 102 to maintain stable and reliable navigation across different surface materials within the environment 100.

The room segmentation data stored within the spatial mappings 251 can be generated by the navigation module 223 through application of spatial partitioning algorithms that analyze the occupancy grid to identify distinct enclosed regions separated by wall structures and connected through doorway openings. The navigation module 223 can implement a connected component analysis (e.g., a flood-fill algorithm, a breadth-first search traversal, a union-find data structure-based segmentation, and/or the like) that groups contiguous free-space grid cells into candidate room regions by iteratively expanding from seed grid cells through adjacent free-space cells while treating occupied grid cells as boundaries that separate distinct regions. The navigation module 223 can identify doorway locations by detecting narrow passages (e.g., openings in wall structures where the width of the free-space corridor falls below a configurable doorway width threshold such as 1.5 meters, and/or the like) that connect adjacent room regions, and can store the doorway locations as edges in a room connectivity graph data structure (e.g., an adjacency list, an adjacency matrix, a graph object with node and edge collections, and/or the like) maintained within the spatial mappings 251 of the computing database 204. Each node in the room connectivity graph can represent a distinct room region and can store associated metadata including a room label (e.g., a semantic label such as “kitchen” or “bedroom” assigned by the signal processing module 224 based on object detection results identifying room-characteristic objects within the region, and/or the like), a room centroid position (e.g., the geometric center of the room region computed from the bounding polygon of the room's free-space cells, and/or the like), and a room area measurement (e.g., the total floor area of the room computed by summing the areas of all free-space grid cells within the room region, and/or the like). The room connectivity graph can be used by the navigation module 223 to perform high-level route planning (e.g., determining the sequence of rooms the apparatus 102 must traverse to reach a target room, identifying the doorways the apparatus 102 must pass through along the route, and/or the like) before generating detailed grid-level paths using the path planning algorithms described herein.

The spatial mappings 251 can be updated by the navigation module 223 through a change detection pipeline that continuously compares newly captured environment signals against the stored spatial mapping to identify discrepancies indicative of environmental changes. The change detection pipeline can operate by projecting the current depth measurements obtained from the sensor 206-1 and the sensor 206-2 into the coordinate frame of the existing occupancy grid and comparing the projected measurements against the stored occupancy values at corresponding grid cell locations. When the navigation module 223 detects a persistent discrepancy (e.g., a previously free grid cell that consistently registers as occupied across multiple consecutive observation frames, a previously occupied grid cell that consistently registers as free, and/or the like) exceeding a configurable change detection threshold (e.g., a minimum number of consecutive frames such as 10 or 20 frames in which the discrepancy is observed, a minimum observation duration such as 2 seconds or 5 seconds, and/or the like), the navigation module 223 can classify the discrepancy as a confirmed environmental change and can update the occupancy grid, the traversability information, and the room segmentation data accordingly. The navigation module 223 can propagate the environmental change through the spatial mappings 251 by re-computing the inflation boundaries around newly occupied cells, re-evaluating the room connectivity graph to determine whether doorway passages have been blocked or new passages have been created, and updating the spatial position data 252 to reflect any changes in the accessibility of signal source locations within the environment 100. The navigation module 223 can store a change log (e.g., a timestamped record of detected environmental changes, including the grid cell coordinates affected, the type of change detected, and the observation evidence supporting the change, and/or the like) in the spatial environment metadata 253 of the computing database 204, enabling the orchestration module 225 to track environmental changes over time and adjust monitoring schedules based on evolving spatial configurations of the environment 100.

Referring again to FIG. 2B, the computing database 204 stores the spatial position data 252 that maps signal sources (e.g., the target signal source 104-1, the candidate signal source 104-2, and/or the like) and objects of interest to corresponding spatial positions (e.g., the spatial location 106-1, the spatial location 106-2, and/or the like) within the environment 100. The spatial position data 252 can include signal source location records (e.g., coordinate tuples, room identifiers, relative position descriptors, and/or the like) that specify where each signal source is located or frequently occupies within the environment 100. The spatial position data 252 can include object position records (e.g., furniture locations, medical device positions, fixture coordinates, and/or the like) that specify the locations of physical objects within the environment 100 that the apparatus 102 can navigate to or around. The spatial position data 252 can include dynamic position tracking data (e.g., last known positions, position histories, movement trajectories, and/or the like) that tracks the positions of mobile signal sources (e.g., the target signal source 104-1, and/or the like) as the mobile signal sources move within the environment 100. The spatial position data 252 can be updated by the navigation module 223 and the signal processing module 224 as the apparatus 102 observes signal sources and objects within the environment 100 during monitoring operations. The spatial position data 252 can be used by the orchestration module 225 to determine which signal sources are accessible from the current position of the apparatus 102 and to plan navigation to signal sources when environment signals from those sources are needed.

With continued reference to FIG. 2B, the computing database 204 stores the spatial environment metadata 253 that provides contextual information about regions and features within the environment 100 beyond geometric layout information stored in the spatial mappings 251. The spatial environment metadata 253 can include room function annotations (e.g., room type labels, activity zone designations, usage pattern descriptions, and/or the like) that describe the purpose and typical activities associated with different regions of the environment 100. The spatial environment metadata 253 can include environmental condition records (e.g., lighting level estimates, ambient noise levels, temperature ranges, and/or the like) that characterize the environmental conditions in different regions of the environment 100 that can affect sensor performance and signal quality. The spatial environment metadata 253 can include accessibility annotations (e.g., wheelchair accessible paths, step locations, narrow passage warnings, and/or the like) that describe accessibility characteristics of different regions of the environment 100 relevant to navigation planning for the apparatus 102. The spatial environment metadata 253 can include temporal usage patterns (e.g., time-of-day activity distributions, weekly routine schedules, seasonal variation data, and/or the like) that describe when the target signal source 104-1 typically occupies different regions of the environment 100. The spatial environment metadata 253 can be used by the orchestration module 225 and the navigation module 223 to optimize monitoring schedules and navigation plans based on contextual knowledge about the environment 100.

As shown in FIG. 2B, the computing database 204 stores the signal source reference data 254 that associates signal sources (e.g., the target signal source 104-1, the candidate signal source 104-2, and/or the like) with metadata describing the characteristics of signals each source provides and the processing appropriate for signals from each source. The signal source reference data 254 can include signal type descriptors (e.g., visual signal indicators, thermal signal indicators, audio signal indicators, and/or the like) that specify the types of environment signals that can be captured from each signal source. The signal source reference data 254 can include data format specifications (e.g., image resolution parameters, sampling rate values, bit depth settings, and/or the like) that describe the format and characteristics of environment signals captured from each signal source. The signal source reference data 254 can include model association records (e.g., model identifiers, processing pipeline specifications, output metric types, and/or the like) that specify which artificial intelligence models 258 are appropriate for processing environment signals from each signal source. The signal source reference data 254 can include calibration parameters (e.g., sensor offset values, gain correction factors, color calibration matrices, and/or the like) that the signal processing module 224 applies when processing environment signals from specific signal sources. The signal source reference data 254 can include relationship mappings (e.g., signal source associations, complementary source identifiers, dependency specifications, and/or the like) that indicate which candidate signal sources are associated with the target signal source 104-1 and can provide complementary environment signals when signals from the target signal source 104-1 do not satisfy correspondence threshold values.

The signal source reference data 254 can include patient history records (e.g., prior diagnosis records, historical treatment data, chronic condition identifiers, surgical history entries, allergy documentation, medication history logs, and/or the like) that associate the target signal source 104-1 with clinical background information relevant to the interpretation of captured environment signals and the generation of output metrics 310 by the signal processing module 224. In a hospital or clinical deployment context, the patient history records can include admission records (e.g., hospital admission dates, presenting complaint descriptions, triage classification codes, attending physician identifiers, and/or the like) that provide contextual information enabling the orchestration module 225 to configure monitoring parameters and alert thresholds based on the clinical status of the target signal source 104-1. The patient history records can include diagnostic history entries (e.g., International Classification of Diseases codes, prior imaging study results, laboratory test result summaries, pathology report references, and/or the like) that the generative AI model 320 can access when generating the query response 324 or the notification alert 326 to contextualize current output metrics 310 within the broader clinical picture of the target signal source 104-1. The patient history records can include medication administration records (e.g., current prescription lists, dosage schedules, drug interaction flags, contraindication warnings, and/or the like) that the orchestration module 225 can reference when evaluating the output metrics 310 against physiological baselines stored in the ontological reference data 255, enabling the apparatus 102 to account for expected physiological effects of administered medications (e.g., heart rate changes due to beta-blocker administration, blood pressure variations due to antihypertensive therapy, temperature fluctuations due to antipyretic treatment, and/or the like) when calculating metric deviation scores. The patient history records can include care plan specifications (e.g., monitoring frequency requirements, vital sign threshold customizations, post-operative observation protocols, rehabilitation milestone targets, and/or the like) that the orchestration module 225 can use to configure the workflow scheduling logic for tailoring monitoring operations to the specific clinical needs of the target signal source 104-1 within the environment 100. The patient history records can be stored in encrypted data structures within the signal source reference data 254 of the computing database 204 and can be updated through the wireless communication circuitry 230 when authorized healthcare provider systems transmit updated clinical information to the apparatus 102 using secure communication protocols compliant with applicable privacy regulations (e.g., Health Insurance Portability and Accountability Act requirements, and/or the like).

With continued reference to FIG. 2B, the computing database 204 stores the ontological reference data 255 that provides structured knowledge representations enabling the orchestration module 225 and the signal processing module 224 to interpret environment signals and output metrics within the context of medical and healthcare domains. The ontological reference data 255 can include medical terminology mappings (e.g., symptom-to-condition associations, measurement-to-diagnosis relationships, vital sign interpretation rules, and/or the like) that enable the apparatus 102 to contextualize physiological measurements captured from the target signal source 104-1 within established medical knowledge frameworks. The ontological reference data 255 can include physiological baseline definitions (e.g., normal heart rate ranges, healthy temperature bounds, expected gait parameters, and/or the like) that specify reference values against which the orchestration module 225 compares output metrics to calculate metric deviation scores indicating degrees of deviation from expected physiological states. The ontological reference data 255 can include medication knowledge records (e.g., drug interaction databases, dosage guidelines, administration schedules, and/or the like) that enable the apparatus 102 to provide medication tracking and reminder functions through the interface module 227. The ontological reference data 255 can include activity classification taxonomies (e.g., daily living activity categories, mobility state definitions, posture classifications, and/or the like) that enable the signal processing module 224 to classify observed behaviors of the target signal source 104-1 based on pose estimation and motion analysis. The ontological reference data 255 can include query interpretation schemas (e.g., intent classification hierarchies, entity extraction patterns, response template structures, and/or the like) that enable the orchestration module 225 to parse input queries received through the interface module 227 and determine appropriate monitoring operations and data retrieval actions. The ontological reference data 255 can be augmented with domain-specific medical knowledge obtained from healthcare institutions (e.g., hospital data partnerships, clinical guideline databases, medical research repositories, and/or the like) to enhance the diagnostic reasoning capabilities of the artificial intelligence models 258.

As further shown in FIG. 2B, the computing database 204 stores the signal data cache 256 that provides temporary storage for environment signals captured by sensors (e.g., the sensor 206-1, the sensor 206-2, and/or the like) and intermediate processing results generated by the signal processing module 224 during active monitoring operations. The signal data cache 256 can include frame buffers (e.g., image frame queues, video segment buffers, rolling window stores, and/or the like) that temporarily store sequences of visual environment signals captured over time periods for processing by artificial intelligence models 258 that analyze temporal patterns (e.g., heart rate extraction from color variations, gait analysis from motion sequences, respiratory rate estimation from chest movements, and/or the like). The signal data cache 256 can include audio buffers (e.g., waveform sample queues, speech segment stores, sound event caches, and/or the like) that temporarily store audio environment signals for voice command processing, sound source localization, and acoustic event detection by the signal processing module 224. The signal data cache 256 can include thermal data buffers (e.g., temperature reading queues, thermal image caches, temperature trend stores, and/or the like) that temporarily store thermal environment signals for body temperature monitoring and fever detection applications. The signal data cache 256 can include intermediate result stores (e.g., feature extraction outputs, partial inference results, preprocessing outputs, and/or the like) that hold intermediate data generated during multi-stage processing pipelines executed by the signal processing module 224. The signal data cache 256 can implement circular buffer structures (e.g., ring buffers, first-in-first-out queues, sliding window stores, and/or the like) that automatically overwrite older data with newer data to maintain bounded memory usage while preserving recent environment signals for processing. The signal data cache 256 can be implemented using high-speed memory (e.g., static random-access memory, on-chip cache memory, dedicated buffer memory, and/or the like) that provides low-latency access for real-time signal processing operations.

Referring again to FIG. 2B, the computing database 204 stores the historical signal data 257 that provides persistent storage for output metrics, environment signal summaries, and monitoring records accumulated over extended time periods for the target signal source 104-1. The historical signal data 257 can include time-series measurement records (e.g., heart rate logs, temperature histories, blood pressure trends, glucose level progressions, and/or the like) that store sequences of output metrics captured at regular intervals or triggered by monitoring events over days, weeks, months, or longer periods. The historical signal data 257 can include event records (e.g., fall detection events, anomaly alerts, medication reminders, vital sign threshold crossings, and/or the like) that document occurrences of monitored events along with timestamps, associated output metrics, and contextual information about the circumstances of each event. The historical signal data 257 can include session summaries (e.g., daily health summaries, weekly trend reports, monthly progress assessments, and/or the like) that aggregate output metrics and events into periodic summary records for review by the target signal source 104-1, caregivers, or healthcare providers through the interface module 227. The historical signal data 257 can include baseline evolution records (e.g., personalized baseline updates, trend shift markers, seasonal adjustment factors, and/or the like) that track how physiological baselines associated with the target signal source 104-1 change over time, enabling the orchestration module 225 to adapt metric deviation score calculations to account for gradual changes in the health status of the target signal source 104-1. The historical signal data 257 can include model training data (e.g., labeled measurement samples, validated output metrics, corrected predictions, and/or the like) that the model maintenance module 226 uses to retrain and personalize artificial intelligence models 258 based on accumulated observations specific to the target signal source 104-1. The historical signal data 257 can be stored using encrypted storage mechanisms (e.g., file-level encryption, database encryption, secure storage containers, and/or the like) that protect the confidentiality of personal health information in alignment with privacy regulations.

With continued reference to FIG. 2B, the computing database 204 stores the artificial intelligence models 258 that the signal processing module 224 and the orchestration module 225 load and execute to transform environment signals into output metrics and generate responses to input queries. The artificial intelligence models 258 can include computer vision models (e.g., convolutional neural networks, vision transformers, object detection networks, and/or the like) that process visual environment signals to detect faces, segment skin regions, estimate poses, and recognize objects within captured images. The artificial intelligence models 258 can include remote photoplethysmography models (e.g., signal extraction networks, pulse waveform estimators, heart rate predictors, and/or the like) that analyze sequences of visual environment signals to extract heart rate measurements from subtle color variations in skin regions of the target signal source 104-1 without physical contact. The artificial intelligence models 258 can include pose estimation models (e.g., keypoint detection networks, skeletal tracking models, body segment estimators, and/or the like) that analyze visual environment signals to estimate three-dimensional positions of body joints and segments for gait analysis, fall detection, and activity recognition applications. The artificial intelligence models 258 can include diffusion-based pose generation models (e.g., score matching networks, denoising diffusion probabilistic models, denoising diffusion implicit models, and/or the like) that generate valid three-dimensional human poses satisfying kinematic constraints based on two-dimensional pose observations, enabling robust pose estimation from monocular camera views. The artificial intelligence models 258 can include large language models (e.g., transformer-based language models, instruction-tuned models, medical domain models, and/or the like) that process natural language input queries and generate alphanumeric responses based on output metrics, historical signal data 257, and ontological reference data 255. The artificial intelligence models 258 can include ensemble configurations (e.g., model cascades, parallel model arrays, hierarchical model stacks, and/or the like) where multiple models process environment signals in sequence or parallel to generate output metrics of different data modalities from environment signals of a uniform data modality.

As shown in FIG. 2B, the artificial intelligence models 258 can be implemented using open-source model architectures (e.g., publicly available model weights, community-developed model structures, research-released model implementations, and/or the like) that the model maintenance module 226 adapts and customizes for the monitoring objectives of the apparatus 102 without requiring proprietary model access or cloud-based inference services. The artificial intelligence models 258 can be adapted using low-rank adaptation techniques (e.g., LoRA parameter updates, adapter layer insertions, efficient fine-tuning methods, and/or the like) that modify a subset of model parameters based on historical signal data 257 specific to the target signal source 104-1, enabling personalization of model behavior while maintaining computational efficiency suitable for execution on the processor 210. The artificial intelligence models 258 can be augmented using retrieval-augmented generation techniques (e.g., document retrieval pipelines, context injection methods, knowledge base queries, and/or the like) that supplement model inputs with relevant information retrieved from the ontological reference data 255 and the historical signal data 257 when generating responses to input queries. The artificial intelligence models 258 can include quantized model variants (e.g., 8-bit quantized models, 4-bit quantized models, mixed-precision models, and/or the like) that reduce memory requirements and increase inference speed for deployment on the processor 210 while maintaining acceptable accuracy for physiological measurement extraction. The artificial intelligence models 258 can include models trained to predict potential health conditions (e.g., neurodegenerative disease indicators, cardiovascular risk factors, sleep disorder markers, and/or the like) based on patterns in gait analysis, vital sign trends, and activity observations captured from the target signal source 104-1 over extended monitoring periods.

With continued reference to FIG. 2B, the signal monitoring platform 200 can execute using a software stack (e.g., JetPack 6.2, embedded Linux distributions, real-time operating systems, and/or the like) that provides operating system services, device drivers, and runtime libraries for the processor 210 to execute the modules of the memory 220 and interface with hardware components of the apparatus 102. The software stack can include graphics processing unit acceleration libraries (e.g., CUDA runtime libraries, TensorRT inference optimizers, cuDNN neural network primitives, and/or the like) that enable the processor 210 to execute artificial intelligence models 258 using parallel processing capabilities of graphics processing unit hardware. The software stack can include computer vision libraries (e.g., OpenCV image processing functions, GStreamer multimedia pipelines, camera interface drivers, and/or the like) that provide image capture, preprocessing, and manipulation functions used by the sensor control module 221 and the signal processing module 224. The software stack can include robotics middleware (e.g., Robot Operating System components, navigation stacks, sensor fusion frameworks, and/or the like) that provides communication infrastructure, coordinate transformation services, and algorithm implementations used by the navigation module 223 and the actuator control module 222. The software stack can include machine learning frameworks (e.g., PyTorch runtime environments, TensorFlow Lite interpreters, ONNX runtime engines, and/or the like) that provide model loading, inference execution, and tensor manipulation functions used by the signal processing module 224 and the model maintenance module 226. The software stack can include security components (e.g., encryption libraries, secure boot mechanisms, trusted execution environments, and/or the like) that protect the integrity of software executing on the processor 210 and the confidentiality of data stored in the computing database 204.

As further shown in FIG. 2B, the signal monitoring platform 200 implements a local storage approach for personal health information that aligns with privacy regulations (e.g., Health Insurance Portability and Accountability Act requirements, General Data Protection Regulation requirements, state privacy laws, and/or the like) by maintaining all environment signals, output metrics, and historical signal data 257 on the apparatus 102 rather than transmitting personal health information to external cloud servers for processing or storage. The local storage approach can include on-device inference execution (e.g., edge computing inference, local model execution, embedded artificial intelligence processing, and/or the like) where the processor 210 executes all artificial intelligence models 258 locally on the apparatus 102, ensuring that environment signals captured from the target signal source 104-1 are processed without leaving the physical control of the apparatus 102. The local storage approach can include encrypted local storage (e.g., file system encryption, database encryption, secure element storage, and/or the like) that protects personal health information stored in the computing database 204 from unauthorized access even if the physical storage media of the apparatus 102 is accessed by unauthorized parties. The local storage approach can include access control mechanisms (e.g., user authentication requirements, role-based access controls, audit logging systems, and/or the like) that restrict access to personal health information stored on the apparatus 102 to authorized users (e.g., the target signal source 104-1, designated caregivers, authorized healthcare providers, and/or the like). The local storage approach can include selective data sharing capabilities (e.g., export functions, secure transmission channels, consent-based sharing controls, and/or the like) that enable the target signal source 104-1 to share specific output metrics or historical signal data 257 with healthcare providers when desired while maintaining local storage as the default. The local storage approach can include data retention policies (e.g., automatic deletion schedules, storage quota management, archival procedures, and/or the like) that manage the accumulation of historical signal data 257 over time while preserving data needed for trend analysis and model personalization.

Referring again to FIG. 2B, the display 240 can be implemented as a 7.1 inch touchscreen display that provides a compact form factor suitable for portable deployments of the apparatus 102 where space constraints limit the size of the display 240. The 7.1 inch touchscreen implementation can include a liquid crystal display panel (e.g., in-plane switching panel, twisted nematic panel, advanced fringe field switching panel, and/or the like) with a capacitive touch overlay that detects touch inputs from users interacting with the interface module 227. The 7.1 inch touchscreen implementation can provide a display resolution (e.g., 1280 by 800 pixels, 1920 by 1080 pixels, and/or the like) that enables the interface module 227 to render user interface elements with sufficient detail for readability while maintaining responsive touch input performance. The 7.1 inch touchscreen implementation can include brightness adjustment capabilities (e.g., backlight dimming controls, ambient light sensor integration, automatic brightness adjustment, and/or the like) that adapt display brightness to ambient lighting conditions within the environment 100 for comfortable viewing by the target signal source 104-1. The 7.1 inch touchscreen implementation can be suitable for stationary deployments of the apparatus 102 where the apparatus 102 is placed on a desk, table, or nightstand within reach of the target signal source 104-1 for direct interaction.

With continued reference to FIG. 2B, the display 240 can alternatively be implemented as a 10.1 inch touchscreen display that provides a larger viewing area suitable for users who benefit from larger text, icons, and interactive elements due to visual impairments, motor control limitations, or preference for larger display surfaces. The 10.1 inch touchscreen implementation can include a liquid crystal display panel (e.g., in-plane switching panel, organic light-emitting diode panel, and/or the like) with a capacitive touch overlay that provides a larger touch-sensitive area for user interactions with the interface module 227. The 10.1 inch touchscreen implementation can provide a display resolution (e.g., 1920 by 1200 pixels, 2560 by 1600 pixels, and/or the like) that enables the interface module 227 to render user interface elements with increased size while maintaining visual clarity and detail. The 10.1 inch touchscreen implementation can include wide viewing angle characteristics (e.g., 178-degree viewing angles, anti-glare coatings, and/or the like) that enable the target signal source 104-1 to view the display 240 from various positions within the environment 100 without significant color shift or contrast reduction. The 10.1 inch touchscreen implementation can be suitable for deployments where the apparatus 102 serves as a primary health monitoring interface for the target signal source 104-1, providing sufficient display area for presenting comprehensive health dashboards, historical trend visualizations, and detailed output metric displays. The 10.1 inch touchscreen implementation can support accessibility features (e.g., large touch targets, simplified navigation layouts, high-contrast display modes, and/or the like) that comply with accessibility standards for elderly users and users with disabilities.

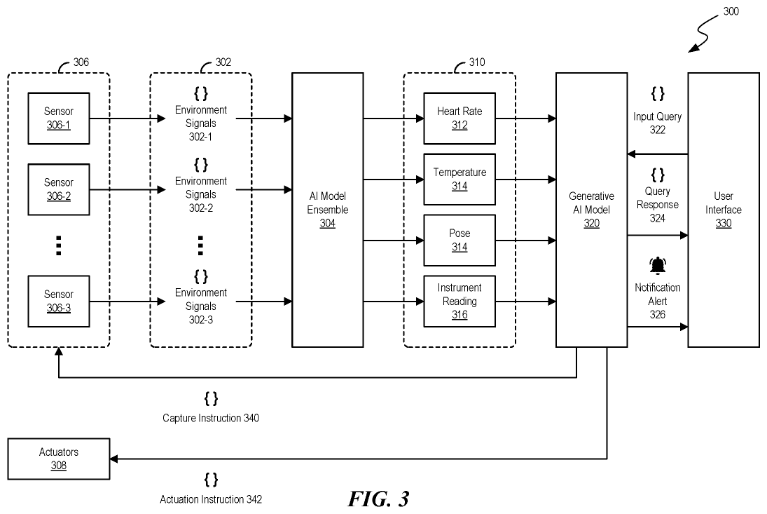

FIG. 3 is a block diagram that illustrates a signal monitoring lifecycle in accordance with some implementations of the present technology. Referring to FIG. 3, a signal monitoring lifecycle 300 illustrates the flow of data and control signals between various components of the signal monitoring platform 200 during active monitoring operations within the environment 100. The signal monitoring lifecycle 300 depicts a closed-loop system architecture (e.g., a feedback control system, a continuous monitoring pipeline, an iterative data processing workflow, and/or the like) where sensors capture environment signals, artificial intelligence models transform the environment signals into output metrics, and generative artificial intelligence models process the output metrics to generate responses and control instructions that feed back to the sensors and actuators for continued monitoring operations. The signal monitoring lifecycle 300 can operate continuously (e.g., 24 hours per day, 7 days per week, and/or the like) to provide persistent health monitoring of the target signal source 104-1 within the environment 100. The signal monitoring lifecycle 300 can be orchestrated by the orchestration module 225 of the computing logic 202, which coordinates the timing and sequencing of data capture, signal processing, response generation, and actuation control operations according to monitoring objectives and signal quality requirements. The signal monitoring lifecycle 300 can implement real-time processing pipelines (e.g., streaming data pipelines, low-latency inference chains, continuous analysis workflows, and/or the like) that minimize delay between environment signal capture and output metric generation to enable timely detection of physiological changes in the target signal source 104-1.

With continued reference to FIG. 3, the signal monitoring lifecycle 300 includes a plurality of sensors 306 that are configured to capture environment signals 302 from the physical environment within which the target signal source 104-1 is located. The sensors 306 include a sensor 306-1, a sensor 306-2, and a sensor 306-3, each of which captures environment signals of a uniform data modality (e.g., digital images, video frames, thermal readings, audio waveforms, and/or the like) from different perspectives, spectral ranges, or physical phenomena within the environment 100. The sensor 306-1 can include a visual image capture device (e.g., a complementary metal-oxide-semiconductor camera, a charge-coupled device camera, a high-frame-rate camera, and/or the like) that captures visual environment signals representing physical features of the target signal source 104-1 and surrounding regions of interest at frame rates suitable for physiological measurement extraction (e.g., approximately 100 frames per second on-device capture, approximately 25 frames per second after network transfer for processing, and/or the like). The sensor 306-2 can include a thermal imaging device (e.g., a microbolometer array, a thermopile sensor, an infrared camera, and/or the like) that captures thermal environment signals representing temperature distributions across surfaces of the target signal source 104-1 and objects within the field of view. The sensor 306-3 can include an audio capture device (e.g., a microelectromechanical system microphone, a condenser microphone, a directional microphone array, and/or the like) that captures audio environment signals representing sounds produced by the target signal source 104-1 (e.g., speech, breathing sounds, coughing, and/or the like) and ambient sounds within the environment 100. The sensors 306 can be physically integrated into the actuated sensor assembly 260 of the signal monitoring platform 200, enabling coordinated positioning and orientation of the sensors 306 relative to the target signal source 104-1 during monitoring operations. In some implementations, the sensors 306 can be physically integrated into the actuated sensor assembly 260 of the apparatus 102, which can serve as a hardware embodiment of the signal monitoring platform 200.

As shown in FIG. 3, the environment signals 302 captured by the sensors 306 include an environment signal 302-1 captured by the sensor 306-1, an environment signal 302-2 captured by the sensor 306-2, and an environment signal 302-3 captured by the sensor 306-3. The environment signal 302-1 can include sequences of visual frames (e.g., RGB image frames, grayscale image frames, high-dynamic-range image frames, and/or the like) captured at regular intervals over a time period, where each frame represents a snapshot of the visual appearance of the target signal source 104-1 and surrounding regions at a specific moment in time. The environment signal 302-2 can include thermal image data (e.g., temperature maps, infrared intensity arrays, thermal gradient representations, and/or the like) that encode temperature values for each pixel location within the field of view of the thermal sensor, enabling extraction of body temperature measurements from the target signal source 104-1. The environment signal 302-3 can include audio waveform data (e.g., pulse-code modulation samples, compressed audio streams, multi-channel audio recordings, and/or the like) that encode sound pressure variations over time captured by the audio sensor. The environment signals 302 are represented in FIG. 3 as data structures indicated by curly braces, signifying that each environment signal includes structured data fields (e.g., timestamp values, sensor identifiers, data payloads, metadata attributes, and/or the like) that enable the signal processing module 224 to associate captured data with specific sensors and time periods. The environment signals 302 can be transferred from the sensors 306 to the computing logic 202 using streaming protocols (e.g., HTTP MJPEG streaming for camera data transfer from capture devices to local processing machines, real-time streaming protocol connections, direct memory access transfers, and/or the like) that enable continuous data flow from sensors to processing components.

With continued reference to FIG. 3, the environment signals 302 are provided as input to a model ensemble 304 that processes the environment signals 302 to generate output metrics 310 of data modalities different from the uniform data modality of the environment signals 302. The model ensemble 304 can include a collection of artificial intelligence models (e.g., convolutional neural networks, transformer models, signal processing algorithms, machine learning classifiers, and/or the like) that are trained to transform input data of the uniform data modality (e.g., visual images, thermal readings, audio waveforms, and/or the like) into output metrics of different data modalities (e.g., heart rate values, temperature measurements, pose estimations, instrument readings, and/or the like). The model ensemble 304 can be implemented using the artificial intelligence models 258 stored in the computing database 204 and loaded into the memory 220 by the model maintenance module 226 for execution by the processor 210. The model ensemble 304 can include multiple models operating in parallel (e.g., a heart rate extraction model processing visual signals while a temperature extraction model processes thermal signals, and/or the like) to generate multiple output metrics simultaneously from the environment signals 302. The model ensemble 304 can include models operating in sequence (e.g., a face detection model identifying face regions followed by a skin segmentation model isolating skin pixels followed by a remote photoplethysmography model extracting heart rate from skin color variations, and/or the like) where the output of one model serves as input to subsequent models in a processing pipeline. The model ensemble 304 can be configured by the orchestration module 225 based on the monitoring objectives and the types of physiological measurements being captured from the target signal source 104-1.

As further shown in FIG. 3, the output metrics 310 generated by the model ensemble 304 include a heart rate 312, a temperature 314, and an instrument reading 316 that indicate physiological measurements associated with the target signal source 104-1. The heart rate 312 can include a numerical value (e.g., beats per minute, pulse rate, cardiac frequency, and/or the like) extracted from the environment signal 302-1 using remote photoplethysmography techniques (e.g., color channel analysis, bandpass filtering, peak detection, frequency domain analysis, and/or the like) that detect subtle color variations in skin regions of the target signal source 104-1 caused by blood volume changes during cardiac cycles. The heart rate 312 can be accompanied by a real-time confidence score (e.g., a measurement quality indicator ranging from 0 to 100 percent, a signal-to-noise ratio value, a reliability metric, and/or the like) that indicates the quality of the heart rate measurement based on factors such as skin pixel count (e.g., 117000 pixels of detected skin area, and/or the like), motion artifacts, lighting conditions, and signal stability. The temperature 314 can include a numerical value (e.g., degrees Celsius, degrees Fahrenheit, and/or the like) extracted from the environment signal 302-2 using thermal image analysis techniques (e.g., body region segmentation, hotspot detection, temperature averaging, emissivity correction, and/or the like) that identify and measure the temperature of relevant body regions (e.g., forehead, inner canthus of the eye, and/or the like) of the target signal source 104-1. The instrument reading 316 can include numerical values (e.g., blood pressure readings, glucose levels, oxygen saturation percentages, and/or the like) extracted from visual environment signals captured from the candidate signal source 104-2 (e.g., medical instrument displays, health monitoring device screens, and/or the like) using a universal visual-based measurement approach where the sensors 306 capture images of display outputs from various medical devices and the model ensemble 304 uses optical character recognition or visual interpretation techniques to extract readings without requiring digital data interfaces with the medical devices.

Referring again to FIG. 3, the signal monitoring platform 200 implements a universal visual-based measurement approach for capturing the instrument reading 316 from medical devices within the environment 100 that addresses the challenge of obtaining digital data from diverse medical instruments that lack standardized data interfaces. In some implementations, the apparatus 102 can serve as a hardware embodiment of the signal monitoring platform 200 that implements the universal visual-based measurement approach. The universal visual-based measurement approach can include positioning the sensors 306 (e.g., the sensor 306-1, and/or the like) to capture visual images of display screens (e.g., liquid crystal displays, light-emitting diode displays, seven-segment displays, and/or the like) on medical devices (e.g., blood pressure monitors, glucose meters, pulse oximeters, thermometers, cholesterol meters, and/or the like) that present measurement readings in visual form (e.g., numerical digits, waveform graphs, indicator bars, and/or the like). The universal visual-based measurement approach can include optical character recognition routines (e.g., digit recognition algorithms, text extraction models, display parsing logic, and/or the like) executed by the signal processing module 224 that analyze captured images to identify and extract numerical readings displayed on medical device screens. The universal visual-based measurement approach can include display type classification logic (e.g., display format detectors, font recognizers, layout analyzers, and/or the like) that identifies the type of display and format of readings presented by different medical devices to apply appropriate extraction techniques. The universal visual-based measurement approach enables the signal monitoring platform 200 to integrate measurement data from a wide variety of medical devices without requiring manufacturers to provide digital data interfaces or application programming interfaces, as the signal monitoring platform 200 reads measurement information by capturing images of display screens and using visual interpretation to extract readings in the same manner that a human observer would read the displays.

With continued reference to FIG. 3, the output metrics 310 are provided as input to a generative AI model 320 that processes the output metrics 310 along with contextual information to generate responses, alerts, and control instructions for the signal monitoring lifecycle 300. The generative AI model 320 can include a large language model (e.g., a transformer-based language model, an instruction-tuned model, a medical domain model, and/or the like) that processes natural language inputs and generates natural language outputs based on the output metrics 310, historical signal data 257, and ontological reference data 255 stored in the computing database 204. The generative AI model 320 can be implemented using open-source model architectures (e.g., publicly available model weights, community-developed model structures, and/or the like) that are adapted and customized by the model maintenance module 226 for the monitoring objectives of the signal monitoring platform 200. The generative AI model 320 can be augmented using retrieval-augmented generation techniques (e.g., document retrieval pipelines, context injection methods, knowledge base queries, and/or the like) that supplement model inputs with relevant medical knowledge, patient history, and measurement data retrieved from the computing database 204. The generative AI model 320 can execute locally on the processor 210 of the signal monitoring platform 200 using graphics processing unit acceleration (e.g., NVIDIA Jetson Thor GPU processing, tensor core acceleration, and/or the like) to perform inference operations without transmitting personal health information to external cloud servers. The generative AI model 320 can generate multiple types of outputs including query responses, notification alerts, and control instructions based on the output metrics 310 and the current state of the monitoring operations.

As shown in FIG. 3, the generative AI model 320 receives an input query 322 from a user interface 330 that provides a natural language request or instruction from a user (e.g., the target signal source 104-1, a caregiver, a healthcare provider, and/or the like) interacting with the signal monitoring platform 200. The input query 322 can include questions about the health status of the target signal source 104-1 (e.g., “What is my current heart rate?”, “How has my blood pressure changed this week?”, “Why do I feel tired?”, and/or the like) that the generative AI model 320 answers based on the output metrics 310 and historical signal data 257. The input query 322 can include commands for the signal monitoring platform 200 to perform specific monitoring operations (e.g., “Check my temperature”, “Go to the kitchen and read my glucose meter”, “Start monitoring my gait”, and/or the like) that the generative AI model 320 translates into control instructions for the sensors 306 and actuators 308. The input query 322 is represented in FIG. 3 as a data structure indicated by curly braces, signifying that the input query includes structured data fields (e.g., query text, timestamp, user identifier, context parameters, and/or the like) that enable the generative AI model 320 to process the query appropriately. The input query 322 can be received through the user interface 330 via text input (e.g., typed queries on the display 240, and/or the like) or voice input (e.g., spoken queries captured by microphones of the sensors 306 and converted to text by speech recognition routines of the interface module 227, and/or the like). The user interface 330 can be implemented using the display 240 and the interface module 227 of the computing logic 202, providing visual and interactive elements for users to submit queries and receive responses from the signal monitoring platform 200.

With continued reference to FIG. 3, the generative AI model 320 generates a query response 324 based on the output metrics 310 and the input query 322 that is transmitted to the user interface 330 for display to the user. The query response 324 can include alphanumeric signals (e.g., text responses, formatted reports, summary statements, and/or the like) that answer questions posed in the input query 322 using information derived from the output metrics 310, historical signal data 257, and ontological reference data 255. The query response 324 can include explanatory content (e.g., interpretations of measurement values, comparisons to physiological baselines, trend descriptions, potential health implications, and/or the like) that contextualizes the output metrics 310 within the health history and medical knowledge relevant to the target signal source 104-1. The query response 324 can include recommendations (e.g., suggestions to consult a healthcare provider, lifestyle modification advice, medication reminders, and/or the like) generated by the generative AI model 320 based on analysis of the output metrics 310 and patterns detected in the historical signal data 257. The query response 324 is represented in FIG. 3 as a data structure indicated by curly braces, signifying that the query response includes structured data fields (e.g., response text, confidence scores, source references, timestamp, and/or the like) that enable the user interface 330 to present the response appropriately. The query response 324 can be presented on the display 240 through the interface module 227, which renders the response text along with relevant visualizations (e.g., charts showing measurement trends, icons indicating health status, and/or the like) to provide comprehensive feedback to the user.

As further shown in FIG. 3, the generative AI model 320 can generate a notification alert 326 that indicates required maintenance or attention regarding the target signal source 104-1 when the output metrics 310 deviate from expected physiological baselines. The notification alert 326 is represented in FIG. 3 by a bell icon, signifying an alert or notification that requires user attention. The notification alert 326 can be generated when the generative AI model 320 calculates metric deviation scores (e.g., differences between current measurements and baseline values, z-scores relative to historical distributions, percentage deviations from normal ranges, and/or the like) for the output metrics 310 that exceed tolerance threshold values (e.g., predefined deviation limits, configurable alert thresholds, clinically significant change thresholds, and/or the like). The notification alert 326 can include alert content (e.g., descriptions of the detected deviation, the specific output metrics involved, the magnitude of deviation, recommended actions, and/or the like) that informs the user about the nature of the alert and appropriate responses. The notification alert 326 can be transmitted to the user interface 330 for immediate display on the display 240, and can also be transmitted through the wireless communication circuitry 230 to external devices (e.g., caregiver mobile phones, healthcare provider systems, emergency services, and/or the like) when the severity of the alert warrants external notification. The notification alert 326 can include different priority levels (e.g., informational alerts, warning alerts, urgent alerts, emergency alerts, and/or the like) that determine the presentation style (e.g., visual prominence, auditory signals, vibration patterns, and/or the like) and notification routing (e.g., local display only, caregiver notification, emergency services contact, and/or the like) for each alert.

Referring again to FIG. 3, the signal monitoring lifecycle 300 includes actuators 308 that enable displacement and positioning of the sensors 306 within the environment 100 to capture environment signals 302 from appropriate positions and orientations relative to the target signal source 104-1 and the candidate signal source 104-2. The actuators 308 can include the actuator 208-1 and the actuator 208-2 of the actuated sensor assembly 260 that adjust the orientation of the sensors 306 (e.g., pan rotation, tilt rotation, and/or the like) to track the target signal source 104-1 and maintain the target signal source 104-1 within the field of view of the sensors 306. The actuators 308 can include the actuator 208-3, the actuator 208-4, and the actuator 208-5 of the displacement assembly 270 that enable displacement of the signal monitoring platform 200 within the environment 100 to navigate to spatial positions (e.g., the spatial location 106-1, the spatial location 106-2, and/or the like) where the sensors 306 can capture environment signals from the target signal source 104-1 and the candidate signal source 104-2. In some implementations, the actuators 308 can enable displacement of the apparatus 102, which can serve as a hardware embodiment of the signal monitoring platform 200. The actuators 308 operate under control of the actuator control module 222, which receives control commands from the orchestration module 225 and the navigation module 223 and generates motor control signals to drive the actuators to specified positions or velocities. The actuators 308 enable the signal monitoring platform 200 to follow the target signal source 104-1 throughout the environment 100, maintaining proximity to the target signal source 104-1 for continuous monitoring as the target signal source 104-1 moves between different rooms and locations.

With continued reference to FIG. 3, the generative AI model 320 generates a capture instruction 340 that is provided to the sensors 306 to control data capture operations based on the monitoring objectives and the current state of the signal monitoring lifecycle 300. The capture instruction 340 can include sensor activation commands (e.g., start capture commands, stop capture commands, sensor selection commands, and/or the like) that specify which sensors of the sensors 306 should be activated to capture environment signals 302. The capture instruction 340 can include capture parameter settings (e.g., frame rate specifications, resolution settings, exposure adjustments, gain configurations, and/or the like) that configure the operating parameters of the sensors 306 based on environmental conditions and the type of physiological measurements being captured. The capture instruction 340 can include region of interest specifications (e.g., face region coordinates, body segment boundaries, instrument display locations, and/or the like) that direct the sensors 306 to focus on specific regions within the field of view for targeted data capture. The capture instruction 340 is represented in FIG. 3 as a data structure indicated by curly braces, signifying that the capture instruction includes structured data fields (e.g., command type, target sensor identifiers, parameter values, timing specifications, and/or the like) that enable the sensor control module 221 to execute the instruction appropriately. The capture instruction 340 can be generated by the generative AI model 320 in response to the input query 322 when the input query requests specific monitoring operations, or can be generated autonomously by the orchestration module 225 based on scheduled monitoring activities and detected changes in the environment 100.

As shown in FIG. 3, an actuation instruction 342 is provided to the actuators 308 to control spatial positioning and displacement of the sensors 306 relative to the target signal source 104-1 and other signal sources within the environment 100. The actuation instruction 342 can include positioning commands (e.g., pan angle targets, tilt angle targets, rotation velocities, and/or the like) that specify the desired orientation of the actuated sensor assembly 260 for capturing environment signals from the target signal source 104-1. The actuation instruction 342 can include navigation commands (e.g., destination coordinates, waypoint sequences, velocity profiles, and/or the like) that specify the desired displacement of the signal monitoring platform 200 within the environment 100 for navigating to spatial positions associated with signal sources. In some implementations, the actuation instruction 342 can specify the desired displacement of the apparatus 102, which can serve as a hardware embodiment of the signal monitoring platform 200. The actuation instruction 342 can include tracking commands (e.g., target following modes, tracking speed parameters, prediction horizons, and/or the like) that configure the actuators 308 to continuously track the target signal source 104-1 as the target signal source 104-1 moves within the environment 100. The actuation instruction 342 is represented in FIG. 3 as a data structure indicated by curly braces, signifying that the actuation instruction includes structured data fields (e.g., command type, target actuator identifiers, position values, velocity values, timing specifications, and/or the like) that enable the actuator control module 222 to execute the instruction appropriately. The actuation instruction 342 can be generated by the generative AI model 320 in response to the input query 322 when the input query requests navigation to specific locations (e.g., “Go to the kitchen and read my glucose meter”, and/or the like), or can be generated by the navigation module 223 based on path planning algorithms that compute traversable routes to target spatial positions.

With continued reference to FIG. 3, the signal monitoring lifecycle 300 demonstrates a closed-loop system architecture where the sensors 306 capture environment signals 302, the model ensemble 304 transforms the environment signals 302 into output metrics 310, and the generative AI model 320 processes the output metrics 310 to generate the query response 324, the notification alert 326, the capture instruction 340, and the actuation instruction 342 that feed back to the sensors 306 and the actuators 308 for continued monitoring operations. The closed-loop architecture enables the signal monitoring platform 200 to adapt monitoring operations based on the quality of captured environment signals and the correspondence between captured signals and the physiological measurements being monitored. The closed-loop architecture enables the signal monitoring platform 200 to respond to changes in the position and posture of the target signal source 104-1 by adjusting sensor positioning and platform displacement to maintain observation of the target signal source 104-1. The closed-loop architecture enables the signal monitoring platform 200 to navigate to the candidate signal source 104-2 when environment signals from the target signal source 104-1 do not satisfy correspondence threshold values, capturing complementary environment signals to generate complete output metrics 310. The closed-loop architecture enables the signal monitoring platform 200 to operate autonomously within the environment 100, continuously monitoring the target signal source 104-1 and generating alerts when physiological measurements deviate from expected baselines without requiring constant user intervention. In some implementations, the apparatus 102 can serve as a hardware embodiment of the signal monitoring platform 200 that implements the closed-loop architecture within the environment 100.

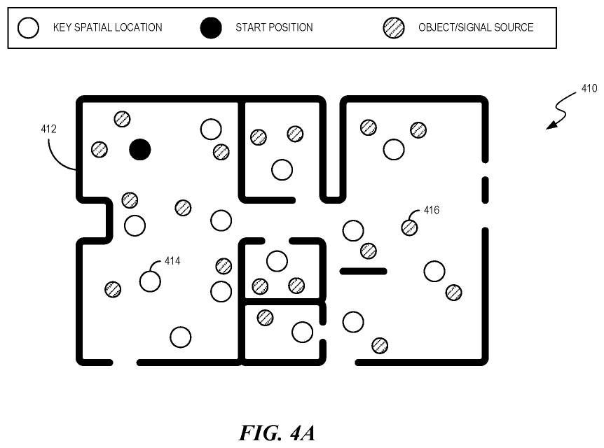

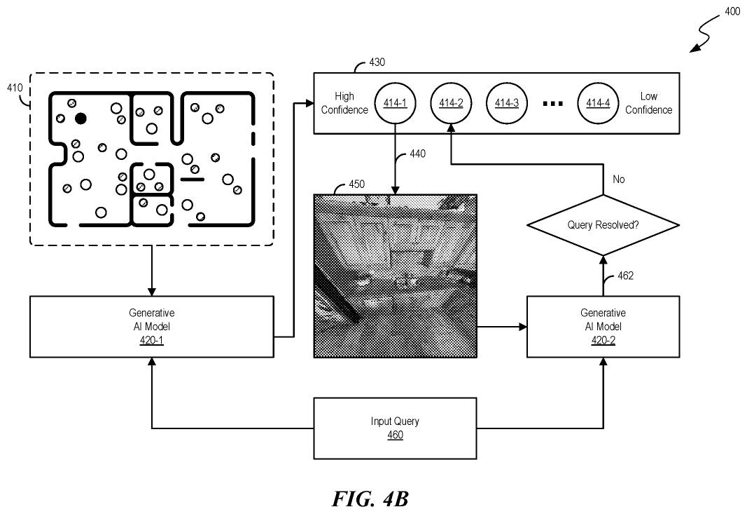

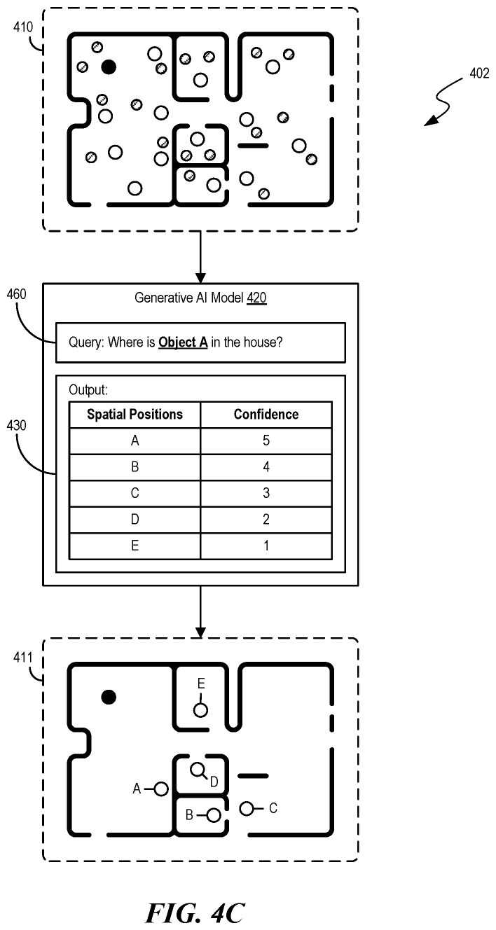

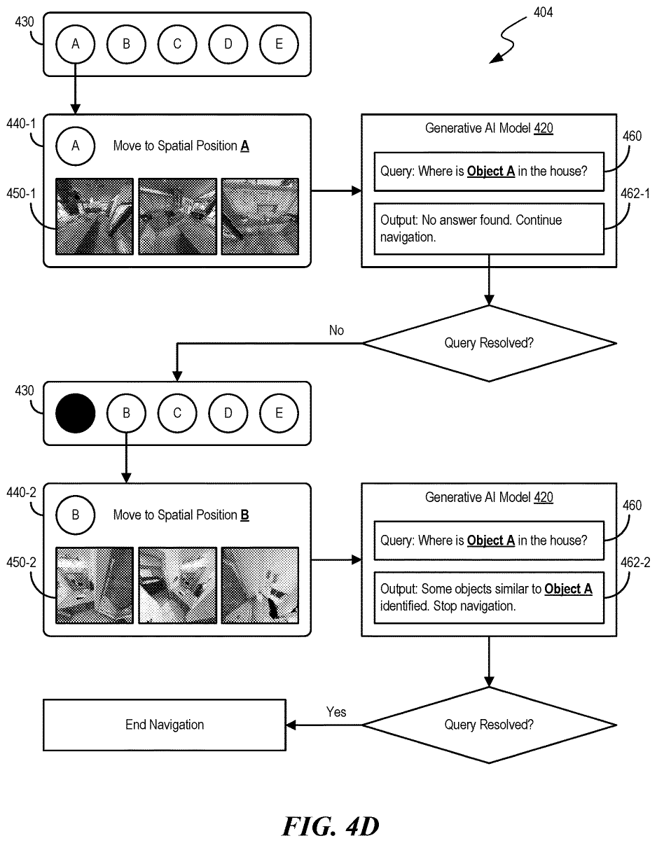

FIG. 4A is a diagram that illustrates an example spatial mapping of a physical environment in accordance with some implementations of the present technology. Referring to FIG. 4A, a spatial mapping 410 represents a floor plan layout of the environment 100 that the navigation module 223 of the computing logic 202 generates and stores in the spatial mappings 251 of the computing database 204 to enable navigation and signal capture operations within the physical space. The spatial mapping 410 can include a two-dimensional representation (e.g., an occupancy grid, a metric map, a topological graph, and/or the like) that encodes the geometric layout of the environment 100, including the positions of walls, doorways, corridors, and rooms that define traversable pathways for the apparatus 102. The spatial mapping 410 can be generated by the navigation module 223 using simultaneous localization and mapping techniques (e.g., visual simultaneous localization and mapping, lidar-based mapping, sensor fusion mapping, and/or the like) that process environment signals captured by the sensor 206-1 and the sensor 206-2 as the apparatus 102 explores the environment 100. The spatial mapping 410 can encode multiple interconnected rooms (e.g., a kitchen, a bedroom, a living room, a bathroom, a hallway, and/or the like) separated by walls with doorways providing passage between adjacent spaces, enabling the navigation module 223 to plan routes that traverse through doorways to reach target spatial positions in different rooms. The spatial mapping 410 can be stored in the computing database 204 as part of the spatial mappings 251 and can be updated by the navigation module 223 when changes to the environment 100 are detected (e.g., furniture moved, new obstacles placed, doorways blocked, and/or the like) to maintain an accurate representation of the current layout of the physical space.

With continued reference to FIG. 4A, a mapping boundary 412 defines the outer perimeter of the monitored space represented by the spatial mapping 410 and establishes the extent of the physical environment within which the apparatus 102 can navigate and capture environment signals. The mapping boundary 412 can include a closed polygon (e.g., a rectangular boundary, an irregular polygon following wall contours, a convex hull enclosing all mapped regions, and/or the like) that delineates the outermost edges of the spatial mapping 410 beyond which the apparatus 102 cannot navigate. The mapping boundary 412 can be determined by the navigation module 223 during initial exploration of the environment 100 based on the positions of exterior walls, fences, or other physical barriers that prevent further displacement of the apparatus 102. The mapping boundary 412 can be represented in the spatial mapping 410 as a dashed line or polygon outline that visually distinguishes the boundary of the mapped area from interior features (e.g., room walls, furniture, obstacles, and/or the like) within the environment 100. The mapping boundary 412 can be used by the navigation module 223 to constrain path planning algorithms (e.g., A-star pathfinding, rapidly-exploring random trees, potential field methods, and/or the like) to generate routes that remain within the mapped area and do not attempt to navigate beyond the physical limits of the environment 100. The mapping boundary 412 can be stored as part of the spatial mappings 251 in the computing database 204 and can be updated by the navigation module 223 if the apparatus 102 discovers additional accessible areas during subsequent exploration operations.

As shown in FIG. 4A, multiple key spatial positions 414 are distributed throughout the spatial mapping 410 and represent locations within the environment 100 where the apparatus 102 can navigate to or capture environment signals from the target signal source 104-1 and the candidate signal source 104-2. The key spatial positions 414 can include waypoint locations (e.g., room centers, doorway thresholds, corridor intersections, furniture adjacencies, and/or the like) that the navigation module 223 uses as intermediate destinations when planning routes between a current spatial position of the apparatus 102 and a target spatial position (e.g., the spatial location 106-1, the spatial location 106-2, and/or the like). The key spatial positions 414 can be indicated in the spatial mapping 410 by unfilled circular markers that visually distinguish navigable positions from obstacles and walls within the floor plan representation. The key spatial positions 414 can be associated with confidence scores (e.g., likelihood scores, probability values, relevance metrics, and/or the like) stored in the spatial position data 252 of the computing database 204 that indicate the likelihood that the target signal source 104-1 or a queried object exists near each key spatial position 414. The key spatial positions 414 can be generated by the navigation module 223 using frontier exploration techniques (e.g., systematic exploration of unknown areas, boundary detection algorithms, coverage path planning, and/or the like) where the apparatus 102 systematically explores unknown areas of the environment 100 to build a complete spatial map with comprehensive coverage of navigable positions. The key spatial positions 414 can be ranked by the orchestration module 225 based on the confidence scores to generate ordered sequences of spatial positions that the apparatus 102 follows when searching for signal sources or responding to input queries requesting information about objects within the environment 100.

With continued reference to FIG. 4A, multiple object positions 416 are shown within the spatial mapping 410 and represent signal sources or objects of interest within the environment 100 that the apparatus 102 can observe and capture environment signals from during monitoring operations. The object positions 416 can include locations of the target signal source 104-1 (e.g., a patient, an elderly individual, a person with a medical condition, and/or the like) and the candidate signal source 104-2 (e.g., medical instruments, health monitoring devices, medication dispensers, and/or the like) that are mapped to corresponding spatial positions within the environment 100. The object positions 416 can be indicated in the spatial mapping 410 by hatched circular markers that visually distinguish signal sources and objects of interest from navigable waypoints represented by the key spatial positions 414. The object positions 416 can be stored in the signal source reference data 254 of the computing database 204 along with metadata describing the type of signals each object provides (e.g., visual signals, thermal signals, audio signals, and/or the like), the data formats of captured signals, and the artificial intelligence models 258 appropriate for processing signals from each object. The object positions 416 can be detected and localized by the signal processing module 224 using object detection algorithms (e.g., convolutional neural network detectors, transformer-based detectors, region-based detectors, and/or the like) that analyze environment signals captured by the sensors 306 to identify and locate objects within the field of view. The object positions 416 can be updated by the navigation module 223 and the signal processing module 224 as the apparatus 102 observes objects within the environment 100 during monitoring operations, enabling the spatial mapping 410 to reflect the current positions of mobile objects (e.g., the target signal source 104-1, and/or the like) and newly detected objects.

As further shown in FIG. 4A, the navigation module 223 can use a scene graph representation in JSON format (e.g., JavaScript Object Notation data structures, hierarchical key-value mappings, nested object arrays, and/or the like) that maps locations within the spatial mapping 410 to detected objects for large language model-based navigation planning by the generative AI model 320. The scene graph representation can include node entries (e.g., object nodes, location nodes, region nodes, and/or the like) that represent detected objects and spatial positions within the environment 100, with each node containing attributes (e.g., object class labels, position coordinates, confidence scores, semantic descriptions, and/or the like) that describe the properties of the corresponding entity. The scene graph representation can include edge entries (e.g., spatial relationship edges, containment edges, proximity edges, and/or the like) that represent relationships between nodes, encoding information about which objects are located at which positions, which objects are near other objects, and which regions contain which objects. The scene graph representation in JSON format can be provided as input to the generative AI model 320 along with the input query 322, enabling the generative AI model 320 to reason about the spatial layout of the environment 100 and generate navigation instructions (e.g., the actuation instruction 342, and/or the like) that direct the apparatus 102 to navigate to positions where queried objects are located. The scene graph representation can be stored in the spatial environment metadata 253 of the computing database 204 and can be updated by the navigation module 223 as new objects are detected and existing objects are re-localized during monitoring operations.

Referring again to FIG. 4A, the navigation module 223 can use a ConceptGraphs method (e.g., an open-vocabulary three-dimensional scene graph construction technique, a semantic mapping approach, a language-grounded spatial representation method, and/or the like) for scene graph construction by performing object detection, segmentation, and association from posed RGB-D images captured by the sensor 206-1 and the sensor 206-2. The ConceptGraphs method can include object detection operations (e.g., running object detection models on RGB frames, generating bounding boxes around detected objects, classifying detected objects into semantic categories, and/or the like) that identify objects present in each captured image frame. The ConceptGraphs method can include segmentation operations (e.g., instance segmentation, semantic segmentation, panoptic segmentation, and/or the like) that delineate the pixel-level boundaries of detected objects within each image frame, enabling precise localization of object extents. The ConceptGraphs method can include association operations (e.g., multi-view object association, temporal object tracking, feature-based matching, and/or the like) that link object detections across multiple image frames captured from different viewpoints, enabling the navigation module 223 to build consistent object representations from multiple observations. The ConceptGraphs method can include three-dimensional localization operations (e.g., depth-based position estimation, triangulation from multiple views, point cloud projection, and/or the like) that determine the three-dimensional positions of detected objects within the environment 100 using depth information from the RGB-D images. The ConceptGraphs method can generate the scene graph representation that maps detected objects to their spatial positions within the spatial mapping 410, enabling the generative AI model 320 to perform language-grounded navigation planning based on natural language queries about objects in the environment 100.

With continued reference to FIG. 4A, the navigation module 223 can use TSDF fusion (e.g., Truncated Signed Distance Function fusion, volumetric integration, implicit surface reconstruction, and/or the like) for three-dimensional scene reconstruction from collected RGB-D frames captured by the sensor 206-1 and the sensor 206-2 as the apparatus 102 explores the environment 100. The TSDF fusion method can include voxel grid initialization operations (e.g., allocating a three-dimensional voxel array, setting initial signed distance values, configuring truncation distances, and/or the like) that establish a volumetric representation of the environment 100 with each voxel storing a signed distance value indicating the distance to the nearest surface. The TSDF fusion method can include depth integration operations (e.g., projecting depth measurements into the voxel grid, updating signed distance values based on observed depths, accumulating weights for each voxel, and/or the like) that incorporate depth information from each captured RGB-D frame into the volumetric representation by updating the signed distance values of voxels along the viewing rays. The TSDF fusion method can include surface extraction operations (e.g., marching cubes algorithm, isosurface extraction, mesh generation, and/or the like) that extract a three-dimensional surface mesh from the volumetric representation by identifying the zero-crossing of the signed distance function. The TSDF fusion method can generate a three-dimensional reconstruction of the environment 100 that the navigation module 223 uses to build the spatial mapping 410, including accurate representations of walls, floors, furniture, and other physical structures that define the geometry of the physical space. The three-dimensional reconstruction generated by TSDF fusion can be used by the navigation module 223 to identify traversable regions, detect obstacles, and plan collision-free paths for the apparatus 102 to navigate within the environment 100.

As shown in FIG. 4A, the apparatus 102 can use frontier exploration (e.g., systematic exploration of unknown areas, boundary-based exploration, coverage-driven mapping, and/or the like) for initial scene mapping where the apparatus 102 systematically explores unknown areas of the environment 100 to build a complete spatial map represented by the spatial mapping 410. The frontier exploration method can include frontier detection operations (e.g., identifying boundaries between known and unknown regions, detecting edges of the mapped area, locating unexplored accessible regions, and/or the like) that identify frontier cells or regions at the boundary between areas that have been observed by the sensors 306 and areas that remain unobserved. The frontier exploration method can include frontier selection operations (e.g., selecting the nearest frontier, selecting the largest frontier, selecting frontiers based on information gain, and/or the like) that choose which frontier the apparatus 102 should navigate to next based on criteria such as distance, expected coverage gain, or exploration efficiency. The frontier exploration method can include navigation operations (e.g., path planning to the selected frontier, obstacle avoidance during navigation, position tracking during movement, and/or the like) that direct the displacement assembly 270 to move the apparatus 102 toward the selected frontier while avoiding collisions with obstacles. The frontier exploration method can include map update operations (e.g., integrating new observations into the spatial mapping 410, updating the mapping boundary 412, adding newly detected key spatial positions 414 and object positions 416, and/or the like) that incorporate environment signals captured at the frontier into the spatial mapping 410. The frontier exploration method can continue iteratively until no frontiers remain, indicating that the apparatus 102 has explored all accessible areas of the environment 100 and the spatial mapping 410 provides complete coverage of the physical space within the mapping boundary 412.

FIG. 4B is a block diagram that illustrates a navigation framework in accordance with some implementations of the present technology. Referring to FIG. 4B, a navigation framework 400 provides a structured approach for the apparatus 102 to navigate within the environment 100 and capture environment signals from spatial positions associated with the target signal source 104-1 and the candidate signal source 104-2 based on input queries received through the user interface 330. The navigation framework 400 can include a multi-stage processing pipeline (e.g., a spatial analysis stage, a position ranking stage, a navigation execution stage, a query resolution stage, and/or the like) that coordinates the operation of the navigation module 223, the orchestration module 225, and the generative AI model 320 to determine where the apparatus 102 should navigate to capture environment signals that satisfy input query requirements. The navigation framework 400 can receive the spatial mapping 410 as input, where the spatial mapping 410 represents the floor plan layout of the environment 100 including the positions of walls, doorways, furniture, and other fixed objects that define traversable pathways for the apparatus 102. The navigation framework 400 can process the spatial mapping 410 using artificial intelligence models to identify spatial positions within the environment 100 that are likely to contain signal sources or objects relevant to an input query, enabling the apparatus 102 to navigate efficiently to positions where queried information can be obtained. The navigation framework 400 can operate iteratively, navigating to successive spatial positions and capturing environment signals at each position until sufficient information has been gathered to generate a query response that satisfies the input query requirements.

With continued reference to FIG. 4B, the navigation framework 400 includes a generative AI model 420-1 that receives information from the spatial mapping 410 and processes the information to generate ranked spatial positions 430 indicating locations within the environment 100 where the apparatus 102 should navigate to capture environment signals. The generative AI model 420-1 can include a large language model (e.g., a transformer-based language model, an instruction-tuned model, a reasoning-capable model, and/or the like) that analyzes the spatial mapping 410 in conjunction with an input query 460 to determine which spatial positions within the environment 100 are most likely to contain objects or signal sources relevant to the input query 460. The generative AI model 420-1 can receive a scene graph representation (e.g., a JSON-formatted data structure, a hierarchical object mapping, a semantic spatial encoding, and/or the like) of the spatial mapping 410 that maps locations within the environment 100 to detected objects, enabling the generative AI model 420-1 to reason about spatial relationships between objects and positions. The generative AI model 420-1 can select question-relevant waypoints from the scene graph using large language model reasoning (e.g., semantic analysis of the input query, object-location association inference, spatial relationship reasoning, and/or the like) that identifies which spatial positions are most likely to provide information needed to answer the input query 460. The generative AI model 420-1 can assign confidence scores (e.g., integer scores ranging from 1 to 5, probability values, relevance rankings, and/or the like) to each identified waypoint, where higher confidence scores indicate greater likelihood that the waypoint location contains objects or signal sources relevant to the input query 460. The generative AI model 420-1 can be implemented using the artificial intelligence models 258 stored in the computing database 204 and executed by the processor 210 of the computing logic 202.

As shown in FIG. 4B, the ranked spatial positions 430 generated by the generative AI model 420-1 are represented as a horizontal sequence of circular nodes including a key spatial position 414-1, a key spatial position 414-2, a key spatial position 414-3, and a key spatial position 414-4 arranged along a spectrum from high confidence to low confidence. The key spatial position 414-1 can represent the spatial position within the environment 100 that the generative AI model 420-1 has determined has the highest likelihood of containing objects or signal sources relevant to the input query 460, and can be assigned a confidence score of 5 (e.g., the maximum confidence value on a 1 to 5 scale, and/or the like) indicating strong confidence that navigating to the key spatial position 414-1 will yield relevant environment signals. The key spatial position 414-2 can represent the spatial position with the second highest confidence score (e.g., a confidence score of 4, and/or the like), indicating moderately high likelihood of containing relevant objects or signal sources. The key spatial position 414-3 can represent the spatial position with a moderate confidence score (e.g., a confidence score of 3, and/or the like), indicating intermediate likelihood of containing relevant information. The key spatial position 414-4 can represent the spatial position with a lower confidence score (e.g., a confidence score of 2 or 1, and/or the like), indicating reduced but non-zero likelihood of containing relevant objects or signal sources. The ranked spatial positions 430 can be stored in the spatial position data 252 of the computing database 204 and can be used by the navigation module 223 to generate ordered sequences of waypoints that the apparatus 102 follows when navigating within the environment 100 to capture environment signals.

With continued reference to FIG. 4B, the navigation module 223 can use greedy waypoint selection (e.g., a sequential decision-making approach, an incremental position selection method, a locally optimal navigation strategy, and/or the like) that calculates a gain value for each candidate waypoint to balance accuracy and efficiency when determining the next spatial position for the apparatus 102 to navigate to. The greedy waypoint selection can calculate the gain value as the large language model confidence score minus a weighted travel distance (e.g., gain equals confidence score minus distance weight multiplied by travel distance, and/or the like), where the large language model confidence score represents the likelihood that the waypoint contains relevant information and the weighted travel distance represents the cost of navigating from the current position of the apparatus 102 to the candidate waypoint. The greedy waypoint selection can select the waypoint with the highest gain value as the next navigation destination, prioritizing waypoints that offer high confidence of containing relevant information while penalizing waypoints that require long travel distances to reach. The greedy waypoint selection can be implemented by the navigation module 223 using the ranked spatial positions 430 generated by the generative AI model 420-1, where the navigation module 223 evaluates each key spatial position (e.g., the key spatial position 414-1, the key spatial position 414-2, the key spatial position 414-3, the key spatial position 414-4, and/or the like) based on the confidence score assigned by the generative AI model 420-1 and the travel distance calculated using the spatial mapping 410. The greedy waypoint selection can enable the apparatus 102 to efficiently navigate to positions that are likely to contain relevant information without expending excessive time and energy traveling to distant waypoints that offer only marginally higher confidence scores.

As further shown in FIG. 4B, a navigation instruction 440 is generated based on the ranked spatial positions 430 and directs the apparatus 102 to navigate to specific locations within the environment 100 for capturing environment signals 450. The navigation instruction 440 can include destination coordinates (e.g., Cartesian coordinates within the spatial mapping 410, grid cell indices, room identifiers with relative positions, and/or the like) that specify the target spatial position where the apparatus 102 should navigate to capture environment signals. The navigation instruction 440 can include path specifications (e.g., waypoint sequences, corridor routes, doorway traversal instructions, and/or the like) that define the route the apparatus 102 should follow from the current spatial position to the target spatial position while avoiding obstacles represented in the spatial mapping 410. The navigation instruction 440 can include velocity parameters (e.g., maximum travel speed, acceleration limits, approach velocities, and/or the like) that configure the displacement assembly 270 to move the apparatus 102 at appropriate speeds during navigation. The navigation instruction 440 can be generated by the navigation module 223 based on the greedy waypoint selection that identifies the next spatial position to visit from the ranked spatial positions 430, and can be transmitted to the actuator control module 222 for execution by the actuator 208-3, the actuator 208-4, and the actuator 208-5 of the displacement assembly 270. The navigation instruction 440 can direct the apparatus 102 to navigate sequentially through the key spatial position 414-1, the key spatial position 414-2, the key spatial position 414-3, and the key spatial position 414-4 in order of decreasing confidence until sufficient environment signals have been captured to resolve the input query 460.

Referring again to FIG. 4B, the environment signals 450 are captured by the sensors 306 (e.g., the sensor 306-1, the sensor 306-2, the sensor 306-3, and/or the like) at the spatial positions to which the apparatus 102 navigates following the navigation instruction 440. The environment signals 450 can include visual data (e.g., RGB image frames, depth images, stereo image pairs, and/or the like) captured by the sensor 206-1 and the sensor 206-2 that represent the physical features of the environment 100 at the navigated position, including objects, surfaces, and signal sources within the field of view of the sensors. The environment signals 450 can include thermal data (e.g., temperature maps, infrared intensity arrays, thermal gradient representations, and/or the like) captured by thermal sensors of the actuated sensor assembly 260 that represent temperature distributions at the navigated position. The environment signals 450 can include audio data (e.g., sound waveforms, speech recordings, ambient noise samples, and/or the like) captured by microphones of the actuated sensor assembly 260 that represent acoustic information at the navigated position. The environment signals 450 can be stored in the signal data cache 256 of the computing database 204 for processing by the signal processing module 224 and the generative AI model 320. The environment signals 450 depicted in FIG. 4B can include an image showing a physical space (e.g., a room with wooden paneling and flooring, a hallway, a kitchen area, and/or the like) representing captured visual data from the environment 100 at a navigated position corresponding to one of the key spatial positions from the ranked spatial positions 430.

With continued reference to FIG. 4B, the apparatus 102 can perform patient tracking by rotating the actuated sensor assembly 260 to listen to and follow the target signal source 104-1 using combined vision and sound triangulation (e.g., multi-modal sensor fusion, audio-visual localization, cross-modal position estimation, and/or the like) that determines the spatial position of the target signal source 104-1 within the environment 100. The combined vision and sound triangulation can include visual triangulation operations (e.g., stereo vision depth calculation, feature-based position estimation, object detection with depth inference, and/or the like) performed by the signal processing module 224 using environment signals captured by the sensor 206-1 and the sensor 206-2 arranged in a stereo configuration, where the depth of the target signal source 104-1 is calculated based on the disparity between corresponding features in the left and right camera images. The combined vision and sound triangulation can include audio triangulation operations (e.g., time-difference-of-arrival calculation, interaural level difference analysis, beamforming-based localization, and/or the like) performed by the signal processing module 224 using environment signals captured by microphones of the actuated sensor assembly 260 arranged in a spatial configuration that enables sound source localization through triangulation of audio signals originating from the target signal source 104-1. The combined vision and sound triangulation can include sensor fusion operations (e.g., Kalman filter fusion, weighted averaging, probabilistic combination, and/or the like) that combine the visual position estimate and the audio position estimate to generate a refined spatial position estimate for the target signal source 104-1 with improved accuracy and robustness compared to either modality alone. The apparatus 102 can use the spatial position estimate from the combined vision and sound triangulation to rotate the actuated sensor assembly 260 using the actuator 208-1 and the actuator 208-2 to orient the sensor 206-1 and the sensor 206-2 toward the target signal source 104-1, enabling continuous tracking of the target signal source 104-1 as the target signal source 104-1 moves within the environment 100.

As shown in FIG. 4B, the input query 460 provides a natural language request or instruction that initiates the navigation and signal monitoring process within the navigation framework 400. The input query 460 can include questions about objects within the environment 100 (e.g., “Where is Object A in the house?”, “Can you find my blood pressure monitor?”, “Where did I leave my medication?”, and/or the like) that the generative AI model 420-1 processes to identify spatial positions likely to contain the queried object. The input query 460 can include questions about the health status of the target signal source 104-1 (e.g., “What is my current heart rate?”, “Can you check my temperature?”, “How has my blood pressure changed this week?”, and/or the like) that require the apparatus 102 to navigate to positions where the target signal source 104-1 or relevant medical instruments are located. The input query 460 can include commands for the apparatus 102 to perform specific monitoring operations (e.g., “Go to the kitchen and read my glucose meter”, “Check on the patient in the bedroom”, “Monitor my gait while I walk to the living room”, and/or the like) that the generative AI model 420-1 translates into navigation instructions and capture instructions. The input query 460 can be received through the user interface 330 via text input (e.g., typed queries on the display 240, and/or the like) or voice input (e.g., spoken queries captured by microphones and converted to text by speech recognition routines of the interface module 227, and/or the like). The input query 460 is provided to both the generative AI model 420-1 for spatial position ranking and to a generative AI model 420-2 for query resolution based on captured environment signals.

With continued reference to FIG. 4B, the generative AI model 420-2 receives the environment signals 450 captured at navigated positions and the input query 460 to determine whether the captured environment signals contain sufficient information to respond to the input query 460. The generative AI model 420-2 can include a large language model (e.g., a transformer-based language model, a vision-language model, a multi-modal reasoning model, and/or the like) that analyzes the environment signals 450 in conjunction with the input query 460 to evaluate whether the queried object or information has been located within the captured data. The generative AI model 420-2 can perform query resolution evaluation (e.g., object presence detection, information sufficiency assessment, answer confidence calculation, and/or the like) that determines whether the environment signals 450 captured at the current navigated position contain the object or information requested by the input query 460. The generative AI model 420-2 can generate a resolution status (e.g., query resolved, query not resolved, partial resolution, and/or the like) that indicates whether the navigation framework 400 should continue navigating to additional spatial positions or should terminate navigation and generate a query response. The generative AI model 420-2 can be implemented using the artificial intelligence models 258 stored in the computing database 204 and executed by the processor 210 of the computing logic 202, enabling on-device inference without transmitting personal health information to external cloud servers. The generative AI model 420-2 can operate in conjunction with the generative AI model 420-1, where the generative AI model 420-1 ranks spatial positions for navigation and the generative AI model 420-2 evaluates captured environment signals to determine when navigation should terminate.

As further shown in FIG. 4B, the generative AI model 420-2 generates a query response 462 based on the environment signals 450 and the input query 460 when the query resolution evaluation determines that sufficient information has been captured to respond to the input query 460. The query response 462 can include alphanumeric signals (e.g., text responses, formatted answers, descriptive statements, and/or the like) that answer questions posed in the input query 460 using information derived from the environment signals 450 captured at navigated positions. The query response 462 can include object location descriptions (e.g., “Object A is located in the kitchen on the counter near the refrigerator”, “Your blood pressure monitor is on the nightstand in the bedroom”, and/or the like) when the input query 460 requests information about the location of objects within the environment 100. The query response 462 can include physiological measurement values (e.g., “Your current heart rate is 72 beats per minute”, “Your body temperature is 98.6 degrees Fahrenheit”, and/or the like) when the input query 460 requests health status information derived from the output metrics 310 generated by the model ensemble 304 processing the environment signals 450. The query response 462 can include confirmation statements (e.g., “I found some objects similar to Object A and have stopped navigation”, “The requested measurement has been captured”, and/or the like) that inform the user about the outcome of the navigation and signal capture operations. The query response 462 can be transmitted to the user interface 330 for display on the display 240, providing feedback to the user about the results of the input query 460 processing by the navigation framework 400.

Referring again to FIG. 4B, the navigation framework 400 operates iteratively by navigating through the ranked spatial positions 430 in order of confidence, capturing environment signals 450 at each position, and evaluating whether the captured signals satisfy the input query 460 requirements before deciding whether to continue navigation or generate the query response 462. The iterative operation can include a navigation loop (e.g., a while loop, a repeat-until loop, a conditional iteration structure, and/or the like) where the navigation module 223 selects the next waypoint from the ranked spatial positions 430 using greedy waypoint selection, generates the navigation instruction 440 to direct the apparatus 102 to the selected waypoint, captures the environment signals 450 at the waypoint using the sensors 306, and invokes the generative AI model 420-2 to evaluate whether the query is resolved. The iterative operation can terminate when the generative AI model 420-2 determines that the environment signals 450 captured at the current position contain sufficient information to answer the input query 460, at which point the generative AI model 420-2 generates the query response 462 and the navigation framework 400 ends the navigation loop. The iterative operation can continue to the next waypoint in the ranked spatial positions 430 when the generative AI model 420-2 determines that the environment signals 450 captured at the current position do not contain sufficient information to answer the input query 460, enabling the apparatus 102 to explore additional spatial positions until the queried object or information is located. The iterative operation can terminate with a negative response (e.g., “Object A was not found in the searched locations”, “Unable to locate the requested item”, and/or the like) when all waypoints in the ranked spatial positions 430 have been visited without locating the queried object or information, indicating that the object may not be present in the mapped areas of the environment 100 or may be occluded from the sensors 306.

FIG. 4C is a block diagram that illustrates a prioritization process for spatial navigation in accordance with some implementations of the present technology. Referring to FIG. 4C, a prioritization process 402 provides a structured approach for the navigation framework 400 to determine which spatial positions within the environment 100 the apparatus 102 should navigate to when responding to the input query 460 requesting information about objects or signal sources within the physical space. The prioritization process 402 can include a multi-stage analysis pipeline (e.g., a query parsing stage, a spatial reasoning stage, a confidence scoring stage, a position ranking stage, and/or the like) that coordinates the operation of the generative AI model 420 and the navigation module 223 to identify and rank spatial positions based on the likelihood that each position contains objects or signal sources relevant to the input query 460. The prioritization process 402 can receive the spatial mapping 410 as input, where the spatial mapping 410 represents the floor plan layout of the environment 100 including the positions of walls, doorways, rooms, furniture, and detected objects that define the spatial structure of the physical space. The prioritization process 402 can process the spatial mapping 410 in conjunction with the input query 460 to generate the ranked spatial positions 430 that indicate which locations within the environment 100 the apparatus 102 should visit in order of decreasing confidence to efficiently locate queried objects or capture relevant environment signals. The prioritization process 402 can be executed by the orchestration module 225 of the computing logic 202, which coordinates the invocation of the generative AI model 420 and the subsequent processing of the ranked spatial positions 430 by the navigation module 223 to generate navigation instructions for the apparatus 102.

With continued reference to FIG. 4C, the prioritization process 402 receives the spatial mapping 410 that represents the layout of the environment 100 as a floor plan showing multiple rooms and spatial regions within the physical space. The spatial mapping 410 can include geometric representations (e.g., occupancy grids, metric maps, topological graphs, polygon boundaries, and/or the like) that encode the positions of walls, doorways, corridors, and room boundaries that define the traversable pathways and spatial structure of the environment 100. The spatial mapping 410 can include object position markers (e.g., circular markers, bounding box annotations, point coordinates, and/or the like) that indicate the locations of detected objects and signal sources within the environment 100, where each marker corresponds to an object that has been identified and localized by the signal processing module 224 during prior exploration or monitoring operations. The spatial mapping 410 can include rectangular elements (e.g., furniture representations, appliance outlines, fixture boundaries, and/or the like) that represent physical structures such as tables, chairs, beds, counters, and other objects that occupy space within the rooms of the environment 100. The spatial mapping 410 can be bounded by a dashed boundary (e.g., the mapping boundary 412, and/or the like) that indicates the extent of the mapped area and delineates the outermost edges of the spatial mapping 410 beyond which the apparatus 102 cannot navigate. The spatial mapping 410 can be retrieved from the spatial mappings 251 stored in the computing database 204 by the navigation module 223 when the prioritization process 402 is initiated in response to the input query 460.

As shown in FIG. 4C, the prioritization process 402 receives the input query 460 that provides a natural language request specifying the object or information that the user seeks to locate within the environment 100. The input query 460 depicted in FIG. 4C can include the question “Where is Object A in the house?” that requests the apparatus 102 to determine the location of a specific object (e.g., a medical device, a medication container, a personal item, a health monitoring instrument, and/or the like) within the physical space represented by the spatial mapping 410. The input query 460 can include object identifiers (e.g., object names, object descriptions, object categories, object attributes, and/or the like) that specify which object the user is seeking to locate, enabling the generative AI model 420 to focus the spatial reasoning on positions likely to contain the specified object. The input query 460 can include contextual information (e.g., room preferences, search constraints, urgency indicators, and/or the like) that guides the prioritization process 402 in ranking spatial positions based on factors beyond simple object-location associations. The input query 460 can be received through the user interface 330 via text input (e.g., typed queries on the display 240, and/or the like) or voice input (e.g., spoken queries captured by microphones of the actuated sensor assembly 260 and converted to text by speech recognition routines of the interface module 227, and/or the like). The input query 460 can be parsed by the orchestration module 225 to extract query parameters (e.g., object identifiers, location constraints, action requests, and/or the like) that are provided to the generative AI model 420 along with the spatial mapping 410 for spatial reasoning and confidence scoring.

With continued reference to FIG. 4C, the generative AI model 420 processes the spatial mapping 410 and the input query 460 to generate the ranked spatial positions 430 that indicate which locations within the environment 100 are most likely to contain the object or signal source specified in the input query 460. The generative AI model 420 can include a large language model (e.g., a transformer-based language model, an instruction-tuned model, a reasoning-capable model, a vision-language model, and/or the like) that analyzes the spatial structure of the environment 100 represented in the spatial mapping 410 and applies semantic reasoning to determine which spatial positions are associated with the type of object specified in the input query 460. The generative AI model 420 can receive a scene graph representation (e.g., a JSON-formatted data structure, a hierarchical object mapping, a semantic spatial encoding, and/or the like) of the spatial mapping 410 that maps locations within the environment 100 to detected objects and room labels, enabling the generative AI model 420 to reason about spatial relationships between objects, rooms, and positions. The generative AI model 420 can apply commonsense reasoning (e.g., inferring that medical devices are likely located in bathrooms or bedrooms, inferring that kitchen items are likely located in the kitchen area, inferring that personal items are likely located near furniture where the user spends time, and/or the like) to associate the queried object with spatial positions based on typical object-location patterns in residential environments. The generative AI model 420 can be implemented using the artificial intelligence models 258 stored in the computing database 204 and executed by the processor 210 of the computing logic 202, enabling on-device inference without transmitting personal health information or query content to external cloud servers.

As further shown in FIG. 4C, the generative AI model 420 generates the ranked spatial positions 430 as a table output that lists spatial positions (e.g., position A, position B, position C, position D, position E, and/or the like) along with corresponding confidence scores that indicate the likelihood that each position contains the object specified in the input query 460. The ranked spatial positions 430 can include position A with a confidence score of 5 (e.g., the maximum confidence value on a 1 to 5 scale, and/or the like) indicating the highest likelihood that position A contains the queried object based on the spatial reasoning performed by the generative AI model 420. The ranked spatial positions 430 can include position B with a confidence score of 4 indicating moderately high likelihood that position B contains the queried object, representing the second most likely location based on the analysis of the spatial mapping 410 and the input query 460. The ranked spatial positions 430 can include position C with a confidence score of 3 indicating intermediate likelihood that position C contains the queried object, representing a plausible but less certain location compared to positions A and B. The ranked spatial positions 430 can include position D with a confidence score of 2 indicating reduced likelihood that position D contains the queried object, representing a location that the generative AI model 420 considers less probable but still worth exploring if higher-confidence positions do not yield the queried object. The ranked spatial positions 430 can include position E with a confidence score of 1 (e.g., the minimum confidence value on a 1 to 5 scale, and/or the like) indicating the lowest likelihood among the ranked positions that position E contains the queried object, representing a fallback location to explore if all other positions have been visited without locating the queried object.

Referring again to FIG. 4C, the prioritization process 402 generates a filtered spatial mapping 411 that displays the same floor plan layout as the spatial mapping 410 but includes labeled markers corresponding to the ranked spatial positions 430 generated by the generative AI model 420. The filtered spatial mapping 411 can include position markers (e.g., labeled circular markers, annotated waypoint indicators, tagged location symbols, and/or the like) labeled A, B, C, D, and E that are positioned at the corresponding locations within the environment 100 identified by the generative AI model 420 as potential locations for the queried object. The filtered spatial mapping 411 can display the position marker labeled A at the spatial position within the environment 100 that the generative AI model 420 has assigned the highest confidence score of 5, indicating that the apparatus 102 should navigate to position A first when searching for the queried object. The filtered spatial mapping 411 can display the position marker labeled B at the spatial position assigned a confidence score of 4, the position marker labeled C at the spatial position assigned a confidence score of 3, the position marker labeled D at the spatial position assigned a confidence score of 2, and the position marker labeled E at the spatial position assigned a confidence score of 1, enabling visual identification of the ranked positions within the floor plan representation. The filtered spatial mapping 411 can be generated by the navigation module 223 by overlaying the position markers from the ranked spatial positions 430 onto the spatial mapping 410, creating a visualization that shows both the spatial structure of the environment 100 and the prioritized navigation targets for responding to the input query 460. The filtered spatial mapping 411 can be stored in the spatial position data 252 of the computing database 204 and can be displayed on the display 240 through the interface module 227 to provide visual feedback to the user about the planned navigation sequence for locating the queried object.

With continued reference to FIG. 4C, the generative AI model 420 implements large language model waypoint confidence scoring (e.g., semantic likelihood estimation, query-conditioned position ranking, language-grounded spatial reasoning, and/or the like) that assigns likelihood values to spatial positions based on analysis of the input query 460 and the spatial structure represented in the spatial mapping 410. The large language model waypoint confidence scoring can include query parsing operations (e.g., object name extraction, attribute identification, constraint recognition, intent classification, and/or the like) that analyze the natural language content of the input query 460 to identify the specific object or information being sought and any constraints or preferences expressed by the user. The large language model waypoint confidence scoring can include object-location association operations (e.g., semantic similarity matching, commonsense inference, knowledge base lookup, learned association retrieval, and/or the like) that determine which types of locations within the environment 100 are typically associated with the type of object specified in the input query 460 based on patterns learned during training of the large language model and augmented by the ontological reference data 255 stored in the computing database 204. The large language model waypoint confidence scoring can include spatial position evaluation operations (e.g., position-by-position scoring, room-level likelihood estimation, proximity-based adjustment, and/or the like) that evaluate each candidate spatial position within the spatial mapping 410 and assign a confidence score based on the strength of association between the position and the queried object type. The large language model waypoint confidence scoring can include confidence normalization operations (e.g., score scaling, rank ordering, threshold application, and/or the like) that transform raw likelihood estimates into the integer confidence scores (e.g., values from 1 to 5, and/or the like) displayed in the ranked spatial positions 430.

As shown in FIG. 4C, the large language model waypoint confidence scoring performed by the generative AI model 420 can incorporate room-level semantic reasoning (e.g., room type classification, room function inference, room-object association mapping, and/or the like) that associates queried objects with specific rooms within the environment 100 based on the typical functions and contents of different room types. The room-level semantic reasoning can include room identification operations (e.g., room boundary detection, room label assignment, room type classification, and/or the like) that identify distinct rooms within the spatial mapping 410 and assign semantic labels (e.g., kitchen, bedroom, living room, bathroom, hallway, and/or the like) to each room based on detected objects, room dimensions, and spatial relationships. The room-level semantic reasoning can include room-object likelihood estimation (e.g., probability calculation, association strength scoring, conditional likelihood computation, and/or the like) that determines the likelihood that the queried object is located in each room type based on commonsense knowledge about where different types of objects are typically stored or used in residential environments. The room-level semantic reasoning can include position-within-room scoring (e.g., furniture proximity scoring, surface likelihood estimation, storage location probability, and/or the like) that refines the room-level likelihood estimates by considering specific positions within each room where the queried object is most likely to be located based on the positions of furniture, surfaces, and storage areas detected in the spatial mapping 410. The room-level semantic reasoning can enable the generative AI model 420 to assign higher confidence scores to positions in rooms that are semantically associated with the queried object type (e.g., assigning higher confidence to bathroom positions when the query requests a blood pressure monitor, assigning higher confidence to kitchen positions when the query requests a medication container typically stored near food preparation areas, and/or the like).

With continued reference to FIG. 4C, the large language model waypoint confidence scoring performed by the generative AI model 420 can incorporate object co-occurrence reasoning (e.g., object proximity inference, co-location pattern recognition, contextual object association, and/or the like) that assigns higher confidence scores to positions where objects related to the queried object have been previously detected. The object co-occurrence reasoning can include co-occurrence pattern retrieval operations (e.g., historical co-location lookup, object relationship graph traversal, association rule application, and/or the like) that identify objects that frequently appear near the queried object type based on patterns stored in the signal source reference data 254 and the ontological reference data 255 of the computing database 204. The object co-occurrence reasoning can include detected object matching operations (e.g., object class comparison, attribute similarity scoring, category membership testing, and/or the like) that compare objects detected in the spatial mapping 410 against the co-occurrence patterns to identify positions where related objects have been observed. The object co-occurrence reasoning can include confidence adjustment operations (e.g., score boosting, likelihood multiplication, additive confidence increase, and/or the like) that increase the confidence scores assigned to positions where related objects have been detected, reflecting the increased likelihood that the queried object is located near objects with which the queried object typically co-occurs. The object co-occurrence reasoning can enable the generative AI model 420 to leverage contextual information about object relationships to improve the accuracy of the ranked spatial positions 430 beyond what would be achieved using room-level reasoning alone.

As further shown in FIG. 4C, the prioritization process 402 can incorporate historical location data (e.g., prior object sighting records, location frequency statistics, temporal location patterns, and/or the like) stored in the historical signal data 257 of the computing database 204 to refine the confidence scores assigned by the generative AI model 420 based on where the queried object has been previously observed within the environment 100. The historical location data can include object sighting records (e.g., timestamps of prior observations, spatial coordinates of prior detections, confidence levels of prior identifications, and/or the like) that document when and where the queried object has been detected by the sensors 306 during prior monitoring operations. The historical location data can include location frequency statistics (e.g., observation counts per position, time-weighted frequency scores, recency-adjusted location probabilities, and/or the like) that summarize how often the queried object has been observed at each spatial position within the environment 100 over extended time periods. The historical location data can include temporal location patterns (e.g., time-of-day location distributions, day-of-week location variations, activity-correlated location associations, and/or the like) that capture how the location of the queried object varies based on temporal factors such as the time of day, day of week, or activities being performed by the target signal source 104-1. The prioritization process 402 can combine the confidence scores generated by the generative AI model 420 with the historical location data to produce refined confidence scores that reflect both semantic reasoning about likely object locations and empirical observations of where the object has actually been located in the past.

Referring again to FIG. 4C, the prioritization process 402 can output the ranked spatial positions 430 and the filtered spatial mapping 411 to the navigation module 223 for use in generating navigation instructions that direct the apparatus 102 to visit the ranked positions in order of decreasing confidence. The navigation module 223 can receive the ranked spatial positions 430 as an ordered list (e.g., a priority queue, a sorted array, a ranked sequence, and/or the like) of spatial positions with associated confidence scores, where the positions are ordered from highest confidence to lowest confidence to enable sequential navigation through the most promising locations first. The navigation module 223 can use the filtered spatial mapping 411 to plan traversable routes from the current position of the apparatus 102 to each of the ranked positions, computing path lengths and travel times that are used in the greedy waypoint selection to balance confidence scores against travel costs. The navigation module 223 can generate navigation instructions (e.g., the navigation instruction 440, and/or the like) that direct the displacement assembly 270 to move the apparatus 102 to the first position in the ranked spatial positions 430 (e.g., position A with confidence score 5, and/or the like) and subsequently to lower-ranked positions if the queried object is not found at higher-ranked positions. The navigation module 223 can update the filtered spatial mapping 411 as the apparatus 102 visits each position, marking visited positions and adjusting the navigation plan based on the results of environment signal capture and query resolution evaluation at each position. The prioritization process 402 can be re-executed by the orchestration module 225 if the initial ranked spatial positions 430 do not yield the queried object, enabling the generative AI model 420 to generate additional candidate positions based on updated information gathered during the navigation process.

FIG. 4D is a flowchart that illustrates a navigation process for spatial navigation in accordance with some implementations of the present technology. Referring to FIG. 4D, a navigation process 404 provides an iterative approach for the apparatus 102 to navigate through the ranked spatial positions 430 generated by the prioritization process 402, capturing environment signals at successive positions and evaluating whether the captured signals contain sufficient information to resolve the input query 460. The navigation process 404 can include a sequential navigation loop (e.g., an iterative position visitation cycle, a waypoint traversal sequence, a progressive search workflow, and/or the like) that directs the apparatus 102 to visit spatial positions in order of decreasing confidence scores until the generative AI model 420 determines that the queried object or information has been located within the captured environment signals. The navigation process 404 can be executed by the orchestration module 225 of the computing logic 202, which coordinates the invocation of the navigation module 223 for generating navigation instructions, the sensor control module 221 for capturing environment signals at each visited position, and the generative AI model 420 for evaluating whether the captured signals satisfy the requirements of the input query 460. The navigation process 404 can operate autonomously within the environment 100, enabling the apparatus 102 to search for queried objects or capture requested physiological measurements without requiring continuous user intervention during the navigation and signal capture operations. The navigation process 404 can terminate when the generative AI model 420 generates a query response indicating that the queried object has been located or when all ranked spatial positions have been visited without locating the queried object, at which point the navigation process 404 generates a final query response summarizing the search results.

With continued reference to FIG. 4D, the navigation process 404 begins with the ranked spatial positions 430 that list spatial positions (e.g., position A, position B, position C, position D, position E, and/or the like) in order of decreasing confidence scores as determined by the generative AI model 420 during the prioritization process 402. The ranked spatial positions 430 can be represented as a visual indicator (e.g., a horizontal sequence of circular nodes, a priority queue display, a ranked list visualization, and/or the like) showing the positions A, B, C, D, and E with position A initially selected for navigation as indicated by a filled circle marker distinguishing the currently selected position from unvisited positions represented by unfilled circle markers. The navigation process 404 can maintain a position index (e.g., a current waypoint pointer, a navigation progress counter, a visited position tracker, and/or the like) that tracks which position in the ranked spatial positions 430 the apparatus 102 is currently navigating to or has most recently visited, enabling the navigation process 404 to advance to the next position in the sequence when the current position does not yield the queried object. The ranked spatial positions 430 can be stored in the spatial position data 252 of the computing database 204 and can be accessed by the navigation module 223 to retrieve the coordinates and confidence scores of each position when generating navigation instructions for the displacement assembly 270. The navigation process 404 can update the visual representation of the ranked spatial positions 430 as the apparatus 102 progresses through the positions, shifting the filled circle marker from position A to position B and subsequently to positions C, D, and E as each position is visited and evaluated.

As shown in FIG. 4D, the navigation process 404 generates a navigation instruction 440-1 that directs the apparatus 102 to move to spatial position A, which represents the first position in the ranked spatial positions 430 with the highest confidence score assigned by the generative AI model 420. The navigation instruction 440-1 can include destination coordinates (e.g., Cartesian coordinates within the spatial mapping 410, grid cell indices corresponding to position A, room identifiers with relative position offsets, and/or the like) that specify the target spatial position where the apparatus 102 should navigate to capture environment signals. The navigation instruction 440-1 can include path specifications (e.g., waypoint sequences from the current position to position A, corridor routes avoiding obstacles, doorway traversal instructions for room transitions, and/or the like) that define the route the apparatus 102 should follow from the current spatial position to position A while avoiding obstacles represented in the spatial mapping 410. The navigation instruction 440-1 can include velocity parameters (e.g., maximum travel speed values, acceleration limits for smooth motion, approach velocities for precise positioning, and/or the like) that configure the displacement assembly 270 to move the apparatus 102 at appropriate speeds during navigation to position A. The navigation instruction 440-1 can be generated by the navigation module 223 based on the greedy waypoint selection that identifies position A as the first navigation destination from the ranked spatial positions 430, and can be transmitted to the actuator control module 222 for execution by the actuator 208-3, the actuator 208-4, and the actuator 208-5 of the displacement assembly 270. The navigation instruction 440-1 can include arrival confirmation criteria (e.g., position tolerance thresholds, orientation alignment requirements, stability verification conditions, and/or the like) that the navigation module 223 uses to determine when the apparatus 102 has successfully arrived at position A and is ready to capture environment signals.

With continued reference to FIG. 4D, the navigation process 404 captures environment signals 450-1 at spatial position A using the sensors 306 (e.g., the sensor 306-1, the sensor 306-2, the sensor 306-3, and/or the like) after the apparatus 102 has navigated to position A following the navigation instruction 440-1. The environment signals 450-1 can include visual data (e.g., RGB image frames captured by the sensor 206-1, depth images captured by the sensor 206-2, stereo image pairs from the stereo camera configuration, and/or the like) that represent the physical features of the environment 100 at position A, including objects, surfaces, and signal sources within the field of view of the sensors. The environment signals 450-1 can include multi-view images (e.g., images captured from multiple camera orientations, images captured after rotating the actuated sensor assembly 260 to different angles, images captured from different positions within the vicinity of position A, and/or the like) that provide comprehensive visual coverage of the area surrounding position A to maximize the likelihood of detecting the queried object if the queried object is present at or near position A. The environment signals 450-1 can be captured by the sensor control module 221 executing capture routines (e.g., frame grabbing operations, multi-view capture sequences, panoramic image acquisition, and/or the like) that activate the sensors 306 and retrieve captured data for storage in the signal data cache 256 of the computing database 204. The environment signals 450-1 depicted in FIG. 4D can include multiple views (e.g., a grid of captured images, a sequence of frames from different orientations, a collection of perspective views, and/or the like) showing the physical space at position A from various angles to enable comprehensive visual analysis by the generative AI model 420. The environment signals 450-1 can be captured over a time period (e.g., a multi-second capture window, a frame sequence duration, a scanning interval, and/or the like) that allows the actuated sensor assembly 260 to rotate and capture images from multiple orientations using the actuator 208-1 and the actuator 208-2.

As further shown in FIG. 4D, the generative AI model 420 receives the environment signals 450-1 captured at position A and the input query 460 to evaluate whether the captured environment signals contain sufficient information to respond to the input query 460. The generative AI model 420 can implement a vision language model (e.g., a multi-modal transformer model, a visual question answering model, a vision-language reasoning model, and/or the like) that processes the multi-view images from the environment signals 450-1 in conjunction with the natural language content of the input query 460 to determine whether the queried object is present in the captured images. The vision language model can perform visual question answering (e.g., image-conditioned text generation, visual grounding, object presence verification, and/or the like) by taking the multi-view images as input and generating a textual response that indicates whether the queried object has been detected within the captured visual data. The vision language model can analyze each image in the multi-view image set (e.g., examining individual frames for object presence, comparing features across multiple views, aggregating detection confidence across images, and/or the like) to determine whether any of the captured views contain the queried object or objects similar to the queried object. The generative AI model 420 can be implemented using the artificial intelligence models 258 stored in the computing database 204 and executed by the processor 210 of the computing logic 202, enabling on-device inference without transmitting the captured environment signals 450-1 or the input query 460 content to external cloud servers. The vision language model can generate a binary determination (e.g., object found or object not found, query resolved or query not resolved, answer available or continue navigation, and/or the like) along with a confidence score indicating the certainty of the determination based on the quality and content of the captured multi-view images.

Referring again to FIG. 4D, the generative AI model 420 generates a query response 462-1 based on the evaluation of the environment signals 450-1 captured at position A, where the query response 462-1 indicates that no answer was found and navigation should continue to the next position in the ranked spatial positions 430. The query response 462-1 can include a negative determination statement (e.g., “No answer found”, “Object not detected at this location”, “Query not resolved”, and/or the like) that indicates the vision language model did not detect the queried object within the multi-view images captured at position A. The query response 462-1 can include a navigation continuation directive (e.g., “Continue navigation”, “Proceed to next waypoint”, “Visit next ranked position”, and/or the like) that instructs the navigation process 404 to advance to the next position in the ranked spatial positions 430 rather than terminating the search. The query response 462-1 can include confidence information (e.g., detection confidence scores, image quality assessments, coverage completeness indicators, and/or the like) that provides context about why the queried object was not detected at position A, enabling the orchestration module 225 to adjust subsequent navigation and capture operations if needed. The query response 462-1 can be generated by the vision language model applying question answering logic (e.g., object presence classification, visual evidence evaluation, answer generation conditioned on visual input, and/or the like) that determines the appropriate response based on the analysis of the environment signals 450-1 and the requirements of the input query 460. The query response 462-1 depicted in FIG. 4D indicates that the generative AI model 420 has determined that the queried object (e.g., Object A as specified in the input query 460, and/or the like) was not found in the environment signals 450-1 captured at position A, and the navigation process 404 should continue to position B.

With continued reference to FIG. 4D, the navigation process 404 proceeds through the prioritization process 402 that evaluates whether the query is resolved based on the query response 462-1 generated by the generative AI model 420. The prioritization process 402 can include a decision evaluation (e.g., a conditional branch, a resolution check, a termination condition test, and/or the like) that examines the query response 462-1 to determine whether the navigation process 404 should terminate with a final response or continue to the next position in the ranked spatial positions 430. The prioritization process 402 can evaluate the query response 462-1 by checking for resolution indicators (e.g., object found flags, answer available markers, query satisfied conditions, and/or the like) that indicate whether the generative AI model 420 has successfully located the queried object or generated a satisfactory answer to the input query 460. The prioritization process 402 depicted in FIG. 4D shows a decision node labeled “query resolved” with two branches: a “Yes” branch leading to navigation termination and a “No” branch returning to the ranked spatial positions 430 for continued navigation. Since the query response 462-1 indicates that no answer was found, the prioritization process 402 follows the “No” branch and returns to the ranked spatial positions 430, where position B is now selected as indicated by the filled circle marker shifting from position A to position B. The prioritization process 402 can update the navigation state (e.g., incrementing the position index, marking position A as visited, selecting position B as the next destination, and/or the like) to reflect the progression through the ranked spatial positions 430.

As shown in FIG. 4D, the navigation process 404 generates a navigation instruction 440-2 that directs the apparatus 102 to move to spatial position B, which represents the second position in the ranked spatial positions 430 with the second highest confidence score assigned by the generative AI model 420. The navigation instruction 440-2 can include destination coordinates (e.g., Cartesian coordinates within the spatial mapping 410 corresponding to position B, grid cell indices for position B, room identifiers with relative position offsets for position B, and/or the like) that specify the target spatial position where the apparatus 102 should navigate after completing the visit to position A. The navigation instruction 440-2 can include path specifications (e.g., waypoint sequences from position A to position B, corridor routes connecting the two positions, doorway traversal instructions if position B is in a different room than position A, and/or the like) that define the route the apparatus 102 should follow from position A to position B while avoiding obstacles represented in the spatial mapping 410. The navigation instruction 440-2 can be generated by the navigation module 223 using the greedy waypoint selection that identifies position B as the next navigation destination from the ranked spatial positions 430 after position A has been visited without locating the queried object. The navigation instruction 440-2 can be transmitted to the actuator control module 222 for execution by the actuator 208-3, the actuator 208-4, and the actuator 208-5 of the displacement assembly 270, causing the apparatus 102 to displace from position A to position B following the specified path. The navigation instruction 440-2 can include the same types of velocity parameters and arrival confirmation criteria as the navigation instruction 440-1, ensuring consistent navigation behavior as the apparatus 102 progresses through the ranked spatial positions 430.

With continued reference to FIG. 4D, the navigation process 404 captures environment signals 450-2 at spatial position B using the sensors 306 after the apparatus 102 has navigated to position B following the navigation instruction 440-2. The environment signals 450-2 can include visual data (e.g., RGB image frames, depth images, stereo image pairs, and/or the like) that represent the physical features of the environment 100 at position B, which differ from the environment signals 450-1 captured at position A due to the different spatial location and field of view at position B. The environment signals 450-2 can include multi-view images (e.g., images captured from multiple camera orientations at position B, images captured after rotating the actuated sensor assembly 260 to different angles, panoramic image sequences covering the area surrounding position B, and/or the like) that provide comprehensive visual coverage of the area at position B to maximize the likelihood of detecting the queried object. The environment signals 450-2 depicted in FIG. 4D can include multiple views showing the physical space at position B from various angles, where the captured images differ from those in the environment signals 450-1 due to the different location within the environment 100. The environment signals 450-2 can be captured using the same multi-view capture approach as the environment signals 450-1, where the sensor control module 221 activates the sensors 306 and the actuator control module 222 rotates the actuated sensor assembly 260 to capture images from multiple orientations. The environment signals 450-2 can be stored in the signal data cache 256 of the computing database 204 for processing by the generative AI model 420.

As further shown in FIG. 4D, the generative AI model 420 receives the environment signals 450-2 captured at position B and the input query 460 to evaluate whether the captured environment signals contain the queried object or sufficient information to respond to the input query 460. The generative AI model 420 can apply the same vision language model approach used for evaluating the environment signals 450-1, processing the multi-view images from the environment signals 450-2 in conjunction with the natural language content of the input query 460 to determine whether the queried object is present in the captured images at position B. The vision language model can perform visual question answering by analyzing each image in the multi-view image set from the environment signals 450-2, examining the captured views for the presence of the queried object or objects similar to the queried object. The vision language model can compare features detected in the environment signals 450-2 against the object description or characteristics specified in the input query 460 (e.g., “Where is Object A in the house?”, and/or the like) to determine whether any of the captured views contain a match. The generative AI model 420 can generate a determination based on the visual analysis that indicates whether the queried object has been located at position B, taking into account the confidence of object detection, the similarity between detected objects and the queried object, and the completeness of visual coverage provided by the multi-view images.

Referring again to FIG. 4D, the generative AI model 420 generates a query response 462-2 based on the evaluation of the environment signals 450-2 captured at position B, where the query response 462-2 indicates that objects similar to the queried object have been identified and navigation should stop. The query response 462-2 can include a positive determination statement (e.g., “Some objects similar to Object A have been identified”, “Query resolved”, “Object located at this position”, and/or the like) that indicates the vision language model has detected the queried object or objects matching the query criteria within the multi-view images captured at position B. The query response 462-2 can include a navigation termination directive (e.g., “Stop navigation”, “Search complete”, “Query satisfied”, and/or the like) that instructs the navigation process 404 to terminate the iterative navigation loop and proceed to generate a final response for the user. The query response 462-2 can include object location information (e.g., position coordinates where the object was detected, room identification, relative position descriptions, and/or the like) that provides specific details about where the queried object was found within the environment 100. The query response 462-2 can include confidence information (e.g., detection confidence scores, similarity metrics between detected objects and the queried object, visual evidence descriptions, and/or the like) that provides context about the certainty of the object identification. The query response 462-2 depicted in FIG. 4D indicates that the generative AI model 420 has determined that objects similar to Object A (e.g., the object specified in the input query 460, and/or the like) have been identified in the environment signals 450-2 captured at position B, and the navigation process 404 should stop.

With continued reference to FIG. 4D, the navigation process 404 proceeds through the prioritization process 402 that evaluates whether the query is resolved based on the query response 462-2 generated by the generative AI model 420. The prioritization process 402 examines the query response 462-2 and determines that the query has been resolved because the query response 462-2 indicates that objects similar to the queried object have been identified at position B. The prioritization process 402 follows the “Yes” branch from the decision node labeled “query resolved” and proceeds to end navigation, terminating the iterative navigation loop of the navigation process 404. The navigation process 404 can generate a final query response (e.g., an alphanumeric signal transmitted to the user interface 330, a formatted answer displayed on the display 240, a spoken response generated through audio output, and/or the like) that communicates the search results to the user, indicating that the queried object was found at position B within the environment 100. The navigation process 404 can store the search results in the historical signal data 257 of the computing database 204, recording the object location, the navigation path followed, the positions visited, and the environment signals captured during the search for future reference. The navigation process 404 can update the spatial position data 252 to reflect the detected location of the queried object, enabling future queries about the same object to benefit from the location information gathered during the current search.

As shown in FIG. 4D, the vision language model implemented by the generative AI model 420 performs visual question answering using a multi-view image capture approach that provides comprehensive visual coverage of each visited spatial position to maximize the likelihood of detecting queried objects. The multi-view image capture approach can include orientation variation (e.g., capturing images at multiple pan angles, capturing images at multiple tilt angles, capturing images from a range of viewing directions, and/or the like) where the actuated sensor assembly 260 rotates to capture images from different orientations at each spatial position, ensuring that objects located in different directions from the apparatus 102 are included in the captured visual data. The multi-view image capture approach can include the actuator 208-1 rotating the actuated sensor assembly 260 about a vertical axis (e.g., a yaw axis, a pan axis, and/or the like) to capture images at multiple horizontal angles (e.g., 0 degrees, 45 degrees, 90 degrees, 135 degrees, 180 degrees, 225 degrees, 270 degrees, 315 degrees, and/or the like) providing panoramic coverage of the area surrounding each spatial position. The multi-view image capture approach can include the actuator 208-2 tilting the actuated sensor assembly 260 about a horizontal axis (e.g., a pitch axis, a tilt axis, and/or the like) to capture images at multiple vertical angles (e.g., upward-looking views, horizontal views, downward-looking views, and/or the like) ensuring that objects at different heights are included in the captured visual data. The multi-view image capture approach can generate a set of images (e.g., 8 to 16 images per position, a panoramic image sequence, a multi-angle image collection, and/or the like) that the vision language model processes collectively to determine whether the queried object is present at the visited spatial position.

With continued reference to FIG. 4D, the vision language model implemented by the generative AI model 420 performs question answering by taking multi-view images as input and determining whether to provide an answer or continue navigation based on the visual content of the captured environment signals and the requirements specified in the input query 460. The vision language model can include a multi-modal transformer architecture (e.g., a vision-language transformer, a cross-attention encoder-decoder model, a unified vision-text embedding network, and/or the like) that processes both visual inputs (e.g., the multi-view images from the environment signals 450-1 or the environment signals 450-2, and/or the like) and textual inputs (e.g., the natural language content of the input query 460, and/or the like) within a shared representation space that enables reasoning about relationships between visual content and query semantics. The vision language model can include image encoding operations (e.g., patch embedding extraction, visual feature computation, spatial position encoding, and/or the like) that transform each image in the multi-view image set into a sequence of visual tokens or feature vectors that represent the visual content at different spatial locations within each image. The vision language model can include text encoding operations (e.g., tokenization of the input query 460, word embedding lookup, positional encoding addition, and/or the like) that transform the natural language query into a sequence of text tokens or feature vectors that represent the semantic content of the query. The vision language model can include cross-modal attention operations (e.g., visual-to-text attention, text-to-visual attention, bidirectional cross-attention, and/or the like) that enable the model to attend to relevant visual regions based on the query content and to ground textual concepts in specific visual features detected within the multi-view images. The vision language model can include answer generation operations (e.g., autoregressive text generation, classification head prediction, binary decision output, and/or the like) that produce a textual response indicating whether the queried object has been detected within the captured images and whether navigation should continue or terminate.

As further shown in FIG. 4D, the vision language model implemented by the generative AI model 420 can perform object presence verification (e.g., visual grounding, object detection conditioned on query, semantic matching between query and visual content, and/or the like) that determines whether the object specified in the input query 460 is present within any of the multi-view images captured at the current spatial position. The object presence verification can include query-conditioned visual search operations (e.g., attention-based region selection, query-guided feature matching, semantic similarity computation between query embeddings and visual region embeddings, and/or the like) that identify regions within the multi-view images that correspond to the object description provided in the input query 460. The object presence verification can include confidence scoring operations (e.g., softmax probability computation, detection confidence estimation, similarity threshold comparison, and/or the like) that assign numerical confidence values to potential object detections, enabling the vision language model to distinguish between high-confidence detections that warrant query resolution and low-confidence detections that require continued navigation to additional spatial positions. The object presence verification can include multi-view aggregation operations (e.g., detection fusion across views, confidence pooling from multiple images, consensus-based object confirmation, and/or the like) that combine object detection results from multiple images in the multi-view image set to produce a unified determination of whether the queried object is present at the current spatial position. The object presence verification can generate a binary determination (e.g., object found or object not found, query resolved or query not resolved, provide answer or continue navigation, and/or the like) that the navigation process 404 uses to decide whether to terminate navigation and generate a final query response or to continue navigating to the next position in the ranked spatial positions 430.

Referring again to FIG. 4D, the vision language model implemented by the generative AI model 420 can generate navigation continuation decisions (e.g., continue navigation directives, proceed to next waypoint instructions, visit additional positions commands, and/or the like) when the object presence verification determines that the queried object is not present within the multi-view images captured at the current spatial position. The navigation continuation decisions can include negative determination outputs (e.g., “No answer found” statements, “Object not detected” responses, “Query not resolved” indicators, and/or the like) that inform the navigation process 404 that the current spatial position does not contain the queried object and navigation should proceed to the next position in the ranked spatial positions 430. The navigation continuation decisions can include confidence-based continuation logic (e.g., low confidence triggering continued search, ambiguous detection prompting additional views, insufficient visual coverage requiring further exploration, and/or the like) where the vision language model determines that the captured multi-view images do not provide sufficient evidence to confirm or deny the presence of the queried object with adequate certainty. The navigation continuation decisions can include the query response 462-1 depicted in FIG. 4D, which indicates that no answer was found at position A and navigation should continue to position B, demonstrating the iterative nature of the navigation process 404 where the apparatus 102 visits successive positions until the queried object is located. The navigation continuation decisions can be transmitted from the generative AI model 420 to the orchestration module 225, which coordinates the invocation of the navigation module 223 to generate the navigation instruction 440-2 directing the apparatus 102 to the next position in the ranked spatial positions 430.

With continued reference to FIG. 4D, the vision language model implemented by the generative AI model 420 can generate query resolution decisions (e.g., query satisfied determinations, object located confirmations, search complete indicators, and/or the like) when the object presence verification determines that the queried object or objects similar to the queried object are present within the multi-view images captured at the current spatial position. The query resolution decisions can include positive determination outputs (e.g., “Objects similar to Object A have been identified” statements, “Query resolved” responses, “Object located at this position” confirmations, and/or the like) that inform the navigation process 404 that the current spatial position contains the queried object and navigation should terminate. The query resolution decisions can include confidence-based resolution logic (e.g., high confidence triggering search termination, strong visual evidence confirming object presence, sufficient similarity between detected objects and query description, and/or the like) where the vision language model determines that the captured multi-view images provide adequate evidence to confirm the presence of the queried object with sufficient certainty to satisfy the requirements of the input query 460. The query resolution decisions can include the query response 462-2 depicted in FIG. 4D, which indicates that some objects similar to Object A have been identified at position B and navigation should stop, demonstrating the termination condition of the navigation process 404 where the iterative navigation loop ends upon successful object detection. The query resolution decisions can include object location information (e.g., spatial coordinates of the detected object, room identification where the object was found, relative position descriptions within the environment 100, and/or the like) that provides specific details about where the queried object was located for inclusion in the final query response transmitted to the user interface 330.

As shown in FIG. 4D, the vision language model implemented by the generative AI model 420 can perform semantic similarity assessment (e.g., embedding distance computation, feature vector comparison, conceptual relatedness scoring, and/or the like) that evaluates the degree of correspondence between objects detected in the multi-view images and the object description specified in the input query 460. The semantic similarity assessment can include object description parsing operations (e.g., extracting object attributes from the query text, identifying object category from the query, determining visual characteristics specified in the query, and/or the like) that analyze the input query 460 to determine what visual features and attributes the queried object should possess. The semantic similarity assessment can include visual feature extraction operations (e.g., computing feature embeddings for detected objects, extracting attribute vectors from object regions, generating semantic representations of visual content, and/or the like) that characterize the visual properties of objects detected within the multi-view images captured at each spatial position. The semantic similarity assessment can include similarity computation operations (e.g., cosine similarity calculation between query and object embeddings, Euclidean distance measurement in feature space, learned similarity scoring using neural network classifiers, and/or the like) that quantify the degree of match between the queried object description and each detected object in the captured images. The semantic similarity assessment can include threshold-based decision operations (e.g., comparing similarity scores against resolution thresholds, evaluating whether similarity exceeds minimum match criteria, determining whether detected objects are sufficiently similar to the queried object, and/or the like) that determine whether the similarity between detected objects and the queried object is sufficient to warrant query resolution or whether navigation should continue to search for objects with higher similarity scores.

With continued reference to FIG. 4D, the vision language model implemented by the generative AI model 420 can perform iterative refinement of query understanding (e.g., progressive query interpretation, context-aware query disambiguation, feedback-based query clarification, and/or the like) as the navigation process 404 visits successive spatial positions and captures additional environment signals. The iterative refinement can include context accumulation operations (e.g., aggregating visual observations from multiple positions, building a cumulative understanding of the environment 100, incorporating negative evidence from positions where the object was not found, and/or the like) that enable the vision language model to refine the interpretation of the input query 460 based on the visual content observed during navigation. The iterative refinement can include query disambiguation operations (e.g., narrowing object interpretation based on observed context, resolving ambiguous object references using environmental cues, adjusting search criteria based on objects detected at visited positions, and/or the like) that improve the precision of object matching as the navigation process 404 progresses through the ranked spatial positions 430. The iterative refinement can include negative evidence incorporation (e.g., excluding object types that were searched for but not found, adjusting confidence scores based on positions visited without success, updating prior beliefs about object locations based on search results, and/or the like) that enables the vision language model to learn from unsuccessful searches at earlier positions to improve object detection at subsequent positions. The iterative refinement can enable the vision language model to generate more accurate query responses as the navigation process 404 accumulates visual evidence from multiple spatial positions within the environment 100.

As further shown in FIG. 4D, the navigation process 404 can implement early termination logic (e.g., confidence-based stopping criteria, efficiency-driven search termination, resource-aware navigation limits, and/or the like) that enables the apparatus 102 to terminate navigation before visiting all positions in the ranked spatial positions 430 when sufficient evidence has been gathered to resolve the input query 460. The early termination logic can include confidence threshold evaluation (e.g., comparing detection confidence against minimum resolution thresholds, evaluating whether accumulated evidence exceeds certainty requirements, determining whether additional navigation would provide diminishing returns, and/or the like) that determines when the vision language model has gathered sufficient visual evidence to generate a reliable query response without visiting additional spatial positions. The early termination logic can include the query resolution evaluation performed by the prioritization process 402 depicted in FIG. 4D, where the decision node labeled “query resolved” evaluates the query response 462-1 or the query response 462-2 to determine whether navigation should continue or terminate. The early termination logic can include resource conservation operations (e.g., limiting navigation distance, constraining search duration, preserving battery power for continued monitoring, and/or the like) that balance the thoroughness of the search against the computational and energy costs of extended navigation through the environment 100. The early termination logic can enable the navigation process 404 to efficiently locate queried objects by terminating navigation as soon as the vision language model determines that the object has been found with sufficient confidence, as demonstrated by the termination at position B in FIG. 4D when the query response 462-2 indicates that objects similar to Object A have been identified.

Referring again to FIG. 4D, the vision language model implemented by the generative AI model 420 can generate structured query responses (e.g., formatted answer outputs, structured data responses, machine-readable result representations, and/or the like) that provide detailed information about the search results for transmission to the user interface 330 and storage in the historical signal data 257 of the computing database 204. The structured query responses can include object location fields (e.g., spatial coordinates where the object was detected, room name or identifier, relative position descriptions such as “on the counter” or “near the bed”, and/or the like) that specify where the queried object was found within the environment 100. The structured query responses can include confidence score fields (e.g., detection confidence values, similarity scores, certainty indicators, and/or the like) that quantify the reliability of the object detection and enable users to assess the trustworthiness of the search results. The structured query responses can include visual evidence fields (e.g., image references, bounding box coordinates, cropped object images, and/or the like) that provide visual documentation of the detected object for user verification. The structured query responses can include navigation summary fields (e.g., positions visited during the search, total navigation distance, search duration, and/or the like) that document the search process for logging and analysis purposes. The structured query responses can be formatted as the query response 462-2 depicted in FIG. 4D, which indicates that objects similar to Object A have been identified and navigation should stop, providing a concise summary of the search outcome that the user interface 330 can display on the display 240 for user review.

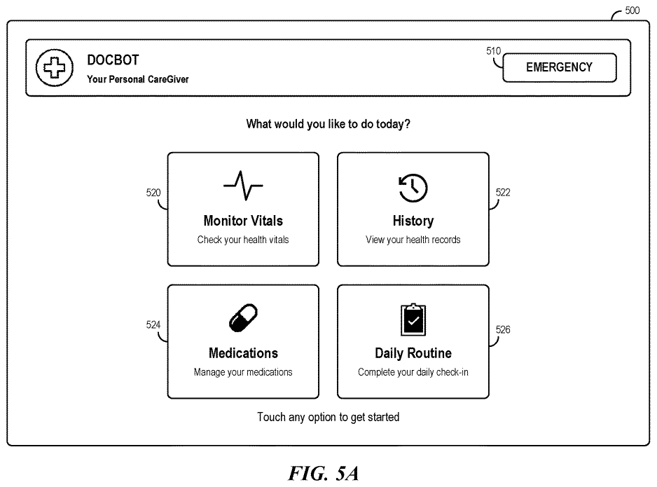

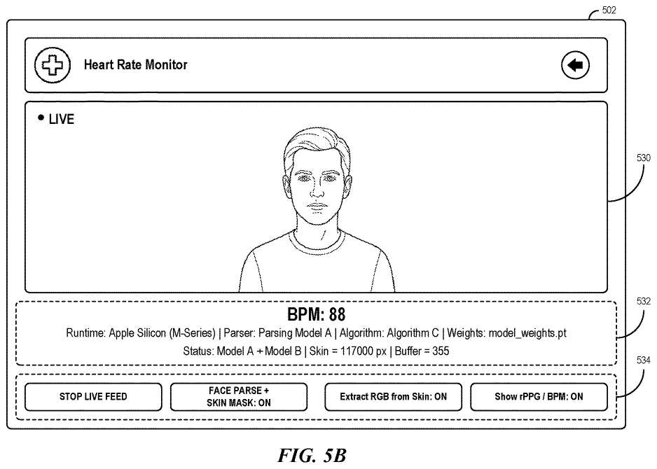

FIGS. 5A-5B are block diagrams that illustrates example user interfaces in accordance with some implementations of the present technology. Referring to FIG. 5A, an interface 500 provides a user-facing application for the signal monitoring platform 200 that enables the target signal source 104-1 (e.g., a patient, an elderly individual, a person with a medical condition, a caregiver, and/or the like) to interact with the apparatus 102 for health monitoring, medication management, and daily routine coordination within the environment 100. The interface 500 can be implemented as a personal caregiver application (e.g., a health assistant application, a patient monitoring interface, a home care coordination tool, and/or the like) labeled “DOCBOT” that presents monitoring functions, health data access, and interactive controls through the display 240 of the computing logic 202. The interface 500 can be rendered by the interface module 227 of the memory 220, which executes graphical user interface rendering routines (e.g., screen composers, widget renderers, layout managers, and/or the like) that generate visual displays presenting monitoring status, output metrics 310, historical trends, and interactive controls for the apparatus 102. The interface 500 can include a header region (e.g., a title bar, an application banner, a branding area, and/or the like) that displays the application name and provides visual identification of the personal caregiver application to users interacting with the apparatus 102. The interface 500 can include a prompt region (e.g., a greeting area, an instruction display, a guidance text section, and/or the like) that presents the text “What would you like to do today?” to guide users toward available functions and encourage interaction with the monitoring and health management features of the apparatus 102.

With continued reference to FIG. 5A, the interface 500 includes a quick action element 510 positioned in an upper right region of the interface 500 and labeled “EMERGENCY” that provides rapid access to emergency functions for the target signal source 104-1 in situations requiring immediate assistance or urgent notification. The quick action element 510 can be implemented as a prominently displayed button (e.g., a high-visibility touch target, a contrasting color button, an always-accessible control element, and/or the like) that enables single-touch activation of emergency response workflows without requiring navigation through multiple interface screens or menu hierarchies. The quick action element 510 can trigger emergency notification routines (e.g., alert transmission to designated caregivers, emergency services contact initiation, urgent status broadcast to healthcare providers, and/or the like) executed by the orchestration module 225 when the target signal source 104-1 activates the quick action element 510 through touch input on the display 240. The quick action element 510 can be configured to transmit emergency notifications through the wireless communication circuitry 230 to external devices (e.g., caregiver mobile phones, healthcare provider systems, emergency dispatch centers, family member devices, and/or the like) that are registered to receive urgent alerts from the apparatus 102. The quick action element 510 can include visual styling (e.g., red background coloring, bold text formatting, contrasting border elements, and/or the like) that distinguishes the emergency function from other interface elements and ensures immediate visual recognition by users in distress situations. The quick action element 510 can be positioned at a consistent location across all screens of the interface 500 to ensure that emergency access remains available regardless of which interface view the target signal source 104-1 is currently using, enabling rapid emergency activation from any point within the personal caregiver application.

As shown in FIG. 5A, the interface 500 includes a vitals interface 520 that provides access to health monitoring functions for capturing and displaying physiological measurements associated with the target signal source 104-1 within the environment 100. The vitals interface 520 can be implemented as a selectable option (e.g., a touch-activated card, a menu selection button, a function access tile, and/or the like) labeled “Monitor Vitals” with a subtitle “Check your health vitals” that indicates the purpose of the vitals interface 520 to users interacting with the interface 500. The vitals interface 520 can include an icon (e.g., a heart symbol, a pulse waveform graphic, a health monitoring indicator, and/or the like) positioned above the label text that provides visual identification of the health monitoring function and aids recognition by users who may have difficulty reading small text. The vitals interface 520 can provide access to real-time physiological measurement displays (e.g., current heart rate 312 readings, current temperature 314 values, current blood pressure measurements, current oxygen saturation levels, and/or the like) generated by the model ensemble 304 processing environment signals 302 captured by the sensors 306 from the target signal source 104-1. The vitals interface 520 can invoke the sensor control module 221 to activate the sensors 306 (e.g., the sensor 306-1, the sensor 306-2, the sensor 306-3, and/or the like) for capturing environment signals when the target signal source 104-1 selects the vitals interface 520, initiating a monitoring session that generates output metrics 310 indicating physiological measurements. The vitals interface 520 can display the output metrics 310 (e.g., the heart rate 312, the temperature 314, the instrument reading 316, and/or the like) in real-time as the model ensemble 304 processes captured environment signals, providing immediate feedback to the target signal source 104-1 about current health status.

With continued reference to FIG. 5A, the interface 500 includes a history interface 522 that provides access to health records and historical signal data 257 accumulated over extended time periods for the target signal source 104-1. The history interface 522 can be implemented as a selectable option (e.g., a touch-activated card, a menu selection button, a function access tile, and/or the like) labeled “History” with a subtitle “View your health records” that indicates the purpose of the history interface 522 to users seeking to review past physiological measurements and health trends. The history interface 522 can include an icon (e.g., a clock symbol, a calendar graphic, a timeline indicator, a chart symbol, and/or the like) positioned above the label text that provides visual identification of the historical data access function and aids recognition by users navigating the interface 500. The history interface 522 can retrieve time-series measurement records (e.g., heart rate logs, temperature histories, blood pressure trends, glucose level progressions, and/or the like) from the historical signal data 257 stored in the computing database 204 and present the records through visualizations (e.g., line charts showing measurement trends over time, bar graphs comparing daily averages, tabular displays of measurement values with timestamps, and/or the like) rendered by the interface module 227. The history interface 522 can enable the target signal source 104-1 to review event records (e.g., fall detection events, anomaly alerts, medication reminders, vital sign threshold crossings, and/or the like) documented in the historical signal data 257 along with timestamps, associated output metrics, and contextual information about the circumstances of each event. The history interface 522 can provide filtering and navigation controls (e.g., date range selectors, measurement type filters, event category filters, and/or the like) that enable the target signal source 104-1 to locate specific historical records within the accumulated health data.

As further shown in FIG. 5A, the interface 500 includes a medication interface 524 that provides medication management functions for tracking, scheduling, and reminding the target signal source 104-1 about medication administration within the environment 100. The medication interface 524 can be implemented as a selectable option (e.g., a touch-activated card, a menu selection button, a function access tile, and/or the like) labeled “Medications” with a subtitle “Manage your medications” that indicates the purpose of the medication interface 524 to users seeking to coordinate medication schedules and track medication adherence. The medication interface 524 can include an icon (e.g., a pill symbol, a medication bottle graphic, a prescription indicator, a capsule symbol, and/or the like) positioned above the label text that provides visual identification of the medication management function and aids recognition by users navigating the interface 500. The medication interface 524 can access medication knowledge records (e.g., drug interaction databases, dosage guidelines, administration schedules, and/or the like) stored in the ontological reference data 255 of the computing database 204 to provide medication tracking and reminder functions through the interface module 227. The medication interface 524 can enable the target signal source 104-1 to input medication information (e.g., medication names, dosage amounts, administration times, prescription details, and/or the like) that the orchestration module 225 uses to generate medication reminder notifications (e.g., the notification alert 326, and/or the like) at scheduled administration times. The medication interface 524 can track medication adherence (e.g., recording when medications are taken, logging missed doses, calculating adherence percentages, and/or the like) by storing medication administration events in the historical signal data 257 for review through the history interface 522 or for transmission to healthcare providers through the wireless communication circuitry 230.

Referring again to FIG. 5A, the interface 500 includes a schedule interface 526 that provides daily routine coordination functions for managing check-in activities, scheduled monitoring sessions, and routine health assessments for the target signal source 104-1. The schedule interface 526 can be implemented as a selectable option (e.g., a touch-activated card, a menu selection button, a function access tile, and/or the like) labeled “Daily Routine” with a subtitle “Complete your daily check-in” that indicates the purpose of the schedule interface 526 to users seeking to follow structured daily health monitoring routines. The schedule interface 526 can include an icon (e.g., a calendar symbol, a checklist graphic, a daily planner indicator, a routine schedule symbol, and/or the like) positioned above the label text that provides visual identification of the daily routine function and aids recognition by users navigating the interface 500. The schedule interface 526 can present scheduled activities (e.g., morning vital sign checks, medication administration times, exercise reminders, meal tracking prompts, and/or the like) organized by time of day that guide the target signal source 104-1 through a structured daily health monitoring routine coordinated by the orchestration module 225. The schedule interface 526 can track completion status (e.g., marking completed activities, highlighting pending tasks, indicating overdue items, and/or the like) for scheduled activities and store completion records in the historical signal data 257 for adherence tracking and trend analysis. The schedule interface 526 can generate reminder notifications (e.g., the notification alert 326, and/or the like) through the orchestration module 225 when scheduled activities approach their designated times, prompting the target signal source 104-1 to complete daily check-in tasks and health monitoring activities.

With continued reference to FIG. 5A, the interface 500 implements accessible user interface design compliant with Web Content Accessibility Guidelines 2.2 (e.g., WCAG 2.2 Level AA compliance, WCAG 2.2 Level AAA compliance, and/or the like) that ensures the personal caregiver application is usable by elderly users and users with visual impairments, motor control limitations, or cognitive challenges. The accessible user interface design can include high contrast visual styling (e.g., dark text on light backgrounds, light text on dark backgrounds, color combinations meeting minimum contrast ratios, and/or the like) that ensures text and interactive elements are clearly visible to users with reduced visual acuity or color vision deficiencies. The accessible user interface design can include simple workflow structures (e.g., single-level navigation hierarchies, direct access to primary functions, minimal steps to complete tasks, and/or the like) that reduce cognitive load and enable users with memory or attention challenges to navigate the interface 500 without becoming confused or lost within complex menu structures. The accessible user interface design can include large touch targets (e.g., buttons with minimum dimensions of 44 by 44 pixels, touch areas with adequate spacing between adjacent elements, interactive regions sized for users with reduced fine motor control, and/or the like) that enable accurate touch input by users with tremors, arthritis, or other conditions affecting hand steadiness and precision. The interface 500 can include a footer region (e.g., an instruction area, a guidance text section, a help prompt display, and/or the like) displaying instructional text reading “Touch any option to get started” that provides clear guidance to users about how to interact with the selectable options (e.g., the vitals interface 520, the history interface 522, the medication interface 524, the schedule interface 526, and/or the like) presented in the interface 500.

As shown in FIG. 5A, the interface 500 presents the vitals interface 520, the history interface 522, the medication interface 524, and the schedule interface 526 in a grid layout (e.g., a two-by-two arrangement, a card-based grid, a tile layout, and/or the like) that organizes the primary functions of the personal caregiver application into visually distinct and easily selectable regions. The grid layout can include consistent card sizing (e.g., equal dimensions for each selectable option, uniform spacing between cards, balanced visual weight across the layout, and/or the like) that creates a predictable and learnable interface structure for users who interact with the interface 500 repeatedly over extended time periods. The grid layout can include visual separation (e.g., card borders, background color differentiation, shadow effects, spacing gaps, and/or the like) between the vitals interface 520, the history interface 522, the medication interface 524, and the schedule interface 526 that prevents accidental selection of adjacent options and enables precise targeting of the intended function. The grid layout can be rendered by the interface module 227 using responsive design techniques (e.g., flexible grid systems, proportional sizing, adaptive layouts, and/or the like) that adjust the presentation of the selectable options based on the dimensions of the display 240 (e.g., the 7.1 inch touchscreen implementation, the 10.1 inch touchscreen implementation, and/or the like) to maintain usability across different display configurations. The grid layout can include icon-label pairing (e.g., icons positioned above text labels, visual symbols accompanying textual descriptions, graphical indicators reinforcing text content, and/or the like) for each selectable option that provides redundant information channels enabling users to identify functions through either visual recognition of icons or reading of text labels.

With continued reference to FIG. 5A, the interface 500 can be implemented using a PyQt5 framework (e.g., a Python binding for the Qt application framework, a cross-platform graphical user interface toolkit, a widget-based interface development library, and/or the like) for building the touchscreen graphical user interface in a first development phase of the apparatus 102. The PyQt5 framework implementation can include widget-based interface construction (e.g., QPushButton widgets for selectable options, QLabel widgets for text displays, QGridLayout containers for grid arrangements, and/or the like) that enables rapid development of the interface 500 using pre-built graphical components provided by the Qt framework. The PyQt5 framework implementation can include signal-slot connections (e.g., touch event handlers, button click callbacks, user interaction processors, and/or the like) that link user interactions with the interface 500 to corresponding functions in the orchestration module 225, the sensor control module 221, and other modules of the memory 220. The PyQt5 framework implementation can include stylesheet-based visual customization (e.g., Qt Style Sheets for appearance configuration, CSS-like styling for widget appearance, theme definitions for consistent visual presentation, and/or the like) that enables the interface module 227 to apply the high contrast visual styling and large touch target sizing required for WCAG 2.2 compliance. The PyQt5 framework implementation can execute natively on the processor 210 of the computing logic 202 without requiring network connectivity or external rendering services, enabling the interface 500 to operate in offline scenarios where the apparatus 102 is not connected to external networks through the wireless communication circuitry 230.

As further shown in FIG. 5A, the interface 500 can be implemented using a Figma design (e.g., a collaborative interface design tool, a vector graphics editor for user interface mockups, a design system platform, and/or the like) with React web application implementation (e.g., a JavaScript library for building user interfaces, a component-based web framework, a declarative user interface development toolkit, and/or the like) for the user interface in a second development phase of the apparatus 102. The Figma design implementation can include design system components (e.g., reusable button components, standardized card layouts, consistent typography definitions, color palette specifications, and/or the like) that establish visual consistency across all screens of the interface 500 and enable efficient iteration on interface designs during development. The React web application implementation can include component-based architecture (e.g., React functional components for interface elements, reusable component libraries for common widgets, hierarchical component composition for complex layouts, and/or the like) that enables modular construction of the interface 500 where the vitals interface 520, the history interface 522, the medication interface 524, and the schedule interface 526 are implemented as separate components that can be independently developed, tested, and maintained. The React web application implementation can include state management (e.g., React hooks for local state, context providers for shared state, state synchronization with the computing database 204, and/or the like) that maintains consistency between the interface 500 display and the underlying data stored in the signal data cache 256 and the historical signal data 257. The React web application implementation can be rendered through a web view component (e.g., an embedded browser widget, a Chromium-based rendering engine, a WebKit view container, and/or the like) integrated into the interface module 227 that displays the React application within the display 240 of the apparatus 102.

With continued reference to FIG. 5A, the interface 500 can be implemented using a PyQt5 framework (e.g., a Python binding for the Qt application framework, a cross-platform graphical user interface toolkit, a widget-based interface development library, and/or the like) for building the touchscreen graphical user interface in a first development phase of the apparatus 102. The PyQt5 framework implementation can include widget-based interface construction (e.g., QPushButton widgets for the quick action element 510, QLabel widgets for text displays within the vitals interface 520, QGridLayout containers for arranging the vitals interface 520, the history interface 522, the medication interface 524, and the schedule interface 526 in a grid arrangement, and/or the like) that enables rapid development of the interface 500 using pre-built graphical components provided by the Qt framework. The PyQt5 framework implementation can include signal-slot connections (e.g., touch event handlers for the quick action element 510, button click callbacks for the vitals interface 520, user interaction processors for the medication interface 524, and/or the like) that link user interactions with the interface 500 to corresponding functions in the orchestration module 225, the sensor control module 221, and other modules of the memory 220. The PyQt5 framework implementation can include stylesheet-based visual customization (e.g., Qt Style Sheets for appearance configuration of the quick action element 510, CSS-like styling for widget appearance of the vitals interface 520, theme definitions for consistent visual presentation across the history interface 522 and the schedule interface 526, and/or the like) that enables the interface module 227 to apply high contrast visual styling and large touch target sizing required for Web Content Accessibility Guidelines 2.2 compliance. The PyQt5 framework implementation can include event loop management (e.g., Qt event dispatchers, asynchronous signal processing, non-blocking user interface updates, and/or the like) that enables the interface 500 to remain responsive while the signal processing module 224 processes environment signals 302 captured by the sensors 306 and generates the output metrics 310 for display through the vitals interface 520. The PyQt5 framework implementation can execute natively on the processor 210 of the computing logic 202 without requiring network connectivity or external rendering services, enabling the interface 500 to operate in offline scenarios where the apparatus 102 is not connected to external networks through the wireless communication circuitry 230. The PyQt5 framework implementation can include accessibility features (e.g., keyboard navigation support for users who cannot use touch input, screen reader compatibility for users with visual impairments, focus indicators for tracking the currently selected interface element, and/or the like) that complement the visual accessibility design of the interface 500 to support users with diverse accessibility needs.

As further shown in FIG. 5A, the interface 500 can be implemented using a Figma design (e.g., a collaborative interface design tool, a vector graphics editor for user interface mockups, a design system platform, a cloud-based prototyping application, and/or the like) with React web application implementation (e.g., a JavaScript library for building user interfaces, a component-based web framework, a declarative user interface development toolkit, and/or the like) for the user interface in a second development phase of the apparatus 102. The Figma design implementation can include design system components (e.g., reusable button components for the quick action element 510, standardized card layouts for the vitals interface 520, consistent typography definitions for text within the history interface 522, color palette specifications for the medication interface 524 and the schedule interface 526, and/or the like) that establish visual consistency across all screens of the interface 500 and enable efficient iteration on interface designs during development. The Figma design implementation can include design tokens (e.g., color variables for high contrast themes, spacing values for touch target sizing, typography scales for readable text sizes, border radius values for rounded interface elements, and/or the like) that encode the Web Content Accessibility Guidelines 2.2 compliance requirements into reusable design parameters that the React web application implementation applies consistently across the vitals interface 520, the history interface 522, the medication interface 524, and the schedule interface 526. The React web application implementation can include component-based architecture (e.g., React functional components for the quick action element 510, reusable component libraries for the vitals interface 520 and the history interface 522, hierarchical component composition for complex layouts within the medication interface 524, and/or the like) that enables modular construction of the interface 500 where each interface element is implemented as a separate component that can be independently developed, tested, and maintained. The React web application implementation can include state management (e.g., React hooks for local state within the vitals interface 520, context providers for shared state across the medication interface 524 and the schedule interface 526, state synchronization with the computing database 204 for the historical signal data 257 displayed through the history interface 522, and/or the like) that maintains consistency between the interface 500 display and the underlying data stored in the signal data cache 256 and the historical signal data 257. The React web application implementation can include responsive design techniques (e.g., CSS media queries for adapting layouts to different display sizes, flexible grid systems for the arrangement of the vitals interface 520, the history interface 522, the medication interface 524, and the schedule interface 526, viewport-relative units for scalable touch targets, and/or the like) that adjust the presentation of the interface 500 based on the dimensions of the display 240 to maintain usability across the 7.1 inch touchscreen implementation and the 10.1 inch touchscreen implementation. The React web application implementation can be rendered through a web view component (e.g., an embedded browser widget, a Chromium-based rendering engine, a WebKit view container, an Electron application shell, and/or the like) integrated into the interface module 227 that displays the React application within the display 240 of the apparatus 102, enabling the interface 500 to leverage web technologies while executing locally on the computing logic 202.

Referring to FIG. 5B, a data interface 502 provides a specialized monitoring view within the interface module 227 that displays real-time physiological measurement data and technical configuration parameters for the signal monitoring operations performed by the apparatus 102 on the target signal source 104-1 within the environment 100. The data interface 502 can be implemented as a heart rate monitor application screen (e.g., a vital sign monitoring view, a remote photoplethysmography display interface, a cardiac measurement visualization panel, and/or the like) that presents live monitoring data alongside the technical parameters of the artificial intelligence models 258 used by the signal processing module 224 to extract physiological measurements from the environment signals 302 captured by the sensors 306. The data interface 502 can include a header region (e.g., a title bar displaying “Heart Rate Monitor”, an application banner with a medical cross icon, a navigation area with a back arrow for returning to the interface 500, and/or the like) that identifies the monitoring function and provides navigation controls for users interacting with the apparatus 102 through the display 240. The data interface 502 can be rendered by the interface module 227 using graphical user interface rendering routines (e.g., screen composers, widget renderers, layout managers, real-time data visualizers, and/or the like) that generate visual displays presenting the output metrics 310 (e.g., the heart rate 312, and/or the like) extracted from the environment signals 302 by the model ensemble 304. The data interface 502 can provide technical transparency (e.g., displaying model parameters, showing processing status, indicating algorithm configurations, revealing runtime information, and/or the like) that enables users, developers, and healthcare providers to understand the technical basis for the physiological measurements displayed by the apparatus 102.

With continued reference to FIG. 5B, the data interface 502 includes a live data region 530 that occupies a central portion of the data interface 502 and displays real-time visual feedback indicating the current monitoring state of the target signal source 104-1 within the environment 100. The live data region 530 can include a “LIVE” indicator (e.g., a text label, a status badge, a recording indicator, a real-time streaming marker, and/or the like) that signals to users that the data interface 502 is displaying current monitoring data captured in real-time by the sensors 306 rather than historical data retrieved from the historical signal data 257 stored in the computing database 204. The live data region 530 can include a simplified illustration (e.g., a human head and upper torso graphic, a silhouette representation, a body outline diagram, a target visualization, and/or the like) representing the target signal source 104-1 being monitored by the apparatus 102, providing visual confirmation that the sensors 306 have detected and are tracking the target signal source 104-1 within the field of view. The live data region 530 can display visual feedback (e.g., face detection bounding boxes, skin region highlights, region of interest indicators, tracking status overlays, and/or the like) generated by the signal processing module 224 that indicates which portions of the captured environment signals 302 are being analyzed for physiological measurement extraction. The live data region 530 can include real-time video feed display (e.g., streaming camera output, processed frame visualization, annotated image sequences, and/or the like) from the sensor 206-1 that shows the actual visual environment signals being captured and processed by the model ensemble 304 for heart rate extraction using remote photoplethysmography techniques. The live data region 530 can update continuously (e.g., at frame rates matching the sensor capture rate, at display refresh intervals, at processing pipeline output rates, and/or the like) as the sensor control module 221 captures new environment signals and the signal processing module 224 processes the captured data through the artificial intelligence models 258.

As shown in FIG. 5B, the data interface 502 includes a model configuration section 532 positioned below the live data region 530 that displays technical parameters and status information for the artificial intelligence models 258 and processing pipelines used by the signal processing module 224 to extract physiological measurements from the environment signals 302. The model configuration section 532 can display the current heart rate reading (e.g., “BPM: 88” indicating beats per minute, a numerical pulse rate value, a cardiac frequency measurement, and/or the like) extracted from the environment signals 302 by the model ensemble 304 using remote photoplethysmography processing logic (e.g., color channel extractors, bandpass filters, peak detectors, frequency domain analyzers, and/or the like) that detects subtle color variations in skin regions of the target signal source 104-1 caused by blood volume changes during cardiac cycles. The model configuration section 532 can display runtime information (e.g., “Apple Silicon (M-Series)” indicating the processor architecture, hardware platform identification, computational backend specification, and/or the like) that identifies the hardware platform 810 on which the artificial intelligence models 258 are executing, enabling users to understand the computational resources available for signal processing operations. The model configuration section 532 can display parser designation (e.g., “Parsing Model A” indicating the face detection or segmentation model, preprocessing pipeline identifier, input parsing algorithm specification, and/or the like) that identifies which parsing model from the artificial intelligence models 258 is being used to detect and segment the face region of the target signal source 104-1 from the captured environment signals 302. The model configuration section 532 can display algorithm identification (e.g., “Algorithm C” indicating the remote photoplethysmography algorithm, signal extraction method identifier, heart rate estimation technique specification, and/or the like) that identifies which algorithm from the model ensemble 304 is being used to extract the heart rate 312 from the parsed skin regions.

With continued reference to FIG. 5B, the model configuration section 532 displays additional technical parameters that provide detailed insight into the signal processing pipeline configuration and current processing state of the apparatus 102. The model configuration section 532 can display weights file reference (e.g., “model_weights.pt” indicating the PyTorch model weights file, trained parameter storage location, neural network weight specification, and/or the like) that identifies the specific trained model parameters loaded from the artificial intelligence models 258 stored in the computing database 204 for execution by the processor 210. The model configuration section 532 can display status information (e.g., “Model A+Model B” indicating active model combination, pipeline stage status, processing chain configuration, and/or the like) that shows which models from the model ensemble 304 are currently active and processing the environment signals 302 in the signal processing pipeline. The model configuration section 532 can display skin pixel count (e.g., “117000 px” indicating the number of detected skin pixels, segmented region size, analysis area measurement, and/or the like) that quantifies the amount of skin region detected within the captured environment signals 302, where larger skin pixel counts generally indicate higher quality signal extraction conditions for remote photoplethysmography processing. The model configuration section 532 can display buffer values (e.g., “355” indicating frame buffer count, signal accumulation depth, temporal window size, and/or the like) that show the current state of the signal data cache 256 used by the signal processing module 224 to accumulate environment signals over time periods for temporal analysis operations (e.g., heart rate extraction from color variation sequences, respiratory rate estimation from motion patterns, and/or the like). The model configuration section 532 can be updated by the interface module 227 in real-time as the signal processing module 224 processes environment signals and the model maintenance module 226 manages the active model configurations.

As further shown in FIG. 5B, the data interface 502 includes a control panel 534 positioned at a bottom portion of the data interface 502 that provides interactive controls for managing signal capture and processing operations performed by the apparatus 102 on the target signal source 104-1. The control panel 534 can include a plurality of interactive buttons (e.g., touch-activated controls, toggle switches, function activation elements, processing control widgets, and/or the like) that enable users to start, stop, and configure the signal monitoring operations executed by the sensor control module 221 and the signal processing module 224. The control panel 534 can include a “STOP LIVE FEED” button (e.g., a capture termination control, a streaming stop button, a monitoring pause element, and/or the like) that enables users to halt the real-time capture of environment signals 302 by the sensors 306 when monitoring is no longer needed or when the user wishes to conserve computational resources. The control panel 534 can include a “FACE PARSE+SKIN MASK: ON” button (e.g., a face detection toggle, a skin segmentation control, a parsing pipeline switch, and/or the like) that enables users to activate or deactivate the face parsing and skin masking operations performed by the signal processing module 224 using the parsing model identified in the model configuration section 532. The control panel 534 can include an “Extract RGB from Skin: ON” button (e.g., a color channel extraction toggle, an RGB signal extraction control, a photoplethysmography input switch, and/or the like) that enables users to activate or deactivate the extraction of red, green, and blue color channel signals from the segmented skin regions for remote photoplethysmography processing. The control panel 534 can include a “Show rPPG/BPM: ON” button (e.g., a heart rate display toggle, a remote photoplethysmography output control, a BPM visualization switch, and/or the like) that enables users to activate or deactivate the display of the extracted heart rate 312 and remote photoplethysmography waveforms in the data interface 502.

Referring again to FIG. 5B, the control panel 534 provides user controls for managing the signal capture and processing operations of the monitoring system through touch input on the display 240 processed by the interface module 227. The control panel 534 can implement toggle button functionality (e.g., binary state switches, on/off controls, activation/deactivation toggles, and/or the like) where each button in the control panel 534 maintains a current state (e.g., “ON” or “OFF”, “ACTIVE” or “INACTIVE”, “ENABLED” or “DISABLED”, and/or the like) that is visually indicated through button styling (e.g., color changes, text label updates, icon modifications, and/or the like) and persisted in the computing database 204 for restoration when the data interface 502 is reopened. The control panel 534 can transmit control commands (e.g., the capture instruction 340, processing configuration updates, pipeline control signals, and/or the like) to the sensor control module 221 and the signal processing module 224 when users interact with the buttons, causing the corresponding signal capture or processing operations to be started, stopped, or reconfigured based on the user input. The control panel 534 can include visual feedback mechanisms (e.g., button press animations, state change confirmations, processing status indicators, and/or the like) that provide immediate confirmation to users that their control inputs have been received and processed by the apparatus 102. The control panel 534 can implement accessibility features (e.g., large touch targets meeting Web Content Accessibility Guidelines 2.2 requirements, high contrast button styling, clear text labels, and/or the like) that ensure the interactive controls are usable by elderly users and users with visual impairments or motor control limitations interacting with the apparatus 102 through the display 240.

With continued reference to FIG. 5B, the data interface 502 can be implemented using a PyQt5 framework (e.g., a Python binding for the Qt application framework, a cross-platform graphical user interface toolkit, a widget-based interface development library, and/or the like) for building the touchscreen graphical user interface that displays the live data region 530, the model configuration section 532, and the control panel 534. The PyQt5 framework implementation can include widget-based interface construction (e.g., QLabel widgets for displaying the “LIVE” indicator and the BPM reading in the model configuration section 532, QPushButton widgets for the interactive buttons in the control panel 534, QVBoxLayout containers for arranging the live data region 530 above the model configuration section 532 and the control panel 534, and/or the like) that enables rapid development of the data interface 502 using pre-built graphical components provided by the Qt framework. The PyQt5 framework implementation can include signal-slot connections (e.g., button click handlers for the control panel 534 buttons, timer-triggered update slots for refreshing the live data region 530, data binding connections for updating the model configuration section 532 values, and/or the like) that link user interactions and data updates to corresponding functions in the sensor control module 221, the signal processing module 224, and the interface module 227. The PyQt5 framework implementation can include real-time update mechanisms (e.g., QTimer-based periodic refresh, signal-driven data updates, asynchronous display synchronization, and/or the like) that enable the live data region 530 and the model configuration section 532 to display current monitoring data without blocking the user interface event loop or causing interface responsiveness degradation. The PyQt5 framework implementation can include stylesheet-based visual customization (e.g., Qt Style Sheets for button appearance in the control panel 534, CSS-like styling for the model configuration section 532 text formatting, theme definitions for consistent visual presentation across the data interface 502, and/or the like) that enables the interface module 227 to apply high contrast visual styling and readable text formatting for the technical parameters displayed in the model configuration section 532.

With continued reference to FIG. 5B, the data interface 502 can display a live data region 530 region that provides real-time visual feedback indicating the current monitoring state of the target signal source 104-1 through pose estimation operations performed by the signal processing module 224 using skeletal keypoint detection techniques (e.g., MediaPipe pose detection, OpenPose keypoint extraction, BlazePose landmark estimation, and/or the like) that identify anatomical landmarks on the body of the target signal source 104-1 from the environment signals 302 captured by the sensors 306. The skeletal keypoint detection can identify a plurality of landmarks (e.g., 33 landmarks corresponding to body joints and reference points, keypoints for head, shoulders, elbows, wrists, hips, knees, ankles, and extremities, anatomical reference positions distributed across the full body, and/or the like) that represent the spatial positions of body parts within the captured visual environment signals, enabling the signal processing module 224 to construct a skeletal representation of the target signal source 104-1 for posture analysis and activity recognition. The live data region 530 can display the detected skeletal keypoints (e.g., overlaid point markers on the video feed, connected line segments forming a stick figure representation, color-coded joint indicators, and/or the like) that provide visual confirmation to users that the apparatus 102 has successfully detected and is tracking the body pose of the target signal source 104-1 within the field of view of the sensor 206-1 and the sensor 206-2. The skeletal keypoint detection can operate in real-time (e.g., at frame rates matching the sensor capture rate, with latency suitable for continuous monitoring, at processing speeds enabling responsive pose tracking, and/or the like) as the sensor control module 221 captures new environment signals and the signal processing module 224 processes the captured data through pose estimation models stored in the artificial intelligence models 258 of the computing database 204.

As shown in FIG. 5B, the signal processing module 224 can classify body postures of the target signal source 104-1 using the skeletal keypoint positions detected from the environment signals 302 to determine the current activity state (e.g., standing posture, sitting posture, walking motion, limping gait, sleeping position, fall state, and/or the like) of the target signal source 104-1 within the environment 100. The posture classification can include standing detection (e.g., identifying vertical torso orientation, detecting extended leg positions, recognizing upright body alignment, and/or the like) where the signal processing module 224 analyzes the relative positions of the detected skeletal keypoints to determine whether the target signal source 104-1 is in an upright standing position. The posture classification can include sitting detection (e.g., identifying bent knee angles, detecting lowered hip positions, recognizing seated torso orientation, and/or the like) where the signal processing module 224 analyzes joint angles and body segment positions to determine whether the target signal source 104-1 is in a seated position on furniture (e.g., a chair, a couch, a bed edge, and/or the like) within the environment 100. The posture classification can include walking detection (e.g., identifying alternating leg motion patterns, detecting forward body displacement, recognizing gait cycle phases, and/or the like) where the signal processing module 224 analyzes temporal sequences of skeletal keypoint positions to determine whether the target signal source 104-1 is engaged in ambulatory motion. The posture classification can include sleeping detection (e.g., identifying horizontal body orientation, detecting recumbent positions, recognizing prone or supine postures, and/or the like) where the signal processing module 224 analyzes the overall body orientation to determine whether the target signal source 104-1 is lying down on a bed or other surface within the environment 100. The posture classification results can be displayed in the live data region 530 region of the data interface 502 and stored in the historical signal data 257 of the computing database 204 for activity tracking and trend analysis.

With continued reference to FIG. 5B, the signal processing module 224 can calculate geometric features (e.g., angular measurements, distance ratios, spatial relationships, body segment orientations, and/or the like) from the detected skeletal keypoints to enable accurate posture classification and gait analysis for the target signal source 104-1. The geometric feature calculation can include torso angle computation (e.g., calculating the angle between the shoulder-hip line segment and the vertical axis, measuring the inclination of the upper body relative to gravity, determining the forward lean or backward tilt of the torso, and/or the like) where the signal processing module 224 uses the positions of shoulder keypoints and hip keypoints to determine the orientation of the torso segment. The geometric feature calculation can include knee angle computation (e.g., calculating the interior angle at the knee joint formed by the thigh and lower leg segments, measuring the degree of knee flexion or extension, determining the bend angle during sitting or walking, and/or the like) where the signal processing module 224 uses the positions of hip keypoints, knee keypoints, and ankle keypoints to determine the angle at each knee joint. The geometric feature calculation can include hip angle computation (e.g., calculating the interior angle at the hip joint formed by the torso and thigh segments, measuring the degree of hip flexion or extension, determining the leg lift angle during walking, and/or the like) where the signal processing module 224 uses the positions of shoulder keypoints, hip keypoints, and knee keypoints to determine the angle at each hip joint. The geometric feature calculation can include leg interior angle computation (e.g., calculating the angle between the left leg and right leg segments, measuring the stance width during standing, determining the leg spread during walking phases, and/or the like) where the signal processing module 224 uses the positions of hip keypoints and ankle keypoints to determine the angular separation between the legs. The geometric feature calculation can include leg elongation ratio computation (e.g., calculating the ratio of current leg length to reference leg length, measuring the apparent leg extension during gait phases, determining the vertical displacement of hip relative to ankle, and/or the like) where the signal processing module 224 uses the positions of hip keypoints and ankle keypoints to determine the elongation state of each leg during walking motion.

As further shown in FIG. 5B, the signal processing module 224 can detect limping gait patterns in the target signal source 104-1 using Trendelenburg gait sign analysis (e.g., hip drop detection during stance phase, pelvic tilt measurement during walking, contralateral hip elevation assessment, and/or the like) that identifies asymmetric hip motion indicative of weakness or dysfunction in the hip abductor muscles. The Trendelenburg gait sign analysis can include hip drop detection (e.g., measuring the vertical displacement of the contralateral hip during single-leg stance, calculating the pelvic tilt angle relative to horizontal, identifying asymmetric hip elevation patterns between left and right gait cycles, and/or the like) where the signal processing module 224 analyzes the positions of left hip keypoints and right hip keypoints during walking to detect abnormal pelvic motion. The Trendelenburg gait sign analysis can include stance phase identification (e.g., detecting when one foot is in contact with the ground while the other foot is in swing phase, identifying the single-leg support period during gait, recognizing the weight-bearing phase of each leg, and/or the like) where the signal processing module 224 analyzes the temporal sequence of ankle keypoint positions to determine the gait phase for each leg. The Trendelenburg gait sign analysis can include asymmetry quantification (e.g., calculating the difference in hip drop magnitude between left and right stance phases, measuring the deviation from normal pelvic motion patterns, determining the severity of gait asymmetry, and/or the like) where the signal processing module 224 compares the hip motion characteristics during left-leg stance and right-leg stance to identify limping patterns. The limping detection results can be stored in the historical signal data 257 of the computing database 204 and can trigger the notification alert 326 through the orchestration module 225 when limping patterns are detected that exceed threshold values indicating potential mobility impairment or injury in the target signal source 104-1.

Referring again to FIG. 5B, the signal processing module 224 can perform fall detection using multimodal fusion (e.g., combining pose estimation data with ambient sound analysis, integrating visual motion detection with acoustic event recognition, fusing skeletal keypoint trajectories with audio impact signatures, and/or the like) that combines information from multiple sensor modalities to improve the accuracy and reliability of fall event detection for the target signal source 104-1 within the environment 100. The multimodal fusion for fall detection can include pose-based fall indicators (e.g., rapid vertical displacement of torso keypoints, sudden transition from upright to horizontal body orientation, loss of skeletal keypoint tracking followed by detection of prone position, and/or the like) where the signal processing module 224 analyzes the temporal trajectory of skeletal keypoints to detect motion patterns characteristic of falling events. The multimodal fusion for fall detection can include sound-based fall indicators (e.g., impact sounds detected by microphones of the actuated sensor assembly 260, acoustic signatures of body contact with floor surfaces, vocalization patterns associated with fall events such as exclamations or calls for help, and/or the like) where the signal processing module 224 analyzes audio environment signals captured by the sensor 306-3 to detect acoustic events correlated with falling. The multimodal fusion for fall detection can include fusion logic (e.g., weighted combination of pose-based and sound-based confidence scores, temporal correlation analysis between visual and acoustic fall indicators, decision-level fusion using learned classifiers, and/or the like) where the signal processing module 224 combines the evidence from multiple modalities to generate a unified fall detection determination with higher accuracy than either modality alone. The fall detection results can trigger immediate notification alerts (e.g., the notification alert 326 transmitted to caregivers, emergency contact notifications, urgent status broadcasts to healthcare providers, and/or the like) through the orchestration module 225 when fall events are detected, enabling rapid response to potential injuries sustained by the target signal source 104-1.

With continued reference to FIG. 5B, the signal processing module 224 can perform three-dimensional human pose estimation using diffusion-based optimization techniques (e.g., Zero-shot Diffusion-based Optimization referred to as ZeDO, iterative pose refinement using diffusion models, optimization-based pose estimation with learned pose priors, and/or the like) that combine optimization-based methods with pre-trained diffusion models to estimate three-dimensional body poses from two-dimensional keypoint observations without requiring paired two-dimensional to three-dimensional training data for the specific deployment environment. The diffusion-based optimization can include a pre-trained diffusion model (e.g., a score matching network trained on three-dimensional pose datasets, a denoising diffusion probabilistic model learning pose distributions, a denoising diffusion implicit model for pose generation, and/or the like) that learns the distribution of valid three-dimensional human poses satisfying kinematic constraints of the human body, enabling the model to generate anatomically plausible poses during the optimization process. The diffusion-based optimization can include an iterative optimization loop (e.g., alternating between pose projection and diffusion-based denoising, progressively refining pose estimates through multiple iterations, converging toward poses that minimize re-projection error while satisfying kinematic constraints, and/or the like) where the signal processing module 224 iteratively updates the three-dimensional pose estimate by projecting the current estimate to minimize two-dimensional re-projection error and then applying the diffusion model to ensure the projected pose remains within the learned distribution of valid poses. The diffusion-based optimization can enable zero-shot pose estimation (e.g., estimating poses without training on paired data from the deployment environment, generalizing to new camera configurations without fine-tuning, adapting to different subjects without subject-specific training, and/or the like) where the signal processing module 224 can estimate three-dimensional poses for the target signal source 104-1 using only the pre-trained diffusion model and the two-dimensional keypoints detected from the environment signals 302 captured by the sensor 206-1.

With continued reference to FIG. 5B, the diffusion-based optimization implemented by the signal processing module 224 can include a score matching diffusion model (e.g., a neural network trained to estimate score functions of pose distributions, a gradient field estimator for pose likelihood, a noise-conditioned score network, and/or the like) that learns the distribution of valid three-dimensional human poses and enables reconstruction of poses by minimizing re-projection error with two-dimensional keypoints detected from the environment signals 302 captured by the sensor 206-1. The score matching diffusion model can learn the three-dimensional pose distribution (e.g., the probability density of anatomically valid poses, the manifold of kinematically feasible body configurations, the statistical distribution of human poses observed in training datasets, and/or the like) by training on datasets of three-dimensional human poses (e.g., Human3.6M dataset, MPI-INF-3DHP dataset, 3DPW dataset, and/or the like) that provide ground truth three-dimensional joint positions for diverse human activities and body configurations. The score matching diffusion model can reconstruct poses by minimizing re-projection error (e.g., calculating the difference between projected three-dimensional keypoints and observed two-dimensional keypoints, computing the pixel-wise distance between predicted and detected joint locations, measuring the alignment between the three-dimensional pose projection and the two-dimensional pose observation, and/or the like) where the signal processing module 224 iteratively adjusts the three-dimensional pose estimate to reduce the discrepancy between the projected pose and the two-dimensional keypoints detected from the environment signals 302. The score matching diffusion model can provide pose prior information (e.g., learned constraints on valid pose configurations, implicit regularization toward anatomically plausible poses, guidance toward poses within the learned distribution, and/or the like) that prevents the optimization process from converging to invalid poses that minimize re-projection error but violate kinematic constraints of the human body.

As shown in FIG. 5B, the diffusion-based optimization implemented by the signal processing module 224 can include an initial pose optimizer (e.g., a rotation optimization module, a translation estimation component, a pose initialization processor, and/or the like) that finds an optimal rotation matrix and translation by minimizing re-projection error before the iterative optimization process begins. The initial pose optimizer can find the optimal rotation matrix (e.g., a three-by-three orthogonal matrix representing the orientation of the initial pose relative to the camera coordinate frame, a rotation transformation aligning the initial pose with the observed two-dimensional keypoints, a yaw-pitch-roll rotation parameterization optimized to minimize projection error, and/or the like) by searching over rotation parameters to identify the rotation that best aligns the initial three-dimensional pose with the two-dimensional keypoints detected from the environment signals 302. The initial pose optimizer can find the optimal translation (e.g., a three-dimensional displacement vector positioning the initial pose in camera coordinates, a depth and lateral offset placing the pose at the correct distance and position relative to the camera, a translation minimizing the re-projection error of the rotated initial pose, and/or the like) by computing the translation that positions the rotated initial pose such that the projected keypoints align with the observed two-dimensional keypoints. The initial pose optimizer can minimize re-projection error (e.g., computing the sum of squared distances between projected and observed keypoints, calculating the weighted re-projection loss using keypoint confidence scores, optimizing the rotation and translation parameters using gradient descent or closed-form solutions, and/or the like) to generate an optimized initial pose that serves as the starting point for the iterative diffusion-based optimization process. The initial pose optimizer can operate during a warmup phase (e.g., first iterations of the optimization process, an initialization period before diffusion-based refinement begins, a preliminary optimization stage establishing a reliable starting pose, and/or the like) where the signal processing module 224 focuses on finding a good initial alignment before applying the diffusion model for pose refinement.

With continued reference to FIG. 5B, the diffusion-based optimization implemented by the signal processing module 224 can use truncated diffusion model inference (e.g., a modified inference procedure with reduced timestamp range, a shortened diffusion process for denoising optimized poses, a truncated reverse diffusion schedule, and/or the like) with timestamp truncated to a range of zero to 0.1 instead of the full training range of zero to 1 for denoising optimized poses generated during the iterative optimization process. The truncated diffusion model inference can address the distribution mismatch (e.g., the difference between standard Gaussian noise used during training and the optimized pose noise characteristics during inference, the discrepancy between random noise initialization and structured pose initialization, the gap between training-time noise levels and inference-time pose perturbations, and/or the like) that arises because the diffusion model is trained to denoise poses starting from standard Gaussian noise but during inference the model receives optimized poses that do not follow the standard Gaussian distribution. The truncated timestamp range (e.g., sampling timestamps from the interval zero to 0.1 instead of zero to 1, using only the final portion of the reverse diffusion process, applying low-noise denoising steps appropriate for near-valid poses, and/or the like) can ensure that the diffusion model applies appropriate denoising operations for poses that are already close to valid configurations rather than applying high-noise denoising operations designed for heavily corrupted inputs. The truncated diffusion model inference can enable the diffusion model to refine optimized poses (e.g., correcting minor kinematic violations in the projected pose, adjusting joint positions to satisfy learned pose constraints, smoothing pose estimates toward the learned pose distribution, and/or the like) without introducing excessive modifications that could disrupt the alignment achieved through re-projection error minimization.

As further shown in FIG. 5B, the signal processing module 224 can use a K-Means clustering algorithm (e.g., a centroid-based clustering method, a partitioning algorithm for pose space segmentation, an unsupervised learning technique for identifying representative poses, and/or the like) to select anchor poses from a training set as initial poses for multi-hypothesis three-dimensional pose estimation that improves accuracy by considering multiple possible pose interpretations of the observed two-dimensional keypoints. The K-Means clustering algorithm can partition the training pose dataset (e.g., dividing the set of three-dimensional poses from Human3.6M or other training datasets into clusters based on pose similarity, grouping poses with similar joint configurations into the same cluster, segmenting the pose space into regions represented by cluster centroids, and/or the like) into a specified number of clusters where each cluster represents a distinct region of the pose space containing similar pose configurations. The K-Means clustering algorithm can select anchor poses (e.g., choosing the cluster centroid poses as representative initial poses, selecting the most central pose from each cluster as an anchor, identifying poses that best represent each region of the pose space, and/or the like) that serve as diverse starting points for the multi-hypothesis optimization process, ensuring that the initial poses cover different regions of the pose space and increase the likelihood that at least one initial pose is close to the true pose of the target signal source 104-1. The multi-hypothesis three-dimensional pose estimation can run the diffusion-based optimization process (e.g., executing parallel optimization from multiple initial poses, performing independent pose refinement for each anchor pose, generating multiple pose hypotheses through separate optimization trajectories, and/or the like) starting from each anchor pose selected by the K-Means clustering algorithm, generating multiple pose estimates that the signal processing module 224 can evaluate to select the best estimate based on re-projection error or other quality metrics. The number of hypotheses (e.g., 1 hypothesis for single-hypothesis estimation, 10 hypotheses for moderate multi-hypothesis estimation, 50 hypotheses for comprehensive multi-hypothesis estimation, and/or the like) can be configured based on the desired trade-off between pose estimation accuracy and computational cost, where larger numbers of hypotheses generally improve accuracy but require more processing time on the processor 210.

Referring again to FIG. 5B, the data interface 502 can display a model configuration section 532 that provides technical parameters and status information for the three-dimensional pose estimation pipeline implemented by the signal processing module 224 using the diffusion-based optimization techniques. The model configuration section 532 can display pose estimation model parameters (e.g., the number of optimization iterations such as 1000 iterations, the timestamp truncation range such as zero to 0.1, the number of pose hypotheses such as 50 hypotheses, the warmup iteration count such as 200 iterations, and/or the like) that configure the behavior of the diffusion-based optimization process for three-dimensional pose estimation from the environment signals 302 captured by the sensors 306. The model configuration section 532 can display pose estimation quality metrics (e.g., mean per joint position error values, Procrustes-aligned mean per joint position error values, percentage of correct keypoints, area under the curve metrics, and/or the like) that indicate the accuracy of the three-dimensional pose estimates generated by the signal processing module 224 for the target signal source 104-1. The model configuration section 532 can display diffusion model information (e.g., the diffusion backbone type such as score matching network or denoising diffusion implicit model, the training dataset used for the pose generation model, the model architecture parameters, and/or the like) that identifies which diffusion model from the artificial intelligence models 258 stored in the computing database 204 is being used for pose prior enforcement during the optimization process. The model configuration section 532 can display initial pose selection information (e.g., the K-Means cluster count, the anchor pose identifiers, the initial pose sampling strategy, and/or the like) that indicates how the signal processing module 224 selects initial poses for the multi-hypothesis optimization process.

With continued reference to FIG. 5B, the control panel 534 can provide interactive controls for configuring the three-dimensional pose estimation operations performed by the signal processing module 224 on the target signal source 104-1 within the environment 100. The control panel 534 can include a pose estimation toggle button (e.g., a “3D Pose Estimation: ON” control, a pose tracking activation switch, a skeletal reconstruction enable button, and/or the like) that enables users to activate or deactivate the three-dimensional pose estimation pipeline, allowing the apparatus 102 to conserve computational resources when pose estimation is not needed for the current monitoring objectives. The control panel 534 can include a hypothesis count selector (e.g., a numerical input for specifying the number of pose hypotheses, a slider control for adjusting multi-hypothesis settings, a dropdown menu for selecting hypothesis count presets, and/or the like) that enables users to configure the number of initial poses used in the multi-hypothesis optimization process based on the desired balance between accuracy and processing speed. The control panel 534 can include an iteration count control (e.g., a numerical input for specifying the number of optimization iterations, a slider for adjusting convergence settings, a preset selector for iteration count configurations, and/or the like) that enables users to configure the number of iterations in the diffusion-based optimization loop, where higher iteration counts generally improve pose accuracy but increase processing latency. The control panel 534 can include a pose visualization toggle (e.g., a “Show 3D Skeleton: ON” control, a skeletal overlay display switch, a pose rendering enable button, and/or the like) that enables users to activate or deactivate the display of the estimated three-dimensional pose as a skeletal overlay on the live data region 530 region of the data interface 502.

As shown in FIG. 5B, the data interface 502 can be implemented using a PyQt5 framework (e.g., a Python binding for the Qt application framework, a cross-platform graphical user interface toolkit, a widget-based interface development library, and/or the like) that provides the graphical components for displaying the pose estimation results and configuration parameters in the live data region 530 region and the model configuration section 532 section. The PyQt5 framework implementation for pose estimation display can include three-dimensional rendering widgets (e.g., QOpenGLWidget for hardware-accelerated skeletal rendering, PyQtGraph three-dimensional visualization components, custom OpenGL-based pose display widgets, and/or the like) that render the estimated three-dimensional pose of the target signal source 104-1 as a skeletal representation overlaid on the video feed or displayed in a separate three-dimensional view. The PyQt5 framework implementation can include real-time update mechanisms (e.g., QTimer-based periodic refresh of pose estimates, signal-driven updates when new pose estimates are available, asynchronous display synchronization with the signal processing module 224 output, and/or the like) that enable the live data region 530 region to display current pose estimation results without blocking the user interface event loop or causing interface responsiveness degradation. The PyQt5 framework implementation can include configuration widgets (e.g., QSpinBox widgets for numerical parameter input in the model configuration section 532, QSlider widgets for continuous parameter adjustment, QComboBox widgets for preset selection, and/or the like) that enable users to modify pose estimation parameters through the control panel 534 and observe the effects on the displayed pose estimates in real-time.

With continued reference to FIG. 5B, the data interface 502 can alternatively be implemented using a React web application (e.g., a JavaScript library for building user interfaces, a component-based web framework, a declarative user interface development toolkit, and/or the like) with WebGL-based three-dimensional rendering for displaying the pose estimation results on the display 240 of the apparatus 102. The React web application implementation can include Three.js integration (e.g., a JavaScript three-dimensional library for WebGL rendering, a scene graph-based three-dimensional visualization framework, a cross-platform three-dimensional graphics library, and/or the like) that provides hardware-accelerated rendering of the estimated three-dimensional pose as a skeletal mesh or line-based representation within the live data region 530 region of the data interface 502. The React web application implementation can include state management (e.g., React hooks for local pose estimation state, context providers for sharing pose data across components, Redux or similar state management libraries for complex state synchronization, and/or the like) that maintains consistency between the pose estimation results generated by the signal processing module 224 and the visual representation displayed in the data interface 502. The React web application implementation can include responsive design techniques (e.g., CSS media queries for adapting the pose visualization to different display sizes, flexible layout systems for the model configuration section 532 and control panel 534 arrangement, viewport-relative sizing for touch targets in the control panel 534, and/or the like) that adjust the presentation of the data interface 502 based on the dimensions of the display 240 to maintain usability across the 7.1 inch touchscreen implementation and the 10.1 inch touchscreen implementation. The React web application implementation can be rendered through a web view component (e.g., an embedded Chromium browser, a WebKit-based rendering engine, an Electron application shell, and/or the like) integrated into the interface module 227 that displays the React application within the display 240 of the apparatus 102.

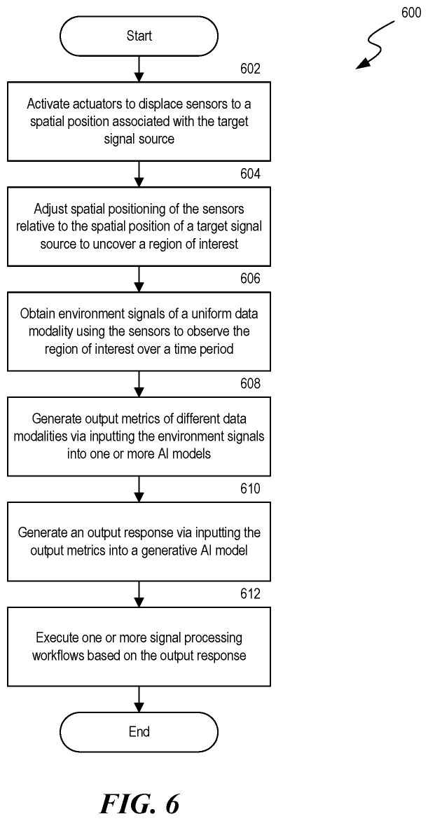

FIG. 6 is a flow diagram that illustrates an example process 600 for adaptive multi-modal signal monitoring in accordance with some implementations of the disclosed technology. The process 600 (e.g., a computer-implemented method) can be performed by a system (e.g., the signal monitoring platform 200, the apparatus 102, and/or the like) configured to capture environment signals from a target signal source within a physical environment, transform the captured environment signals into output metrics indicating physiological measurements using artificial intelligence models, and generate responses and control instructions based on the output metrics for continued monitoring operations. In one example, the system includes at least one hardware processor (e.g., the processor 210, and/or the like) and at least one non-transitory memory (e.g., the memory 220, and/or the like) storing instructions, which, when executed by the at least one hardware processor, cause the system to perform the process 600. In another example, the system includes a non-transitory, computer-readable storage medium including instructions recorded thereon, which, when executed by at least one data processor, cause the system to perform the process 600. The process 600 can implement a closed-loop monitoring architecture (e.g., a feedback control system, a continuous monitoring pipeline, an iterative data processing workflow, and/or the like) where the system captures environment signals, processes the environment signals through artificial intelligence models to generate output metrics, and uses the output metrics to generate responses and control instructions that feed back to sensors and actuators for continued monitoring operations within the environment 100.

At step 602, the signal monitoring platform 200 can activate actuators (e.g., the actuator 208-3, the actuator 208-4, the actuator 208-5 of the displacement assembly 270, and/or the like) to displace sensors (e.g., the sensor 206-1, the sensor 206-2, and/or the like) to a spatial position (e.g., the spatial location 106-1, the spatial location 106-2, and/or the like) associated with the target signal source 104-1 within the environment 100. The step 602 can include generating navigation instructions (e.g., the navigation instruction 440, destination coordinates, path specifications, velocity parameters, and/or the like) that direct the displacement assembly 270 to move the apparatus 102 from a current spatial position to a target spatial position where the sensors can capture environment signals from the target signal source 104-1. The step 602 can include executing path planning algorithms (e.g., A-star pathfinding, rapidly-exploring random trees, potential field methods, and/or the like) through the navigation module 223 that compute traversable routes from the current spatial position to the target spatial position while avoiding obstacles represented in the spatial mappings 251 stored in the computing database 204. The step 602 can include activating drive motors (e.g., brushless direct current motors, geared motors, hub motors, and/or the like) of the displacement assembly 270 that provide rotational power to locomotion elements (e.g., wheels, legs, tracks, and/or the like) to propel the apparatus 102 across floor surfaces within the environment 100. The step 602 can include monitoring position feedback (e.g., encoder readings, potentiometer samples, limit switch states, and/or the like) through the actuator control module 222 to verify that the apparatus 102 has arrived at the target spatial position associated with the target signal source 104-1.

In some implementations, the step 602 can include retrieving spatial mappings (e.g., the spatial mappings 251, floor plan representations, occupancy grids, topological maps, and/or the like) from the computing database 204 that represent the layout of the environment 100 and enable the navigation module 223 to plan traversable routes for displacing the apparatus 102 to the spatial position associated with the target signal source 104-1. The step 602 can include generating ordered sequences of key spatial positions (e.g., waypoints, intermediate positions, navigation checkpoints, and/or the like) from an initial spatial position to a final spatial position that the apparatus 102 follows when navigating to the target signal source 104-1. The step 602 can include executing localization routines (e.g., simultaneous localization and mapping algorithms, visual odometry processors, sensor fusion filters, and/or the like) through the navigation module 223 that determine the current spatial position of the apparatus 102 within the environment 100 by processing environment signals from sensors and comparing observed features to the spatial mappings 251. The step 602 can include implementing obstacle avoidance capabilities (e.g., proximity sensors, collision detection systems, path replanning algorithms, and/or the like) that enable the apparatus 102 to navigate around furniture, walls, and other obstacles within the environment 100 while moving to the spatial position associated with the target signal source 104-1.

With continued reference to FIG. 6, the step 602 can include following the target signal source 104-1 throughout the environment 100 by continuously updating the target spatial position as the target signal source 104-1 moves between different rooms and locations within the physical space. The step 602 can include executing target tracking routines (e.g., Kalman filter trackers, particle filter estimators, motion predictors, and/or the like) through the navigation module 223 that track the position of the target signal source 104-1 as the target signal source 104-1 moves within the environment 100 and update navigation plans to maintain proximity to the target signal source 104-1 for continuous monitoring. The step 602 can include using combined vision and sound triangulation (e.g., multi-modal sensor fusion, audio-visual localization, cross-modal position estimation, and/or the like) that determines the spatial position of the target signal source 104-1 within the environment 100 by combining visual triangulation from stereo cameras with audio triangulation from microphone arrays of the actuated sensor assembly 260. The step 602 can enable the apparatus 102 to accompany the target signal source 104-1 continuously (e.g., 24 hours per day, 7 days per week, and/or the like) to provide persistent health monitoring as the target signal source 104-1 moves throughout the environment 100.

At step 604, the signal monitoring platform 200 can adjust spatial positioning of the sensors (e.g., the sensor 206-1, the sensor 206-2, and/or the like) relative to the spatial position of the target signal source 104-1 to uncover a region of interest (e.g., a face region for heart rate estimation, a torso region for respiratory monitoring, a limb region for gait analysis, a full body region for pose estimation, and/or the like) corresponding to the target signal source 104-1. The step 604 can include activating actuators (e.g., the actuator 208-1, the actuator 208-2 of the actuated sensor assembly 260, and/or the like) that adjust the orientation of the sensors to track the target signal source 104-1 and maintain the target signal source 104-1 within the field of view of the sensors. The step 604 can include rotating the actuated sensor assembly 260 about a vertical axis (e.g., a yaw axis, a pan axis, an azimuth axis, and/or the like) using the actuator 208-1 to orient the sensors toward the target signal source 104-1 as the target signal source 104-1 moves within the environment 100. The step 604 can include tilting the actuated sensor assembly 260 about a horizontal axis (e.g., a pitch axis, a tilt axis, an elevation axis, and/or the like) using the actuator 208-2 to adjust the vertical angle of the sensors based on whether the target signal source 104-1 is standing, sitting, or lying down. The step 604 can include generating trajectory commands (e.g., motion profile specifications, acceleration limits, jerk controllers, and/or the like) through the actuator control module 222 that compute smooth motion trajectories for actuator movements to minimize vibration and ensure stable sensor positioning during environment signal capture.

In some implementations, the step 604 can include determining the region of interest on the target signal source 104-1 based on the type of physiological measurements being captured and the monitoring objectives specified by the orchestration module 225. The step 604 can include identifying face regions (e.g., forehead areas, cheek regions, skin surfaces suitable for remote photoplethysmography, and/or the like) when the monitoring objective includes heart rate extraction from subtle color variations in skin caused by blood volume changes during cardiac cycles. The step 604 can include identifying body regions (e.g., full body silhouettes, skeletal landmark areas, limb segments, and/or the like) when the monitoring objective includes pose estimation and gait analysis for detecting mobility impairments or neurodegenerative disease indicators. The step 604 can include identifying thermal regions (e.g., forehead surfaces, inner canthus of the eye, exposed skin areas, and/or the like) when the monitoring objective includes body temperature measurement using thermal sensors of the actuated sensor assembly 260. The step 604 can include adjusting sensor positioning to capture the region of interest from viewing angles (e.g., frontal views for face detection, lateral views for gait analysis, overhead views for fall detection, and/or the like) that provide reliable environment signals for the specific physiological measurements being extracted.

With continued reference to FIG. 6, the step 604 can include detecting displacement of the target signal source 104-1 from a first spatial position to a second spatial position within the environment 100 and re-adjusting spatial positioning of the sensors relative to the second spatial position to continue uncovering the region of interest. The step 604 can include executing coordinated motion logic (e.g., multi-axis interpolators, synchronized movement controllers, kinematic solvers, and/or the like) through the actuator control module 222 that coordinates the movement of the actuator 208-1 and the actuator 208-2 to achieve compound movements for tracking the target signal source 104-1 as the target signal source 104-1 moves within the environment 100. The step 604 can include implementing patient tracking by rotating the actuated sensor assembly 260 to listen to and follow the target signal source 104-1 using combined vision and sound triangulation that determines the direction and distance of the target signal source 104-1 from the apparatus 102. The step 604 can include maintaining continuous observation of the region of interest as the target signal source 104-1 transitions between different postures (e.g., standing to sitting, sitting to lying down, lying down to standing, and/or the like) by adjusting the tilt angle of the actuated sensor assembly 260 to compensate for changes in the vertical position of the region of interest.

At step 606, the signal monitoring platform 200 can obtain, via activating the sensors (e.g., the sensor 206-1, the sensor 206-2, the sensor 306-1, the sensor 306-2, the sensor 306-3, and/or the like) over a time period, environment signals (e.g., the environment signals 302, the environment signal 302-1, the environment signal 302-2, the environment signal 302-3, and/or the like) of a uniform data modality (e.g., digital images, video frames, thermal readings, audio waveforms, and/or the like) indicating physical features of the region of interest corresponding to the target signal source 104-1. The step 606 can include executing sensor initialization routines (e.g., power-on sequences, calibration procedures, configuration loading operations, and/or the like) through the sensor control module 221 that prepare sensors for data capture operations by establishing communication interfaces, setting capture parameters, and verifying sensor functionality. The step 606 can include capturing visual environment signals (e.g., RGB image frames, grayscale image frames, high-dynamic-range image frames, and/or the like) at frame rates suitable for physiological measurement extraction (e.g., approximately 100 frames per second on-device capture, approximately 25 frames per second after network transfer for processing, and/or the like) using the sensor 206-1 and the sensor 206-2. The step 606 can include capturing thermal environment signals (e.g., temperature maps, infrared intensity arrays, thermal gradient representations, and/or the like) using thermal sensors of the actuated sensor assembly 260 that encode temperature values for each pixel location within the field of view. The step 606 can include capturing audio environment signals (e.g., pulse-code modulation samples, compressed audio streams, multi-channel audio recordings, and/or the like) using microphones of the actuated sensor assembly 260 that encode sound pressure variations over time.

In some implementations, the step 606 can include capturing environment signals without physical contact with the target signal source 104-1 using non-contact sensing techniques (e.g., remote photoplethysmography, thermal imaging, visual pose estimation, acoustic monitoring, and/or the like) that enable the apparatus 102 to obtain physiological measurements from a distance. The step 606 can include coordinating the timing of environment signal capture across multiple sensors using capture timing logic (e.g., frame rate controllers, sampling schedulers, synchronization mechanisms, and/or the like) through the sensor control module 221 to ensure that environment signals from the sensor 206-1 and the sensor 206-2 are captured simultaneously for stereo vision processing and depth calculation. The step 606 can include configuring sensor operating parameters (e.g., resolution settings, exposure values, gain adjustments, and/or the like) using sensor mode selection logic through the sensor control module 221 based on environmental conditions (e.g., lighting levels, distance to target signal source, motion characteristics, and/or the like) and the type of physiological measurements being captured. The step 606 can include storing captured environment signals in the signal data cache 256 of the computing database 204 using data acquisition routines (e.g., frame grabbers, buffer managers, data packetizers, and/or the like) that retrieve captured data from sensor hardware for subsequent processing by the signal processing module 224.

With continued reference to FIG. 6, the step 606 can include implementing a universal visual-based measurement approach for capturing instrument readings from medical devices (e.g., blood pressure monitors, glucose meters, pulse oximeters, thermometers, cholesterol meters, and/or the like) within the environment 100 that display measurement readings in visual form. The step 606 can include positioning the sensors to capture visual images of display screens (e.g., liquid crystal displays, light-emitting diode displays, seven-segment displays, and/or the like) on medical devices that present measurement readings as numerical digits, waveform graphs, or indicator bars. The step 606 can include navigating the apparatus 102 to the spatial location 106-2 associated with the candidate signal source 104-2 (e.g., medical instruments, health monitoring devices, medication dispensers, and/or the like) when the orchestration module 225 determines that environment signals from the candidate signal source 104-2 are needed to complement signals captured from the target signal source 104-1. The step 606 can enable the signal monitoring platform 200 to integrate measurement data from a wide variety of medical devices without requiring manufacturers to provide digital data interfaces or application programming interfaces, as the signal monitoring platform 200 reads measurement information by capturing images of display screens and using visual interpretation to extract readings.

At step 608, the signal monitoring platform 200 can generate output metrics (e.g., the output metrics 310, the heart rate 312, the temperature 314, the instrument reading 316, and/or the like) of data modalities different from the uniform data modality via inputting the environment signals into one or more artificial intelligence models (e.g., the artificial intelligence models 258, the model ensemble 304, and/or the like). The step 608 can include loading artificial intelligence models from the computing database 204 into the memory 220 using model loading routines (e.g., weight deserializers, graph loaders, runtime initializers, and/or the like) through the model maintenance module 226 for execution by the processor 210 during signal processing operations. The step 608 can include executing image processing routines (e.g., face detection algorithms, skin segmentation processors, region of interest extractors, and/or the like) through the signal processing module 224 that analyze visual environment signals to identify and isolate regions of the target signal source 104-1 relevant to physiological measurement extraction. The step 608 can include executing remote photoplethysmography processing logic (e.g., color channel extractors, bandpass filters, peak detectors, frequency domain analyzers, and/or the like) through the signal processing module 224 that processes sequences of visual environment signals to extract subtle color variations in skin regions caused by blood volume changes, enabling non-contact heart rate estimation from the target signal source 104-1. The step 608 can include executing thermal processing routines (e.g., temperature mappers, hotspot detectors, body region segmenters, emissivity correction algorithms, and/or the like) through the signal processing module 224 that analyze thermal environment signals to extract body temperature measurements from the target signal source 104-1.

In some implementations, the step 608 can include executing pose estimation routines (e.g., skeletal keypoint detectors, joint angle calculators, body segment trackers, and/or the like) through the signal processing module 224 that analyze visual environment signals to estimate the three-dimensional pose of the target signal source 104-1 for gait analysis and fall detection applications. The step 608 can include detecting a plurality of landmarks (e.g., 33 landmarks corresponding to body joints and reference points, keypoints for head, shoulders, elbows, wrists, hips, knees, ankles, and extremities, anatomical reference positions distributed across the full body, and/or the like) that represent the spatial positions of body parts within the captured visual environment signals, enabling the signal processing module 224 to construct a skeletal representation of the target signal source 104-1 for posture analysis and activity recognition. The step 608 can include calculating geometric features (e.g., torso angle computation, knee angle computation, hip angle computation, leg interior angle computation, leg elongation ratio computation, and/or the like) from the detected skeletal keypoints to enable accurate posture classification and gait analysis for the target signal source 104-1. The step 608 can include executing optical character recognition routines (e.g., text region detectors, character classifiers, digit recognizers, and/or the like) through the signal processing module 224 that extract numerical readings from displays of medical instruments captured in visual environment signals from the candidate signal source 104-2.

With continued reference to FIG. 6, the step 608 can include monitoring gait characteristics (e.g., walking speed measurements, stride length calculations, support time durations, stride-to-stride variability metrics, cadence values, and/or the like) of the target signal source 104-1 for disease detection applications using the pose estimation routines executed by the signal processing module 224. The step 608 can include extracting walking speed (e.g., meters per second, distance traveled per unit time, velocity of forward progression, and/or the like) from temporal sequences of skeletal keypoint positions by calculating the displacement of the target signal source 104-1 over time periods during ambulatory motion. The step 608 can include extracting stride length (e.g., distance between successive heel strikes of the same foot, step length measurements, gait cycle distance, and/or the like) from the positions of ankle keypoints detected during walking to quantify the spatial extent of each gait cycle. The step 608 can include extracting support time (e.g., duration of single-leg stance phase, time spent with one foot in contact with the ground, weight-bearing period for each leg, and/or the like) from the temporal analysis of ankle keypoint positions to quantify the balance and stability characteristics of the gait pattern. The step 608 can include extracting stride-to-stride variability (e.g., coefficient of variation in stride length, standard deviation of gait cycle timing, consistency metrics across successive strides, and/or the like) from multiple gait cycles to quantify the regularity and predictability of the walking pattern. The step 608 can include extracting cadence (e.g., steps per minute, gait cycle frequency, walking rhythm, and/or the like) from the temporal sequence of detected footfalls to quantify the pace of ambulatory motion.

As further shown in FIG. 6, the step 608 can include detecting limping gait patterns in the target signal source 104-1 using Trendelenburg gait sign analysis (e.g., hip drop detection during stance phase, pelvic tilt measurement during walking, contralateral hip elevation assessment, and/or the like) that identifies asymmetric hip motion indicative of weakness or dysfunction in the hip abductor muscles. The step 608 can include measuring the vertical displacement of the contralateral hip during single-leg stance (e.g., calculating the pelvic tilt angle relative to horizontal, identifying asymmetric hip elevation patterns between left and right gait cycles, quantifying the magnitude of hip drop during weight-bearing phases, and/or the like) where the signal processing module 224 analyzes the positions of left hip keypoints and right hip keypoints during walking to detect abnormal pelvic motion. The step 608 can include identifying stance phase periods (e.g., detecting when one foot is in contact with the ground while the other foot is in swing phase, identifying the single-leg support period during gait, recognizing the weight-bearing phase of each leg, and/or the like) where the signal processing module 224 analyzes the temporal sequence of ankle keypoint positions to determine the gait phase for each leg. The step 608 can include quantifying gait asymmetry (e.g., calculating the difference in hip drop magnitude between left and right stance phases, measuring the deviation from normal pelvic motion patterns, determining the severity of gait asymmetry, and/or the like) where the signal processing module 224 compares the hip motion characteristics during left-leg stance and right-leg stance to identify limping patterns indicative of mobility impairment or injury.

Referring again to FIG. 6, the step 608 can include executing diffusion-based optimization techniques (e.g., Zero-shot Diffusion-based Optimization referred to as ZeDO, iterative pose refinement using diffusion models, optimization-based pose estimation with learned pose priors, and/or the like) through the signal processing module 224 that combine optimization-based methods with pre-trained diffusion models to estimate three-dimensional body poses from two-dimensional keypoint observations without requiring paired two-dimensional to three-dimensional training data for the specific deployment environment. The step 608 can include loading a pre-trained diffusion model (e.g., a score matching network trained on three-dimensional pose datasets, a denoising diffusion probabilistic model learning pose distributions, a denoising diffusion implicit model for pose generation, and/or the like) from the artificial intelligence models 258 stored in the computing database 204 that learns the distribution of valid three-dimensional human poses satisfying kinematic constraints of the human body. The step 608 can include executing an iterative optimization loop (e.g., alternating between pose projection and diffusion-based denoising, progressively refining pose estimates through multiple iterations, converging toward poses that minimize re-projection error while satisfying kinematic constraints, and/or the like) where the signal processing module 224 iteratively updates the three-dimensional pose estimate by projecting the current estimate to minimize two-dimensional re-projection error and then applying the diffusion model to ensure the projected pose remains within the learned distribution of valid poses. The step 608 can include using truncated diffusion model inference (e.g., a modified inference procedure with reduced timestamp range, a shortened diffusion process for denoising optimized poses, a truncated reverse diffusion schedule with timestamp range of zero to 0.1 instead of zero to 1, and/or the like) that addresses the distribution mismatch between training-time noise levels and inference-time pose perturbations.

With continued reference to FIG. 6, the step 608 can include using a K-Means clustering algorithm (e.g., a centroid-based clustering method, a partitioning algorithm for pose space segmentation, an unsupervised learning technique for identifying representative poses, and/or the like) to select anchor poses from a training set as initial poses for multi-hypothesis three-dimensional pose estimation that improves accuracy by considering multiple possible pose interpretations of the observed two-dimensional keypoints. The step 608 can include partitioning the training pose dataset (e.g., dividing the set of three-dimensional poses from Human3.6M or other training datasets into clusters based on pose similarity, grouping poses with similar joint configurations into the same cluster, segmenting the pose space into regions represented by cluster centroids, and/or the like) into a specified number of clusters where each cluster represents a distinct region of the pose space containing similar pose configurations. The step 608 can include selecting anchor poses (e.g., choosing the cluster centroid poses as representative initial poses, selecting the most central pose from each cluster as an anchor, identifying poses that best represent each region of the pose space, and/or the like) that serve as diverse starting points for the multi-hypothesis optimization process, ensuring that the initial poses cover different regions of the pose space and increase the likelihood that at least one initial pose is close to the true pose of the target signal source 104-1. The step 608 can include running the diffusion-based optimization process (e.g., executing parallel optimization from multiple initial poses, performing independent pose refinement for each anchor pose, generating multiple pose hypotheses through separate optimization trajectories, and/or the like) starting from each anchor pose selected by the K-Means clustering algorithm, generating multiple pose estimates that the signal processing module 224 can evaluate to select the best estimate based on re-projection error or other quality metrics.

At step 610, the signal monitoring platform 200 can generate an output response (e.g., the query response 324, alphanumeric signals, formatted reports, summary statements, diagnostic assessments, and/or the like) via inputting the output metrics 310 into a generative AI model (e.g., the generative AI model 320, a large language model, a transformer-based language model, an instruction-tuned model, a medical domain model, and/or the like) that processes the output metrics 310 along with contextual information to generate responses, alerts, and control instructions for the signal monitoring lifecycle 300. The step 610 can include loading the generative AI model from the artificial intelligence models 258 stored in the computing database 204 into the memory 220 using model loading routines (e.g., weight deserializers, graph loaders, runtime initializers, and/or the like) through the model maintenance module 226 for execution by the processor 210 during response generation operations. The step 610 can include augmenting the generative AI model using retrieval-augmented generation techniques (e.g., document retrieval pipelines, context injection methods, knowledge base queries, and/or the like) that supplement model inputs with relevant medical knowledge, patient history, and measurement data retrieved from the ontological reference data 255 and the historical signal data 257 stored in the computing database 204. The step 610 can include executing the generative AI model locally on the processor 210 of the signal monitoring platform 200 using graphics processing unit acceleration (e.g., NVIDIA Jetson Thor GPU processing, tensor core acceleration, parallel inference execution, and/or the like) to perform inference operations without transmitting personal health information to external cloud servers. The step 610 can include generating metric deviation scores (e.g., differences between current measurements and baseline values, z-scores relative to historical distributions, percentage deviations from normal ranges, and/or the like) for the output metrics 310 that indicate degrees of deviation between the output metrics 310 and a physiological baseline associated with the target signal source 104-1.

In some implementations, the step 610 can include receiving an input query (e.g., the input query 322, natural language questions, voice commands, text requests, and/or the like) from the user interface 330 that provides a natural language request or instruction from a user (e.g., the target signal source 104-1, a caregiver, a healthcare provider, and/or the like) interacting with the signal monitoring platform 200. The step 610 can include processing the input query through query processing routines (e.g., natural language parsers, intent classifiers, parameter extractors, and/or the like) executed by the orchestration module 225 that determine the monitoring operations and data retrieval actions needed to generate responses to the input query. The step 610 can include inputting the output metrics 310 and the input query into the generative AI model to generate an alphanumeric signal (e.g., text responses, formatted answers, descriptive statements, health status summaries, and/or the like) that responds to the input query based on the physiological measurements extracted from the environment signals 302 captured by the sensors 306. The step 610 can include generating explanatory content (e.g., interpretations of measurement values, comparisons to physiological baselines, trend descriptions, potential health implications, and/or the like) that contextualizes the output metrics 310 within the health history and medical knowledge relevant to the target signal source 104-1. The step 610 can include generating recommendations (e.g., suggestions to consult a healthcare provider, lifestyle modification advice, medication reminders, activity suggestions, and/or the like) based on analysis of the output metrics 310 and patterns detected in the historical signal data 257.

With continued reference to FIG. 6, the step 610 can include generating the notification alert 326 that indicates required maintenance or attention regarding the target signal source 104-1 when the output metrics 310 deviate from expected physiological baselines. The step 610 can include comparing the metric deviation scores against tolerance threshold values (e.g., predefined deviation limits, configurable alert thresholds, clinically significant change thresholds, and/or the like) through alert generation routines (e.g., threshold comparators, deviation calculators, notification formatters, and/or the like) executed by the orchestration module 225 to determine when notification alerts should be generated. The step 610 can include transmitting the notification alert 326 to the user interface 330 for immediate display on the display 240, and can also include transmitting the notification alert 326 through the wireless communication circuitry 230 to external devices (e.g., caregiver mobile phones, healthcare provider systems, emergency services, family member devices, and/or the like) when the severity of the alert warrants external notification. The step 610 can include assigning priority levels (e.g., informational alerts, warning alerts, urgent alerts, emergency alerts, and/or the like) to the notification alert 326 that determine the presentation style (e.g., visual prominence, auditory signals, vibration patterns, and/or the like) and notification routing (e.g., local display only, caregiver notification, emergency services contact, and/or the like) for each alert based on the magnitude of the metric deviation scores and the type of physiological measurement involved.

As further shown in FIG. 6, the step 610 can include training the gait analysis AI model (e.g., a neural network classifier, a recurrent neural network for temporal pattern analysis, a convolutional neural network for gait feature extraction, and/or the like) to predict potential neurodegenerative diseases (e.g., Alzheimer's disease, Parkinson's disease, dementia, and/or the like) from continuous gait pattern monitoring performed by the signal processing module 224 on the target signal source 104-1 within the environment 100. The step 610 can include analyzing gait characteristics (e.g., walking speed measurements, stride length calculations, support time durations, stride-to-stride variability metrics, cadence values, and/or the like) extracted during the step 608 to identify patterns indicative of early-stage neurodegenerative conditions that manifest as subtle changes in gait before other clinical symptoms become apparent. The step 610 can include comparing current gait characteristics against historical gait data stored in the historical signal data 257 to detect progressive changes (e.g., gradual slowing of walking speed, increasing stride-to-stride variability, decreasing stride length over time, and/or the like) that correlate with neurodegenerative disease progression. The step 610 can include generating disease risk assessments (e.g., probability scores for Parkinson's disease, likelihood indicators for dementia onset, risk factors for Alzheimer's disease, and/or the like) based on the gait analysis AI model processing the extracted gait characteristics and comparing the characteristics against patterns learned from clinical datasets of patients with confirmed neurodegenerative diagnoses. The step 610 can include recommending clinical evaluation (e.g., suggesting consultation with a neurologist, recommending cognitive assessment testing, advising follow-up with a healthcare provider, and/or the like) when the disease risk assessments exceed threshold values indicating elevated likelihood of neurodegenerative conditions.

Referring again to FIG. 6, the step 610 can include generating output responses that incorporate longitudinal health metric analytics (e.g., trend analysis over extended time periods, pattern recognition across weeks or months of data, progressive change detection, seasonal variation analysis, and/or the like) to track health patterns of the target signal source 104-1 over extended time periods stored in the historical signal data 257 of the computing database 204. The step 610 can include analyzing time-series measurement records (e.g., heart rate logs spanning multiple weeks, temperature histories over months, blood pressure trends across seasons, glucose level progressions over years, and/or the like) to identify gradual changes in physiological baselines that indicate evolving health conditions or responses to treatments. The step 610 can include generating trend visualizations (e.g., line charts showing measurement trends over time, bar graphs comparing weekly or monthly averages, statistical summaries of measurement distributions, and/or the like) that the interface module 227 presents through the display 240 to enable the target signal source 104-1 and healthcare providers to understand long-term health trajectories. The step 610 can include detecting anomalous patterns (e.g., sudden deviations from established baselines, cyclical variations correlating with medication schedules, progressive deterioration trends, and/or the like) in the longitudinal data that warrant clinical attention or adjustment of care plans. The step 610 can include generating periodic health summaries (e.g., weekly health reports, monthly trend assessments, quarterly progress evaluations, and/or the like) that aggregate the output metrics 310 and longitudinal analytics into comprehensive reports for review by the target signal source 104-1, caregivers, or healthcare providers.

With continued reference to FIG. 6, the step 610 can include supporting Electronic Health Record integration (e.g., EHR data exchange, clinical workflow integration, healthcare information system connectivity, and/or the like) with secure data transmission (e.g., encrypted communication channels, Health Insurance Portability and Accountability Act compliant data transfer, secure socket layer connections, and/or the like) for clinical workflow integration that enables healthcare providers to access the output metrics 310 and longitudinal health data generated by the signal monitoring platform 200. The step 610 can include formatting the output metrics 310 and historical signal data 257 according to healthcare data standards (e.g., Health Level Seven International standards, Fast Healthcare Interoperability Resources specifications, Continuity of Care Document formats, and/or the like) that enable interoperability with Electronic Health Record systems used by healthcare providers. The step 610 can include transmitting formatted health data through the wireless communication circuitry 230 to healthcare provider systems (e.g., hospital information systems, clinic Electronic Health Record platforms, physician practice management systems, and/or the like) using secure communication protocols (e.g., Transport Layer Security encryption, certificate-based authentication, secure application programming interface connections, and/or the like) that protect the confidentiality of personal health information during transmission. The step 610 can include implementing consent-based data sharing controls (e.g., user authorization requirements, selective data sharing permissions, granular access controls, and/or the like) that enable the target signal source 104-1 to control which output metrics 310 and historical data are shared with healthcare providers while maintaining local storage as the default for personal health information.

As shown in FIG. 6, the step 610 can include generating output responses that incorporate future advanced features including blood oxygen saturation estimation (e.g., SpO2 measurement, oxygen saturation percentage calculation, pulse oximetry equivalent readings, and/or the like) via infrared sensing and stereo vision (e.g., infrared camera imaging, near-infrared light absorption analysis, multi-wavelength optical sensing, stereo depth-enhanced tissue analysis, and/or the like) that enable non-contact measurement of blood oxygenation levels from the target signal source 104-1. The step 610 can include analyzing infrared environment signals (e.g., near-infrared reflectance patterns, infrared absorption characteristics, multi-spectral imaging data, and/or the like) captured by infrared sensors of the actuated sensor assembly 260 to detect variations in light absorption that correlate with blood oxygen saturation levels in tissue of the target signal source 104-1. The step 610 can include combining infrared analysis with stereo vision depth information (e.g., tissue depth estimation, surface geometry compensation, viewing angle correction, and/or the like) from the sensor 206-1 and the sensor 206-2 to improve the accuracy of blood oxygen saturation estimation by accounting for tissue thickness and surface orientation variations. The step 610 can include generating blood oxygen saturation output metrics (e.g., SpO2 percentage values, oxygen saturation trend data, hypoxia risk indicators, and/or the like) that the generative AI model incorporates into health assessments and alert generation when oxygen saturation levels fall below threshold values indicating potential respiratory or cardiovascular concerns.

At step 612, the signal monitoring platform 200 can execute one or more signal processing workflows (e.g., monitoring continuation workflows, alert response workflows, data storage workflows, model update workflows, navigation workflows, and/or the like) based on the output response generated by the generative AI model at the step 610. The step 612 can include executing workflow scheduling logic (e.g., task schedulers, priority queues, event dispatchers, and/or the like) through the orchestration module 225 that determines the sequence and timing of subsequent monitoring operations based on the output response, monitoring objectives, signal quality requirements, and the current state of the apparatus 102 within the environment 100. The step 612 can include generating the capture instruction 340 (e.g., sensor activation commands, capture parameter settings, region of interest specifications, and/or the like) that is provided to the sensors 306 to control data capture operations for continued monitoring of the target signal source 104-1 based on the output response indicating that additional environment signals are needed. The step 612 can include generating the actuation instruction 342 (e.g., positioning commands, navigation commands, tracking commands, and/or the like) that is provided to the actuators 308 to control spatial positioning and displacement of the sensors 306 relative to the target signal source 104-1 based on the output response indicating that sensor repositioning or apparatus navigation is required. The step 612 can include storing the output metrics 310 and the output response in the historical signal data 257 of the computing database 204 using data storage workflows (e.g., time-series record insertion, event logging, session summary generation, and/or the like) that accumulate monitoring data over extended time periods for longitudinal analysis and model personalization.

In some implementations, the step 612 can include executing closed-loop control logic (e.g., feedback controllers, adaptive schedulers, quality monitors, and/or the like) through the orchestration module 225 that adjusts monitoring operations based on the quality of captured environment signals and the correspondence between captured signals and the physiological measurements being monitored. The step 612 can include evaluating signal quality scores (e.g., the signal quality score generated at the step 608, correspondence threshold values, minimum confidence levels, data completeness metrics, and/or the like) to determine whether the environment signals captured at the step 606 provide sufficient information for reliable physiological measurement extraction. The step 612 can include initiating navigation to the candidate signal source 104-2 (e.g., medical instruments, health monitoring devices, medication dispensers, and/or the like) when the signal quality scores indicate that environment signals from the target signal source 104-1 do not satisfy correspondence threshold values and complementary signals from the candidate signal source 104-2 are needed to generate complete output metrics 310. The step 612 can include adjusting sensor configurations (e.g., modifying capture parameters, changing sensor orientations, selecting different sensor combinations, and/or the like) based on the output response indicating that current sensor settings are not optimal for the monitoring objectives. The step 612 can include returning to the step 602 to displace the apparatus 102 to a new spatial position when the output response indicates that the current position does not provide adequate viewing angles or proximity for capturing environment signals from the target signal source 104-1.

With continued reference to FIG. 6, the step 612 can include executing model update workflows (e.g., model retraining procedures, parameter adaptation routines, personalization updates, and/or the like) through the model maintenance module 226 that update the artificial intelligence models 258 based on the output metrics 310 and historical signal data 257 accumulated during monitoring operations. The step 612 can include retrieving prior output metrics (e.g., historical heart rate measurements, previous temperature readings, past pose estimations, earlier gait analysis results, and/or the like) from the historical signal data 257 that indicate physiological measurements associated with the target signal source 104-1 at prior timestamps. The step 612 can include retraining the generative AI model using the prior output metrics and the current output metrics 310 through model adaptation routines (e.g., low-rank adaptation processors, retrieval-augmented generation configurators, fine-tuning executors, and/or the like) that update the artificial intelligence models 258 to become personalized to the physiological characteristics of the target signal source 104-1 over time. The step 612 can include updating physiological baselines (e.g., personalized baseline values, trend shift markers, seasonal adjustment factors, and/or the like) stored in the ontological reference data 255 based on the accumulated output metrics 310 to enable the orchestration module 225 to adapt metric deviation score calculations to account for gradual changes in the health status of the target signal source 104-1. The step 612 can include storing model training data (e.g., labeled measurement samples, validated output metrics, corrected predictions, and/or the like) in the historical signal data 257 for use by the model maintenance module 226 in subsequent model retraining operations.

As further shown in FIG. 6, the step 612 can include executing alert response workflows (e.g., emergency notification procedures, caregiver alert transmission, healthcare provider notification, escalation protocols, and/or the like) through the orchestration module 225 when the output response generated at the step 610 indicates that the metric deviation scores exceed tolerance threshold values requiring immediate attention or intervention for the target signal source 104-1. The alert response workflows can include transmitting the notification alert 326 through the wireless communication circuitry 230 to external devices (e.g., caregiver mobile phones, family member smartphones, healthcare provider paging systems, emergency dispatch centers, and/or the like) using secure communication protocols (e.g., Transport Layer Security encryption, certificate-based authentication, encrypted messaging services, and/or the like) that protect the confidentiality of personal health information during transmission. The alert response workflows can include activating local notification mechanisms (e.g., audible alarms through speakers of the actuated sensor assembly 260, visual alerts on the display 240, vibration patterns for tactile feedback, and/or the like) that immediately inform the target signal source 104-1 and nearby individuals about the detected health concern. The alert response workflows can include logging alert events (e.g., recording alert timestamps, storing associated output metrics 310, documenting alert severity levels, capturing contextual information about the circumstances, and/or the like) in the historical signal data 257 of the computing database 204 for subsequent review by healthcare providers and for trend analysis of alert frequency and patterns. The alert response workflows can include initiating follow-up monitoring sequences (e.g., increased measurement frequency, additional sensor activation, enhanced tracking of the target signal source 104-1, and/or the like) that provide more detailed observation of the target signal source 104-1 following detection of concerning metric deviations.

With continued reference to FIG. 6, the step 612 can include executing navigation workflows (e.g., position update procedures, waypoint traversal sequences, target tracking operations, obstacle avoidance maneuvers, and/or the like) through the navigation module 223 when the output response generated at the step 610 indicates that the apparatus 102 should navigate to a different spatial position within the environment 100 to capture additional environment signals or to follow the target signal source 104-1 as the target signal source 104-1 moves between locations. The navigation workflows can include updating the spatial position data 252 stored in the computing database 204 to reflect the current position of the target signal source 104-1 detected through the environment signals 302 captured at the step 606, enabling the navigation module 223 to maintain accurate tracking of the target signal source 104-1 within the environment 100. The navigation workflows can include generating updated navigation instructions (e.g., revised destination coordinates, modified path specifications, adjusted velocity parameters, and/or the like) that direct the displacement assembly 270 to move the apparatus 102 to positions that provide improved viewing angles or closer proximity to the target signal source 104-1 for enhanced environment signal capture. The navigation workflows can include executing obstacle avoidance maneuvers (e.g., path replanning around detected obstacles, velocity reduction near furniture, careful navigation through doorways, and/or the like) that enable the apparatus 102 to navigate safely within the environment 100 while following the target signal source 104-1 or moving to the candidate signal source 104-2. The navigation workflows can include returning to the step 602 to initiate a new navigation sequence when the output response indicates that the current spatial position of the apparatus 102 is not suitable for the monitoring objectives specified by the orchestration module 225.

Referring again to FIG. 6, the step 612 can include executing data synchronization workflows (e.g., backup procedures, data replication operations, selective sharing transmissions, archive management routines, and/or the like) through the wireless communication circuitry 230 that enable the signal monitoring platform 200 to share selected output metrics 310 and historical signal data 257 with external systems while maintaining local storage as the default for personal health information. The data synchronization workflows can include formatting the output metrics 310 and historical signal data 257 according to healthcare data standards (e.g., Health Level Seven International standards, Fast Healthcare Interoperability Resources specifications, Continuity of Care Document formats, Clinical Document Architecture templates, and/or the like) that enable interoperability with Electronic Health Record systems used by healthcare providers for clinical documentation and care coordination. The data synchronization workflows can include implementing consent-based data sharing controls (e.g., user authorization requirements before transmission, selective data sharing permissions for specific metric types, granular access controls for different healthcare providers, revocable sharing permissions, and/or the like) that enable the target signal source 104-1 to control which output metrics 310 and historical data are shared with external systems while maintaining privacy for data that the target signal source 104-1 chooses not to share. The data synchronization workflows can include secure data transmission (e.g., end-to-end encryption of transmitted data, certificate-based authentication of receiving systems, secure socket layer connections for data transfer, Health Insurance Portability and Accountability Act compliant transmission protocols, and/or the like) that protects the confidentiality of personal health information during transmission to Electronic Health Record systems and healthcare provider platforms. The data synchronization workflows can include data retention management (e.g., automatic deletion of transmitted data copies, storage quota enforcement, archival of historical data to secure backup storage, and/or the like) that manages the accumulation of data on the apparatus 102 while ensuring that transmitted data reaches intended recipients for clinical workflow integration.

With continued reference to FIG. 6, the step 612 can include executing continuous monitoring workflows (e.g., persistent observation procedures, scheduled measurement sequences, periodic health assessments, background monitoring operations, and/or the like) through the orchestration module 225 that enable the signal monitoring platform 200 to operate continuously (e.g., 24 hours per day, 7 days per week, and/or the like) to provide persistent health monitoring of the target signal source 104-1 within the environment 100. The continuous monitoring workflows can include scheduling periodic measurement captures (e.g., hourly vital sign checks, daily gait assessments, weekly trend analyses, monthly comprehensive evaluations, and/or the like) that ensure regular collection of output metrics 310 for longitudinal health tracking and early detection of gradual changes in the physiological status of the target signal source 104-1. The continuous monitoring workflows can include implementing power management routines (e.g., battery level monitoring, charging schedule coordination, low-power standby modes, energy-efficient sensor activation patterns, and/or the like) that enable the apparatus 102 to operate continuously while managing energy consumption to maintain availability for monitoring operations. The continuous monitoring workflows can include background observation operations (e.g., passive environment signal capture, ambient monitoring without active tracking, opportunistic measurement collection, and/or the like) that capture environment signals when the target signal source 104-1 is within the field of view of the sensors 306 without requiring active navigation or positioning adjustments by the apparatus 102. The continuous monitoring workflows can include returning to the step 602 to initiate new monitoring cycles when scheduled measurement times arrive or when the orchestration module 225 detects that the target signal source 104-1 has moved to a new location within the environment 100 requiring apparatus displacement for continued observation.

As shown in FIG. 6, the process 600 can implement a gait analysis artificial intelligence model (e.g., a neural network classifier for gait pattern recognition, a recurrent neural network for temporal gait sequence analysis, a convolutional neural network for gait feature extraction, a transformer model for gait sequence modeling, and/or the like) that is trained to predict potential neurodegenerative diseases (e.g., Alzheimer's disease, Parkinson's disease, dementia, Huntington's disease, amyotrophic lateral sclerosis, and/or the like) from continuous gait pattern monitoring performed by the signal processing module 224 on the target signal source 104-1 within the environment 100. The gait analysis artificial intelligence model can be trained using clinical datasets (e.g., gait recordings from patients with confirmed neurodegenerative diagnoses, longitudinal gait data showing disease progression patterns, control group gait data from healthy individuals, multi-center clinical trial gait databases, and/or the like) that provide labeled examples of gait patterns associated with different neurodegenerative conditions and disease stages. The gait analysis artificial intelligence model can learn discriminative features (e.g., gait asymmetry patterns characteristic of Parkinson's disease, shuffling gait signatures associated with dementia, reduced arm swing indicative of early Parkinson's disease, festinating gait patterns, and/or the like) that distinguish between healthy gait and gait patterns indicative of neurodegenerative disease onset or progression. The gait analysis artificial intelligence model can generate disease risk assessments (e.g., probability scores for Parkinson's disease ranging from 0 to 100 percent, likelihood indicators for dementia onset, risk factors for Alzheimer's disease, confidence intervals for disease predictions, and/or the like) based on processing the gait characteristics extracted at the step 608 and comparing the characteristics against patterns learned from clinical datasets. The gait analysis artificial intelligence model can be stored in the artificial intelligence models 258 of the computing database 204 and loaded by the model maintenance module 226 for execution by the processor 210 during the step 608 and the step 610 of the process 600.

With continued reference to FIG. 6, the process 600 can monitor gait characteristics (e.g., walking speed measurements, stride length calculations, support time durations, stride-to-stride variability metrics, cadence values, and/or the like) of the target signal source 104-1 for disease detection applications using the pose estimation routines executed by the signal processing module 224 at the step 608. The walking speed monitoring can include calculating the velocity of forward progression (e.g., meters per second, distance traveled per unit time, average speed over gait cycles, instantaneous speed at each frame, and/or the like) from temporal sequences of skeletal keypoint positions by measuring the displacement of the pelvis or torso keypoints of the target signal source 104-1 over time periods during ambulatory motion, where reduced walking speed correlates with increased risk of neurodegenerative disease and functional decline. The stride length monitoring can include measuring the distance between successive heel strikes of the same foot (e.g., left heel strike to next left heel strike distance, right heel strike to next right heel strike distance, average stride length across multiple gait cycles, and/or the like) from the positions of ankle keypoints detected during walking to quantify the spatial extent of each gait cycle, where shortened stride length indicates potential gait impairment associated with Parkinson's disease or other movement disorders. The support time monitoring can include measuring the duration of single-leg stance phase (e.g., time spent with one foot in contact with the ground while the other foot is in swing phase, weight-bearing period for each leg, percentage of gait cycle spent in single support, and/or the like) from the temporal analysis of ankle keypoint positions to quantify the balance and stability characteristics of the gait pattern, where prolonged support time indicates compensatory strategies for balance deficits. The stride-to-stride variability monitoring can include calculating the coefficient of variation in stride length (e.g., standard deviation of stride length divided by mean stride length, variability in gait cycle timing, consistency metrics across successive strides, and/or the like) from multiple gait cycles to quantify the regularity and predictability of the walking pattern, where increased variability correlates with fall risk and neurodegenerative disease progression. The cadence monitoring can include measuring the steps per minute (e.g., gait cycle frequency, walking rhythm, number of steps taken per unit time, and/or the like) from the temporal sequence of detected footfalls to quantify the pace of ambulatory motion, where altered cadence patterns indicate potential gait abnormalities requiring clinical evaluation.

As further shown in FIG. 6, the process 600 can include future advanced features for blood oxygen saturation estimation (e.g., SpO2 measurement, oxygen saturation percentage calculation, pulse oximetry equivalent readings, peripheral oxygen saturation monitoring, and/or the like) via infrared sensing and stereo vision (e.g., infrared camera imaging, near-infrared light absorption analysis, multi-wavelength optical sensing, stereo depth-enhanced tissue analysis, and/or the like) that enable non-contact measurement of blood oxygenation levels from the target signal source 104-1 without requiring physical contact with pulse oximeter devices. The blood oxygen saturation estimation can include capturing infrared environment signals (e.g., near-infrared reflectance patterns at wavelengths around 660 nanometers and 940 nanometers, infrared absorption characteristics of oxygenated and deoxygenated hemoglobin, multi-spectral imaging data across oxygen-sensitive wavelength bands, and/or the like) using infrared sensors of the actuated sensor assembly 260 that detect variations in light absorption correlating with blood oxygen saturation levels in tissue of the target signal source 104-1. The blood oxygen saturation estimation can include combining infrared analysis with stereo vision depth information (e.g., tissue depth estimation from stereo camera disparity, surface geometry compensation for viewing angle variations, tissue thickness correction factors, and/or the like) from the sensor 206-1 and the sensor 206-2 to improve the accuracy of blood oxygen saturation estimation by accounting for tissue thickness and surface orientation variations that affect light absorption measurements. The blood oxygen saturation estimation can include generating SpO2 output metrics (e.g., oxygen saturation percentage values ranging from 0 to 100 percent, oxygen saturation trend data over time, hypoxia risk indicators when saturation falls below threshold values such as 90 percent, and/or the like) that the generative AI model 320 incorporates into health assessments and alert generation when oxygen saturation levels indicate potential respiratory or cardiovascular concerns requiring clinical attention.

Referring again to FIG. 6, the process 600 can include Electronic Health Record integration (e.g., EHR data exchange, clinical workflow integration, healthcare information system connectivity, patient portal synchronization, and/or the like) with secure data transmission (e.g., encrypted communication channels, Health Insurance Portability and Accountability Act compliant data transfer, secure socket layer connections, certificate-based authentication, and/or the like) for clinical workflow integration that enables healthcare providers to access the output metrics 310 and longitudinal health data generated by the signal monitoring platform 200 within their existing clinical documentation systems. The Electronic Health Record integration can include formatting the output metrics 310 (e.g., the heart rate 312, the temperature 314, gait analysis results, pose estimation data, and/or the like) and historical signal data 257 according to healthcare data standards (e.g., Health Level Seven International Fast Healthcare Interoperability Resources specifications, Continuity of Care Document formats, Clinical Document Architecture templates, Consolidated Clinical Document Architecture standards, and/or the like) that enable interoperability with Electronic Health Record systems (e.g., Epic Systems, Cerner, Meditech, Allscripts, athenahealth, and/or the like) used by healthcare providers for clinical documentation and care coordination. The Electronic Health Record integration can include transmitting formatted health data through the wireless communication circuitry 230 to healthcare provider systems (e.g., hospital information systems, clinic Electronic Health Record platforms, physician practice management systems, remote patient monitoring platforms, and/or the like) using secure communication protocols (e.g., Transport Layer Security version 1.3 encryption, mutual certificate authentication, secure application programming interface connections with OAuth 2.0 authorization, and/or the like) that protect the confidentiality of personal health information during transmission in compliance with Health Insurance Portability and Accountability Act requirements. The Electronic Health Record integration can include implementing bidirectional data exchange (e.g., receiving medication lists from Electronic Health Record systems, obtaining allergy information for medication interaction checking, retrieving historical diagnoses for contextual health assessment, and/or the like) that enables the generative AI model 320 to incorporate clinical information from healthcare provider systems into the health assessments and recommendations generated at the step 610.

With continued reference to FIG. 6, the process 600 can include longitudinal health metric analytics (e.g., trend analysis over extended time periods, pattern recognition across weeks or months of data, progressive change detection, seasonal variation analysis, baseline drift monitoring, and/or the like) that track health patterns of the target signal source 104-1 over extended time periods using the historical signal data 257 stored in the computing database 204. The longitudinal health metric analytics can include analyzing time-series measurement records (e.g., heart rate logs spanning multiple weeks showing circadian rhythm patterns, temperature histories over months revealing fever episodes and recovery patterns, blood pressure trends across seasons indicating seasonal variation effects, glucose level progressions over years tracking diabetes management effectiveness, gait characteristic trends over months detecting gradual mobility decline, and/or the like) to identify gradual changes in physiological baselines that indicate evolving health conditions or responses to treatments. The longitudinal health metric analytics can include generating trend visualizations (e.g., line charts showing measurement trends over configurable time windows, bar graphs comparing weekly or monthly averages against historical baselines, statistical summaries of measurement distributions including mean, standard deviation, and percentile values, heat maps showing temporal patterns in health metrics, and/or the like) that the interface module 227 presents through the display 240 to enable the target signal source 104-1 and healthcare providers to understand long-term health trajectories and identify concerning patterns requiring clinical intervention. The longitudinal health metric analytics can include detecting anomalous patterns (e.g., sudden deviations from established baselines exceeding statistical thresholds, cyclical variations correlating with medication schedules or activity patterns, progressive deterioration trends indicating disease progression, seasonal variations in health metrics, and/or the like) in the longitudinal data that warrant clinical attention or adjustment of care plans. The longitudinal health metric analytics can include generating periodic health summaries (e.g., weekly health reports aggregating daily measurements and notable events, monthly trend assessments comparing current month to previous months, quarterly progress evaluations tracking long-term health goals, annual comprehensive reviews summarizing year-over-year health changes, and/or the like) that aggregate the output metrics 310 and longitudinal analytics into comprehensive reports for review by the target signal source 104-1, caregivers, or healthcare providers through the interface module 227 or through Electronic Health Record integration.

### Example Computing Environment

FIG. 7 is a system diagram illustrating an example of a computing environment in which the disclosed system operates in some implementations. In some implementations, environment 700 includes one or more client computing devices 705A-D, examples of which can host the signal monitoring platform 200 of FIG. 2B. Client computing devices 705 operate in a networked environment using logical connections through network 730 to one or more remote computers, such as a server computing device (e.g., an onboard computing logic of a computing hardware system).

In some implementations, server 710 is an edge server which receives client requests and coordinates fulfillment of those requests through other servers, such as servers 720A-C. In some implementations, servers 710 and 720, or associated computing devices, comprise computing systems, such as the signal monitoring platform 200 of FIG. 2B. Though each server 710 and 720, or associated computing device, is displayed logically as a single server, server computing devices can each be a distributed computing environment encompassing multiple computing devices located at the same or at geographically disparate physical locations. In some implementations, each server 720 corresponds to a group of servers.

Client computing devices 705 and servers 710 and 720, or associated computing devices, can each act as a server or client to other server or client devices. In some implementations, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information such as claims data, email data, call transcripts, call logs, policy data and so on. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN) but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

### Example Machine Learning Architecture

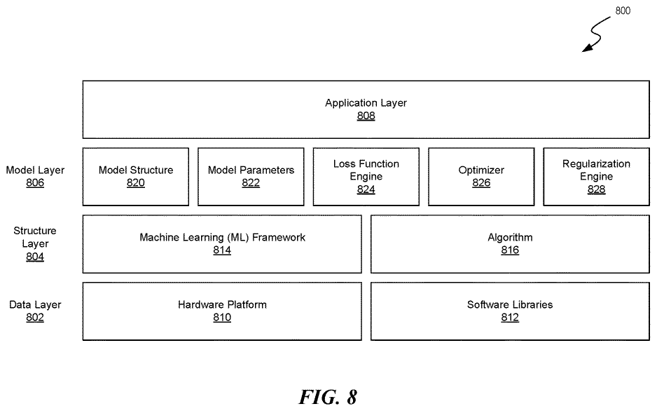

FIG. 8 illustrates a layered architecture of an artificial intelligence (AI) system 800 that can implement the ML models of the signal monitoring platform 200 of FIG. 2B, in accordance with some implementations of the present technology. Example ML models can include one or more executable statistical inference algorithms stored at computing databases 715, 725 and/or retrieved from external service providers (e.g., a third-party cloud host) via the network 730 of the example computing environment 700. Accordingly, the computing environment 700 and/or components thereof (e.g., servers 710, 720, databases 715, 725, network 730, and/or the like) can include, or be incorporated within, one or more components of the AI system 800. The AI system 800 provides a comprehensive software stack capable of hosting suitable runtime environments for one or more operations of ML models, as further described herein.

As shown, the AI system 800 can include a set of layers, which conceptually organize elements within an example network topology for the AI system's architecture to implement a particular AI model. Generally, an AI model is a computer-executable program implemented by the AI system 800 that analyses input data to generate inferential output data (e.g., a classification label for input feature vectors). Information can pass through each layer of the AI system 800 to generate outputs for the AI model. The layers can include a data layer 802, a structure layer 804, a model layer 806, and an application layer 808. The algorithm 816 of the structure layer 804 and the model structure 820 and model parameters 822 of the model layer 806 together form an example AI model. The optimizer 826, loss function engine 824, and regularization engine 828 work to refine and optimize the AI model, and the data layer 802 provides resources and support for application of the AI model by the application layer 808.

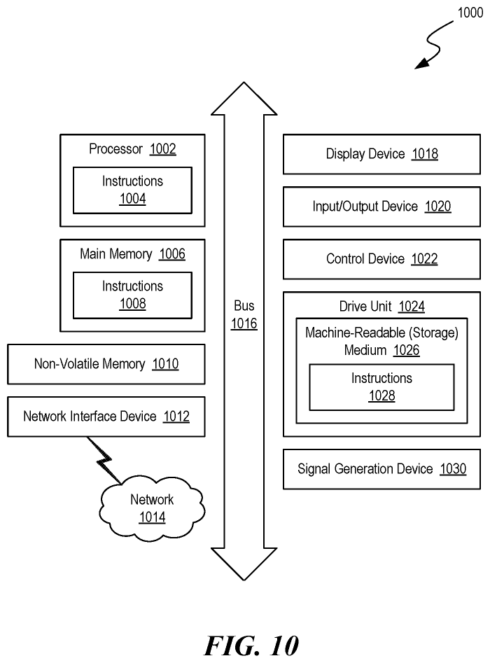

The data layer 802 acts as the foundation of the AI system 800 by preparing data for the AI model. As shown, the data layer 802 can include two sub-layers: a hardware platform 810 and one or more software libraries 812. The hardware platform 810 can be designed to perform operations for the AI model and include computing resources for storage, memory, logic and networking, such as the resources described in relation to FIGS. 7 and 10. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 can include computing resources, (e.g., servers, memory, etc.) offered by a cloud services provider. The hardware platform 810 can also include computer memory for storing data about the AI model, application of the AI model, and training data for the AI model. The computer memory can be a form of random-access memory (RAM), such as dynamic RAM, static RAM, and non-volatile RAM.

The software libraries 812 can be thought of suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include INTEL Math Kernel Library, NVIDIA cuDNN, EIGEN, and OpenBLAS.

The structure layer 804 can include an ML framework 814 and an algorithm 816. The ML framework 814 can be thought of as an interface, library, or tool that allows users to build and deploy the AI model. The ML framework 814 can include an open-source library, an application programming interface (API), a gradient-boosting library, an ensemble method, and/or a deep learning toolkit that work with the layers of the AI system facilitate development of the AI model. For example, the ML framework 814 can distribute processes for application or training of the AI model across multiple resources in the hardware platform 810. The ML framework 814 can also include a set of pre-built components that have the functionality to implement and train the AI model and allow users to use pre-built functions and classes to construct and train the AI model. Thus, the ML framework 814 can be used to facilitate data engineering, development, hyperparameter tuning, testing, and training for the AI model. Examples of ML frameworks 814 that can be used in the AI system 800 include TENSORFLOW, PYTORCH, SCIKIT-LEARN, KERAS, LightGBM, RANDOM FOREST, and AMAZON WEB SERVICES.

The algorithm 816 can be an organized set of computer-executable operations used to generate output data from a set of input data and can be described using pseudocode. The algorithm 816 can include complex code that allows the computing resources to learn from new input data and create new/modified outputs based on what was learned. In some implementations, the algorithm 816 can build the AI model through being trained while running computing resources of the hardware platform 810. This training allows the algorithm 816 to make predictions or decisions without being explicitly programmed to do so. Once trained, the algorithm 816 can run at the computing resources as part of the AI model to make predictions or decisions, improve computing resource performance, or perform tasks. The algorithm 816 can be trained using supervised learning, unsupervised learning, semi-supervised learning, and/or reinforcement learning.

Using supervised learning, the algorithm 816 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. Furthermore, training data can include spatial mappings 251, spatial position data 252, spatial environment metadata 253, signal source reference data 254, ontological reference data 255, signal data cache 256, historical signal data 257, and/or the like of the signal monitoring platform 200 described in relation to FIG. 2B. The user may label the training data based on one or more classes and trains the AI model by inputting the training data into the algorithm 816. The algorithm determines how to label the new data based on the labeled training data. The user can facilitate collection, labeling, and/or input via the ML framework 814. In some instances, the user may convert the training data to a set of feature vectors for input to the algorithm 816. Once trained, the user can test the algorithm 816 on new data to determine if the algorithm 816 is predicting accurate labels for the new data. For example, the user can use cross-validation methods to test the accuracy of the algorithm 816 and retrain the algorithm 816 on new training data if the results of the cross-validation are below an accuracy threshold.

Supervised learning can involve classification and/or regression. Classification techniques involve teaching the algorithm 816 to identify a category of new observations based on training data and are used when input data for the algorithm 816 is discrete. Said differently, when learning through classification techniques, the algorithm 816 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 816 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 816 is continuous. Regression techniques can be used to train the algorithm 816 to predict or forecast relationships between variables. To train the algorithm 816 using regression techniques, a user can select a regression method for estimating the parameters of the model. The user collects and labels training data that is input to the algorithm 816 such that the algorithm 816 is trained to understand the relationship between data features and the dependent variable(s). Once trained, the algorithm 816 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 816 learns patterns from unlabeled training data. In particular, the algorithm 816 is trained to learn hidden patterns and insights of input data, which can be used for data exploration or for generating new data. Here, the algorithm 816 does not have a predefined output, unlike the labels output when the algorithm 816 is trained using supervised learning. Said another way, unsupervised learning is used to train the algorithm 816 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remains in a group that has less or no similarities to another group. Examples of clustering techniques density-based methods, hierarchical based methods, partitioning methods, and grid-based methods. In one example, the algorithm 816 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 816 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 816 include factor analysis, item response theory, latent profile analysis, and latent class analysis.

The model layer 806 implements the AI model using data from the data layer and the algorithm 816 and ML framework 814 from the structure layer 804, thus enabling decision-making capabilities of the AI system 800. The model layer 806 includes a model structure 820, model parameters 822, a loss function engine 824, an optimizer 826, and a regularization engine 828.

The model structure 820 describes the architecture of the AI model of the AI system 800. The model structure 820 defines the complexity of the pattern/relationship that the AI model expresses. Examples of structures that can be used as the model structure 820 include decision trees, support vector machines, regression analyses, Bayesian networks, Gaussian processes, genetic algorithms, and artificial neural networks (or, simply, neural networks). The model structure 820 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 820 may include one or more hidden layers of nodes between the input and output layers. The model structure 820 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 822 represent the relationships learned during training and can be used to make predictions and decisions based on input data. The model parameters 822 can weight and bias the nodes and connections of the model structure 820. For instance, when the model structure 820 is a neural network, the model parameters 822 can weight and bias the nodes in each layer of the neural networks, such that the weights determine the strength of the nodes and the biases determine the thresholds for the activation functions of each node. The model parameters 822, in conjunction with the activation functions of the nodes, determine how input data is transformed into desired outputs. The model parameters 822 can be determined and/or altered during training of the algorithm 816.

The loss function engine 824 can determine a loss function, which is a metric used to evaluate the AI model's performance during training. For instance, the loss function engine 824 can measure the difference between a predicted output of the AI model and the actual output of the AI model and is used to guide optimization of the AI model during training to minimize the loss function. The loss function may be presented via the ML framework 814, such that a user can determine whether to retrain or otherwise alter the algorithm 816 if the loss function is over a threshold. In some instances, the algorithm 816 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 826 adjusts the model parameters 822 to minimize the loss function during training of the algorithm 816. In other words, the optimizer 826 uses the loss function generated by the loss function engine 824 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 826 used may be determined based on the type of model structure 820 and the size of data and the computing resources available in the data layer 802.

The regularization engine 828 executes regularization operations. Regularization is a technique that prevents over- and under-fitting of the AI model. Overfitting occurs when the algorithm 816 is overly complex and too adapted to the training data, which can result in poor performance of the AI model. Underfitting occurs when the algorithm 816 is unable to recognize even basic patterns from the training data such that it cannot perform well on training data or on validation data. The optimizer 826 can apply one or more regularization techniques to fit the algorithm 816 to the training data properly, which helps constraint the resulting AI model and improves its ability for generalized application. Examples of regularization techniques include lasso (L1) regularization, ridge (L2) regularization, and elastic (L1 and L2 regularization).

The application layer 808 describes how the AI system 800 is used to solve problem or perform tasks. In an example implementation, the application layer 808 can be communicatively coupled (e.g., display application data, receive user input, and/or the like) to an interactable user interface of the signal monitoring platform 200 of FIG. 2B.

### Example Transformer for Machine Learning Models

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

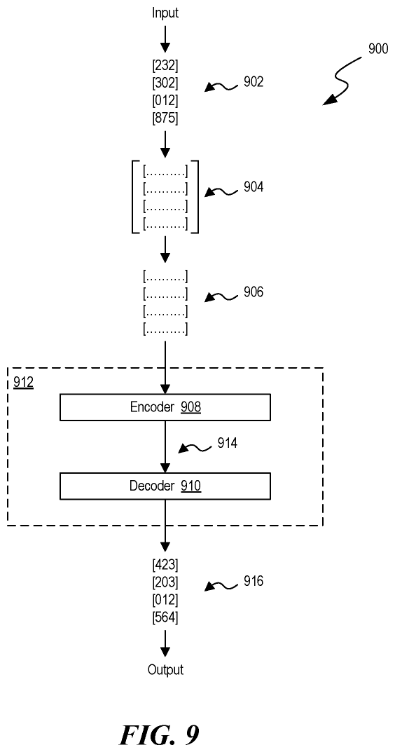

FIG. 9 is a block diagram of an example transformer 912 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 912 includes an encoder 908 (which can comprise one or more encoder layers/blocks connected in series) and a decoder 910 (which can comprise one or more decoder layers/blocks connected in series). Generally, the encoder 908 and the decoder 910 each include a plurality of neural network layers, at least one of which can be a self-attention layer. The parameters of the neural network layers can be referred to as the parameters of the language model.

The transformer 912 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 912 is trained to perform certain functions on other input formats than natural language input. For example, the input can include objects, images, audio content, or video content, or a combination thereof.

The transformer 912 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 9 illustrates an example of how the transformer 912 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write one summary” can be parsed into the segments [write], [one], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 9, a short sequence of tokens 902 corresponding to the input text is illustrated as input to the transformer 912. Tokenization of the text sequence into the tokens 902 can be performed by some pre-processing tokenization module such as, for example, a byte-pair encoding tokenizer (the “pre” referring to the tokenization occurring prior to the processing of the tokenized input by the LLM), which is not shown in FIG. 9 for simplicity. In general, the token sequence that is inputted to the transformer 912 can be of any length up to a maximum length defined based on the dimensions of the transformer 912. Each token 902 in the token sequence is converted into an embedding vector (also referred to simply as an embedding 906). An embedding 906 is a learned numerical representation (such as, for example, a vector) of a token that captures some semantic meaning of the text segment represented by the token 902. The embedding 906 represents the text segment corresponding to the token 902 in a way such that embeddings corresponding to semantically related text are closer to each other in a vector space than embeddings corresponding to semantically unrelated text. For example, assuming that the words “write,” “one,” and “summary” each correspond to, respectively, a “write” token, an “one” token, and a “summary” token when tokenized, the embedding 906 corresponding to the “write” token will be closer to another embedding corresponding to the “jot down” token in the vector space as compared to the distance between the embedding 906 corresponding to the “write” token and another embedding corresponding to the “summary” token.

The vector space can be defined by the dimensions and values of the embedding vectors. Various techniques can be used to convert a token 902 to an embedding 906. For example, another trained ML model can be used to convert the token 902 into an embedding 906. In particular, another trained ML model can be used to convert the token 902 into an embedding 906 in a way that encodes additional information into the embedding 906 (e.g., a trained ML model can encode positional information about the position of the token 902 in the text sequence into the embedding 906). In some examples, the numerical value of the token 902 can be used to look up the corresponding embedding in an embedding matrix 904 (which can be learned during training of the transformer 912).

The generated embeddings 906 are input into the encoder 908. The encoder 908 serves to encode the embeddings 906 into feature vectors 914 that represent the latent features of the embeddings 906. The encoder 908 can encode positional information (i.e., information about the sequence of the input) in the feature vectors 914. The feature vectors 914 can have very high dimensionality (e.g., on the order of thousands or tens of thousands), with each element in a feature vector 914 corresponding to a respective feature. The numerical weight of each element in a feature vector 914 represents the importance of the corresponding feature. The space of all possible feature vectors 914 that can be generated by the encoder 908 can be referred to as the latent space or feature space.

Conceptually, the decoder 910 is designed to map the features represented by the feature vectors 914 into meaningful output, which can depend on the task that was assigned to the transformer 912. For example, if the transformer 912 is used for a translation task, the decoder 910 can map the feature vectors 914 into text output in a target language different from the language of the original tokens 902. Generally, in a generative language model, the decoder 910 serves to decode the feature vectors 914 into a sequence of tokens. The decoder 910 can generate output tokens 916 one by one. Each output token 916 can be fed back as input to the decoder 910 in order to generate the next output token 916. By feeding back the generated output and applying self-attention, the decoder 910 is able to generate a sequence of output tokens 916 that has sequential meaning (e.g., the resulting output text sequence is understandable as a sentence and obeys grammatical rules). The decoder 910 can generate output tokens 916 until a special [EOT] token (indicating the end of the text) is generated. The resulting sequence of output tokens 916 can then be converted to a text sequence in post-processing. For example, each output token 916 can be an integer number that corresponds to a vocabulary index. By looking up the text segment using the vocabulary index, the text segment corresponding to each output token 916 can be retrieved, the text segments can be concatenated together, and the final output text sequence can be obtained.

In some examples, the input provided to the transformer 912 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Example Computer System

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Further Examples

In some implementations, the techniques described herein relate to an edge computing apparatus for monitoring multi-modal signals. The edge computing apparatus can include at least one hardware processor, one or more sensors coupled to the at least one hardware processor that are configured to capture data signals associated with a target signal source, and at least one non-transitory memory storing instructions. The instructions, when executed by the at least one hardware processor, can cause the apparatus to obtain, via activating the one or more sensors, a first environment signal set indicating a physical environment around the edge computing apparatus that includes the target signal source. The apparatus can calculate, using an environment signal subset from the first environment signal set, a spatial position of the target signal source within the physical environment. The apparatus can adjust spatial positioning of the one or more sensors relative to the spatial position of the target signal source to uncover a region of interest corresponding to the target signal source. The apparatus can obtain, via activating the one or more sensors over a time period, a second environment signal set of a uniform data modality indicating physical features of the region of interest. The apparatus can input the second environment signal set into one or more artificial intelligence (AI) models to generate at least two output metrics of data modalities different from the uniform data modality, the at least two output metrics indicating physiological measurements associated with the target signal source. The apparatus can input the at least two output metrics into a generative AI model to generate one or more metric deviation scores for the at least two output metrics, the one or more metric deviation scores indicating degrees of deviation between the at least two output metrics and a physiological baseline associated with the target signal source. Responsive to the one or more metric deviation scores failing a tolerance threshold value, the apparatus can automatically transmit a notification indicating required maintenance of the target signal source.

In some implementations, the techniques described herein relate to an edge computing apparatus, wherein the apparatus includes one or more actuators enabling displacement of the apparatus within the physical environment. The apparatus can be further caused to obtain, from a cache memory coupled to the at least one hardware processor, a spatial mapping of the physical environment including one or more key spatial positions associated with confidence scores that satisfy a validation threshold, the confidence scores indicating likelihood of the target signal source existing near the one or more key spatial positions. The apparatus can generate, using the spatial mapping of the physical environment, an ordered sequence of key spatial positions from an initial spatial position to a final spatial position, wherein the initial spatial position is closest to a current spatial position of the apparatus and the final spatial position is closest to a second target signal source. The apparatus can cause the one or more actuators to displace the apparatus from the current spatial position to the final spatial position following the ordered sequence of key spatial positions.

In some implementations, the techniques described herein relate to an edge computing apparatus further caused to selectively extract two or more environment signal subsets that indicate distinct depth values between a relative spatial position of the target signal source and different known spatial positions within the physical environment. The apparatus can determine, using the distinct depth values of the two or more environment signal subsets, the spatial position of the target signal source.

In some implementations, the techniques described herein relate to an edge computing apparatus, wherein the spatial position of the target signal source is a first spatial position. The edge computing apparatus can be further caused to detect, via the one or more sensors, displacement of the target signal source from the first spatial position to a second spatial position within the physical environment. The apparatus can re-adjust spatial positioning of the one or more sensors relative to the second spatial position of the target signal source to continue uncovering the region of interest.

In some implementations, the techniques described herein relate to an edge computing apparatus further caused to retrieve, from a cache memory coupled to the at least one hardware processor, one or more prior output metrics that indicate physiological measurements associated with the target signal source at a prior timestamp. The apparatus can re-train the generative AI model using the one or more prior output metrics and the at least two output metrics.

In some implementations, the techniques described herein relate to an edge computing apparatus further caused to retrieve, from a cache memory coupled to the at least one hardware processor, a historical record associated with the target signal source. The historical record can include at least one prior output metric indicating physiological measurements associated with the target signal source at a prior timestamp. The apparatus can input the at least one prior output metric and the at least two output metrics into the generative AI model to generate the one or more metric deviation scores.

In some implementations, the techniques described herein relate to an edge computing apparatus, wherein the target signal source can correspond to a user, a physical object, or a combination thereof.

In some implementations, the techniques described herein relate to an edge computing apparatus, wherein the at least two output metrics of physiological measurements can include a heart rate, a body temperature, a skeletal pose, a measurement originating from a digital device, or a combination thereof.

In some implementations, the techniques described herein relate to an edge computing apparatus, wherein the one or more AI models include an ensemble of AI models that are trained to transform input data of the uniform data modality into output metrics of data modalities different from the uniform data modality.

In some implementations, the techniques described herein relate to an edge computing apparatus, wherein the first environment signal set of the uniform data modality is obtained via the one or more sensors without physical contact with the target signal source

In some implementations, the techniques described herein relate to an edge computing apparatus, wherein the first environment signal set of the uniform data modality includes digital images.

In some implementations, the techniques described herein relate to at least one non-transitory, computer-readable storage medium, including instructions recorded thereon. The instructions, when executed by at least one data processor of an edge computing system, can cause the edge computing system to receive, via a user interface, an input query requesting physiological information associated with a target signal source that exists within a physical environment accessible to the edge computing system. The system can capture, using one or more sensors over a time period, an environment signal set of a uniform data modality indicating physical features of a region of interest corresponding to the target signal source. The system can input the environment signal set into one or more artificial intelligence (AI) models to generate at least two output metrics of data modalities different from the uniform data modality, the at least two output metrics indicating physiological measurements associated with the target signal source. The system can input the at least two output metrics and the input query into a generative AI model to generate an alphanumeric signal based, in part, on the at least two output metrics that responds to the input query. The system can cause to display, at the user interface, the alphanumeric signal for the input query.

In some implementations, the techniques described herein relate to an at least one non-transitory, computer-readable storage medium, wherein the instructions further cause the system to input the input query into the generative AI model to determine a region of interest on the target signal source for capturing environment signals using the one or more sensors. The system can adjust spatial positioning of the one or more sensors relative to a spatial position of the target signal source to uncover the region of interest of the target signal source.

In some implementations, the techniques described herein relate to an at least one non-transitory, computer-readable storage medium, wherein the instructions further cause the system to generate, using the environment signal set captured via the one or more sensors, a structural spatial graph representing one or more connected physical features of the target signal source. The system can input the structural spatial graph and the input query into the generative AI model to generate the alphanumeric signal that responds to the input query.

In some implementations, the techniques described herein relate to an at least one non-transitory, computer-readable storage medium, wherein the instructions further cause the system to input the at least two output metrics into the generative AI model to generate one or more metric deviation scores for the at least two output metrics, the one or more metric deviation scores indicating degrees of deviation between the at least two output metrics and a physiological baseline associated with the target signal source. Responsive to the one or more metric deviation scores failing a tolerance threshold value, the system can automatically transmit a notification indicating required maintenance of the target signal source.

In some implementations, the techniques described herein relate to an at least one non-transitory, computer-readable storage medium, wherein the instructions further cause the system to retrieve, from a cache memory, a historical record associated with the target signal source. The historical record can include at least one prior output metric indicating physiological measurements associated with the target signal source at a prior timestamp. The system can input the at least one prior output metric and the at least two output metrics into the generative AI model to generate the one or more metric deviation scores.

In some implementations, the techniques described herein relate to at least one non-transitory, computer-readable storage medium, including instructions recorded thereon. The instructions, when executed by at least one data processor of an edge computing device, can cause the edge computing device to capture, using one or more sensors over a time period, a first environment signal set of a uniform data modality indicating physical features for a region of interest within a physical environment that corresponds to a target signal source. The device can input the first environment signal set into one or more artificial intelligence (AI) models to generate at least two output metrics of data modalities different from the uniform data modality, the at least two output metrics indicating select physiological measurements associated with the target signal source. The device can input the first environment signal set and the at least two output metrics into a generative AI model to generate a signal quality score indicating a degree of correspondence between the first environment signal set and the select physiological measurements. Responsive to the at least two output metrics failing to satisfy a minimum correspondence threshold value, the device can selectively determine, from a stored mapping of available signal sources within the physical environment that are associated with the target signal source, at least one second target signal source for capturing a second environment signal set that complements the first environment signal set to satisfy the minimum correspondence threshold value. The device can obtain, from a cache memory, a spatial mapping of the physical environment that maps the available signal sources to corresponding spatial positions within the physical environment. The device can input the spatial mapping of the physical environment into a generative AI model to generate an ordered sequence of key spatial positions from an initial spatial position to a final spatial position, wherein the initial spatial position is closest to a first spatial position corresponding to the target signal source and the final spatial position is closest to a second spatial position corresponding to the at least one second target signal source. The device can capture, using the one or more sensors over a second time period, the second environment signal set at the second spatial position of the at least one second target signal source via causing one or more actuators to displace the one or more sensors from the first spatial position to the second spatial position. The device can input the first environment signal set and the second environment signal set into the one or more AI models to re-generate at least two output metrics of data modalities different from the uniform data modality.

In some implementations, the techniques described herein relate to an at least one non-transitory, computer-readable storage medium, wherein the one or more sensors are located at a first configuration of spatial positions around the target signal source within the physical environment. The instructions can further cause the device to generate a second configuration of spatial positions different from the first configuration for locating the one or more sensors around the target signal source. The device can capture, using the one or more sensors over a third time period, a third environment signal set via causing the one or more actuators to displace the one or more sensors from the first configuration of spatial positions to the second configuration of spatial positions. The device can input the first environment signal set, the second environment signal set, and the third environment signal set into the one or more AI models to re-generate at least two output metrics of data modalities different from the uniform data modality.

In some implementations, the techniques described herein relate to an at least one non-transitory, computer-readable storage medium, wherein the instructions further cause the device to retrieve, from a cache memory, one or more prior output metrics that indicate physiological measurements associated with the target signal source at a prior timestamp. The device can re-train the generative AI model using the one or more prior output metrics and the at least two output metrics.

In some implementations, the techniques described herein relate to an at least one non-transitory, computer-readable storage medium, wherein the at least two output metrics of physiological measurements can include a heart rate, a body temperature, a skeletal pose, a measurement originating from a digital device, or a combination thereof.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any specific portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. An edge computing apparatus for monitoring multi-modal signals, the edge computing apparatus comprising:
at least one hardware processor;
one or more sensors coupled to the at least one hardware processor that are configured to capture data signals associated with a target signal source; and
at least one non-transitory memory storing instructions, which, when executed by the at least one hardware processor, cause the apparatus to:
obtain, via activating the one or more sensors, a first environment signal set indicating a physical environment around the edge computing apparatus that comprises the target signal source;
calculate, using an environment signal subset from the first environment signal set, a spatial position of the target signal source within the physical environment;
adjust spatial positioning of the one or more sensors relative to the spatial position of the target signal source to uncover a region of interest corresponding to the target signal source;
obtain, via activating the one or more sensors over a time period, a second environment signal set of a uniform data modality indicating physical features of the region of interest;
input the second environment signal set into one or more artificial intelligence (AI) models to generate at least two output metrics of data modalities different from the uniform data modality, the at least two output metrics indicating physiological measurements associated with the target signal source;
input the at least two output metrics into a generative AI model to generate one or more metric deviation scores for the at least two output metrics, the one or more metric deviation scores indicating degrees of deviation between the at least two output metrics and a physiological baseline associated with the target signal source; and
responsive to the one or more metric deviation scores failing a tolerance threshold value, automatically transmit a notification indicating required maintenance of the target signal source.

2. The edge computing apparatus of claim 1, wherein the apparatus comprises one or more actuators enabling displacement of the apparatus within the physical environment, and wherein the apparatus is further caused to:
obtain, from a cache memory coupled to the at least one hardware processor, a spatial mapping of the physical environment comprising one or more key spatial positions associated with confidence scores that satisfy a validation threshold, the confidence scores indicating likelihood of the target signal source existing near the one or more key spatial positions;
generate, using the spatial mapping of the physical environment, an ordered sequence of key spatial positions from an initial spatial position to a final spatial position,
wherein the initial spatial position is closest to a current spatial position of the apparatus and the final spatial position is closest to a second target signal source; and
cause the one or more actuators to displace the apparatus from the current spatial position to the final spatial position following the ordered sequence of key spatial positions.

3. The edge computing apparatus of claim 1 further caused to:
selectively extract two or more environment signal subsets that indicate distinct depth values between a relative spatial position of the target signal source and different known spatial positions within the physical environment; and
determine, using the distinct depth values of the two or more environment signal subsets, the spatial position of the target signal source.

4. The edge computing apparatus of claim 1, wherein the spatial position of the target signal source is a first spatial position, and wherein the edge computing apparatus is further caused to:
detect, via the one or more sensors, displacement of the target signal source from the first spatial position to a second spatial position within the physical environment; and
re-adjust spatial positioning of the one or more sensors relative to the second spatial position of the target signal source to continue uncovering the region of interest.

5. The edge computing apparatus of claim 1 further caused to:
retrieve, from a cache memory coupled to the at least one hardware processor, one or more prior output metrics that indicate physiological measurements associated with the target signal source at a prior timestamp; and
re-train the generative AI model using the one or more prior output metrics and the at least two output metrics.

6. The edge computing apparatus of claim 1 further caused to:
retrieve, from a cache memory coupled to the at least one hardware processor, a historical record associated with the target signal source, the historical record comprising at least one prior output metric indicating physiological measurements associated with the target signal source at a prior timestamp; and
input the at least one prior output metric and the at least two output metrics into the generative AI model to generate the one or more metric deviation scores.

7. The edge computing apparatus of claim 1, wherein the target signal source can correspond to a user, a physical object, or a combination thereof.

8. The edge computing apparatus of claim 1, wherein the at least two output metrics of physiological measurements can comprise a heart rate, a body temperature, a skeletal pose, a measurement originating from a digital device, or a combination thereof.

9. The edge computing apparatus of claim 1, wherein the one or more AI models comprise an ensemble of AI models that are trained to transform input data of the uniform data modality into output metrics of data modalities different from the uniform data modality.

10. The edge computing apparatus of claim 1, wherein the first environment signal set of the uniform data modality is obtained via the one or more sensors without physical contact with the target signal source.

11. The edge computing apparatus of claim 1, wherein the first environment signal set of the uniform data modality comprises digital images.

12. At least one non-transitory, computer-readable storage medium, comprising instructions recorded thereon, wherein the instructions when executed by at least one data processor of an edge computing system, cause the edge computing system to:
receive, via a user interface, an input query requesting physiological information associated with a target signal source that exists within a physical environment accessible to the edge computing system;
capture, using one or more sensors over a time period, a environment signal set of a uniform data modality indicating physical features of a region of interest corresponding to the target signal source;
input the environment signal set into one or more artificial intelligence (AI) models to generate at least two output metrics of data modalities different from the uniform data modality, the at least two output metrics indicating physiological measurements associated with the target signal source;
input the at least two output metrics and the input query into a generative AI model to generate an alphanumeric signal based, in part, on the at least two output metrics that responds to the input query; and
cause to display, at the user interface, the alphanumeric signal for the input query.

13. The at least one non-transitory, computer-readable storage medium of claim 12, wherein the instructions further cause the system to:
input the input query into the generative AI model to determine a region of interest on the target signal source for capturing environment signals using the one or more sensors; and
adjust spatial positioning of the one or more sensors relative to a spatial position of the target signal source to uncover the region of interest of the target signal source.

14. The at least one non-transitory, computer-readable storage medium of claim 12, wherein the instructions further cause the system to:
generate, using the environment signal set captured via the one or more sensors, a structural spatial graph representing one or more connected physical features of the target signal source; and
input the structural spatial graph and the input query into the generative AI model to generate the alphanumeric signal that responds to the input query.

15. The at least one non-transitory, computer-readable storage medium of claim 12, wherein the instructions further cause the system to:
input the at least two output metrics into the generative AI model to generate one or more metric deviation scores for the at least two output metrics, the one or more metric deviation scores indicating degrees of deviation between the at least two output metrics and a physiological baseline associated with the target signal source; and
responsive to the one or more metric deviation scores failing a tolerance threshold value, automatically transmit a notification indicating required maintenance of the target signal source.

16. The at least one non-transitory, computer-readable storage medium of claim 15, wherein the instructions further cause the system to:
retrieve, from a cache memory, a historical record associated with the target signal source, the historical record comprising at least one prior output metric indicating physiological measurements associated with the target signal source at a prior timestamp; and
input the at least one prior output metric and the at least two output metrics into the generative AI model to generate the one or more metric deviation scores.

17. At least one non-transitory, computer-readable storage medium, comprising instructions recorded thereon, wherein the instructions when executed by at least one data processor of an edge computing device, cause the edge computing device to:
capture, using one or more sensors over a time period, a first environment signal set of a uniform data modality indicating physical features for a region of interest within a physical environment that corresponds to a target signal source;
input the first environment signal set into one or more artificial intelligence (AI) models to generate at least two output metrics of data modalities different from the uniform data modality, the at least two output metrics indicating select physiological measurements associated with the target signal source;
input the first environment signal set and the at least two output metrics into a generative AI model to generate a signal quality score indicating a degree of correspondence between the first environment signal set and the select physiological measurements; and
responsive to the at least two output metrics failing to satisfy a minimum correspondence threshold value:
selectively determine, from a stored mapping of available signal sources within the physical environment that are associated with the target signal source, at least one second target signal source for capturing a second environment signal set that complements the first environment signal set to satisfy the minimum correspondence threshold value;
obtain, from a cache memory, a spatial mapping of the physical environment that maps the available signal sources to corresponding spatial positions within the physical environment;
input the spatial mapping of the physical environment into a generative AI model to generate an ordered sequence of key spatial positions from an initial spatial position to a final spatial position,
wherein the initial spatial position is closest to a first spatial position corresponding to the target signal source and the final spatial position is closest to a second spatial position corresponding to the at least one second target signal source;
capture, using the one or more sensors over a second time period, the second environment signal set at the second spatial position of the at least one second target signal source via causing one or more actuators to displace the one or more sensors from the first spatial position to the second spatial position; and
input the first environment signal set and the second environment signal set into the one or more AI models to re-generate at least two output metrics of data modalities different from the uniform data modality.

18. The at least one non-transitory, computer-readable storage medium of claim 17, wherein the one or more sensors are located at a first configuration of spatial positions around the target signal source within the physical environment, and wherein the instructions further cause the device to:
generate a second configuration of spatial positions different from the first configuration for locating the one or more sensors around the target signal source;
capture, using the one or more sensors over a third time period, a third environment signal set via causing the one or more actuators to displace the one or more sensors from the first configuration of spatial positions to the second configuration of spatial positions; and
input the first environment signal set, the second environment signal set, and the third environment signal set into the one or more AI models to re-generate at least two output metrics of data modalities different from the uniform data modality.

19. The at least one non-transitory, computer-readable storage medium of claim 17, wherein the instructions further cause the device to:
retrieve, from a cache memory, one or more prior output metrics that indicate physiological measurements associated with the target signal source at a prior timestamp; and
re-train the generative AI model using the one or more prior output metrics and the at least two output metrics.

20. The at least one non-transitory, computer-readable storage medium of claim 17, wherein the at least two output metrics of physiological measurements can comprise a heart rate, a body temperature, a skeletal pose, a measurement originating from a digital device, or a combination thereof.
